(19) United States
(12) Patent Application Publication
(10) Pub. No.: US 2025/0245424 A1
(43) Pub. Date: Jul. 31, 2025

(54) METHODS AND SYSTEMS FOR A FAMILY OF DUAL ENTRY SPREADSHEET FUNCTIONS, IMPROVED SPREADSHEET VALIDATIONS, AND PARTIAL LOCKING OF SPREADSHEET FUNCTIONS AND CELL CAPABILITIES

(71) Applicant: Adaptam Inc., Palo Alto, CA (US)

(72) Inventors: Robert E. Dvorak, Portola Valley, CA (US); Yuriy Garin, San Carlos, CA (US); Alexey Verkhovskiy, Calgary (CA)

(73) Assignee: Adaptam Inc., Palo Alto, CA (US)

(21) Appl. No.: 19/031,145

(22) Filed: Jan. 17, 2025

Related U.S. Application Data
(60) Provisional application No. 63/622,515, filed on Jan. 18, 2024.

(51) Int. Cl. G06F 40/18

(52) U.S. Cl. CPC G06F 40/18

(57) ABSTRACT

The disclosed technology creates differentiated input prebuilt spreadsheet functions including a family of input validation functions. It also creates a regular input family of input validation functions. It creates multiple values within a single cell validation capability. It creates a partial locking cell and function capability working for the prior mentioned spreadsheet functions and capabilities as well as additional spreadsheet functions and capabilities.

### CROSS-REFERENCE

This application claims the benefit of and priority to U.S. Application No. 63/622,515 titled “Methods and Systems for a Family of Dual Entry Spreadsheet Functions, Improved Spreadsheet Validations, and Partial Locking of Spreadsheet Functions and Cell Capabilities,” filed 18 Jan. 2024. The priority application is incorporated by reference herein for all purposes.

### RELATED APPLICATIONS

This application is related to and incorporates by reference the following applications:

U.S. application Ser. No. 16/31,339 titled “Methods and Systems for Providing Selective Multi-Way Replication and Atomization of Cell Blocks and Other Elements in Spreadsheets and Presentations,” filed 10 Jul. 2018, now U.S. Pat. No. 11,182,548, issued 23 Nov. 2021, which claims the benefit of U.S. Provisional Application No. 62/530,835, filed 10 Jul. 2017.

U.S. application Ser. No. 16/31,379 titled “Methods and Systems for Connecting a Spreadsheet to External Data Sources with Formulaic Specification of Data Retrieval,” filed 10 Jul. 2018, now U.S. Pat. No. 11,354,494, issued 7 Jun. 2022, which claims the benefit of U.S. Provisional Application No. 62/530,786, filed 10 Jul. 2017.

U.S. application Ser. No. 16/31,759 titled “Methods and Systems for Connecting a Spreadsheet to External Data Sources with Temporal Replication of Cell Blocks,” filed 10 Jul. 2018, now U.S. Pat. No. 11,017,165, issued 25 May 2021, which claims the benefit of U.S. Provisional Patent Application No. 62/530,794, filed 10 Jul. 2017.

U.S. application Ser. No. 16/191,402 titled “Methods and Systems for Connecting a Spreadsheet to External Data Sources with Ordered Formulaic Specification of Data Retrieved,” filed 14 Nov. 2018, now U.S. Pat. No. 11,036,929, issued 15 Jun. 2021, which claims the benefit of U.S. Provisional Patent Application No. 62/586,719, filed on Nov. 15, 2017.

U.S. application Ser. No. 17/359,430 titled “Methods and Systems for Constructing a Complex Formula in a Spreadsheet Cell,” filed 25 Jun. 2021, now U.S. Pat. No. 11,836,444, issued 5 Dec. 2023, which claims the benefit of U.S. Provisional Patent Application No. 63/044,990, filed 26 Jun. 2020.

U.S. application Ser. No. 17/359,418 titled “Methods and Systems for Presenting Drop-Down, Pop-Up or Other Presentation of a Multi-Value Data Set in a Spreadsheet Cell,” filed 25 Jun. 2021, now U.S. Pat. No. 11,657,217, issued 25 May 2023, which claims the benefit of U.S. Provisional Patent Application No. 63/044,989, filed 26 Jun. 2020.

U.S. application Ser. No. 17/384,404 titled “Method and System for Improved Spreadsheet Charts,” filed 23 Jul. 2021, now U.S. Pat. No. 12,056,445, issued 4 Aug. 2024, which claims the benefit of U.S. Provisional Patent Application No. 63/055,581, filed 23 Jul. 2020.

U.S. application Ser. No. 17/374,898 titled “Method and System for Improved Spreadsheet Analytical Functioning,” filed 13 Jul. 2021, now U.S. Pat. No. 11,694,23, issued 4 Jul. 2023, which claims the benefit of U.S. Provisional Patent Application No. 63/051,280, filed 13 Jul. 2020.

U.S. application Ser. No. 17/374,901 titled “Method and System for Improved Ordering of Output from Spreadsheet Analytical Functions,” filed 13 Jul. 2021, now U.S. Pat. No. 11,972,220, issue 30 Apr. 2024, which claims the benefit of U.S. Provisional Patent Application No. 63/051,283, filed 13 Jul. 2020.

U.S. application Ser. No. 17/752,814 titled “Method and System for Spreadsheet Error Identification and Avoidance,” filed 24 May 2022, now U.S. Pat. No. 11,977,835, issued 7 May 2024 which claims the benefit of U.S. Provisional Patent Application No. 63/192,475, filed 24 May 2021.

U.S. application Ser. No. 17/903,934 titled “Method and System for Improved 2d Ordering of Output from Spreadsheet Analytical Functions,” filed 6 Sep. 2022, now U.S. Pat. No. 12,050,859, issued 30 Jul. 2024 which claims the benefit of U.S. Provisional Patent Application No. 63/240,828, filed 3 Sep. 2021.

U.S. application Ser. No. 17/988,641 titled “Methods and Systems for Sorting Spreadsheet Cells with Formulas,” filed 16 Nov. 2022 which claims the benefit of U.S. Provisional Patent Application No. 63/280,590, filed 17 Nov. 2021.

U.S. application Ser. No. 18/074,301 titled “Method and System for Improved Visualization of Charts in Spreadsheets,” filed 2 Dec. 2022 which claims the benefit of U.S. Provisional Patent Application No. 63/285,945, filed 3 Dec. 2021.

U.S. application Ser. No. 18/142,560 titled “Methods and Systems for Spreadsheet Function and Flex Copy-Paste Control of Formatting and Use of Selection List Panels,” filed 2 May 2022, now U.S. Pat. No. 12,169,687, issued 17 Dec. 2024 which claims the benefit of U.S. Provisional Application No. 63/337,576, filed 2 May 2022.

U.S. application Ser. No. 18/142,557 titled “Methods and Systems for Bucketing Values in Spreadsheet Functions,” filed 2 May 2023 which claims the benefit of U.S. Provisional Application No. 63/337,572, filed 2 May 2022.

U.S. application Ser. No. 18/542,510 titled “Methods and Systems for Flexibly Linking Spreadsheet Cell Movements and Formulas,” filed 23 Dec. 2023 which claims the benefit of U.S. Provisional Application No. 63/433,408, filed 16 Dec. 2022.

U.S. application Ser. No. 18/765,168 titled “Methods and Systems for Specifying and using in Spreadsheet Cell Formulas Joins Between Data Sets,” filed 5 Jul. 2024 which claims the benefit of U.S. Provisional Application No. 63/525,138, filed 5 Jul. 2023.

U.S. application Ser. No. 18/777,446 titled “Methods and Systems for Specifying and using Joins Between Data Sets in a Spreadsheet Data Visualizer,” filed 18 Jul. 2024 which claims the benefit of U.S. Provisional Application No. 63/529,135, filed 5 Jul. 2023.

### BACKGROUND

Spreadsheet super users fairly often set up spreadsheets or parts of spreadsheets to be used by other people. They often then want to give those normal users the ability to make cell input changes while simultaneously wanting to protect those inputs from incorrect input values. They currently have a very limited ways of doing that using a spreadsheet cell capability called “Validation”. That capability allows users to set up to a data type limitation and further set up value constraint requirements that must be met by the user input. They also can set up a list selector cell capability fed by a range of values referenced within the validation cell. However, they cannot set up a value input or a value selector capability that populates more than one value within a cell.

Users of the existing single value cell validation capability cannot partially lock the cell so other users can change the value input or list value selection but cannot change the validation setup that limits the inputs or the list. They must either totally lock the cell so the user cannot make any change or leave it totally unlocked where user can change the validation constraints and therefore eliminate its intended purpose of limiting inputs. Therein lie multiple opportunities to partially protect the input or selector content by locking the ability to change the validation constraints or selection list without locking the user from changing the input or from changing the selection from the list. There also lies an opportunity to broaden the cell input validation capability and cell dropdown list selection to populate multiple values within a cell. Additionally, there is an opportunity to make the validation of all of the single or multiple inputs simpler and more powerful by accomplishing it via prebuilt spreadsheet functions which automate a number of manual cell capability requirements and automatically add more sophisticated ones.

Users of regular prebuilt functions also face the same totally locked or totally unlocked situation without the ability in functions that accept two or more arguments to lock one or more arguments while leaving unlocked one or more arguments. Thereby partially locking the function and the functional formula.

There also lies an additional opportunity to improve the protection of the locked content by removing password access, thereby eliminating any password security breach, or hacking possibility of gaining access to the locked content. In the process providing locked content protection more similar to that of the application code to a spreadsheet user for the content they wanted to protect within their spreadsheet.

### SUMMARY

The disclosed technology creates a family of prebuilt spreadsheet functions for validating value inputs. In doing so the embodiments create prebuilt spreadsheet functions that accept different inputs within the in-cell input and the formula bar input. Where the formula input validates the value input. Different embodiments support the input and validation of single and multiple values. Different embodiments support the separation of the cell and formula bar inputs starting from the beginning of the initial formula set up or starting after initial formula set up.

Embodiments of the disclosed technology broaden the existing spreadsheet cell validation capability to situations with multi-value inputs within a single cell that are then usable by formulas within other regular spreadsheet cells. A capability not supported by traditional spreadsheets. Embodiments also broaden the spreadsheet list selection capability to populating multi-value selections within a single regular spreadsheet cell for use by formulas in other regular spreadsheet cells.

Embodiments of the disclosed technology allow functions within regular spreadsheet cells to be partially locked so users cannot change the formula but can still change its value. This applies to our family of input functions described herein and our family of drop-down or pop-up functions which are the subject of U.S. application Ser. No. 17/359,418 titled “Methods and Systems for Presenting Drop-Down, Pop-Up or Other Presentation of a Multi-Value Data Set in a Spreadsheet Cell,” filed 25 Jun. 2021, now U.S. Pat. No. 11,657,217, issued 25 May 2023. Embodiments of our partial locking technology also apply to the family of cell input validation capabilities described herein and the single value drop-down list selection capability and the multi-value pop-up list selection capability described herein.

Embodiments of our technology apply our partial locking to the existing spreadsheet prebuilt functions which can accept two or more arguments. Those functions which thereby support having at least one argument locked and at least one argument unlocked. Embodiments also apply our partial locking technology to our multi-cell populating functions described in our filings cited herein.

Embodiments of the disclosed technology provide formula hiding capabilities to the partially locked cell functions and cell capabilities. Additional embodiments improve the locking protection and security via password free locking of the spreadsheet cell content. Embodiments of that password free locking of the spreadsheet content provide content protection similar to the application code content protection.

Particular aspects of the technology disclosed are described in the claims, specification, and drawings.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1A and FIG. 1B example a user locking an entire Worksheet 173/177 in Microsoft Excel.

FIGS. 2 and 3 example the seven additional steps laid out by Microsoft Excel support should the user want to lock only some of the cells in a Worksheet.

FIG. 4 examples all the potential exception selections to locking in Microsoft Excel.

FIG. 5 displays the Microsoft Excel documentation on what the exception selections do and do not do regarding locking.

FIGS. 6A, 6B, 7A, and 7B examples the locking of a Microsoft Excel spreadsheet with the AutoFilter exception and then the use of the AutoFilter for a locked table.

FIGS. 8A, 8B, 9A, and 9B examples the locking of a Microsoft Excel spreadsheet with the PivotTable and PivotChart exception and then the use of a Filter for a locked PivotTable.

FIGS. 10A, 10B, 10C, 11A, 11B, 12A, 12B, 12C, 13A, 13B, 13C, 14A, and 14B examples how the ‘Edit scenarios’ locked exemption allows the user to edit scenarios but does not allow those edited scenarios to change the values in locked cells in a Microsoft Excel spreadsheet.

FIGS. 15A, 15B, 16A, 16B, 17A, and 17B examples the unlocking, hiding only, locking only, and locking combined with hiding of spreadsheet cells with protection in Microsoft Excel.

FIGS. 18A, 18B, 19A, 19B, 20A, 20B, 21A, and 21B examples the operation of the unlocking, hiding only, locking only, and locking combined with hiding of spreadsheet cells with protection in Microsoft Excel showing there is no partial locking.

FIGS. 22A and 22B examples the workbook level of protection application in Microsoft Excel.

FIG. 23 examples the Google Sheets approach to locking, which is person specific.

FIGS. 24A, 24B, 24C, 25A, 25B, 25C, and 25D_examples the set-up of a date validating cell capability and it rejecting an invalid input in Microsoft Excel.

FIGS. 26A, 26B, 26C, 26D, 27A, and 27B examples the validating cell manual set-up and then automatic operation of a custom ‘Error Alert’ in Microsoft Excel.

FIGS. 28A, 28B, and 28C examples the validation cell validation constraint type options in Google Sheets.

FIGS. 29A, 29B, 30A, and 30B examples the set-up of a date validating cell capability and it warning of an invalid input in Google Sheets.

FIGS. 31A, 31B, and 31C examples the set-up of a date validating cell capability and it rejecting an invalid input in Google Sheets.

FIGS. 32A, 32B, and 32C examples the set-up of a date validating cell capability with a custom reject message in Google Sheets.

FIGS. 33A, 33B, 33C, and 33D examples the set-up of a checkbox validating cell capability and it rejecting an invalid input in Google Sheets.

FIGS. 34A, 34B, and 34C examples that a validation cell is not a regular cell with a formula in both Microsoft Excel and Google Sheets.

FIGS. 35A, 35B, 36A, and 36B examples how the locking of a validation cell in Microsoft Excel results in the cell completely locked.

FIGS. 37A, 37B, 38A, 38B, 39A, and 39B examples the set up and locking of ‘List’ validation cell in Microsoft Excel and shows how the cell is completely locked.

FIG. 40 examples differential input validation prebuilt spreadsheet functions employing the post initial formula set up differentiation of the cell and formula bar inputs in our technology.

FIGS. 41A, 41B, 41C, 42A, and 42B examples the initial set-up of a differential input validation prebuilt spreadsheet functional formula in our technology.

FIGS. 42C, 42D, and 42E examples the use of the in-cell differential input post formula instantiation when the in-cell input is limited to the value input and the formula bar input displays and accepts inputs into the entire formula in our technology.

FIGS. 43A and 43B examples another method of setting up the differential input validation prebuilt spreadsheet validation constraint values in our technology.

FIGS. 44A, 44B, 44C, and 44D examples the altering of validation values constraint in our differential input validation prebuilt spreadsheet function and the automatic alteration of our input message.

FIGS. 45A, 45B, 45C, 46A, 46B, 46C, and 46D examples some of the options supported by our differential input validation prebuilt spreadsheet function and the set-up within it of a custom input message.

FIGS. 47A and 47B examples the rejection of an invalid date in-cell input into our differential input validation prebuilt spreadsheet function.

FIGS. 47C and 47D examples the rejection of an invalid date input int to the value argument in our differential input validation prebuilt spreadsheet function formula bar formula.

FIGS. 48A, 48B, 48C, and FIG. 48D examples in-cell marking of the cells populated by the INPUT example of our differential input validation function which is also applicable to any of the other family of differential input validation functions described herein.

FIGS. 49A, 49B, 49C, 50A, 50B, 50C, and 50D examples the set-up and usage of a differential input validation function for a numeric validation with the minimum initial argument and its then rejection of a post formula instantiation invalid in-cell input.

FIGS. 51A, 51B, and FIG. 51C examples the set-up of one of our differential input validation function family of functions with the typical existing spreadsheet FUNCTION selection only selection lists and the typical function syntax guide.

FIGS. 52A, 52B, 52C, and FIG. 52D examples our differential input validation function technology where the inputs start differential from the beginning.

FIGS. 53A, 53B, 53C, and FIG. 53D examples how the validation responses of our differential input validation function technology where the inputs start differential from the beginning are the same as when the differential inputs only starts after the first completed formula.

FIGS. 54A, 54B, 54C, FIGS. 54D, and 54E examples the set-up of one of our always differential input validation family of functions with the typical existing spreadsheet FUNCTION selection only selection lists and the typical function syntax guide.

FIG. 55 examples a prebuilt spreadsheet function employing the post initial formula set up differentiation of the cell and formula bar inputs in our technology for a single spreadsheet cell containing multiple validated values in a range.

FIG. 56 examples a prebuilt spreadsheet function employing the always differentiation of the cell and formula bar inputs in our technology for a single spreadsheet cell containing multiple validated values in a range.

FIGS. 57A, 57B, 57C, 58A, 58B, 59A, 59B, 59C, FIG. 59D, and FIG. 59E examples the setup of the initial then differential range input validation function with hints and then its usage in a cell referencing formula.

FIG. 60 examples a prebuilt spreadsheet function employing the post initial formula set up differentiation of the cell and formula bar inputs in our technology for a single spreadsheet cell containing multiple validated values entered as discrete values within the single cell.

FIG. 61 examples a prebuilt spreadsheet function employing the always differentiation of the cell and formula bar inputs in our technology for a single spreadsheet cell containing multiple validated values entered discretely.

FIG. 62 examples a prebuilt spreadsheet function employing our post initial formula set up differentiation of the cell and formula bar inputs in our technology for a single spreadsheet cell containing multiple validated values entered as an inequality within the single cell.

FIG. 63 examples a prebuilt spreadsheet function embodiment employing the always differentiation of the cell and formula bar inputs in our technology for a single spreadsheet cell containing multiple validated values entered via an inequality.

FIG. 64 contains multiple examples and description of how our new spreadsheet cell locking technology partially locks our “Differential input validation functions”.

FIGS. 65A and 65B example two different ways of setting up the partial locking in our technology.

FIGS. 66A, 66B, 66C, 66D, 66E, 67A, 67B, 67C, and FIG. 67D examples in greater depth some of the feature and functionality of the “Differential input validation functions” locking.

FIG. 68 examples our partial locking capability for a single value differential input validation function with formula hiding.

FIGS. 69A, 69B, 69C, 69D, 69E, 70A, 70B, 70C, and FIG. 70D examples in greater depth some of the feature and functionality of the differential input validation function hiding and locking.

FIG. 71 examples our partial locking capability for the range differential input validation function.

FIGS. 72A, 72B, 72C, 72D, 72E, 73A, 73B, 73C, and FIG. 73D examples in greater depth some of the feature and functionality of the range differential input validation function locking.

FIG. 74 examples our partial locking capability for the multiple values set range differential input validation function with formula hiding.

FIG. 75 examples our partial locking capability for the multi value differential input validation function.

FIG. 76 examples our partial locking and formula hiding capability for the inequality differential input validation function.

FIG. 77 examples our partial locking capability for the inequality differential input validation function.

FIG. 78 examples our partial locking and formula hiding capability for the discretely entered multiple values set differential input validation function.

FIG. 79A examples the setup of a single value selection variant of our multi-value data set presenting prebuilt spreadsheet function in this embodiment called ‘DROPDOWN’.

FIG. 79B examples the single value selection usage of our multi-value data set presenting prebuilt spreadsheet function when unlocked or partially locked.

FIG. 79C examples our partial locking capability locking the formula argument specifying the multi-value data set from which to select the value in our single value selection variant of our multi-value data set presenting prebuilt spreadsheet function in this embodiment called ‘DROPDOWN’.

FIG. 80 examples how our partially locking and formula hiding technology works for our single value selection variant of our multi-value data set presenting prebuilt spreadsheet function in this embodiment called ‘DROPDOWN’.

FIG. 81A examples the setup of a multi-value selection variant of our multi-value data set presenting prebuilt spreadsheet function in this embodiment called ‘DROPDOWN_MANY’.

FIG. 81B examples the multi-value selection usage of our multi-value data set presenting prebuilt spreadsheet function when unlocked or partially locked.

FIG. 82A examples our partial locking capability locking the formula argument specifying the multi-value data set from which to select the values in our multi-value selection variant of our multi-value data set presenting prebuilt spreadsheet function in this embodiment called ‘DROPDOWN_MANY’.

FIG. 82B examples our partial locking and hiding capability locking and hiding the formula specifying the multi-value data set from which to select the values in our multi-value selection variant of our multi-value data set presenting prebuilt spreadsheet function in this embodiment called ‘DROPDOWN_MANY’.

FIGS. 83A, 83B, 84A, and 84B examples the setup in our technology of a single value cell validation capability in a manner similar to other spreadsheets.

FIGS. 85A and 85B examples how our single value cell validation capability technology differs in the automatic generation of a cell input message communicating the validation constraint or constraints.

FIGS. 85C and 85D examples how our single value cell validation capability technology differs in the automatic generation of an invalid cell input rejection alter or warning communicating the validation constraint or constraints.

FIGS. 86A and 86B examples how our partial locking of our single value cell validation capability technology results in the cell input value being unlocked and therefore changeable post the partial locking.

FIGS. 86C, 87A, and 87B examples how our partial locking of our single value cell validation capability technology results in the validation specifications being locked and therefore not changeable post the partial locking.

FIGS. 88A, and 88B examples how our partial locking and hiding of our single value cell validation capability technology results in the validation specifications being locked and hidden and therefore not visible and changeable post the partial locking.

FIGS. 88C and 88D examples how our partial locking and hiding of our single value cell validation capability technology results in the cell input value being unlocked and therefore changeable post the partial locking and hiding.

FIGS. 89A, 89B, 90A, 90B, 91A, and 91B examples the setup and use in our technology of a multi-value cell validation capability.

FIGS. 91C and 91D examples how our multi-value cell validation capability rejects a multiple value input if any one of the multiple values input violates the validation constraint or constraints.

FIGS. 92A and 92B examples how our partial locking of our multi-value cell validation capability technology results in the cell input value being unlocked and therefore any or all of the values changeable post the partial locking.

FIGS. 93A, 93B, 94A, and 94B examples how our partial locking of our single value cell validation capability technology results in the validation specifications being locked and therefore not changeable post the partial locking.

FIGS. 95A and 95B examples how our partial locking and hiding of our multi-value cell validation capability technology results in the cell input value being unlocked and therefore any or all of the values changeable post the partial locking.

FIGS. 95C, and 95D examples how our partial locking and hiding of our single value cell validation capability technology results in the validation specifications being locked and hidden and therefore not visible or changeable post the partial locking with the user attempting to do so via the ribbon Valid button.

FIGS. 96A, 96B, 97A, 97B, 98A, 98B, 98C, and 99A examples the setup and use in our technology of a multi-value list cell validation capability.

FIGS. 99B, 99C, and 99D examples how our partial locking of our multi-value list cell validation capability technology results in the cell selection list being unlocked and therefore any or all of the selected values changeable post the partial locking where any changes results in changes to any cell locked or unlocked referencing the cell.

FIGS. 100A, 100B, and 100C examples how our partial locking of our multi-value list cell validation capability technology results in the validation specifications being locked and therefore not changeable post the partial locking.

FIGS. 101A, and 101B examples how our partial locking and hiding of our multi-value list cell validation capability technology results in the validation specifications being locked and hidden, and therefore not visible or changeable post the partial locking if the user attempts to do so via the ribbon Valid button.

FIGS. 102A, and 102B examples how our partial locking and hiding of our multi-value list cell validation capability technology results in the validation specifications being locked and hidden, and therefore not visible or changeable post the partial locking with the user attempting to do so via formula bar access.

FIG. 103A examples how our partial locking and hiding of our single value cell validation capability technology results in the validation specifications being locked and hidden, and therefore not visible or changeable post the partial locking with the user attempting to do so via formula bar access.

FIG. 103B examples how our partial locking and hiding of our multi-value cell validation capability technology results in the validation specifications being locked and hidden, and therefore not visible or changeable post the partial locking with the user attempting to do so via the ribbon Valid button.

FIGS. 104A, 104B, and 105A examples the setup of our multi-value cell validation capability populating the multiple values in a spreadsheet prebuilt function.

FIGS. 105B, 105C, 105D, and 105E examples the changing of our multi-value cell validation capability populating the multiple values in a spreadsheet prebuilt function values from no input to three text values and the resulting change to a cell formula referencing that cell and its values.

FIGS. 106A, 106B, 106C, and 106D examples the partial locking of our multi-value cell validation capability populating the multiple values in a spreadsheet prebuilt function and how this results in the cell input values being unlocked and therefore any or all of the values changeable post the partial locking.

FIG. 106E examples how the post locking changes in FIGS. 106C and 106D resulted in a change to a cell formula referencing that cell and its values.

FIGS. 107A, 107B, and 107C examples how our multi-value cell validation capability populating the multiple values in a spreadsheet prebuilt function results in the validation specifications being locked or changeable post the partial locking with the user attempting to do so via the ribbon Valid button.

FIGS. 108A, 108B, 109A, 109B, 110A, and 110B examples the setup and use in our technology of a multi-value range cell validation capability.

FIGS. 110C and 110D examples how our multi-value range cell validation capability rejects a range input that violates one or more of the validation constraint or constraints.

FIGS. 111A, 111B, and 111C examples how our partial locking of our multi-value range cell validation capability technology results in the validation specifications being locked and therefore not changeable post the partial locking with the user attempting to do so via the ribbon Valid button.

FIGS. 112A and 112B examples how our partial locking and hiding of our multi-value range cell validation capability technology results in the validation specifications being locked and hidden, and therefore not visible and not changeable post the partial locking and hiding with the user attempting to do access the validation specifications via the ribbon Valid button.

FIGS. 113A, 113B, 114A, 114B, 115A, and 115B examples the setup and use in our technology of a multi-value inequality cell validation capability.

FIGS. 115C and 115D examples how our multi-value inequality cell validation capability rejects an inequality input that violates one or more of the validation constraint or constraints.

FIGS. 116A, 116B, and 116C examples how our partial locking of our multi-value inequality cell validation capability technology results in the validation specifications being locked and therefore not changeable post the partial locking with the user attempting to do so via the ribbon Valid button.

FIGS. 117A and 117B examples how our partial locking and hiding of our multi-value inequality cell validation capability technology results in the validation specifications being locked and hidden, and therefore not visible and not changeable post the partial locking and hiding.

FIGS. 118A, 118B, 119A, 119B, and 120 examples the operation of our partially locked typical spreadsheet function for the function SUM with one locked argument and one unlocked argument.

FIGS. 121A, 121B, 122A, 122B, and 123 examples the operation of our partially locked typical spreadsheet function for the function XLOOKUP with two locked arguments and one unlocked argument.

FIGS. 124A, 124B, 125A, and 125B examples a slightly different locking/unlocking highlighting approach within our technology changing the unlocked arguments in the formula color coding to match the referenced unlocked cell or cell ranges within the partially locked formula.

FIG. 126 examples prebuilt spreadsheet functions employing the always differentiation of the cell and formula bar inputs in our technology for a single spreadsheet cell containing one validated input.

FIG. 127A examples an embodiment of the start differential input validation function where the value is inputted in-cell only and not an argument in the formula.

FIG. 127B examples an embodiment our employing the post initial formula set up differentiation of the cell and formula bar inputs of our differential input validation functions where the value is inputted in-cell only and not an argument in the formula.

FIG. 128A, 128B, 128C, and FIG. 128D examples where the argument that determines the output value in our differential input validation function is supplied by a referenced cell where that value is then validated like any other inputted value with a warning or rejection if the value does not meet the functional formula constraint.

FIGS. 129A, 129B, 129C, 130A, 130B, 130C, 130D, and 130E examples the setup and use of a checkbox variant of our single value differentiated dual input functions.

FIGS. 131A, 131B, 131C, 132A, and 132B examples the setup and usage of a single value differential input validation function with a validation constraint or constraints warning rather than a rejection.

FIG. 133A and FIG. 133B examples a user building a locked, partially locked, and hidden version of a spreadsheet in our technology which post the build users cannot change the locked, partially locked, and hidden functional formulas and cells.

FIGS. 134A and 134B examples a UI for partially locking of spreadsheet functions with the selection of the one or more function arguments to be locked and the selection of the one or more arguments to be unlocked.

FIGS. 135A and 135B examples our fully automated unlocked argument message operation compared with our user specified unlocked message in a partially locked functional formula.

FIGS. 136A and 136B examples our list validation technology working with our formulaic data.

FIGS. 137A and 137B examples a different syntax for our differential input validation family of functions with an additional input type argument which collapse different multiple functions into one.

FIGS. 138A and 138B examples the working of one of our differential input validation functions after partial locking with a validation input failure rejection.

FIGS. 138C and 138D examples the working of one of our differential input validation functions after partial locking with a validation input failure warning.

FIG. 139 examples our single value regular input validation prebuilt spreadsheet function.

FIGS. 140A, 140B, 140C, and 140D examples our single value regular input validation prebuilt spreadsheet functions rejecting an input which fails the validation constraint.

FIGS. 141A, 141B, 141C, 141D, and 141E examples the partial locking of our regular input validation functions and the successful changing of the partially locked unlocked input.

FIGS. 142A, 142B, 142C, and 142D examples our single value regular input validation prebuilt spreadsheet functions rejecting inputs which fail the validation constraint post partial locking.

FIG. 143 examples our multiple set of values regular range input validation prebuilt spreadsheet function.

FIGS. 144A, 144B, 144C, 144D, 144E, and 141F examples the partial locking of our regular range input validation functions and the successful changing of the partially locked unlocked input including its use in a referenced cell formula.

FIGS. 145A, 145B, 145C, and 145D examples our multiple set of values range regular input validation prebuilt spreadsheet functions rejecting inputs which fail the validation constraint post partial locking.

FIG. 146 examples our multiple set of values regular multiple inputs validation prebuilt spreadsheet function.

FIG. 147 examples our multiple set of values regular inequality input validation prebuilt spreadsheet function.

FIGS. 148A, 148B, 148C, 148D, and 148E examples the partial locking and hiding of our regular input validation functions and the successful changing of the partially locked unlocked input.

FIGS. 149A, 149B, 149C, and 149D examples our single value regular input validation prebuilt spreadsheet functions rejecting inputs which fail the validation constraint post partial locking and hiding.

FIGS. 150A, 150B, 150C, 150D, 150E, and 150F examples the partial locking and hiding of our regular range input validation functions and the successful changing of the partially locked unlocked input including its use in a referenced cell formula.

FIGS. 151A, 151B, 151C, and 151D examples our multiple set of values range regular input validation prebuilt spreadsheet functions rejecting inputs which fail the validation constraint post partial locking and hiding.

FIG. 152 depicts an example computer system that can be used to implement aspects of the technology disclosed.

### DETAILED DESCRIPTION

The following detailed description is made with reference to the figures. Example implementations are described to illustrate the technology disclosed, not to limit its scope, which is defined by the claims. Those of ordinary skill in the art will recognize a variety of equivalent variations on the description that follows.

When spreadsheet applications were first created, they electronically emulated tabular paper spreadsheets. More recently, Microsoft Excel, Google Sheets, Apple Numbers, and others have dramatically increased the breadth of capabilities and usefulness of spreadsheets. Spreadsheet applications now access data across a wide variety of sources including relational, structured, and semi-structured, open data protocol, Web and Hadoop among others; and these applications manipulate data—such as in pivot tables and via Microsoft PowerPivot. Additionally, spreadsheets have extensive functionality for creating charts with SmartArt and for building forms, and they even have programming languages embedded within them, such as Visual Basic, Apps Script and Apple Script.

With all the added capabilities, spreadsheet applications have become substantially more complicated. All this complexity has led to over a hundred books and thousands of online videos that have been published to help users understand the capabilities of Excel alone. However, unlike programming languages and programming where users tend to spend long hours of focused use day after day, most spreadsheet users are much more occasional users episodically working in spreadsheets as part of being a student, doing their job, or doing some other activity. Therefore, they tend to know how to use a small fraction of the spreadsheet capabilities and not to remember non-intuitive instructions. For these users it is incredibly beneficial to make the usage simple and intuitive requiring no memory of what to do and how to do it. For those users it is very valuable to have external data simply available in their spreadsheets and to eliminate as much data manipulation and data analytics as possible. Spreadsheet providers like Microsoft Excel and Google Sheets, as well as the other spreadsheet providers, have not made external data directly available in their regular spreadsheet formulas as our technologies have done in our related applications. The other spreadsheet providers also have not made it easy for a user, for purposes of differentiation we will call a super user, to protect spreadsheet content they create while allowing other users, we will call regular user only for differentiation purposes, to use the content created with typical in spreadsheet formulas and content, as opposed to table content and alter inputs into the protected cells.

We will example the limitations of the current spreadsheet input validation, input selection capabilities by themselves and in combination with the spreadsheet cell locking capabilities before exampling how embodiments of our technologies solve those limitations and dramatically expand what can be done by the super user and the regular users using the super user created spreadsheet content.

### Prior Art Spreadsheet Cell Locking

We will start exampling the existing spreadsheet prior art using Microsoft Excel as it has the most extensive feature functionality. Google Sheets will also be exampled as it takes a very different user-based approach, with less features and functionality. With very few exceptions, which are table capabilities in Microsoft Excel, spreadsheet content locking is binary like a light switch either on or off with no partial locking. The process is very easy for locking entire worksheets or entire spreadsheets but becomes more complicated to lock individual cells or groups of cells.

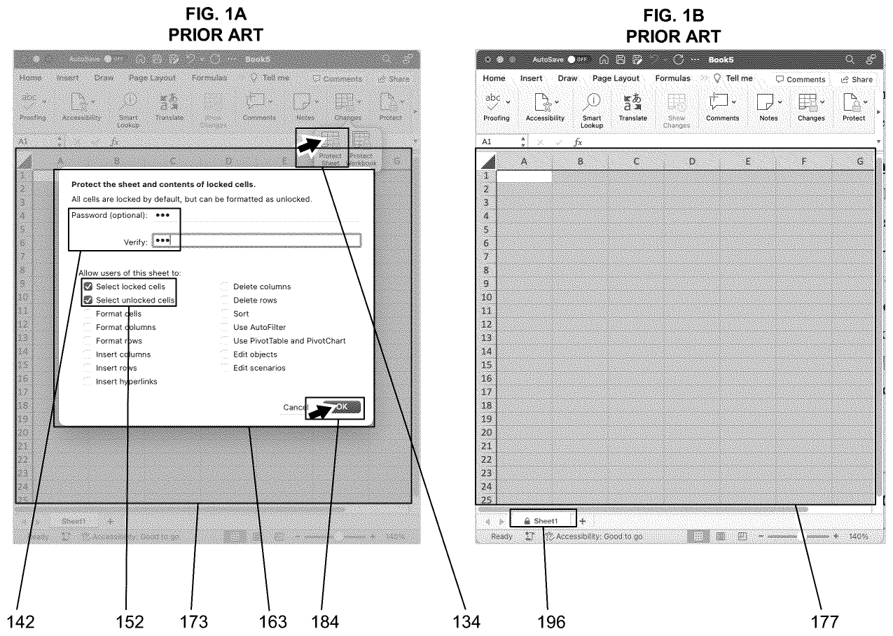

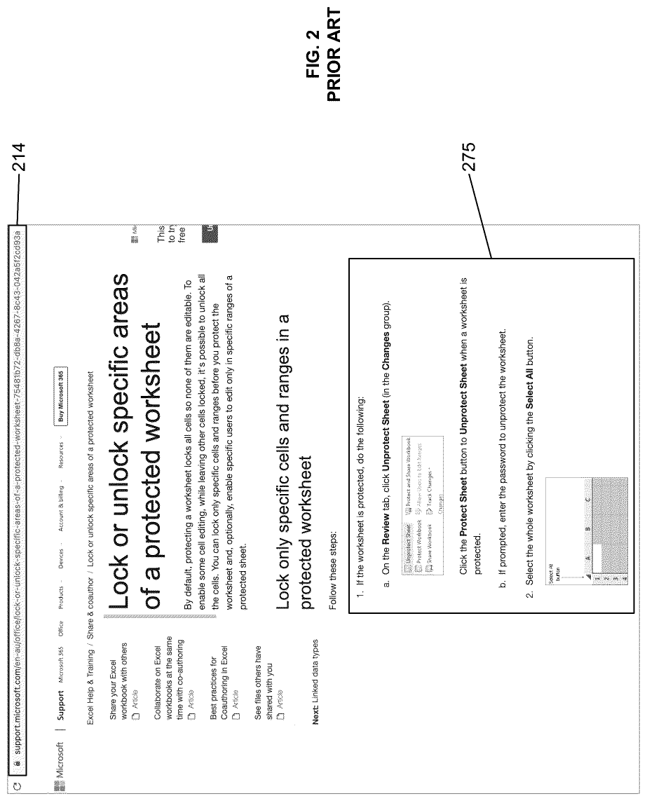

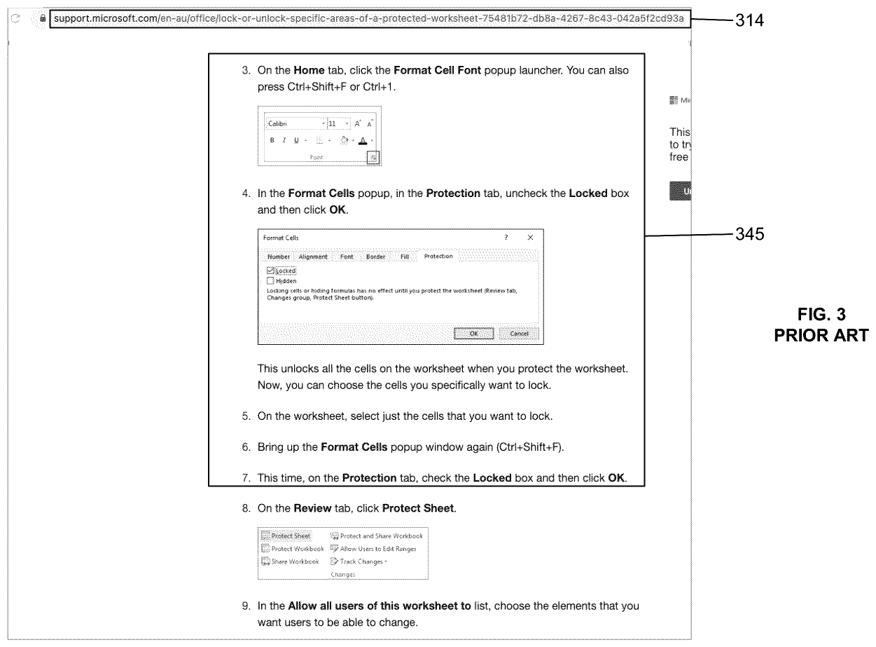

FIG. 1A and FIG. 1B example a user locking an entire Worksheet 173/177 in Microsoft Excel. The user goes to the ‘Review’ tab and clicks the ‘Protect Sheet’ ribbon icon 134 to open the ‘Protect the sheet and contents of locked cells’ popup 163. It opens with the ‘Allow users of this sheet to:’ with default settings checked for ‘Select locked cells’ and ‘Select unlocked cells’ 152, which in this example are fine. The user opts to add a password 142 and clicks ‘OK’ 184 to lock worksheet ‘Sheet1’ as exampled in FIG. 1B 196/177. This was a relatively simple process because the user was locking the entire sheet. FIG. 2 and FIG. 3 example the seven additional steps 275 in FIGS. 2 and 345 in FIG. 3 laid out by Microsoft Excel support 214 in FIGS. 2 and 314 in FIG. 3 should the user want to lock only some of the cells in the Worksheet.

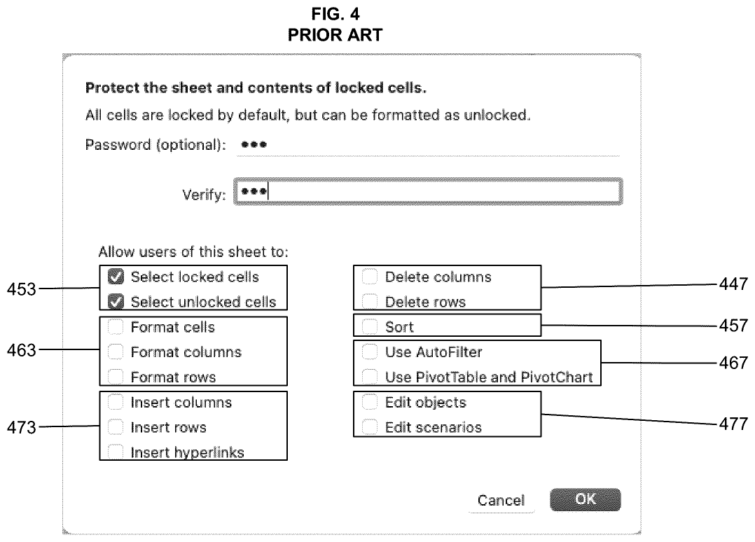

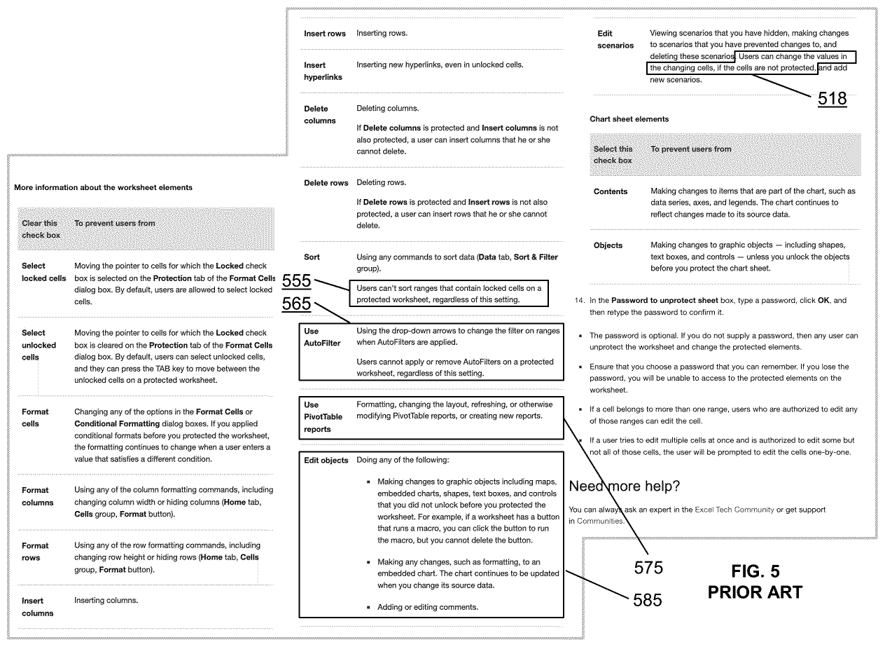

FIG. 4 refers back to locking popup 163 in FIG. 1A that lists all the potential exceptions the user can elect in Microsoft Excel. As we will example later, none of them partially unlock functional formulas in spreadsheet cells. The first two selections 453 are about cell selection, the next three 463 are about formatting, the next three 473 are about inserts, and the next two 447 about deleting. None of which has to do with cell formulas and allowing users to change formulas or values in spreadsheet cells. The next one 457 is about sorting but when you dive deeper into what is does in the Microsoft documentation in FIG. 5 you learn that ‘Users can't sort ranges that contain locked cells on a protected worksheet, regardless of this setting.’ 555. Thus, not changing formula in locked spreadsheet cells and not allowing users to change values in spreadsheet locked spreadsheet cells.

### Prior Art Spreadsheet Cell Locking—Autofilter and PivotTable

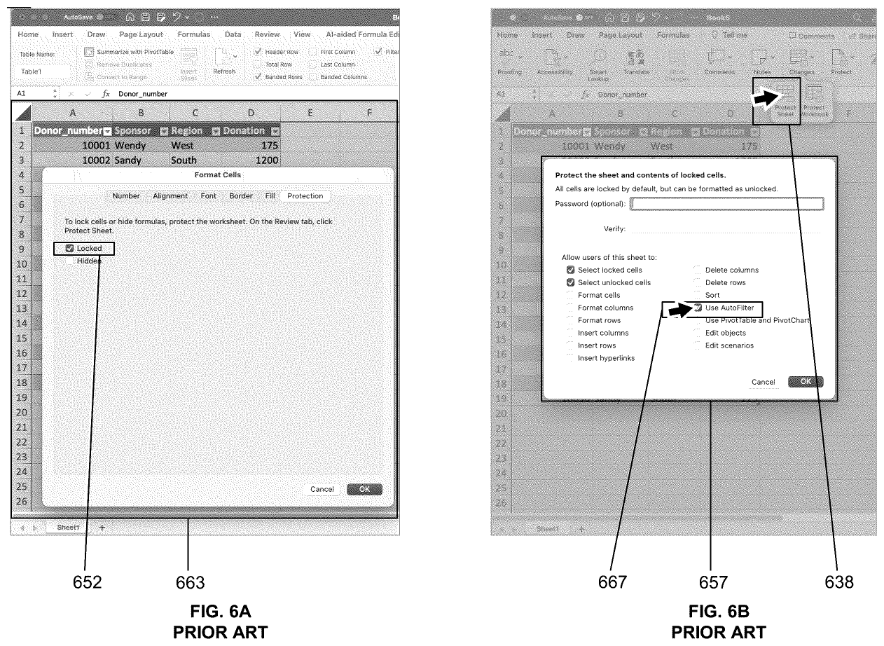

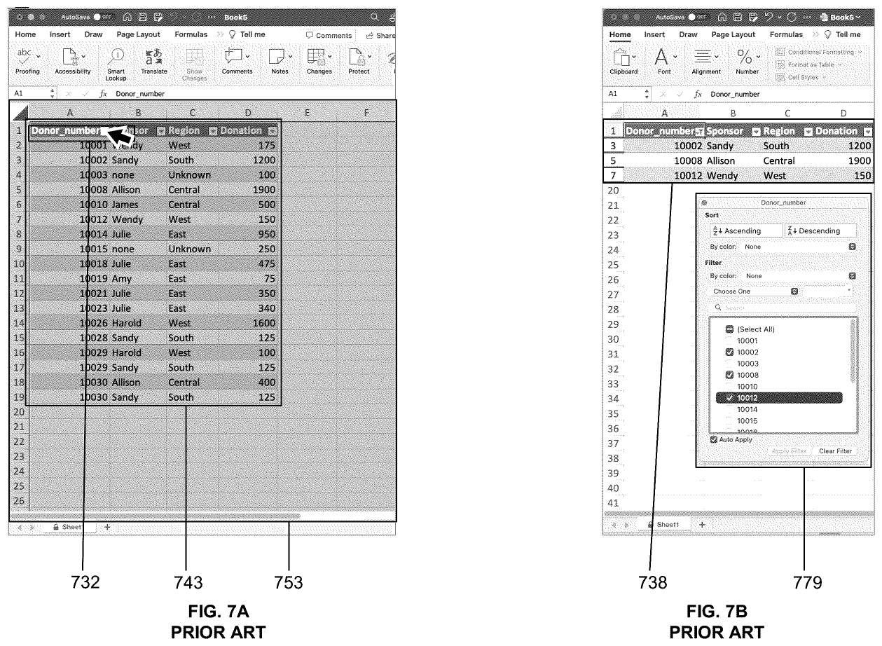

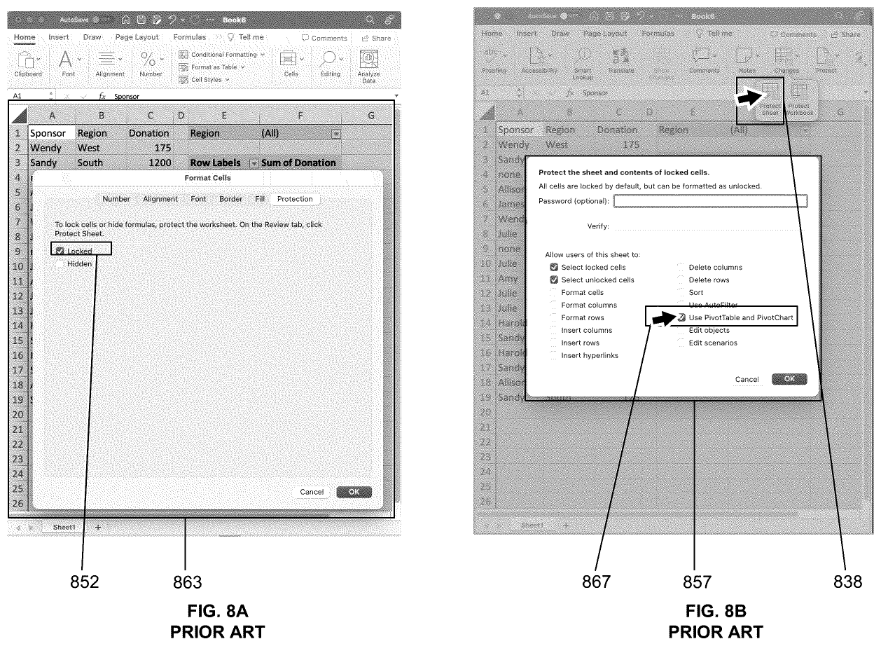

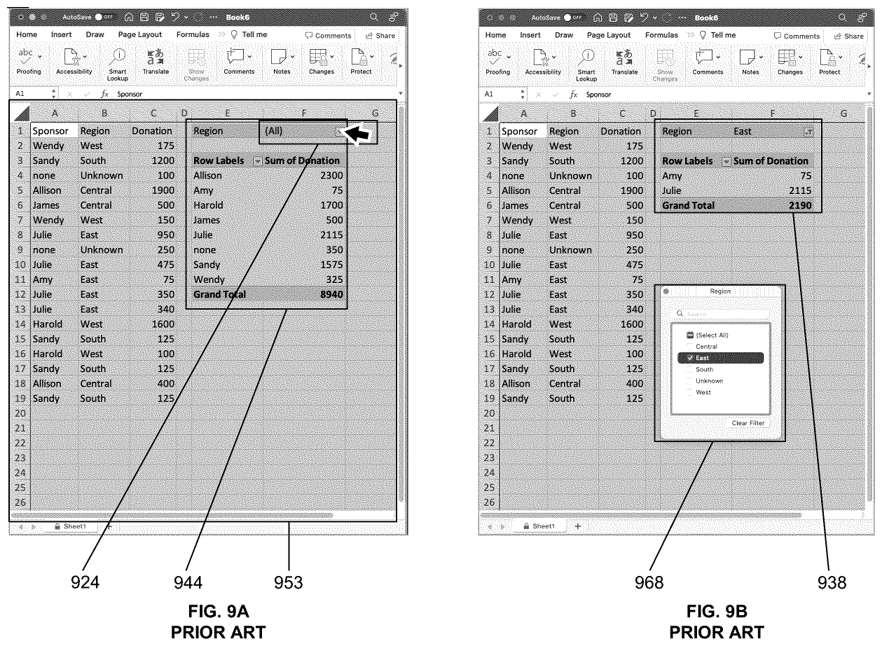

The next two potential locking exceptions 467 in FIG. 4 allow users to change ‘Autofilter’ selections in spreadsheet tables and users to change selections in ‘PivotTables’ and ‘PivotCharts’. None of these allow users to free form input their own content but to simply change selections from predetermined lists. None of these works only on a single cell, as they are all multi cell table capabilities or a chart which is not a cell. None of these results in changes in regular spreadsheet cell formulas as both Tables and PivotTables are what we call capabilities, not functions. FIG. 6A examples the locking 652 of a worksheet 663 with the ‘AutoFilter’ exception checked 667 in the set-up popup 657 triggered by the ‘Protect Sheet’ selection 638 in FIG. 6B. The result is that the user can change the table 743 ‘Autofilter’ selection clicking the selector button 732 in the locked worksheet 753 as exampled in FIG. 7A and then changing the selections as shown in the 779 in FIG. 7B to change the number of table rows visible in the spreadsheet, as exampled in 738 in FIG. 7B versus 743 in FIG. 7A. Note, the user can change the selection of the AutoFilter which is a predetermined list, they cannot change the list itself or make freeform inputs. Also, this allowed the user to change what was seen in the locked worksheet but not change any of the cell content, simply change what cells are visible. FIG. 8A and FIG. 8B example the locking 852 of a worksheet 863 in FIG. 8A protecting 838 the worksheet in FIG. 8B with the ‘Use PivotTable and PivotChart’ exception checked 867 in the set-up popup 857. The result is that the user can change the PivotTable 944 in the locked worksheet 953 in this example clicking the filter selector button 924 as exampled in FIG. 9A and then changing the selections as shown in the 968 in FIG. 9B to change the PivotTable output, as exampled in 938 in FIG. 9B versus 944 in FIG. 9A. Note, again the user can do is change a selection from a predetermined list but they cannot make freeform changes to the content or a user determined input that is not on the list. Note they have the same ability to change the selections of the PivotTable rows, columns and calculations from the predetermined fields and functions list but no ability to freeform input anything not from the selection lists. The result was they changed the PivotTable output in a locked worksheet, 953 in FIG. 9A but because PivotTables are not regular cell formulas in regular cells but a specialized capability populating many cells with values but not populating the cells with cell formulas and not working for just one cell, this did not change regular cell input values or regular cell functional formula values in a locked cell. Note, spreadsheet capabilities do not generate cell content from typing or otherwise populating into a cell a formula. They instead populate content from formula free methods such as the set-up of a PivotTable, convert existing content for other usage cell formula free like a Table or conditional formatting, validate content from a cell formula free setup as in validation, or other cell formula free situations.

### Prior Art Spreadsheet Cell Locking—Edit Objects and Scenario Manager

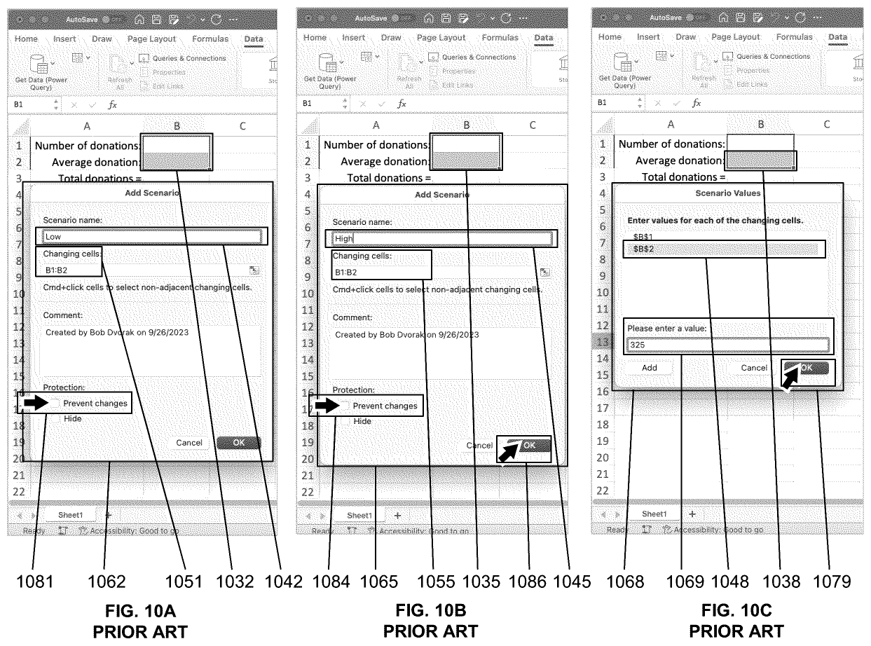

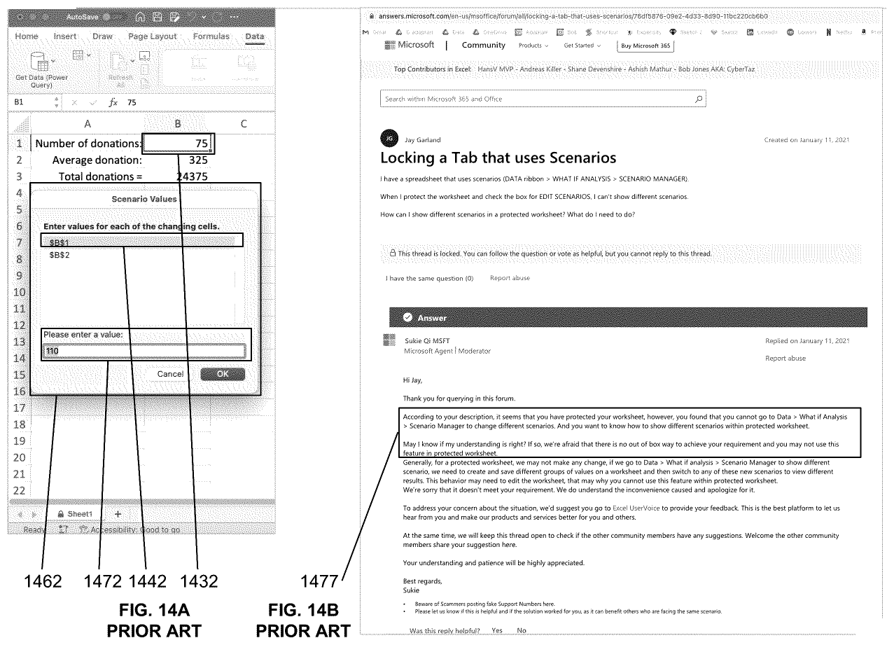

The final two locking exceptions 477 in the Microsoft Excel popup in FIG. 4 are also specialized situations. The ‘Edit objects’ described in more depth in 585 in FIG. 5 is not about spreadsheet cell content but graphic content, charts, and comments. Nothing having to do with what our technology will address, partially locking regular spreadsheet cell formulas and capabilities. The ‘Edit scenarios’ allows the user to edit scenarios but does not allow those edited scenarios to change the values in locked cells as exampled in FIG. 10A through FIG. 14B. This is confirmed by the ‘Microsoft Agent|Moderator’ responding to a user trying to make such a change in FIG. 14B.

FIG. 10A examples a charity user setting up Low and High case scenarios of ‘Number of donations’ and ‘Average donation’ which they then use to calculate the ‘Total donations’. To do so they open the ‘Review’ tab ‘What If Analysis’ button ‘Scenario Manager . . . ’ in Microsoft Excel. That opens the “Add Scenario” popup 1062 FIG. 10A where they set up the ‘Low’ 1042 scenario with values for the two changing cells ‘B1:B2’ 1051/1032 in this example while unchecking the ‘Protection:’ ‘Prevent changes’ check box 1081. For brevity purpose we will not show every step of the process and will not show the process redone with the ‘Protection:’ ‘Prevent changes’ check box 1081 checked as it did not change the cell locking aspect of Microsoft Excel that we are interested in. We also will only show the set-up of one of the two scenarios, exampling what was done for the ‘High’ scenario starting in FIG. 10B. The ‘Low’ values that we populated were ‘10’ in ‘B1’ and ‘50’ in ‘B2’.

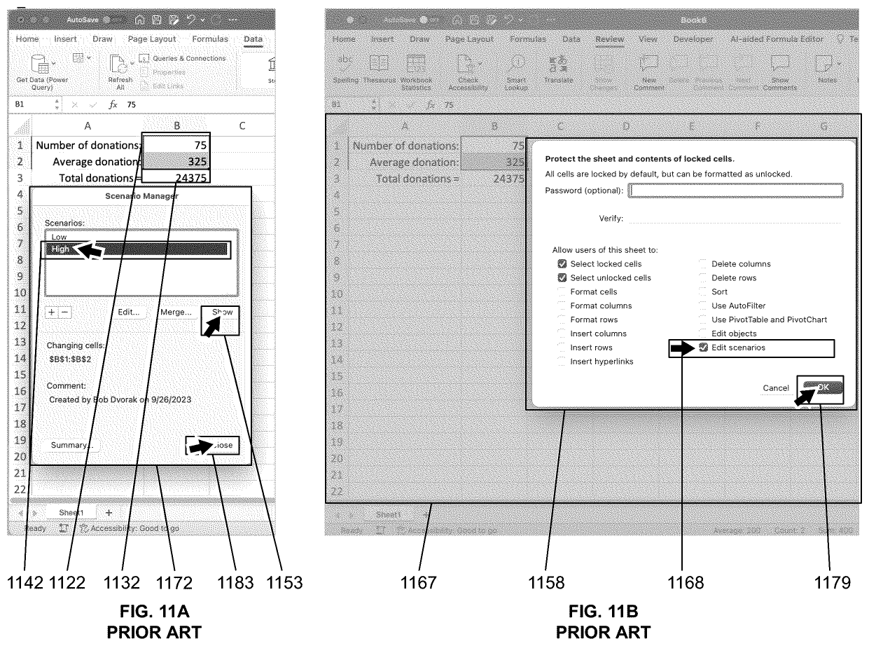

FIG. 10B examples the charity user starting to populate the ‘High’ scenario 1045 for the two cells ‘B1:B2’ 1055/1035 again with the ‘Protection:’ ‘Prevent changes’ check box 1084 unchecked in the ‘Add Scenario’ popup 1065. When the user clicks ‘OK’ 1086 they move to populating the scenario values as exampled in FIG. 10C. FIG. 10C examples the user populating the ‘B2’ 1038/‘$B$2’ 1048 value of ‘325’ 1069 after having put ‘75’ in the ‘B1’/‘$B$1’ scenario value. The user then clicks ‘OK’ 1079 to finish the ‘High’ and ‘Low’ scenario input in the ‘Scenario Values’ popup 1068. The user then inputs the formula into cell ‘B3’ for ‘Total donations=’ of ‘=B1*B2’ to use the scenario values. They then again open the ‘Scenario Manager’ popup 1172 in FIG. 11A and decide to select the ‘High’ scenario 1142 to calculate and click ‘Show’ 1153 which populates the ‘High’ scenario values in cells ‘B1’ and ‘B2’ 1122. This then automatically uses those values to calculate the ‘Total donations=’ ‘24375’ in cell ‘B3’ 1132. The user can repeat the process selecting the ‘Low’ scenario to show the values ‘10’ in ‘B1’ and ‘50’ in ‘B2’ which then support the recalculation of the Total donations=‘‘50’ in cell ‘B3’. For brevity we will move onto locking the worksheet with the scenarios in FIG. 11B.

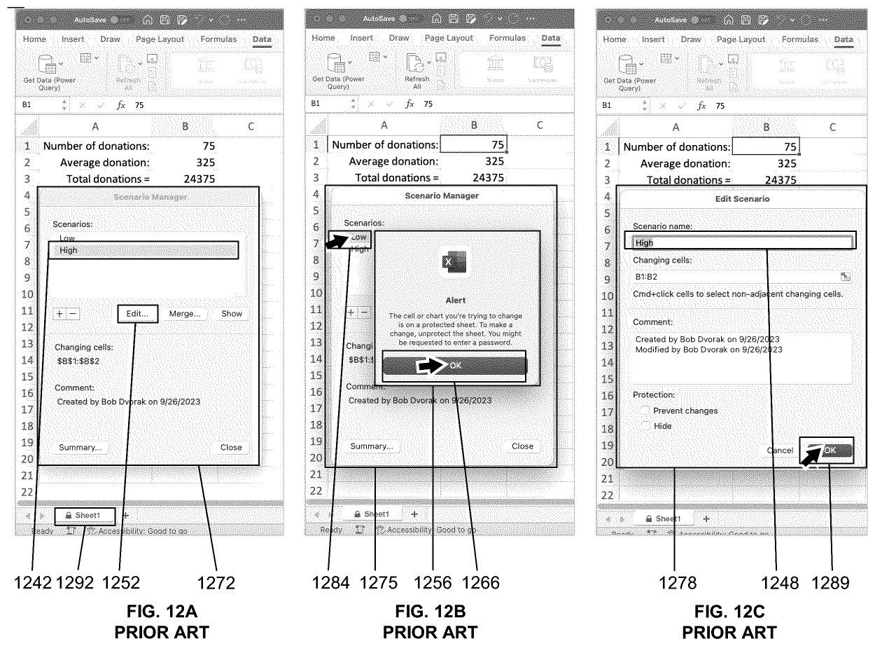

FIG. 11B examples the charity user locking the worksheet 1167 containing the scenarios with the ‘Allow users of this sheet to:’ ‘Edit scenarios’ selection checked 1168 in the ‘Protect the sheet and contents of locked cells.’ popup 1158. When the user clicks ‘OK’ 1179 they get the locked worksheet in FIG. 12A. Note the lock in the ‘Sheet1’ tab 1292. They can reopen the ‘Scenario Manager’ popup 1272 and they then see the ‘High’ scenario highlighted 1242. Excel allows the user to then change the highlighted option, so the user selects ‘Low’ as exampled in 1284 in FIG. 12B. However, when they click ‘Show’ to change the values in the spreadsheet cells they instead get the ‘Alert’ popup 1256 which informs them ‘The cell or chart you're trying to change is on a protected sheet. To make a change, unprotect the sheet. You might be requested to enter a password’. So, they are unable to change the scenario and therefore change the values within the locked cells. However, they are able to edit the scenarios as we will example in FIG. 12C through FIG. 14A, but just not able to use those changed scenarios until the cells are unlocked.

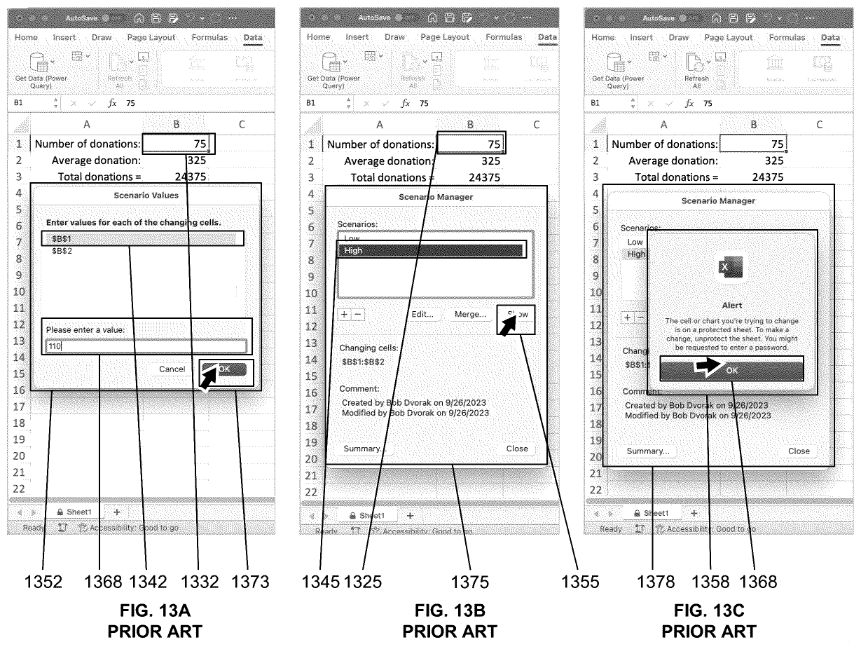

In FIG. 12C the user starts to change the ‘High’ 1248 scenario clicking the ‘OK’ button 1289 in the ‘Edit Scenario’ popup 1278. This opens the ‘Scenario Values’ popup 1352 in FIG. 13A. Where the user changes the ‘75’ scenario value in cell ‘B1’ 1332 to ‘110’ 1368. They then click ‘OK’ 1373 to get back to the ‘Scenario Manager’ popup 1375 in FIG. 13B still selected to the ‘High’ scenario 1345. The value in ‘B1’ 1325 has not changed to the newly inputted value of ‘110’ so the user clicks ‘Show’ 1355 to refresh the ‘High’ scenario. Instead of replacing the value in the locked cell the user gets on top of the ‘Scenario Manager’ popup 1378 the Alert popup 1358 which informs them ‘The cell or chart you're trying to change is on a protected sheet. To make a change, unprotect the sheet. You might be requested to enter a password’. So, they are unable to change the values within the locked cells despite the fact that they changed the scenario. When they click the ‘OK’ 1368 in the Alert popup 1358 they then confirm that they have changed the scenario value by clicking the ‘Edit’ button to again access the ‘Scenario Values’ popup 1462 in FIG. 14A. In that Scenario Values' popup 1462 they see the ‘$B$1’ 1442 value is the recently changed ‘110’ 1472 while the value locked in the cell ‘B1’ is still the ‘75’ 1432. This finding is consistent with the ‘Microsoft Agent|Moderator’ response back to a user wanting to make a similar scenario change in a locked cell. As they responded ‘According to your description it seems that you have protected your worksheet, however, you found that you cannot go to Data>What if Analysis>Scenario Manager to change different scenarios. And you want to know how to show different scenarios within protected worksheet. May I know if my understand is right? If so, we're afraid there is no out of box way to achieve your requirement and you may not use this feature in a protected cell’ 1477 in FIG. 14B. Thus, checking the ‘Edit scenarios’ option 477 in FIG. 4 does not partially lock the content of the cell but fully locks it. There is no partial locking of regular cell formulas as we will further example in the following prior art.

### Prior Art Spreadsheet Cell Locking—Regular Cell Function Formulas

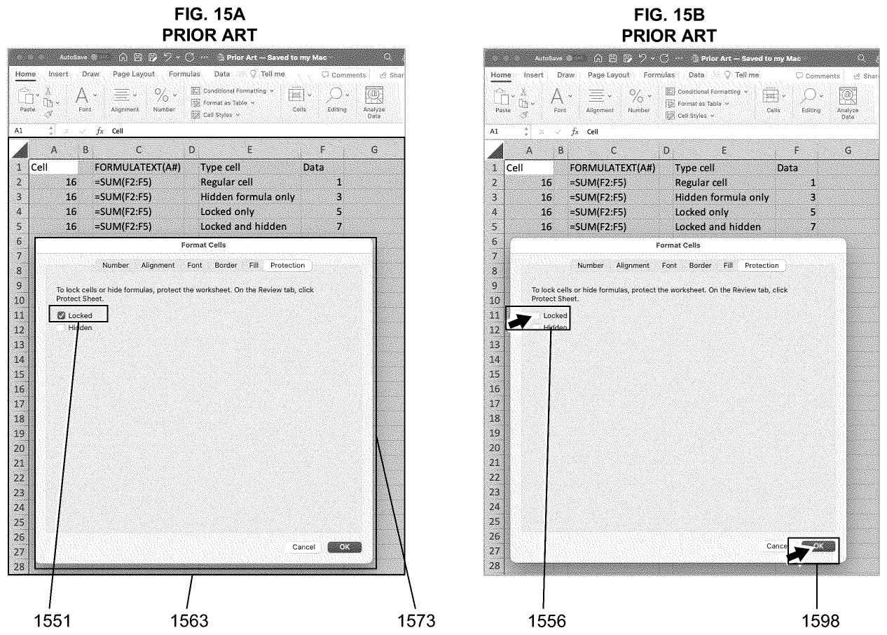

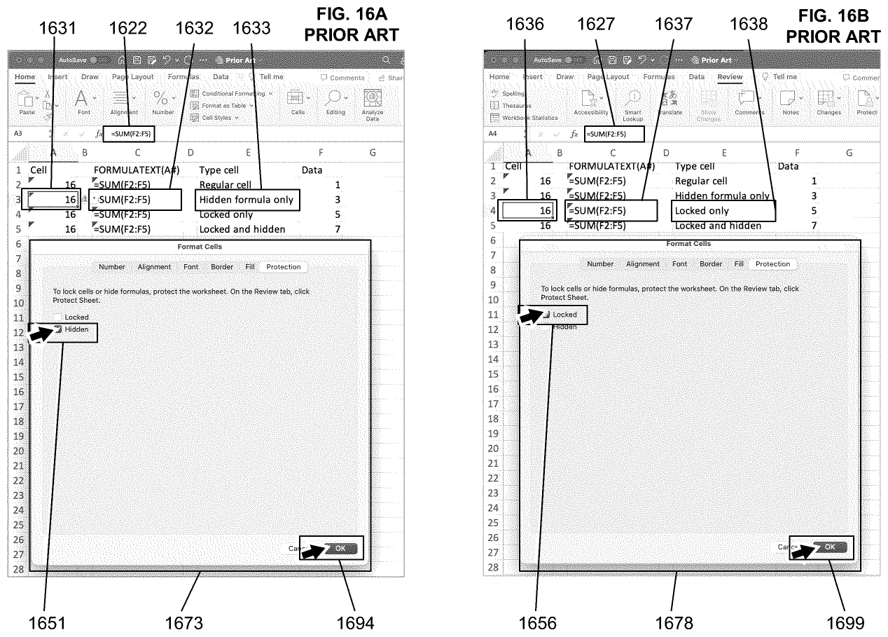

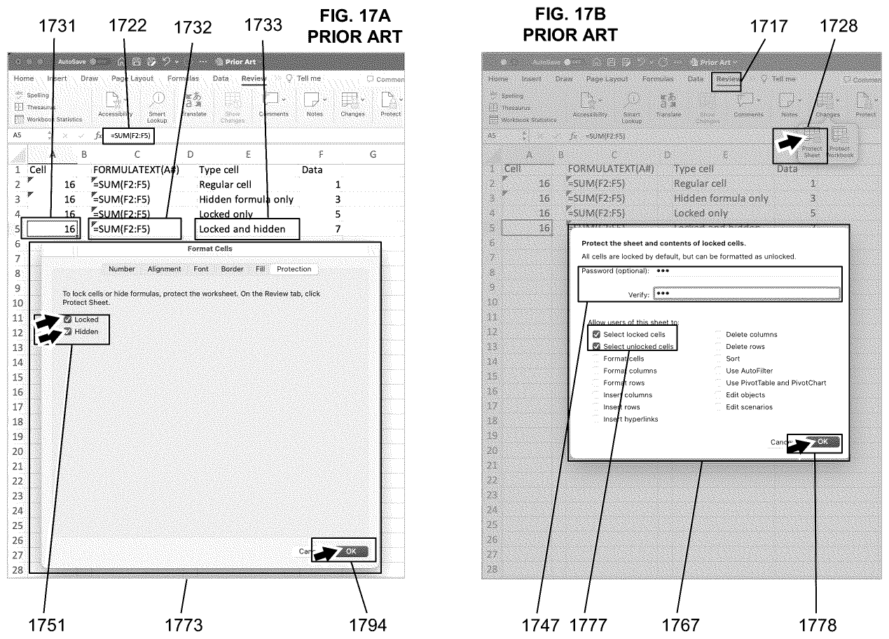

FIG. 15A and FIG. 15B examples the charity user unlocking all the cells in the worksheet 1563 in FIG. 15A by unclicking 1556 in FIG. 15B the default ‘Locked’ setting 1551 in FIG. 15A in the ‘Format Cells popup 1573 in FIG. 15A and then clicking the ‘OK’ 1598 in FIG. 15B. Note, these actions example a variant of the steps outlined in FIG. 2 and FIG. 3. The user can then apply locking and/or hiding to the cells of their choice as exampled in FIG. 16A through FIG. 17A.

FIG. 16A examples the charity user setting up cell ‘A3’ 1631 for ‘Hidden’ 1651 protection when the user clicks ‘OK’ 1694 in the ‘Format Cells’ popup 1673. The hidden formula will not happen until the worksheet is protected and therefore is still visible in the formula bar 1622 and in the ‘FORMULA_TEXT’ output in cell ‘C3’ 1632 showing the cell formula in cell ‘A3’ 1631. The user also added a label of ‘Hidden formula only’ 1633 in cell ‘E3’ so we can easily understand the outcomes for the hidden formula situation.

FIG. 16B examples the charity user setting up cell ‘A4’ 1636 for ‘Locked’ 1656 protection when the user clicks ‘OK’ 1699 in the ‘Format Cells’ popup 1678. The locked cell will not happen until the worksheet is protected which has not happened yet. In cell ‘C4’ 1637 the user set up a ‘FORMULA_TEXT’ showing the cell formula in cell ‘A4’ 1636. The user also added a label of ‘Locked only’ 1638 in cell ‘E4’ so we can easily understand the protection impact on the cell formula 1627 relative to what was done in the cell.

FIG. 17A examples the charity user setting up cell ‘A5’ 1731 for ‘Locked’ and ‘Hidden’ 1751 protection when the user clicks ‘OK’ 1794 in the ‘Format Cells’ popup 1773. The locked cell and hidden formula will not happen until the worksheet is protected which has not happened yet. In cell ‘C5’ 1732 the user set up a ‘FORMULA_TEXT’ function formula showing the cell formula in cell ‘A5’ 1731. The user also added a label of ‘Locked and hidden’ 1733 in cell ‘E5’ so we can easily see protection impact on the cell formula 1722. At this point the charity user has prepared all the cells of interest and is ready to protect the cells they have ‘formatted’ in the worksheet. Therefore FIG. 17B examples the user on the ‘Review’ tab 1717 clicking on the ‘Protect Sheet’ button 1728 to open the ‘Protect the sheet and content of locked cells.’ popup 1767 where the user is fine with the two default check boxes 1777 that allows users to select the locked and unlocked cells. They then put in a three-digit password 1747 and click ‘OK’ 1778 to protect cells within the worksheet.

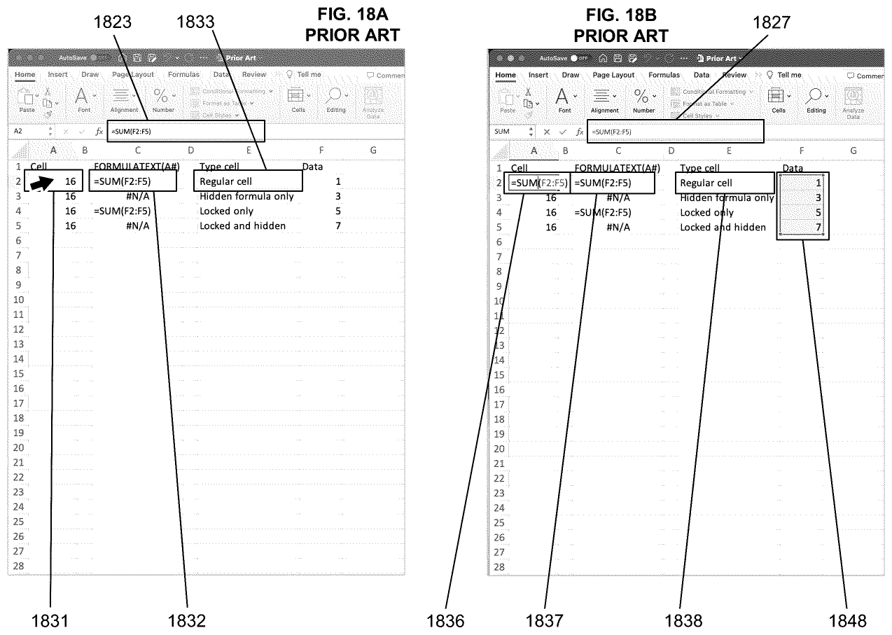

FIG. 18A through FIG. 21B examples the outcomes of the different protection of these typical functional formula cells. What they show is that Microsoft Excel protection, like the protection in the other spreadsheets, is binary on regular cell formulas and cell values. Specifically, the cell is either completely locked or completely unlocked with no partial or differential locking of the cell formula and the cell value.

FIG. 18A examples a cell that was not locked nor hidden in a protected worksheet, therefore exampling complete unlock. It was labelled a ‘Regular cell’ 1833 which is in ‘A2’ 1831 which is unlocked and with its formula visible in the formula bar 1823 and in the ‘FORMULA_TEXT’ formula cell ‘C2’ 1832. When the user double clicks into cell ‘A2’ 1831 it opens the formula ‘=SUM’ 1836 within the cell as exampled in FIG. 18B highlighting the range 1848 within the ‘SUM’ and with the formula visible in the formula bar 1827 as it normally would. There has been no impact on the typical cell functioning of the formula by the protection of the worksheet because the unlocked cells were set to ‘Select unlocked cells’ 1777 FIG. 17B.

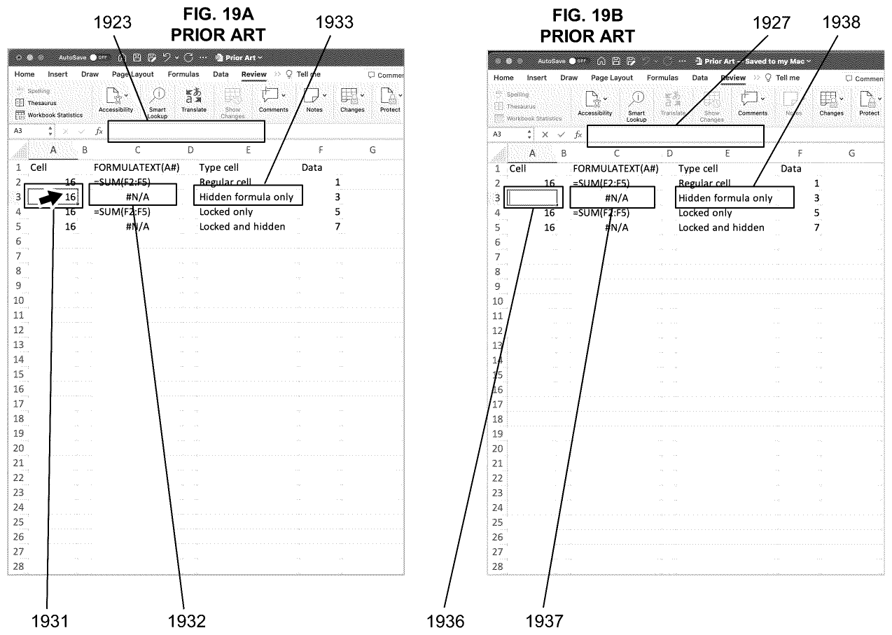

However, the regular cell formula of ‘=SUM’ that is in cell ‘A3’ 1931 in FIG. 19A is a different situation as its formula is not visible in its formula bar 1923 in FIG. 19A and is not visible in its ‘FORMULA_TEXT’ formula cell ‘C3’ instead showing a value of ‘#N/A’ 1932. We labelled this regular cell formula ‘Hidden formula only’ 1933 as the cell is not locked as shown in FIG. 19B when the user is able to double click into the cell ‘A3’ 1936 with the ability to edit the invisible formula. So, from a locking perspective the cell formula is entirely unlocked allowing the user to erase it or edit it just as would be expected from the cell format protect settings for the ‘Hidden formula only’ 1938.

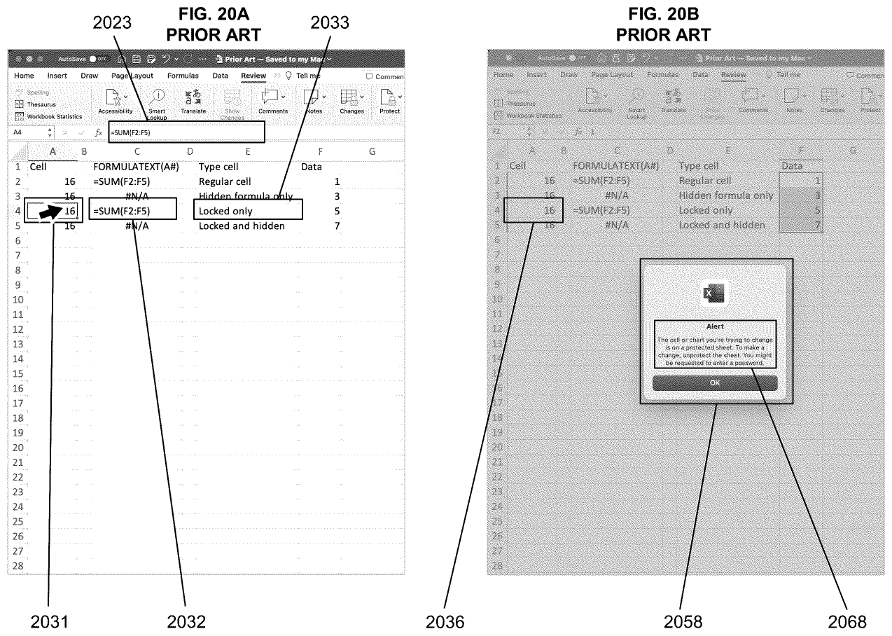

FIG. 20A examples the charity user double clicking into cell ‘A4’ 2031 which is a locked cell in Microsoft Excel as was set up in FIG. 16B and indicated by the text ‘Locked only’ 2033 label in cell ‘E4’ in FIG. 20A. This regular cell with the regular functional formula ‘=SUM’ has the formula visible in the formula bar 2023 and in the ‘FORMULA_TEXT’ formula cell ‘C4’ 2032. And as expected the double clicking into the locked cell ‘C4’ 2036 does not gain access to the cell formula and any ability to change it but instead triggers the ‘Alert’ popup 2058 exampled in FIG. 20B with the message ‘The cell or chart you're trying to change is on a protected sheet. To make a change, unprotect the sheet. You might be requested to enter a password’ 2068. Again, exampling how formulas in regular cells are either locked or unlocked with nothing in between and exampling the general nature of the Excel Alert messages as it is not specific to whether it is a cell or a chart and to whether a password has been set or not. It also indicates that the protection is sheet specific and not cell specific. As most of the cells in this sheet were left unlocked as exampled in FIG. 15B.

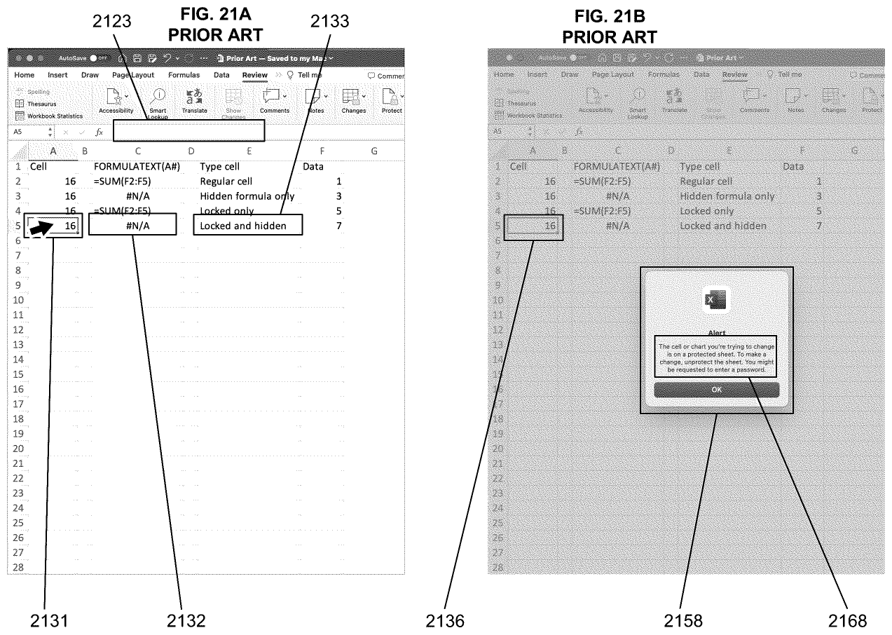

FIG. 21A examples the charity user double clicking into cell ‘A5’ 2131 which is a locked cell with a hidden formula in Microsoft Excel as was set up in FIG. 17A and indicated by the text ‘Locked and hidden’ 2133 descriptor in cell ‘E5’ in FIG. 21A. This regular cell with the regular functional formula ‘=SUM’ has a visible value ‘16’ in cell ‘A5’ 2131 but an invisible formula in the formula bar 2123 and in the ‘FORMULA_TEXT’ formula cell ‘C5’ 2132. And as expected the double clicking into the locked cell ‘A5’ 2131 in FIG. 21A or 2136 in FIG. 21B does not gain access to the cell formula and any ability to change it but instead triggers the ‘Alert’ popup 2158 in FIG. 21B with the message ‘The cell or chart you're trying to change is on a protected sheet. To make a change, unprotect the sheet. You might be requested to enter a password’ 2168. Again, exampling how formulas in regular cells are either locked or unlocked with nothing in between and exampling the general nature of the Excel Alert messages as it is not specific to whether it is a cell or a chart and to whether a password has been set or not. It also again indicates that the protection application and elimination is at least sheet specific and not cell specific.

### Prior Art Spreadsheet Cell Locking—Spreadsheet Level Protection

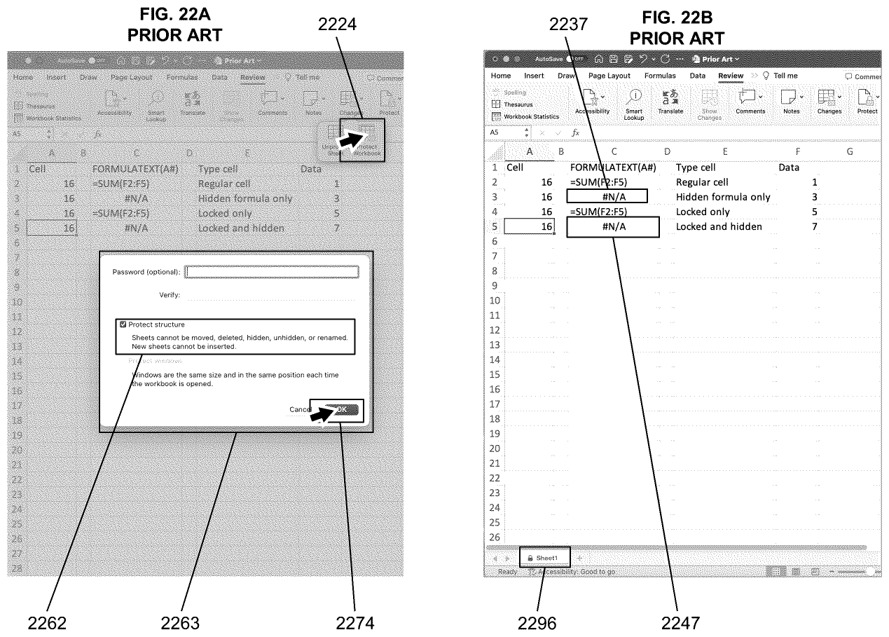

FIG. 22A and FIG. 22B example the other level of protection application which is ‘Protect Workbook’ 2224 in FIG. 22A. The previous examples in FIG. 17B through FIG. 21B had the protection applied at the ‘Sheet’ level. The other level available in Microsoft Excel is the ‘Workbook’ level applied by the ‘Protect Workbook’ click 2224 in FIG. 22A. This opens the ‘Protect structure’ option that locks the entire spreadsheet as explained in the text ‘Sheets cannot be moved, deleted, hidden, unhidden. Or renamed. New sheets cannot be inserted.’ 2262 in the popup 2263. When the user clicks ‘OK’ 2274 the protection which was applied to the cells with the locked and hidden formatting set up like in FIG. 15A through FIG. 17A delivers the outcome in FIG. 22B. Where the formulas that are supposed to be hidden are hidden 2237/2247 and the Sheet is locked 2296. So, Microsoft Excel protection occurs at the ‘Sheet’ level or the entire ‘Workbook’ level.

### Prior Art Spreadsheet Cell Locking—Person Specific Protection

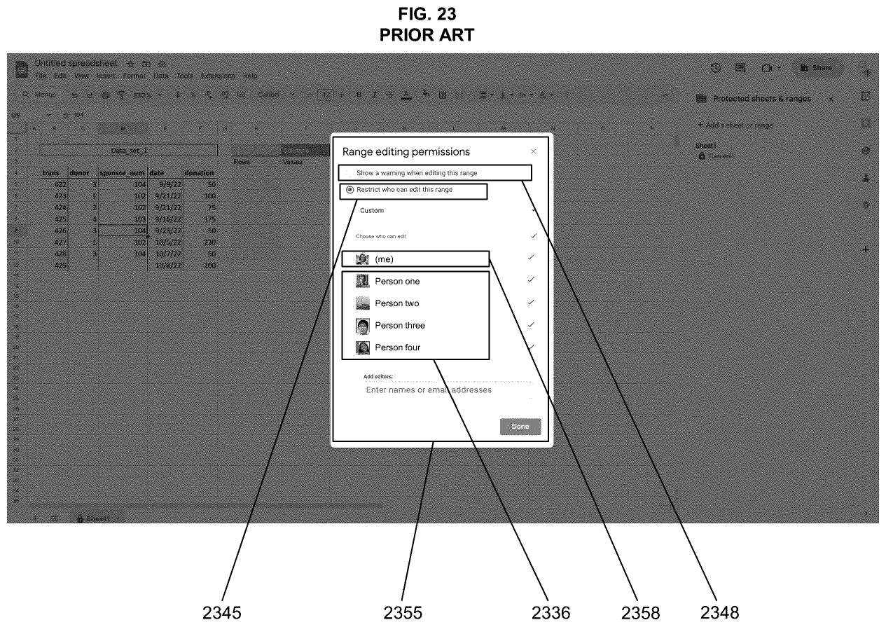

Google Sheets takes a different approach to locking cells which is a person specific locking allowing edits by specific individuals as exampled in FIG. 23. However, the editing is more binary than in Microsoft Excel as there are no Excel like exceptions. Google Sheets regular cell formula or capabilities are either locked or unlocked with no partial locking. FIG. 23 examples our charity user 2358 getting ready to restrict 2345 which users 2336 can edit a specified range within a spreadsheet using the popup 2355. Like Microsoft Excel they instead can simply give a warning 2348 to users when editing the range.

Before we go into the final aspect of prior art cell locking, we will example the validation capabilities within the existing spreadsheets. Its understanding is relevant to our locking technology as well as a new type of function in our technology that addresses the validation user need in a very different manner that is more easily accessible to some users, requires substantially less work, and automatically provides a highly tailored post validation setup usage.

### Prior Art Validation—Microsoft Excel

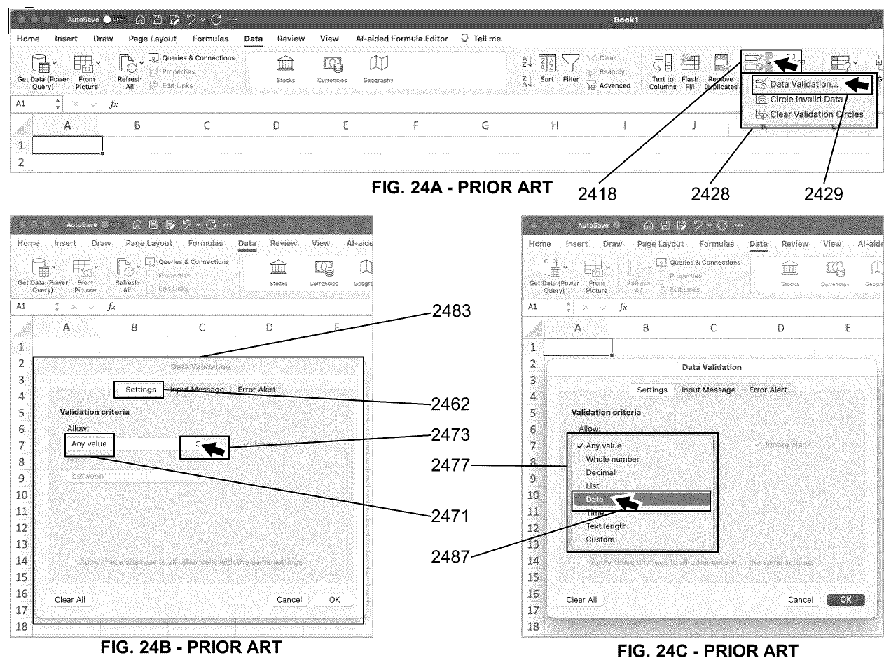

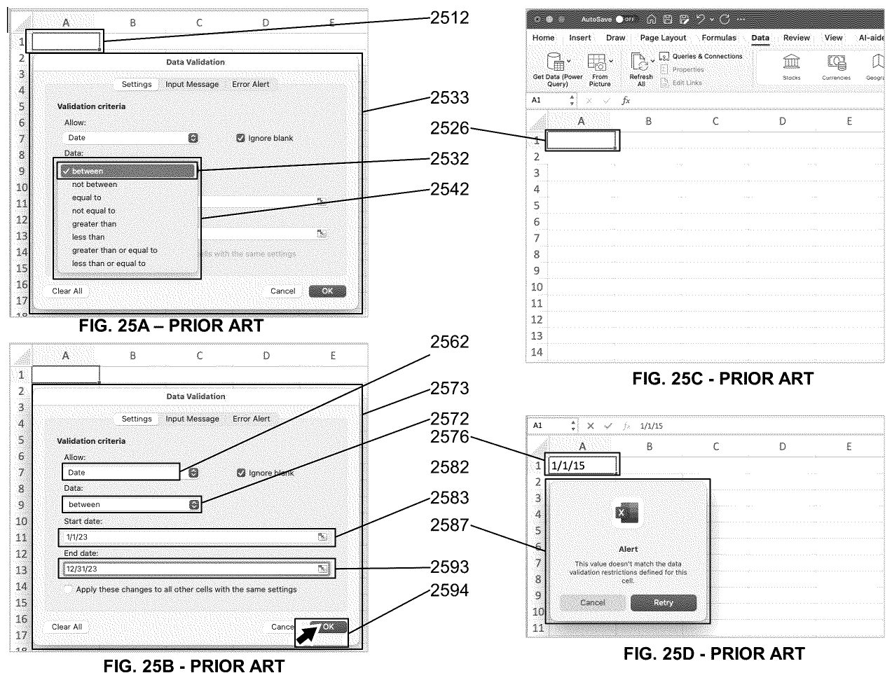

Existing spreadsheets have a cell capability called validation which is used to limit inputs or create a dropdown selection list with the cell. In Microsoft Excel it is accessed via a buttons on the ‘Data’ tab as exampled by the click 2418 to open a selector list 2428 and then the ‘Data Validation . . . ’ 2429 selection in FIG. 24A. That opens the ‘Data Validation’ popup 2483 exampled in FIG. 24B where the user starts on the ‘Settings’ tab 2462. To move beyond allowing ‘Any value’ 2471 in the cell the user clicks the selector 2473. That opens a selector list 2477 in FIG. 24C which displays a set of different validation type options. In this example the user selects the ‘Date’ 2487 option which changes the content of the ‘Settings’ tab with ‘Data’ selection options 2542 in FIG. 25A which give the user a set of ‘Date’ validation criteria to select from. Those validation criteria contain a range, non-range, equality, non-equality, and a set of inequalities. In this example the user selects the ‘between’ 2532 option in the selection list 2542 within the ‘Data Validation; ‘Settings’ popup 2533 to be applied to the cell ‘A1’ 2512. The ‘between’ is then populated 2572 in FIG. 25B after which the user populates the two between dates ‘1/1/23’ 2583 and ‘12/31/23’ 2593 before clicking the ‘OK’ 2594 in the ‘Data Validation’ ‘Settings’ popup 2573 to populate the ‘Date’ 2562 data type and ‘between’ 2572 value range validation in cell ‘A1’ 2526 in FIG. 25C.

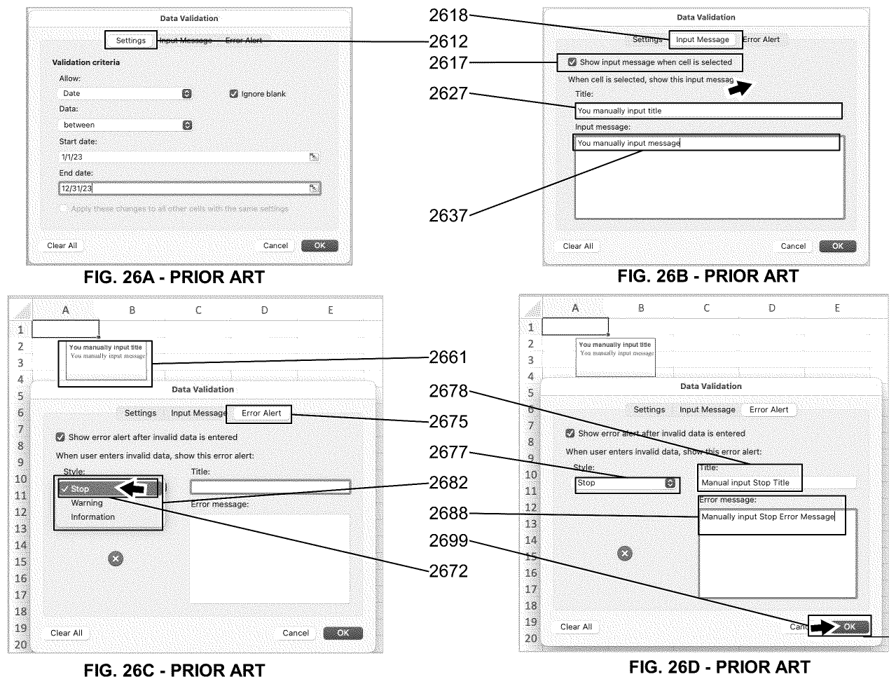

FIG. 25D then examples the user testing the cell validation by typing ‘1/1/15’ within cell ‘A1’ 2576 to find the validation works giving an ‘Alert’ popup 2587 messaging ‘This value doesn't match the data validation restrictions defined for this cell’. Then asking the user to ‘Cancel’ the input or ‘Retry’ it. Achieving the purpose of not allowing an input not meeting the validation criteria inputted by the user in the validation cell capability, but not helping the user to know what to do. There is no cell formula or message to guide the user as to how to correct the input to meet the constraints. There is nothing that told them even whether they inputted the correct data type let alone whether there was a value constraint and what it is. However, if we return to the ‘Data Validation’ setup popup as exampled in FIG. 26A and change from the ‘Settings’ tab 2612 to the ‘Input Message’ 2618 tab as exampled in FIG. 26B, the user can manually create a message. For example, purposes, we inputted a message ‘Title:’ ‘You manually input title’ 2627 and an ‘Input message:’ ‘You manually input message’ 2637. This then displays as shown in FIG. 26C 2661 just below the cell when it is opened. There are two challenges with this. One is it required quite a bit of user work because it was not automatically generated when the users specified those criteria but requires many manual selections and inputs. The second is that the title and message are static and do not dynamically change if the user changes the validation criteria.

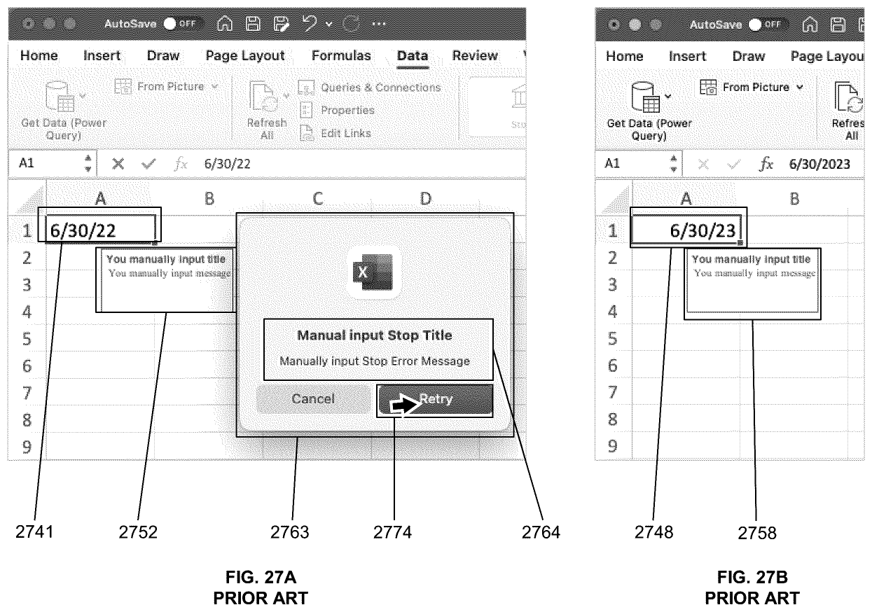

The ‘Error Alert’ is slightly different in there was a very generic ‘Alert’ automatically generated, as shown in 2587 in FIG. 25D. However, that ‘Alert’ did nothing to inform the user as to what was wrong with their input, was it the data type or was it the value and the criteria for fixing it. Again, the Microsoft Excel user can manually input a custom ‘Error Alert’ as exampled in FIG. 26C and FIG. 26D which also requires user work and are also static not automatically changing with any change in the cell validation criteria. Setting up this custom ‘Error Alert’ is done by moving to the ‘Error Alert’ tab 2675 in FIG. 26C and then selecting its ‘Style:’ 2682. In this example the user selects ‘Stop’ 2672 as shown in 2677 in FIG. 26D. Then the user manually fills out the ‘Title:’ 2678 and ‘Error message:’ 2688 as exampled in FIG. 26D. After clicking ‘OK’ 2699 the custom ‘Error Alert’ is available for use as exampled in FIG. 27A. Also having the two problems of requiring user work and being static with titles and error messages not automatically changing with changes in the user validation constraints.

In FIG. 27A the user has the custom input message and title 2752 and because they inputted an invalid value ‘6/30/22’ in cell ‘A1’ 2741 they received the custom ‘Error Alert’ 2763 with the custom ‘Title’ and ‘Error message’ 2764. Depending upon what the user put in the ‘Error Alert’ it may inform the user on how to correct their error when they click ‘Retry’ 2774. FIG. 27B examples the user then correcting the value to ‘6/30/23’ 2748 while still in the cell exposing the custom created ‘Input message’ 2758. The problem for the user is there is no automatically created ‘Input message’ that is created when the user sets the validation criteria and which automatically alters itself when the user changes those criteria). The default ‘Error message’ is only slightly better as there is a very generic automatically generated message which however does not give the user any information on the criteria they failed to fulfil. Their custom entered Error message title and message requires multiple selections and inputs and is static and does not automatically change as the validation constraints are changed.

### Prior Art Validation—Google Sheets

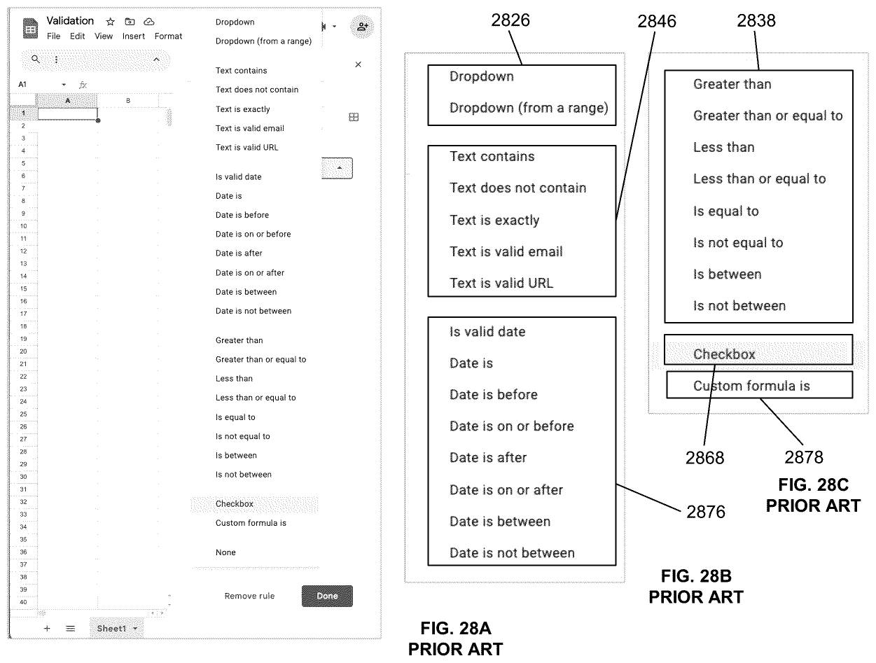

Google Sheets validation is very similar in concept to Microsoft Excel validation with a largely similar set of dropdown/list, date, numeric, and custom formula validation rules exampled in FIG. 28A and its blow-ups in FIG. 28B and FIG. 28C. Google Sheets has a more extensive set of text validation rules 2846 in FIG. 28B and a ‘Checkbox’ option 2868 in FIG. 28C that we will example later as it has a graphical element not found in the Microsoft Excel validation.

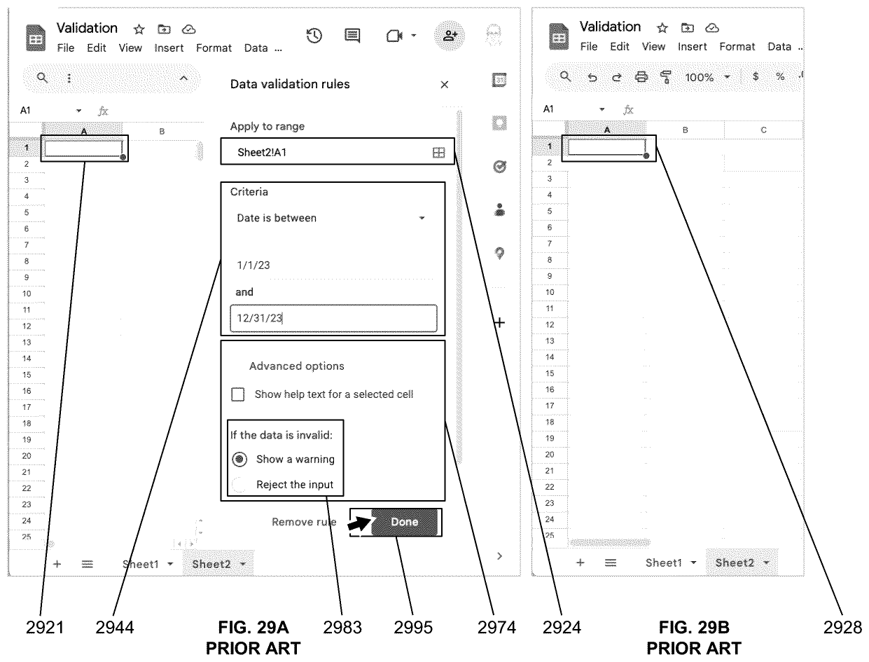

Google Sheets has no “Input message” equivalent as exampled in FIG. 29A and FIG. 29B. It has the ability to manually set up after an invalid input custom invalid data warnings or rejection messages but no automatic or manually set up input message and has a default setting of automatically generating a warning in the event of an invalid input. FIG. 29A examples a user setting up ‘Data validation rules’ with a validation type of date with a validation criterion of ‘Date is between’ and validation values of ‘1/1/23’ and ‘12/31/23’ 2944 for the cell ‘Sheet2!A1’ 2921/2924. The validation rules have a default setting of ‘If the data is invalid:’ ‘Show a warning’ 2983. When the user clicks ‘Done’ 2995 they get the completed validation cell ‘A1’ shown in FIG. 29B 2928 with no input message.

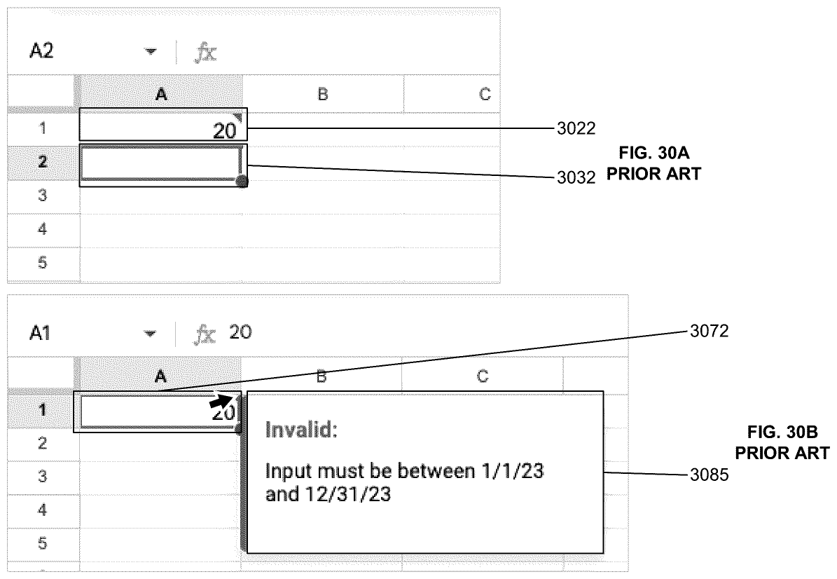

FIG. 30A and FIG. 30B example the outcome of a user entering an invalid input of ‘20’ into the cell ‘A1’ set up in FIG. 29A and FIG. 29B. When the user enters the number ‘20’ into cell ‘A1’ 3022 in FIG. 30A Google Sheets automatically displays the red triangle in the cell and moves to the cell below ‘A2’ 3032. The user then needs to click on the red triangle in cell ‘A1’ 3072 as they do in FIG. 30B to display the warning 3085. The error warning is specific to the validation set up and automatically changes if the user changes the validation criteria.

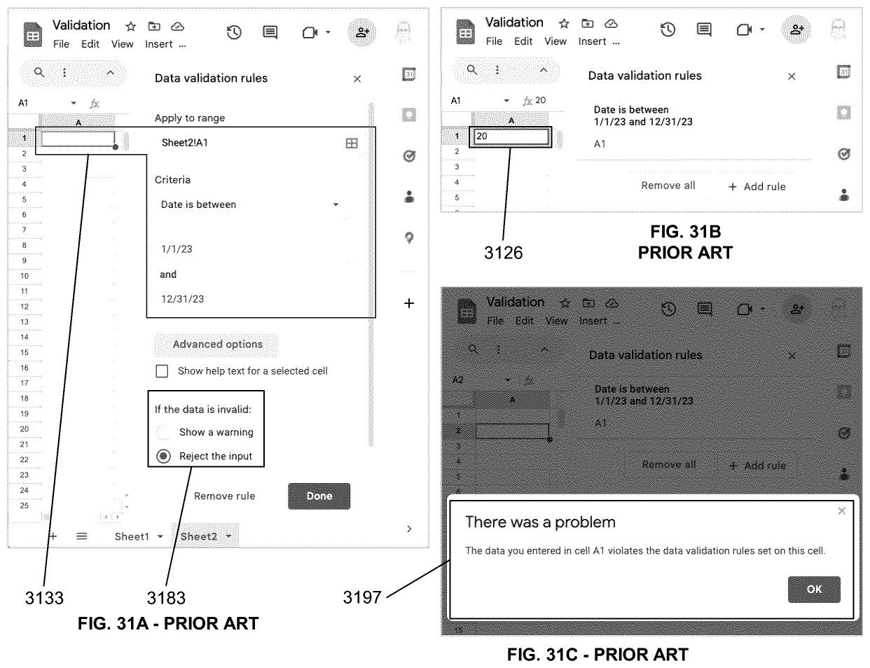

FIG. 31A through FIG. 31C example for Google Sheets changing the ‘If the data is invalid:’ setting to ‘Reject the input’ and then entering an invalid value to the cell ‘A1’ validation criteria set up in FIG. 29A and FIG. 29B. In this situation the “Error message’ is automatically generated but its message is generic, not validation criteria specific like the default warning message. FIG. 31A examples the Data validation rules with a validation type of date with a validation criterion of ‘Date is between’ and validation values of ‘1/1/23’ and ‘12/31/23’ for the cell ‘Sheet2!A1’ 3133. This time the user has selected the ‘If the data is invalid:’ setting to ‘Reject the input’ 3183. When the user enters ‘20’ into cell ‘A1’ 3126 as exampled in FIG. 31B Google Sheets automatically opens the error message 3197 as exampled in FIG. 31C. This message tells the user ‘There was a problem’ with a generic message of ‘The data you entered in cell A1 violates the data validation rules set on this cell’. It is not validation criteria specific like the Google Sheets default validation violation warning message.

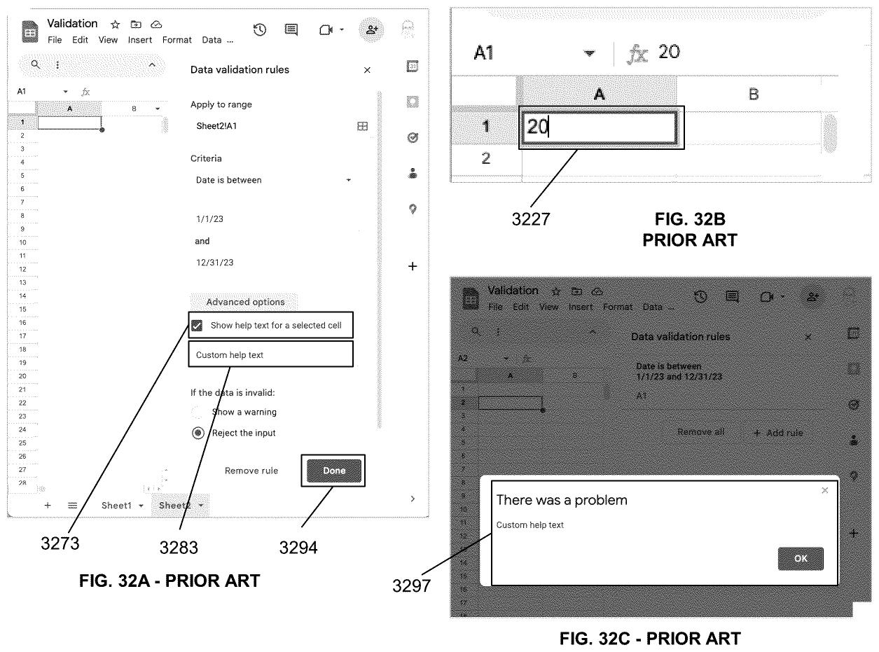

Google Sheets does allow the user to input their own reject message as exampled in FIG. 32A through FIG. 32C. The user clicks the ‘Show help text for a selected cell’ box 3273 which opens the box 3283 in FIG. 32A into which the user types ‘Custom help text’ 3283. The user then clicks ‘Done’ 3294 and the cell ‘A1’ is ready for use. The user then enters ‘20’ into cell ‘A1’ 3227 as exampled in FIG. 32B and Google Sheets automatically opens the error message 3297 as exampled in FIG. 32C. This message 3297 tells the user ‘There was a problem’ and displays the manually inputted message ‘Custom help text’. As shown here that works for the error message but it does not replace the warning message if the user then changes the radio button to ‘Show a warning’ rather than ‘Reject the input’.

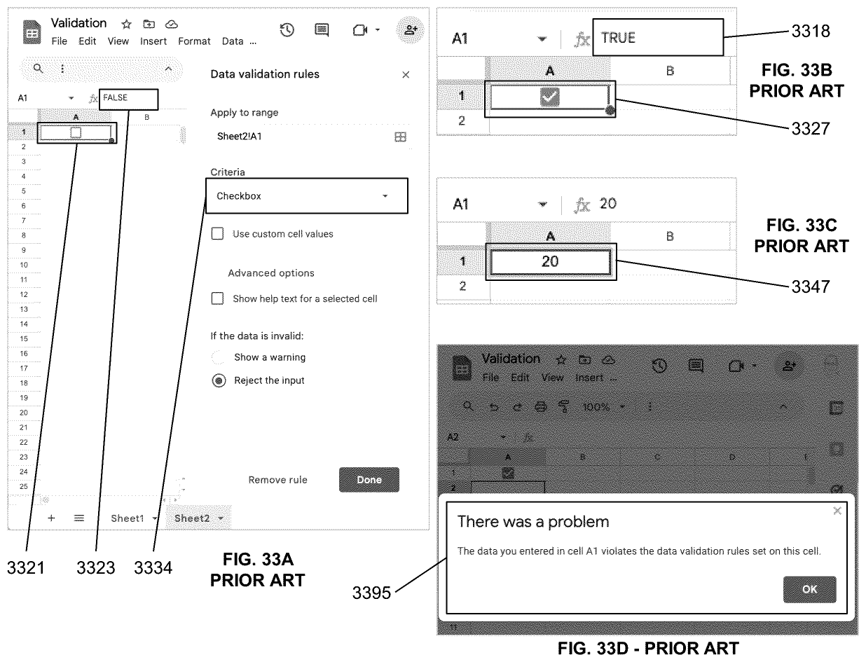

As we mentioned in FIG. 28C 2868 Google Sheets has a checkbox feature which is exampled in FIG. 33A through FIG. 33D. It uses a checkbox to generate Boolean values. FIG. 33A examples a minimal input ‘Data validation rules’ ‘Checkbox’ 3334 for the cell ‘A1’ 3321 showing the unchecked box displaying a ‘FALSE’ value 3323 in the ‘A1’ formula bar. FIG. 33B examples the user having checked the box in cell ‘A1’ 3327 displaying a ‘TRUE’ value 3318 in the ‘A1’ formula bar. FIG. 33C examples the user in the process of entering an invalid value ‘20’ in cell ‘A1’ 3347 and when they hit enter automatically getting the generic reject message 3395 exampled in FIG. 33D.

### Prior Art Validation—not Regular Cells or Formula

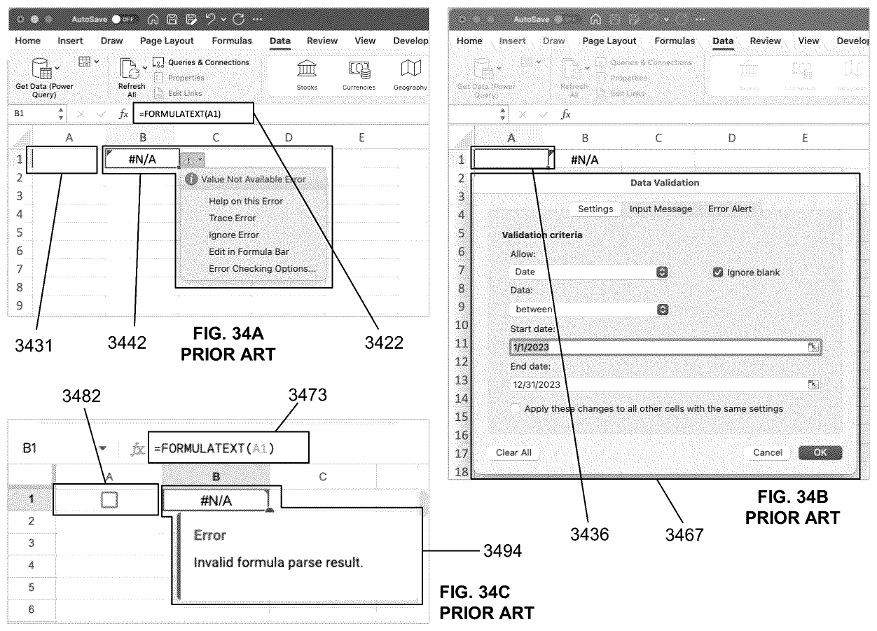

Our final validation point is that cells that have undergone validation set up are not regular cells and are not cells containing cell formula. The first point is fairly obvious given a regular cell accepts any input including correct formulas and all values without generating an error. On the second point a formula starts with an equal's sign which is not present in validation cells and a formula generates a ‘FORMULATEXT’ output without an error message for any formula that has not been hidden. FIG. 34A and FIG. 34B examples Microsoft Excel generating an error message in cell ‘B1’ 3442 when referencing cell ‘A1’ 3431, which is an empty non-hidden validation cell, in its ‘=FORMULATEXT’ formula shown in the formula bar 3422. The user will get the same ‘=FORMULATEXT’ result of ‘#N/A’ if the cell ‘A1’ instead of being empty has a value within it. Note, FIG. 34B displays the ‘Data Validation 3467 setup of cell ‘A1’ 3436. FIG. 34C examples that there is no formula for a Google Sheets checkbox validated cell ‘A1’ 3482 from its ‘=FORMULATEXT’ 3473 referencing formula in cell ‘B1’, which displays an error and error message 3494. Similarly confirming that validation cells do not contain a formula.

While we could example more Microsoft Excel, Google Sheets and other spreadsheet validation criteria and situations, we have exampled the manual or missing nature of their input messages. We have exampled their generic automatic error stop/reject messages their ability to manually replace those generic error stop/reject messages. And we have exampled that the current spreadsheet cell validation is a cell capability not a cell formula or regular value. We will return to how our technologies resolve these validation deficiencies after we example the validation locking deficiencies in the existing spreadsheets.

### Prior Art Validation Locking

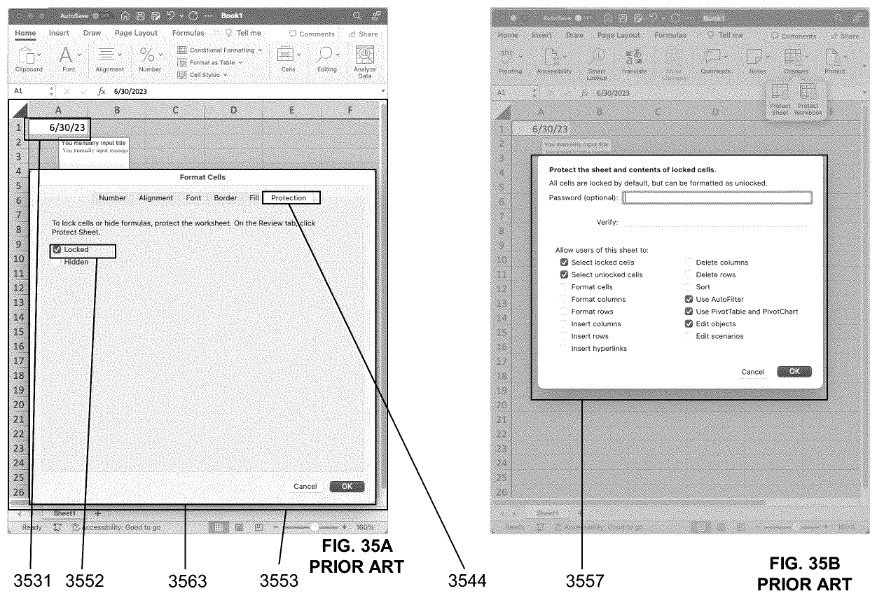

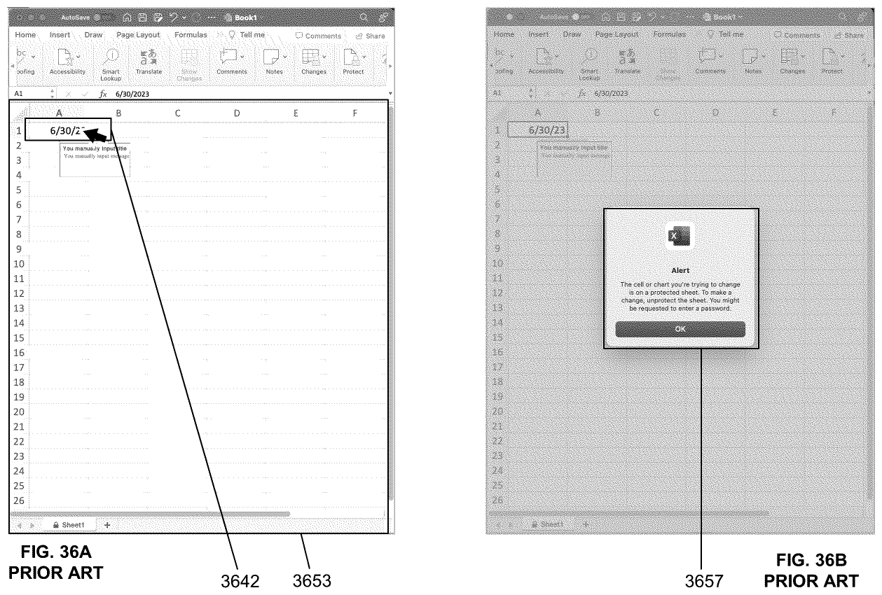

With a layout of how validation works in existing spreadsheets we will now example how its combination with locking is binary, either the validation cell is locked or not with no partial locking. FIG. 35A examples locking the cell ‘A1’ 3531 which is the cell ‘A1’ 2748 in FIG. 27B which has the validation set up in FIG. 26A through FIG. 26D. In this example the Microsoft Excel user is formatting all the cells in ‘Sheet1’ 3553 to be ‘Locked’ 3552 using the ‘Protection’ tab 3544 on the ‘Format Cells’ popup 3563. The user then protects the sheet using the ‘Protect the sheet and contents of locked cells.’ popup 3557 in FIG. 35B having clicked all the ‘Allow user of the sheet to:’ check box options which they thought might impact the operation of the validation cell. FIG. 36A examples the user trying to double click into the validated cell ‘A1’ 3642 now on the protected ‘Sheet1’ 3653. What the user finds is that the cell is totally locked via the ‘Alert’ popup 3657 automatically displayed in FIG. 36B. That ‘Alert’ tells the user ‘The cell or chart you're trying to change is on a protected sheet. To make a change, unprotect the sheet. You might be requested to enter a password’ as we have seen before for locked cells.

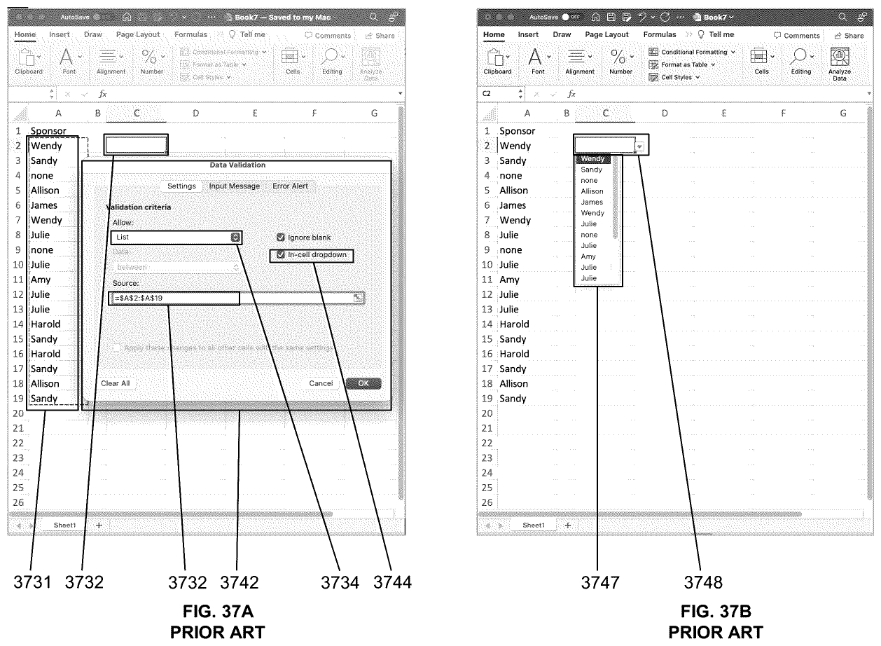

The same locking is true for ‘List’ validation exampled in FIG. 37A through FIG. 39B which is a different variant of validation where the user instead of inputting a value that is validated, selects from a list. Where there would be a highly usable feature of locking the list but not locking the selection from the list as we will example in our technologies.

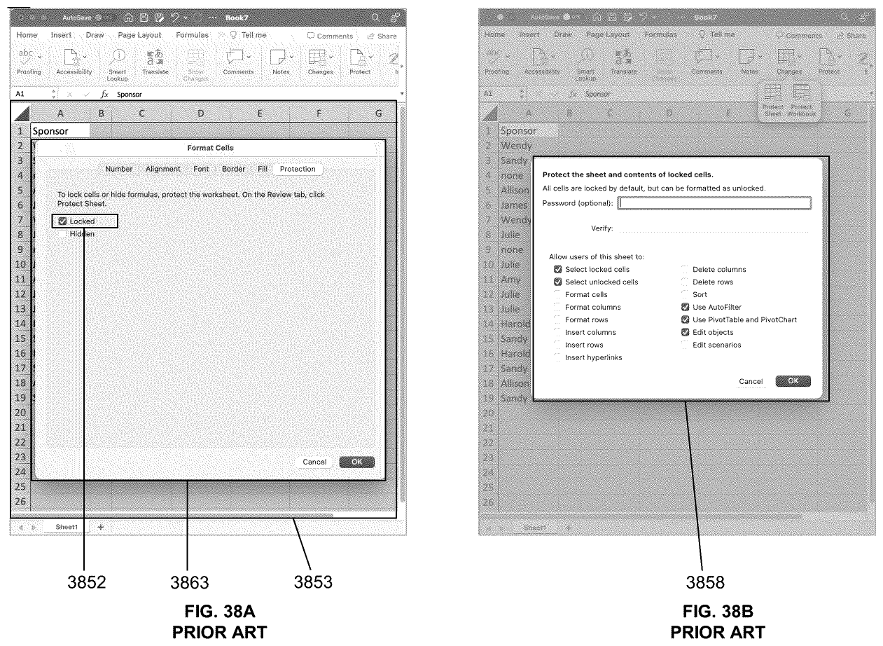

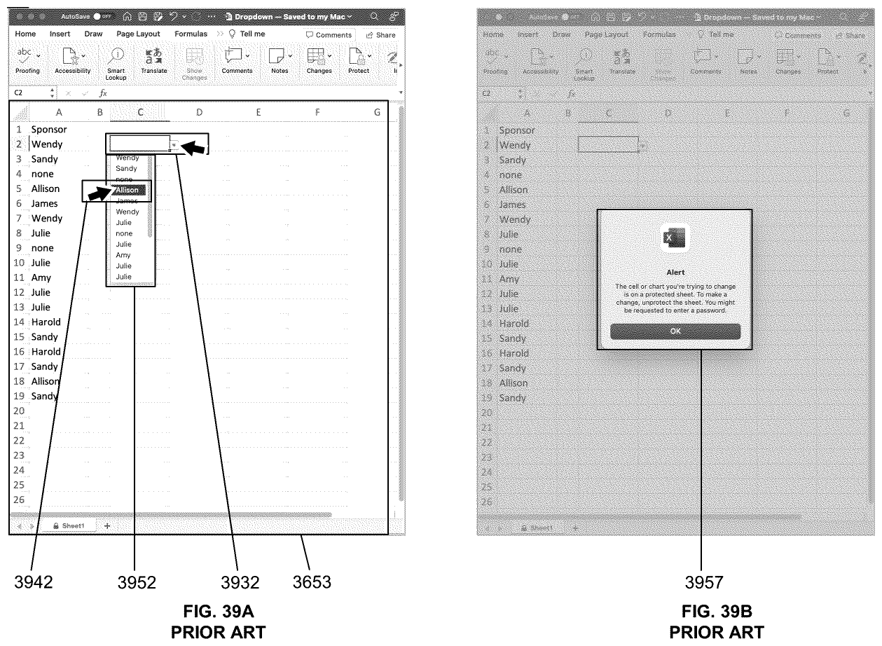

FIG. 37A examples a user with a list of charity sponsors in cells ‘A2’ through ‘A19’ 3731 that they are setting up as an ‘In-cell dropdown’ 3744 ‘List’ 3734 from the source cells ‘=$A$3:$A$19’ 3732 in the ‘Data Validation’ popup 3742 for cell ‘C2’ 3732. Once the user clicks ‘OK’ they get the dropdown list 3747 as exampled in FIG. 37B for cell ‘C2’ 3748. In FIG. 38A the user starts the process to lock the sheet that contains the list cell ‘C2’ 3748 in FIG. 37B by formatting all the cells in the ‘Sheet1’ 3853 ‘Locked’ 3852 using the ‘Format Cells’ popup 3863. The user then protects the sheet using the ‘Protect the sheet and contents of locked cells’ popup 3858 in FIG. 38B having clicked any ‘Allow user of the sheet to:’ which they thought might impact the operation of the validation list cell. FIG. 39A examples the user trying to double click into the validated list cell ‘C2’ 3932 and make a selection 3942 from the dropdown list 3952 now on the protected ‘Sheet1’ 3953. But instead, the user finds the cell is locked via the ‘Alert’ popup 3957 automatically displayed in FIG. 39B. That ‘Alert’ 3957 tells the user ‘The cell or chart you're trying to change is on a protected sheet. To make a change, unprotect the sheet. You might be requested to enter a password’ as we have seen before for locked cells. The ability to make changes to the value in the list is locked as is the ability to change the validation list.

While we could example more locking situations across different spreadsheets and cell formula, cell values, and cell capabilities, we will instead move on to exampling how our technologies expand the spreadsheet locking capabilities by partially locking some prebuilt functions and regular cell capabilities. However, before we example those new locking technology embodiments, we will example embodiments of our family of prebuilt validation functions and how they dramatically simplify validation set up, create the first spreadsheet functions that differentiate what is inputted in cell from what is inputted in the formula bar, and automatically provide validation usage enhancements.

### Differential Input Validation Function

Our new family of functions provide a technology that uniquely differentiates what a spreadsheet user inputs into the cell input from what they input into the formula bar. This simplifies usage for a family of spreadsheet prebuilt functions that provide cell validation like capabilities within a spreadsheet function. As we will example there are different embodiments of our technology as to when the inputs into the cell directly and into the cell indirectly via the formula bar differ. One set of embodiments immediately differentiate the inputs directly into the cell and indirectly into the cell via the formula bar while another set of embodiments differentiate the two inputs after the initial set up of the formula. We will start exampling the later set of embodiments and then example the former.

### Differential Input Validation Function—Post Initial Formula Set Up Differentiation

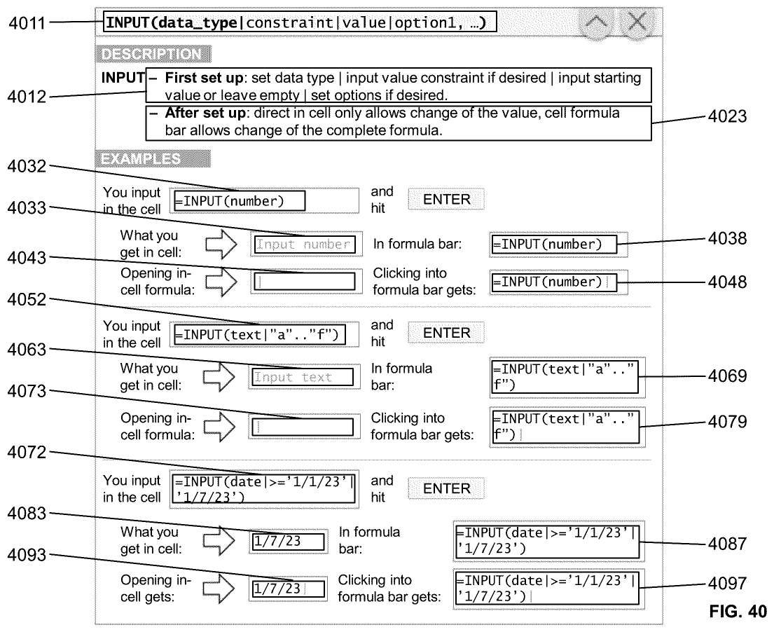

FIG. 40 examples differential input validation prebuilt spreadsheet functions employing the post initial formula set up differentiation of the cell and formula bar inputs in our technology. It lays out an embodiment with a function name of ‘INPUT’, although it could have any name although ideally one not already used by another spreadsheet function. It has a syntax exampled in 4011 in FIG. 40 employing four argument groups divided by three vertical bars ‘l’. Although it could have easily been fixed order arguments with as many optional arguments as needed, e.g., INPUT. And of course, a variant of the function could be without the optional argument group or optional arguments.

FIG. 40 examples the ‘First set up:’ 4012 instructions of use for creating the formula directly in the cell or indirectly in the cell via the formula bar in this embodiment. It instructs the user to ‘set data type’ in the first argument group, ‘input value constraint if desired’ in the second argument group, ‘input starting value or leave empty’ in the third argument group and ‘set options if desired’ in the fourth argument group. It then examples ‘After set up:’ 4023 of the initial formula how the cell direct input and cell indirect input via the formula bar will work differently. The ‘cell only allows change of value’ while the ‘formula bar allows change of the complete formula’ 4023. This post original formula set as well as the original formula set up is exampled in the three examples that follow in FIG. 40.

In the first example in FIG. 40 the user has typed or otherwise inputted the formula ‘=INPUT’ 4032 into a cell and hit ‘ENTER’ to get ‘Input number’ 4033 in the cell in light gray text as an instruction as to what to do for the cell input in this embodiment. In the formula bar they get the cell formula ‘=INPUT’ 4038. Note, the ‘INPUT’ function that the user created limits the inputs to number values. In other embodiments the cell post formula with no specified value could have populated with something else, been blank, or as exampled later be differentiated in some other way to indicate to the user it is an input function populated cell. If the user then reopens the cell in-cell for formula editing in this embodiment the user gets the cursor in an otherwise empty cell 4043 ready for an input while in the formula bar they can see the formula ‘=INPUT’ which they can then click into to change as shown in 4048. And the user is then able to edit the cell formula, in this example the ‘INPUT’ functional formula in the formula bar. Note, in this embodiment when the user opens the cell in-cell for editing instead of getting the cell formula ready for editing as you normally would get in a typical spreadsheet cell, instead the user gets the empty cell ready to accept an input 4043. In this example a numeric input in order to pass the ‘number’ validation test.

In the second example in FIG. 40 the user has typed or otherwise inputted the formula ‘=INPUT’ 4052 into a cell and hit ‘ENTER’ to get ‘Input text’ 4063 displayed in the cell in light gray text as an instruction as to what to do for the cell input. Note, the user has not only limited the input to text but to text within the range ‘“a” . . . “f”’. In the formula bar they get the cell formula ‘=INPUT’ 4069. In other embodiments the cell could have populated with something else, been blank, or as exampled later be differentiated in some other way to indicate to the user it is an input function populated cell. If the user then reopens the cell in-cell for editing in this embodiment the user gets the cursor in an otherwise empty cell 4073. While in the formula bar they can see the formula ‘=INPUT’ 4069 which they can then click into to change as shown in 4079. In this embodiment the in-cell and the formula bar visible content is different once the user opens the cell for editing and the changes the cell and the cell formula bar will accept are different as previously mentioned and exampled later.

In the third example in FIG. 40 the user has typed or otherwise inputted the formula ‘=INPUT’ 4072 into a cell and hit ‘ENTER’ to get in this embodiment ‘1/7/23’ 4083 as the existing value in the cell. Note, the user has not only limited the input to date inputs but to dates after or equal to 1/1/23. In the formula bar they get the cell formula ‘=INPUT’ 4087. If the user then reopens the cell in this embodiment the user gets the cursor positioned after the value ‘1/7/23’ 4093 or wherever they positioned the cursor when they double clicked into the cell. While in the formula bar they can see the formula ‘=INPUT’ which they can then click into to change as shown in 4097. And the user is then able to edit the cell formula, in this example the ‘INPUT’ functional formula in the formula bar. Note, in this embodiment when the user opens the cell in-cell for editing instead of getting the cell formula ready for editing as you normally would get in a typical spreadsheet cell, instead the user gets the ‘1/7/23’ value 4093 ready to be changed. In this example changed to a date equal to or after ‘1/1/23’ in order to pass the date data type and ‘>=’ 1/1/23” data value validation test.

All the examples in FIG. 40 showed that the user could first set up the prebuilt functional formula directly in the cell but after completing that formula for the first time then within the cell directly they could only input a value while in the formula bar they could access and edit the entire spreadsheet prebuild formula. This creates a spreadsheet cell function post initial set up with two different input modes, one for the value presented by the cell for use in other cell calculations and a second where the user can edit the formula including the value presented by the cell for use in other cell calculations. However, the function does more than just present the value as we will example next, it limits user inputs to a data type, it can further limit the value to a subset of values within that data type, it can present input messages to guide the user on what to input, and it can automatically present input error warnings or error rejections with automatic or manual adjusting messages when the formula changes.

### Differential Input Validation Function—Initial Formula Set Up

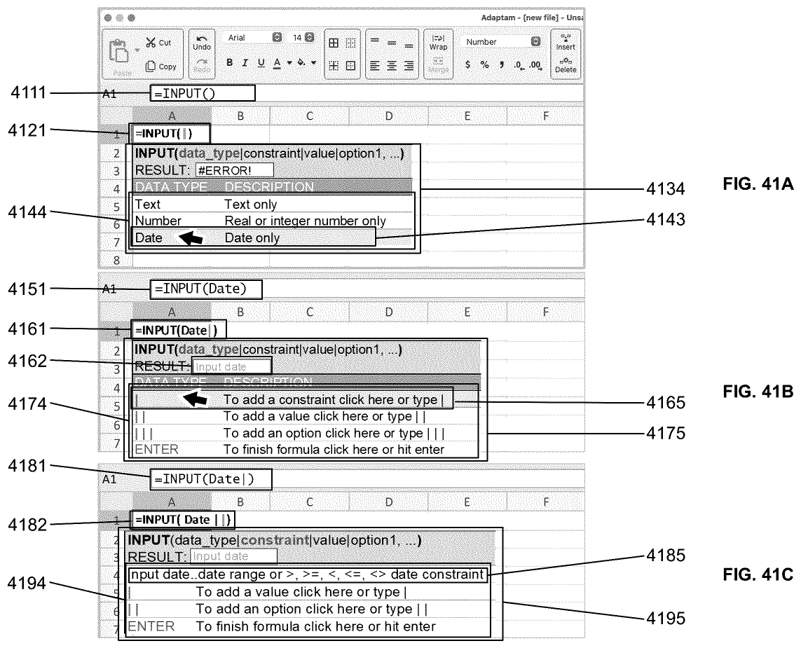

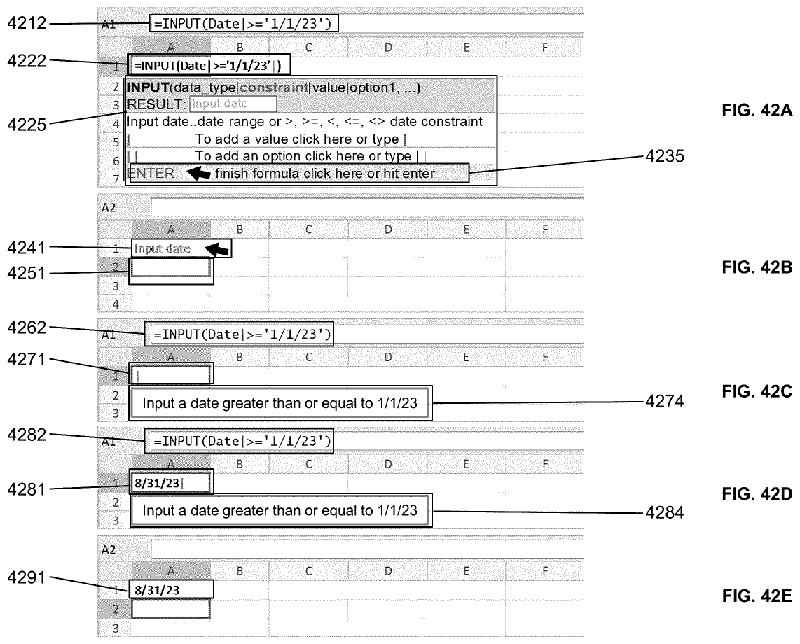

The differential input validation function can be set up in our technology with the very limited existing spreadsheet function selection lists or those combined with our selection lists within the function argument/argument group by argument/argument group selection lists as in our U.S. application Ser. No. 17/752,814 titled “Method and System for Spreadsheet Error Identification and Avoidance,” filed 24 May 2022. In FIG. 41A we will begin after the function selection employing our argument/argument group selection lists as they better example some of the embodiment functionality and then later we will example an embodiment without them. FIG. 41A examples three data type options 4144 selectable in the selection list 4134 for the first argument group ‘data type’ in our ‘INPUT’ prebuilt spreadsheet function in cell ‘A1’ 4121. There could have been more data types, e.g., Time, Boolean, Text length and separating ‘Number’ into Integer and Real, however we have kept it simple for ease of exampling purposes. The user has the cursor within the parentheses of the ‘INPUT’ function with the spreadsheet cell formula 4121 with the normal spreadsheet replicating of the formula in the formula bar 4111. The user selects ‘Date’ 4143 which automatically populates directly in the cell formula 4161 in FIG. 41B, replicating in the formula bar 4151. Because the formula has met the minimum argument criteria this embodiment of our technology shows the ‘RESULT:’ ‘Input date’ in light gray 4162 in the selection list 4175. That selection list also gives the user their remaining selection alternatives 4174 to finish the formula or add another argument group. In this example the user decides to add a constraint and therefore they click the first selection 4165 in the selection list 4175. This automatically adds the first bar to the cell formula 4182 and replicates into the formula bar 4181 in FIG. 41C. It also automatically gives the user their alternatives 4194 to input the date constraint, move on to another argument group or ‘ENTER’ the formula in the selection list 4195. However, the user sees the instructions for the constraint argument 4185 and types the constraint they desire ‘>=’1/1/23’ into the in-cell formula in ‘A1’ as shown in 4222 in FIG. 42A. As before that formula change replicates in the formula bar 4212. Note, in this example the selection list is not intelligent enough to realize that a completed constraint has been added and eliminate that option in 4225, other embodiments could accomplish that. The user then clicks ‘ENTER’ 4235 in the selection list 4225 to finish the formula as shown in FIG. 42B where the cell highlight has moved to the cell below ‘A2’ 4251. The formula now has been initially set up in cell ‘A1’ 4241 with ‘Input date’ in light gray populated to inform the user what to put in the cell. Note, as previously described that ‘Input date’ population could be different in different embodiments.

### Differential Input Validation Function—Constraint Selection List Alternative

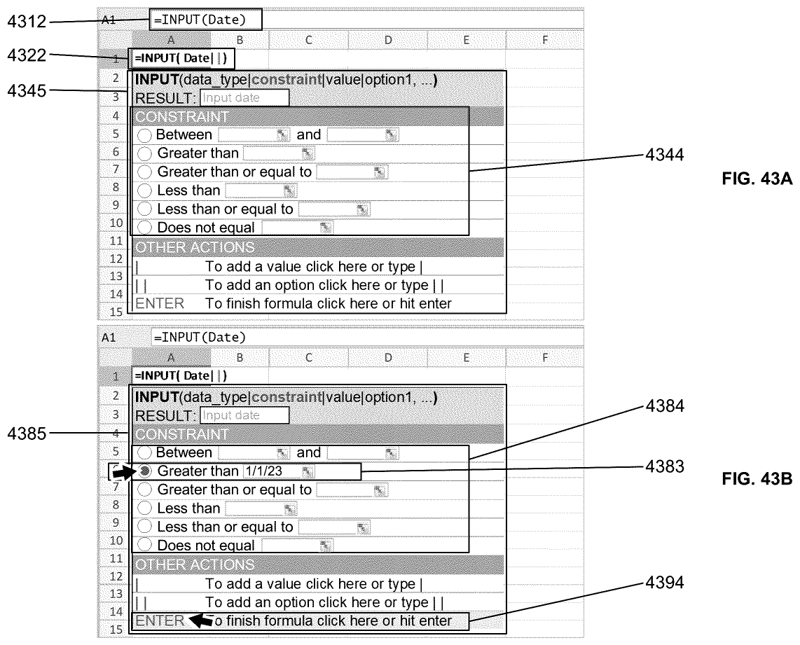

FIG. 43A and FIG. 43B example a different variant of our selection lists for populating the ‘CONSTRAINT’ in the differential input validation function. FIG. 43A examples an alternative for what was populated by the constraint selection 4165 in FIG. 41B thereby replacing FIG. 41C. Rather than the user having to type the constraint as they did in FIG. 41C, in FIG. 43A the user is presented a set of ‘CONSTRAINT’ options 4344 in the selection list 4345. Just like in FIG. 41C this is with the cursor in the cell ‘A1’ 4322 directly creating the initial differential input validation function formula while it replicates it in the formula bar 4312 without the cursor. The user then clicks the radio button 4383 in FIG. 43B for the constraint option they desire in the selection list 4385 and fill in the ‘1/1/23’ date before clicking ‘ENTER’ 4394 to finish the cell formula as shown in FIG. 42B where the cell highlight has moved to the cell below ‘A2’ 4251. The formula now has been initially set up in cell ‘A1’ 4241 with ‘Input date’ in light gray populated to inform the user what to put in the cell.

### Differential Input Validation Function—Different Initial Set Ups

Our technology supports many different ways of doing the initial differential Input validation function formula set up. We exampled two different selection list driven approaches however there could be many more selection list variants as well as no or minimal selection list variants where the user types all or most of the formula. In the examples in FIG. 41A through FIG. 42B and FIG. 43A and FIG. 43B the user initially set up a differential input validation function formula specifying a ‘data type’ and ‘constraint’, however they could have inputted any combination of a data type and the constraint, value, and options during the initial formula set up. For brevity's sake we will not example all these potential combinations, instead we will now move on to exampling the post initial formula set up differential input behavior of this embodiment.

### Differential Input Validation Function—Post Initial Formula Set Up

In this embodiment when the user double clicks back into cell ‘A1’ 4241 they get cursor in the cell 4271 and the formula visible in the formula bar 4262 as exampled in FIG. 42C. They also get in this embodiment an automatically generated input message 4274 that informs them of the required data type and the values constraint if one has been specified. So, in this example the automatically generated input message ‘Input a date greater than or equal to 1/1/23’ which tells the user the ‘data type’ is ‘Date’ and that the values ‘constraint’ is ‘>=’ 1/1/23’ as you can see in the formula bar formula 4262. Our differential input validation spreadsheet function automatically generated an input message specific to the ‘data type’ input and the values ‘constraint’ if specified, which it was in this example. In this embodiment the ‘Input date’ in cell ‘A1’ 4241 in FIG. 42B that the user double clicked into told the user that no value has been populated in the cell/formula so far. The user can then populate a date value into the cell ‘A1’ 4281 as they have done with the ‘8/31/23’ in FIG. 42D. Note, in this embodiment that entry in the cell is not replicated into the cell formula 4282 until the user enters the value, in other embodiments the value can automatically enter character by character into the value argument of the formula as the user types it. Then when they hit ENTER the value ‘8/31/23’ populates in the cell ‘A1’ 4291 as exampled in FIG. 42E because it passed both the data type and data values constraints.

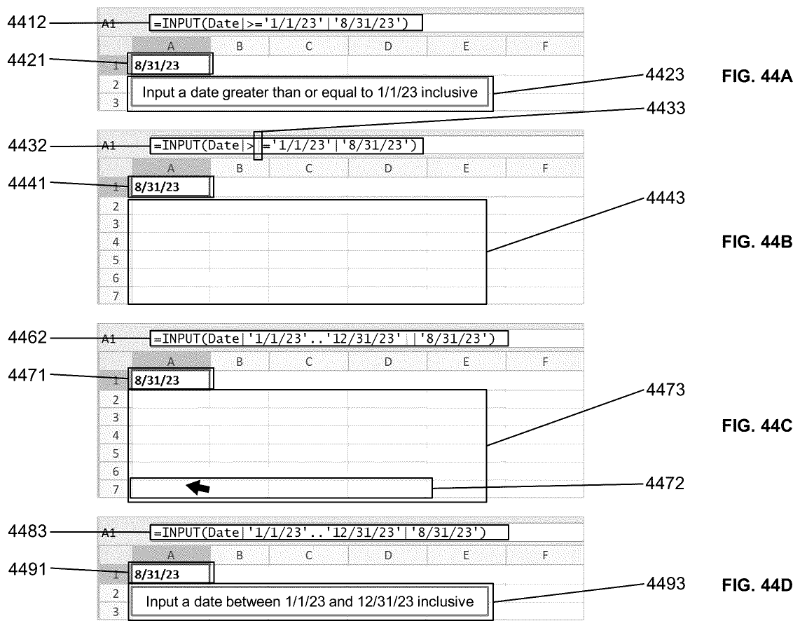

When the user re-highlights cell ‘A1’ 4421, as exampled in FIG. 44A, the user continues to see the value ‘8/31/23’ 4421 in the cell, sees the formula in the formula bar 4412, and sees the input message 4423 below the cell. In this embodiment they also see that the date ‘8/31/23’ inputted into the cell has been automatically populated in the formula 4412 with the correct syntax for this embodiment of the date in single quotes in the formula. At this point to edit the formula the user clicks into the formula bar formula 4432 in this example in FIG. 44B putting the cursor 4433 just in between the ‘>’ and the ‘=’ in the constraint argument/argument group. Note, the formula does not then replicate in the cell ‘A1’ 4441 as it would in a typical spreadsheet formula but instead stays showing the current value ‘8/31/23’. This populates the ‘REPLACE CONSTRAINT’ selection list 4443 in this embodiment. Note it could have populated the ‘CONSTRAINT’ part of the selection list like 4384 in FIG. 43B or some other variant. The user then changes the constraint argument/argument group to “1/1/23’ . . . ‘12/31/23” in the formula bar 4462 as exampled in FIG. 44C and then clicks ‘ENTER’ 4472 in the selection list 4473 to alter the ‘constraint’ argument. FIG. 44D examples the outcome of that when the user re-enters the cell ‘A1’ 4491. The user sees the value ‘8/31/23’ in the cell ‘A1’ 4491, the new formula with the altered constraint in the formula bar 4483 and the automatically altered input message 4493 reflecting the change in the constraint. Where the input message automatically changed from ‘Input a date greater than or equal to 1/1/23’ 4423 in FIG. 44A pre change to ‘Input a date between 1/1/23 and 12/31/23’ 4493 in FIG. 44D post change.

In this embodiment the user can also directly change the value, options and the data type in the formula bar but can only change the value directly in-cell post the initial formula set up. While we could example doing any or all of the data type, constraint, value, and option combination of changes we will instead example an option to round out exampling the use of each of the arguments/argument groups within our differential input validation function.

### Differential Input Validation Function—Options

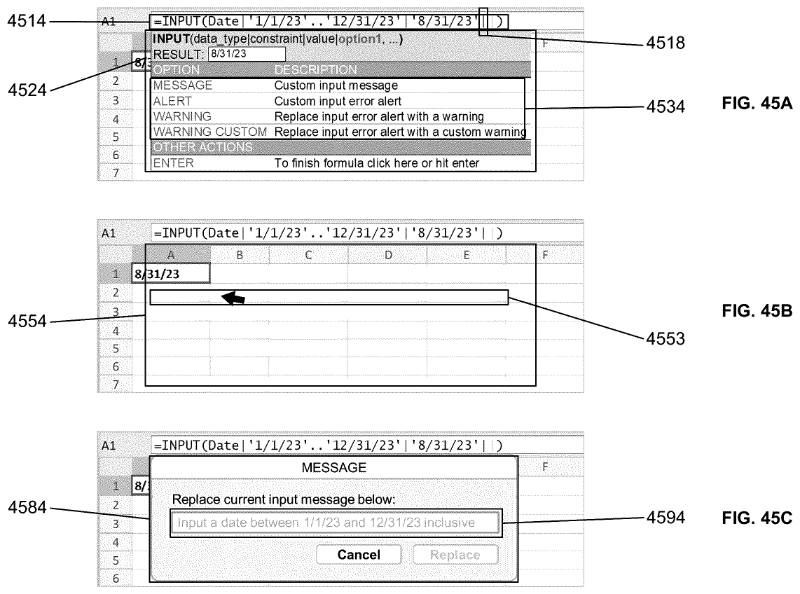

FIG. 45A examples the user reopening the formula 4483 that was populated in cell ‘A1’ 4491 in FIG. 44D. The user has reopened the formula adding the argument group bar 4518 in FIG. 45A to begin the option argument group which in this embodiment automatically opens the selection list 4524 displaying four ‘OPTION’ selections 4534. These options allow the user to customize the differential input validation function messages and alerts, replacing the automatically generated input message with a user created one, replacing the automatically generated error alert message with a user created one, retaining the automatically generated error alert message but altering its function to be a warning versus an input rejection, and replacing the automatically generated error alert rejection and message with a warning and a user inputted message. While our technology supports further options, such as user differentiation of the input cell, different input message UIs, and beyond, the four example the workings of our new types of prebuilt spreadsheet differential input validation functions.

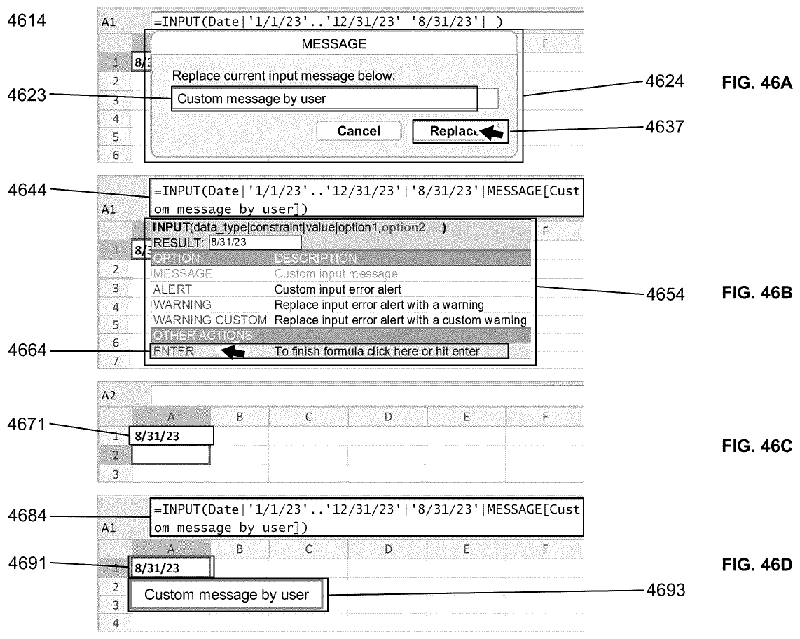

FIG. 45B examples the user selecting the ‘MESSAGE’ option 4553 from the selection list 4554. In this embodiment it automatically opens the ‘MESSAGE’ popup 4584 in FIG. 45C which displays in light gray type the current input message 4594, which in this situation is the automatically generated input message ‘Input a date between 1/1/23 and 12/31/23 inclusive’. Thus, showing the user what they are replacing and giving them a place to type, or copy paste their replacement message as the user has done with the new message ‘Custom message by user’ 4623 in the ‘MESSAGE’ popup 4624 in FIG. 46A. Note, further embodiments support the user referencing a cell holding the desired text. The user then clicks the ‘Replace’ button 4637 to record the option1 argument ‘MESSAGE[Custom message by user] exampled in the formula bar formula 4644 in FIG. 46B. In this example the user then clicks ‘ENTER’ 4664 in the selection list 4654 to instantiate the revised formula in the cell ‘A1’ 4671 in FIG. 46C. When the user moves back into cell ‘A1’ 4691 in FIG. 46D the user not only sees the altered formula 4684 in the formula bar but also automatically sees the custom input message ‘Custom message by user’ 4693 adjacent to the cell.

For brevity's sake we will not example setting up the other options as they use similar approaches and similar UIs in this embodiment. In other embodiments the UIs can be done differently or versions with no UI where the user types the ‘MESSAGE’ argument in the formula. Note, the preceding examples where the user made selections to supply the arguments also support the user manually typing in the arguments. We will next example the situations that lead to the error alerts and the reader will understand how the error rejection alert can be altered to instead a warning.

### Differential Input Validation Function—Input Error Alert

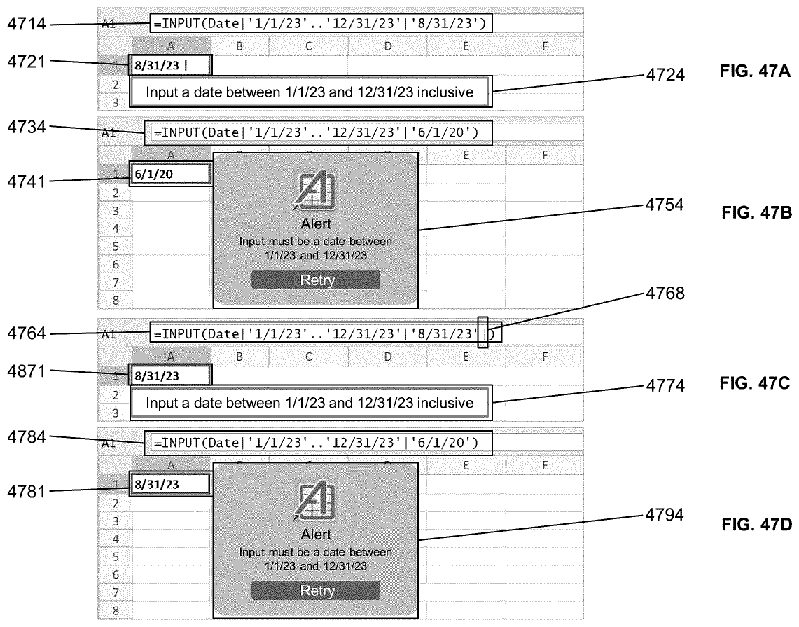

FIG. 47A examples the user reopening the equivalent of cell ‘A1’ 4491 in FIG. 44D populated with the formula 4483 in cell ‘A1’ 4721 populated with the formula 4714. The cell has the automatically generated input message 4724 adjacent to the cell. However, despite this message the user inputs a replacement date ‘6/1/20’ 4741 in cell ‘A1’ for the date ‘8/31/23’ 4721 in FIG. 47A. But because that date violates the value constraint date range of ‘1/1/23’ . . . ‘12/31/23’ the automatic rejection alert 4754 displays giving an automatically situationally specific input rejection message ‘Input must be a date between 1/1/23 and 12/31/23’. At which point the user must ‘Retry’ until they input a date within the values constraint or remove the date and revert to having no date in the cell. Note, in this embodiment the changed in-cell input of ‘6/1/20’ 4741 replicates immediately into the formula 4734, however in other embodiments the change in the formula could occur after the input is validated. Our technology has exampled its automatic situationally tailored Alert message, tailoring the message to the constraints specified in the formula. In this example ‘date’ and ‘between 1/1/23 and 12/31/23’. And where those alert messages automatically change with any changes to the data type and value constraint changes in the formula.

FIG. 47C examples the user again reopening the equivalent of cell ‘A1’ 4491 in FIG. 44D populated with the formula 4483 in cell ‘A1’ 4771 populated with the formula 4764. The cell has the automatically generated input message 4774 adjacent to the cell. However, this time the user reopened the formula in the formula bar 4764 with the light gray cursor 4768 inside the closing parenthesis. Despite the input message 4774 the user inputs a date ‘6/1/20’ in formula bar 4784 in FIG. 47D to replace the date ‘8/31/23’ in the formula bar 4764 in FIG. 47C. But because that date violates the value constraint date range of ‘1/1/23 . . . 12/31/23’, the automatic rejection alert 4794 in FIG. 47D displays giving an automatically situationally specific message ‘Input must be a date between 1/1/23 and 12/31/23’. At which point the user must ‘Retry’ until they input a date within the values constraint or remove the date to have no date in the cell. Note, in this example embodiment the date change in the formula does not change the in-cell date value until it passes the validation constraints, although as previously mentioned the changes could propagate immediately. Our technology has exampled its automatic situationally tailored Alert message, tailoring the message to the constraints specified in the formula works whether the changes are within the in-cell input or the formula bar input. In this example automatically situationally tailoring ‘date’ and ‘between 1/1/23 and 12/31/23’. And where those alert messages automatically change with any changes to the data type and value constraint changes in the formula.

### Differential Input Validation Function—Input Error Warning

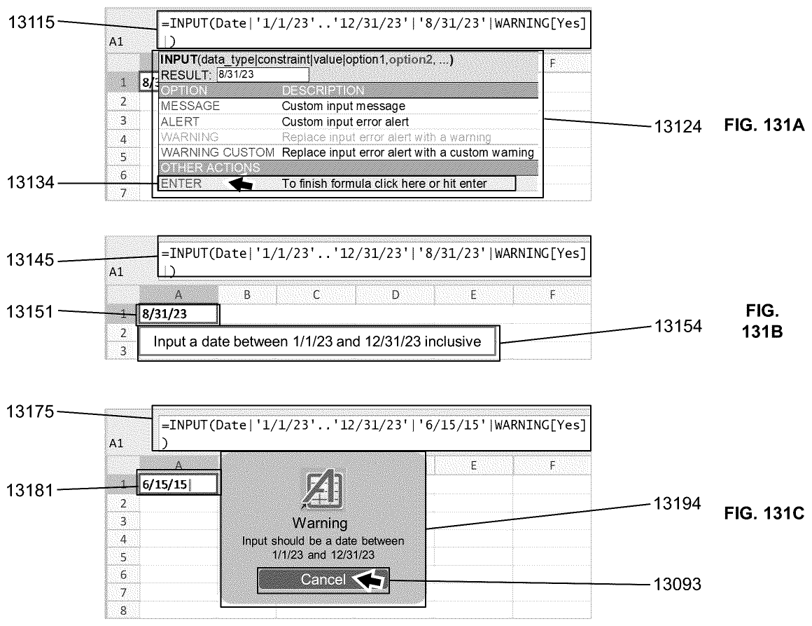

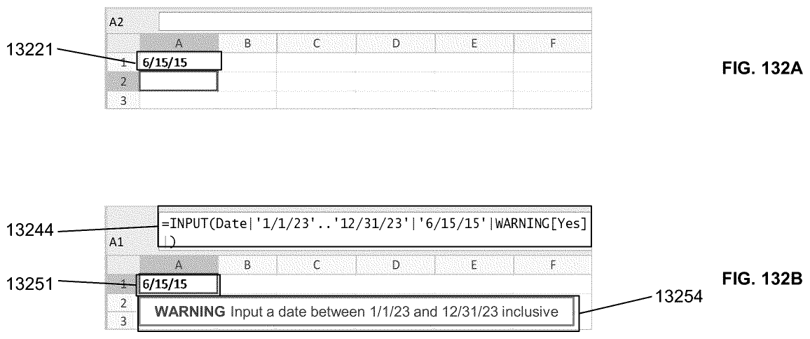

FIG. 131A through FIG. 132B examples the setup and usage of a single value differential input validation function with a validation constraint or constraints warning rather than a rejection. In this embodiment the user has populated a ‘WARNING[Yes]’ argument in ‘INPUT’ function as shown in the formula bar formula 13115 in FIG. 131A. Thus, getting the populated cell ‘validation constraint when the use clicks ‘ENTER’ 13134 in the selection list 13124 in FIG. 131A. When the user reopens the cell ‘A1’ 13151 in FIG. 131B our technology automatically displays the input message 13154 that messages the validation constraints. When the user enters a value ‘6/15/15’ 13181 in FIG. 131C instead of getting a rejection alert the user gets a ‘Warning’ message 13194 that automatically messages to the user the validation constraint or constraints. Note, in this embodiment the value ‘6/15/15’ is immediately altered in formula bar formula 13175 but could in another embodiment only be replicated after the user clicks ‘Cancel’. When the user then clicks the ‘Cancel’ 13093 they populate the value ‘6/15/15’ 13181 into cell ‘A1’ as exampled in FIG. 132A despite having failed the validation values constraint. This failure is more visible upon re-entering cell ‘A1’ 13251 in FIG. 132B automatically re-opening the input message 13254 which in this embodiment changes the input message to say ‘WARNING Input a date between 1/1/23 and 12/31/23 inclusive’ in red to inform the user that they are currently violating the validation. Other embodiments support different ways of informing the user of the validation failure.

In this embodiment the warning message was an option but in other embodiments could be the functional default. This has been exampled for the single value differential input validation function but is applicable to all the family of differential input validation functions described herein when unlocked or locked. And variants of the warning could be used in our validation capabilities discussed herein.

### Differential Input Validation Function—Data Type Constraint Only Formula

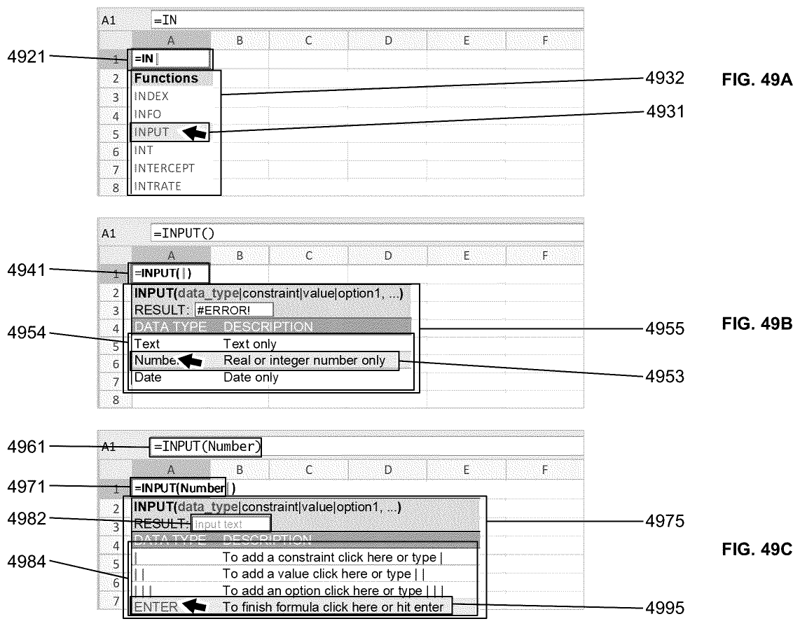

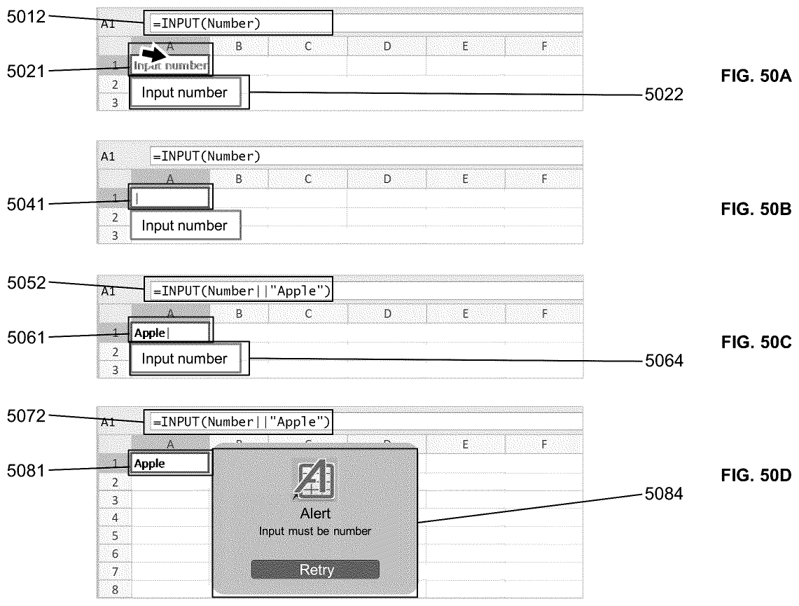

FIG. 49A through FIG. 50D examples a simpler data type only input into a differential input validation function and an ‘Alert’ rejection situation starting with no previously inputted value. FIG. 49A examples a user having typed ‘=IN’ 4921 into the cell ‘A1’ and getting a version of the traditional spreadsheet function selection list 4932. They see the differential input validation function they desire ‘INPUT’ and click it 4931. That populates the function into cell ‘A1’ 4941 and automatically opens the selection list 4955 for the first argument ‘DATA TYPE’/data_type as exampled in FIG. 49B. As mentioned before, the data type list here 4954 is kept simple for brevity's sake and could contain many more data types as discussed and exampled herein. The user selects ‘DATA TYPE’ ‘Number’ 4953 which is then populated into the formula as exampled in cell ‘A1’ 4971 in FIG. 49C and automatically opens the selection list 4975 displaying the selection alternatives 4984 for continuing or finishing the ‘INPUT’ functional formula 4961. The user decides to finish the formula and clicks ‘ENTER’ 4995 to deliver the completed formula the user has re-entered in FIG. 50A.

FIG. 50A examples a user double clicking into a cell ‘A1’ 5021 previously populated with an ‘INPUT’ formula with only a ‘Number’ data type constraint visible in the formula bar 5012 which also displays an automatically generated input message ‘Input number’ 5022 adjacent to the cell. The result is the light gray cursor is positioned in the cell ‘A1’ 5041 in FIG. 50B ready to input a value. The user inputs the value ‘Apple’ 5061 in FIG. 50C which in this embodiment automatically replicates into the formula bar formula 5052 with the text formula syntax of double quotes however when the user hits ENTER instead of accepting the input, this embodiment automatically rejects it with the automatically tailored popup alert 5084. In this example automatically situationally tailoring the message with the data type constraint ‘number’ and rejecting the input until it contains a number or no value. And as stated before automatically changing the rejection ‘Alert’ with any user change to the data type or data value constraint.

### Differential Input Validation Function—Cell Marking

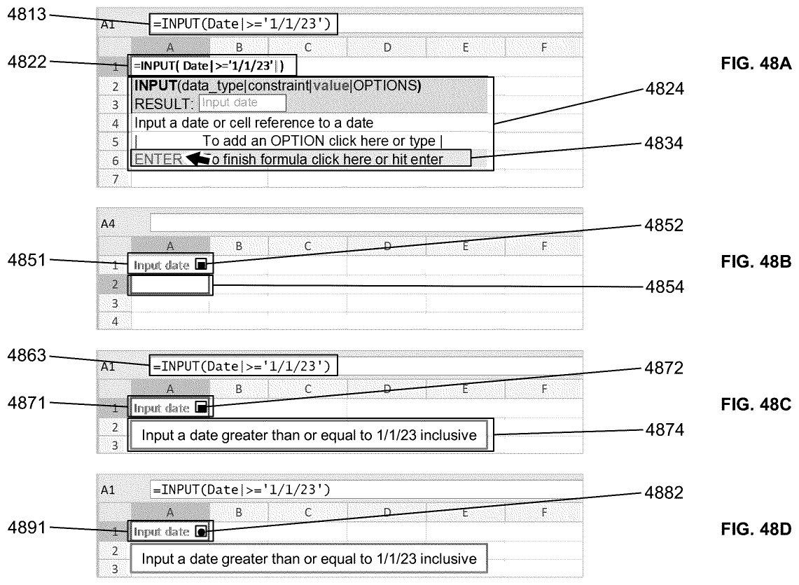

FIG. 48A through FIG. 48D examples in-cell differential marking of the cells populated by the INPUT function and is applicable to any of the other INPUT family of differential input validation functions described herein, realizing for simplicity we have used INPUT for all of them but of course as previously stated the function name could be different. FIG. 48A examples a user completing for the first time an ‘INPUT’ formula 4822/4813 with both a data type constraint and a data values constraint however it could have been any acceptable constraints for any of the family of ‘INPUT’ functions. In this example they do so by clicking the ‘ENTER’ option 4834 in the selection list 4824, however they could have just as easily hit the enter key on their PC. When they do so in this embodiment the populated cell ‘A1’ 4851 in FIG. 48B displays a black box marker 4852, while cell focus moves to the cell ‘A2’ 4854 as it does when you enter a formula in other spreadsheets. Moving the focus back into the cell ‘A1’ 4871 still displays the black box cell marker 4872, while displaying the cell formula in formula bar 4863 and displaying the input message 4874 adjacent to the cell. FIG. 48D examples another embodiment with the only difference being a different marker, in this example a round black dot 4882 in the cell ‘A1’ 4891. Other forms of differentiation of an ‘INPUT’ or ‘INPUT’ family of functions populated cell from cells populated by regular values or formulas works in our technology.

### Differential Input Validation Function—No Function Argument Selection Lists

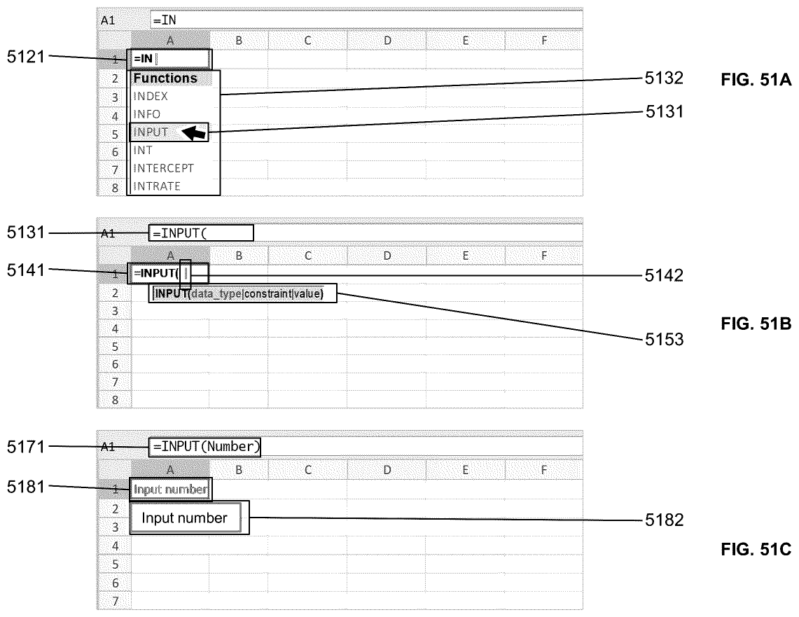

FIG. 51A through FIG. 51C examples the set-up of one of our ‘INPUT’ family of functions with the typical existing spreadsheet FUNCTION selection only selection lists and the typical function syntax guide. FIG. 51A examples the user selecting the ‘INPUT’ function 5131 from a variant of the typical spreadsheet function selection list 5132 after typing ‘=IN’ into the in-cell formula 5121. It then populates the ‘INPUT’ function with a starting parenthesis and the cursor 5142 ready for typing as exampled in cell ‘A1’ 5141 in FIG. 51B. Note, in this embodiment selecting a function does not populate both the opening and closing parentheses as is frequently done in our other embodiments. The function syntax guide 5153 also automatically displays as it does in a typical spreadsheet. In this embodiment we simplified the ‘INPUT’ function syntax to only include the ‘data type’, ‘constraint’ and ‘value’ argument groups but could have included the ‘options’ and could change the argument groups to arguments and change the order of the arguments in other embodiments. The user then types the ‘data_type’ ‘Number’ followed by the closing parenthesis into the formula and hits ENTER to finish the formula. FIG. 51C then examples the user moving the focus back into the cell ‘A1’ 5181 containing the ‘INPUT’ formula 5171, the grayed ‘Input number’ cell message 5181, and the adjacent input message 5182 just as it did in our previous selection list generated examples.

### Differential Input Validation Function—Start Differential Invisible Argument

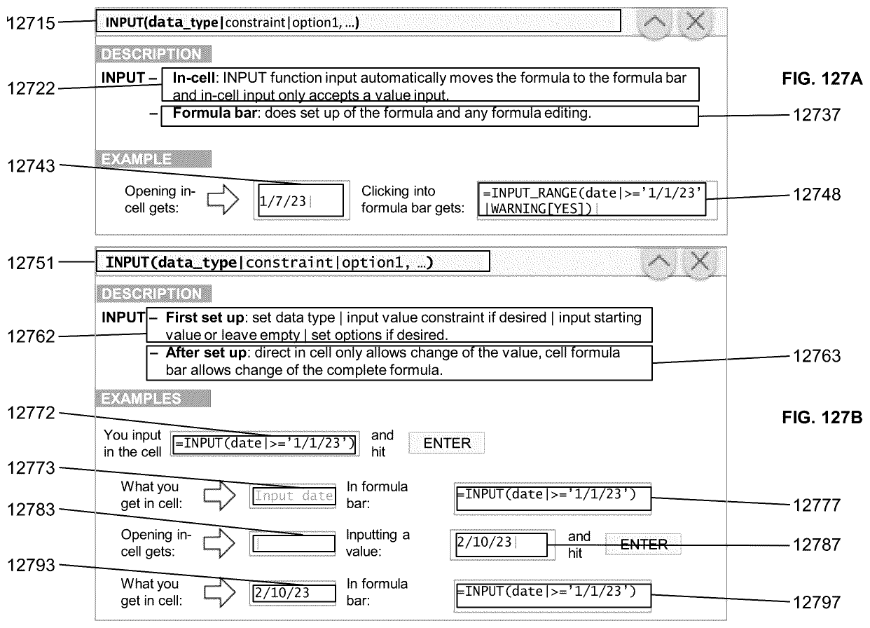

FIG. 127B examples an embodiment employing the post initial formula set up differentiation of the cell and formula bar inputs of our differential input validation functions where the value is inputted in-cell only and not an argument in the formula. There is no value argument in the formula as exampled in 12751 where the three argument groups are the ‘data type’, ‘constraint’ if desired, and the options if desired. After the initial formula successful input, the in-cell direct input is reserved for the value as described in 12763. In this embodiment when you set up the formula, as exampled in 12772, there is no argument for the value to be validated. Instead the cell populates blank or in this embodiment with a data type specific message ‘Input date’ 12773 and the formula bar holding the formula 12777. When the user populates a value to be validated in the cell, as exampled by opening the cell 12783 and then inputting a value ‘2/10/23’ 12787 and then hitting ‘ENTER the user gets the validated value populated in the cell 12793 and the formula populated in the formula bar 12797. Our technology supports different variants of what goes where and what is visible where.

### Differential Input Validation Function—Start Differential

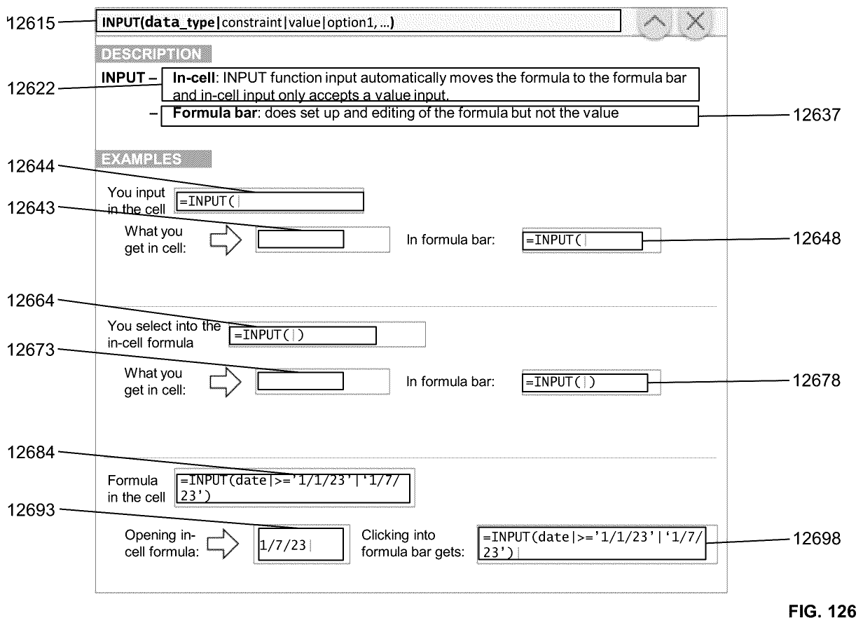

FIG. 126 examples prebuilt spreadsheet functions employing the always differentiation of the cell and formula bar inputs in our technology for a single spreadsheet cell containing one validated input. It lays out an embodiment with a function name of ‘INPUT’, although it could have any name although ideally one not already used by another spreadsheet function. Also note it could have a different name than our previous version of the differential input validation function where the differentiation starts after the initial formula is successfully entered into the cell. It has a syntax exampled in 12615 in FIG. 126 employing four argument groups divided by three vertical bars ‘1’. Although it could have easily been three fixed order arguments with a fourth and beyond optional arguments, e.g., INPUT. And of course, a variant of the function could be without the optional arguments or an optional argument group.

FIG. 126 examples the ‘In-cell:’ 12622 set up instructions of how the ‘INPUT function automatically moves the formula to the formula bar and the in-cell input only accepts a value input’. Where in this embodiment that movement to the formula bar automatically happens after enough of the ‘INPUT’ function is entered that it is recognized, in this example ‘=INPUT’ 12664 into the cell and in this embodiment our technology automatically moves the formula to the formula bar as exampled in 12678 leaving the cell empty as exampled in 12673. The user can then continue to input the formula in the formula bar 12678. In this embodiment, the in-cell and the formula bar capabilities are different once an INPUT family of functions is populated as well as after the formula has been completely entered into the cell as exampled next.

In the third example in FIG. 126 the user has already entered the formula ‘=INPUT’ 12684 into a cell and is about to reopen the different inputs. When the user then reopens the cell in this embodiment the user gets the cursor positioned after the value ‘1/7/23’ 12693 or wherever they positioned the cursor when they double clicked into the cell. Note, in our technology dates are recognized as dates in cells but require single quotes around the dates when specified in formulas. When the user clicks into the formula bar, they can position the cursor wherever they want and, in this example, have positioned it at the end of the functional formula ‘=INPUT’ 12698 as indicated by the light gray bar. Exampling the difference in the editing capabilities of the two different inputs for this embodiment of the differential input validation function.

### Differential Input Validation Function—Invisible Argument

FIG. 127A examples an embodiment of the start differential input validation function where the value is inputted in-cell only and not an argument in the formula. There is no value argument in the formula as exampled in 12715 where the three argument groups are the ‘data type’, ‘constraint’ if desired, and the options if desired. As exampled in more depth next herein the in-cell formula automatically moves the formula to the formula bar once the function is populated within a cell formula with an equal's sign and at least an opening parenthesis per 12722. The in-cell direct input is reserved for the value as exampled in 12743 while the formula shown in formula bar does not visibly contain the value as exampled in 12748. While there are different variants of what goes where our technology supports what could be thought of as invisible arguments in our differential input validation function formula that are then otherwise visible to the user as in this example in the cell itself.

### Differential Input Validation Function—Start Differential Detailed Example

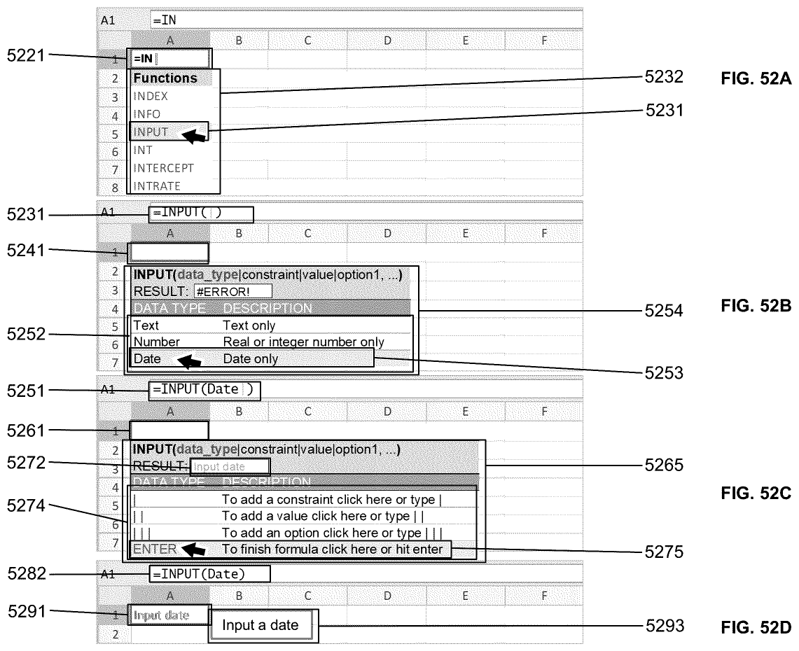

FIG. 52A through FIG. 52D examples our differential input validation function technology where the inputs start differential from the beginning. In this embodiment, when the user first types or selects the ‘INPUT’ function into the formula our technology automatically moves further inputs into the formula bar if they are not already there. FIG. 52A examples a user who has started typing ‘=IN’ within the in-cell formula in cell ‘A1’ 5221. They then select 5231 the ‘INPUT’ function from the function selection list 5232. At that point our technology populates ‘INPUT’ into the formula in FIG. 52B and moves the formula input from in-cell 5241 to the formula bar 5231 leaving the cell content empty 5241. That is because in this embodiment once an ‘INPUT’ family of functions is correctly inputted the formula input is only in the formula bar with the in-cell input only accepting a value input. In this embodiment it also automatically opens a selection list 5254 for the first argument of the ‘INPUT’ function which is the one required argument or argument group. This example has been kept simple with only three ‘DATA TYPE’ alternatives 5252 although as previously discussed and later exampled there could have been more data type options. The user selects the ‘DATA TYPE’ ‘Date’ 5253 which immediately populates in the formula bar formula 5251 in FIG. 52C and opens the next selection list 5265. That selection list gives the user their remaining alternatives 5274 for continuing or finishing the formula. It does not populate anything into cell ‘A1’ 5261 because the formula has not yet been completed. In our embodiment however the selection list also displays the function syntax and the ‘RESULT’ if the user were to enter the formula now, which shows then cell result of ‘Input date’ in light gray 5272. As it happens the user does select ‘ENTER’ 5275 and after entering the formula and re-highlighting the cell ‘A1’ 5291 in FIG. 52D sees the ‘Input date’ within the cell 5291, the formula ‘=INPUT’ in the formula bar 5282 and the automatically generated tailored input message ‘Input a date’ 5293 adjacent to the cell.

Rather than exampling other data type constraints, adding of value constraints, or adding of options which work similarly to the previous examples, we will example how the Alerts work for the different inputs.

### Differential Input Validation Function—Start Differential Alerts

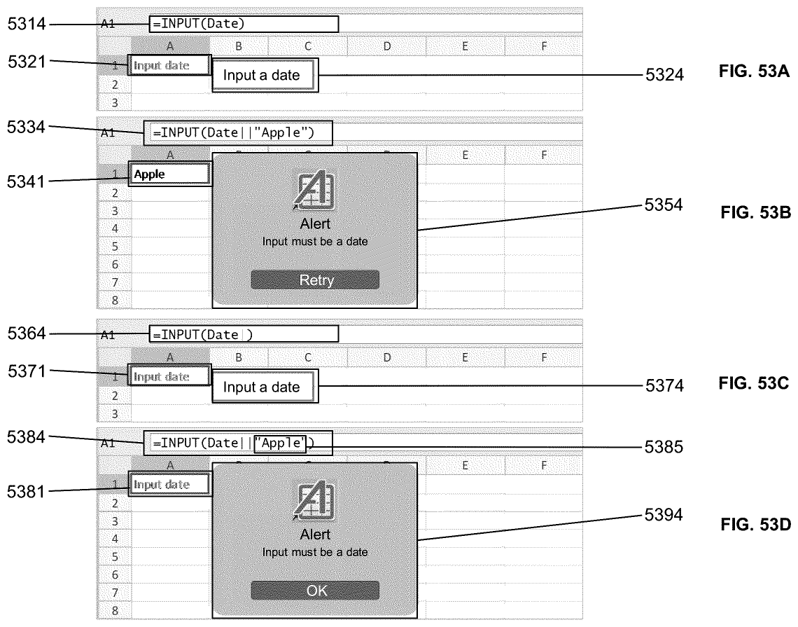

The starting differential with the in-cell and formula bar inputs does not alter the way our technology alerts respond to inputs violating the validation constraints as exampled in FIG. 53A through FIG. 53D.

FIG. 53A examples the user reopening the equivalent of cell ‘A1’ 5291 in FIG. 52D populated with the formula 5282 in cell ‘A1’ 5321 with the formula 5314. The cell has the automatically generated input message 5324 adjacent to the cell. However, despite this message the user inputs a replacement value of ‘Apple’ 5341 in cell ‘A1’ in FIG. 53B. When they hit ENTER because a text field violates the date data type constraint, the automatic rejection ‘Alert’ 5354 displays an automatically situationally specific message ‘Input must be a date’ as exampled in FIG. 53B. At which point the user must ‘Retry’ until they input a date or revert to having no value in the cell. Note, in this embodiment the changed in-cell input of ‘Apple’ 5341 replicates immediately into the formula 5334, however in other embodiments the change in the formula could occur after the input is validated. Our technology has exampled its automatic situationally tailored Alert message, tailoring the message to the constraints specified in the formula. In this example the formula argument ‘Date’. And where those alert messages automatically change with any changes to the data type and data value constraint changes in the formula.

FIG. 53C examples the user again reopening the equivalent of cell ‘A1’ 5291 in FIG. 52D populated with the formula 5282 in cell ‘A1’ 5371 with the formula 5364. The cell has the automatically generated input message 5374 adjacent to the cell. However, this time the user reopened the formula in the formula bar 5364 with the light gray cursor inside the closing parenthesis. Despite the input message 5374 the user inputs “Apple” in the formula bar formula 5384 in FIG. 53D. But because a text field violates the date data type constraint, the automatic rejection ‘Alert’ 5394 displays an automatically situationally specific message ‘Input must be a date’ as exampled in FIG. 53D. At which point the user must ‘Retry’ until they input a date or revert to having no value in the cell. Note, in this embodiment the changed formula bar formula input of ‘Apple’ 5385 does not immediately replicate into the cell value 5381 but waits to be successfully validated, which in this situation does not happen.

Differential Input Validation Function—Start Differential without Selection Lists

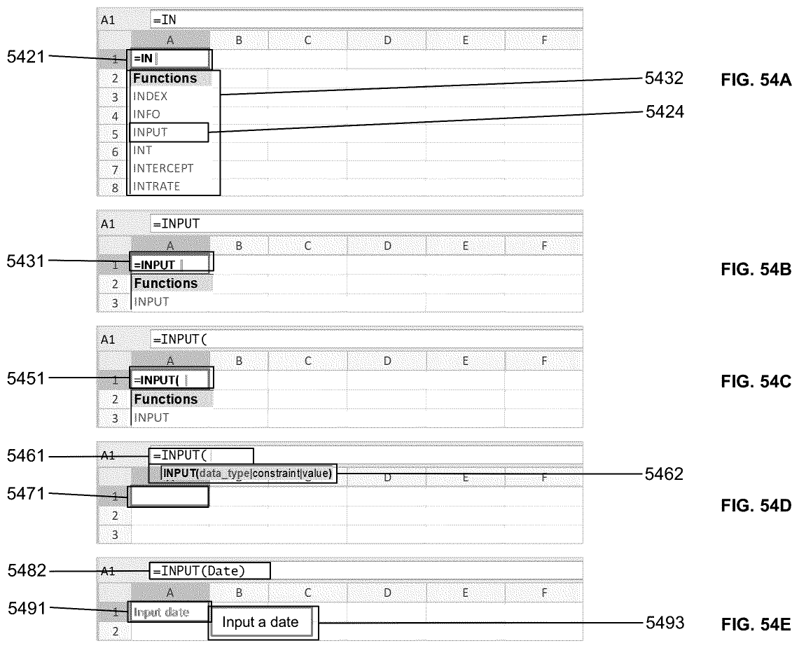

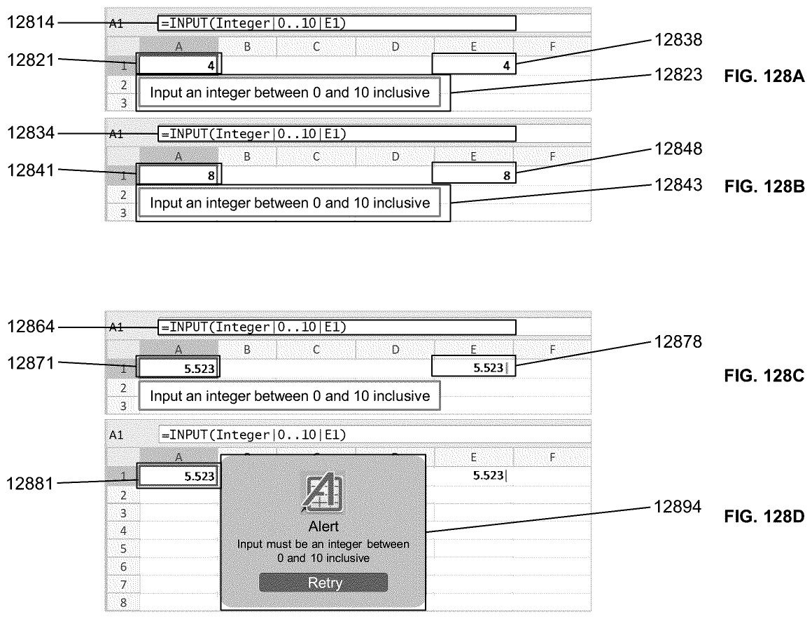

FIG. 54A through FIG. 54E examples the set-up of one of our always differential input validation family of functions with the typical existing spreadsheet FUNCTION selection only selection lists and the typical function syntax guide. FIG. 54A examples the user typing ‘=IN’ into the in-cell formula 5421 triggering the function selection list 5432 containing the function ‘INPUT’ 5424 in FIG. 51A. However, the user continues typing ‘=INPUT’ 5431 within the cell formula in FIG. 51B. When the user fulfils the requirement for recognizing the ‘INPUT’ function, which in this situation is minimally having the ‘=’ sign followed by ‘INPUT’ followed by an opening parenthesis ‘. FIG. 128A examples a differential input validation function which has been set-up with the formula ‘=INPUT’ 12814 where the value being validated is supplied by the cell ‘E1 12838. Because the user only single clicked into cell ‘A1’ 12821 they see the value ‘4’ rather than the input ‘E1’ supplying it which they would see if they double clicked to open the in-cell input. When the user changes the value in cell ‘E1’ 12848 as exampled in FIG. 128B the validation in cell ‘A1’ 12841 is automatically updated and because the value ‘8’ supplied by cell ‘E1’ 12848 is both an integer and between the value constraint ‘0 . . . 10’ shown in the formula bar formula 12834 the new value is successfully updated. However, had the user instead changed the value in cell ‘E1’ to ‘5.523’ 12878, as exampled in FIG. 128C, the validation in cell ‘A1’ 12871 is automatically updated and because it fails the data type argument of ‘Integer’ in the differential input validation function formula 12864 for the cell ‘A1’ 12871 it automatically triggers, in this embodiment, the rejection ‘Alert’ 12894 as exampled in in FIG. 128D for cell ‘A1’ 12881. Just as it would have done had the user typed ‘5.523’ into cell ‘A1’. Note, this cell reference works for the other of our INPUT family of differential input validation functions described later.

### Differential Input Validation Functions—Booleans

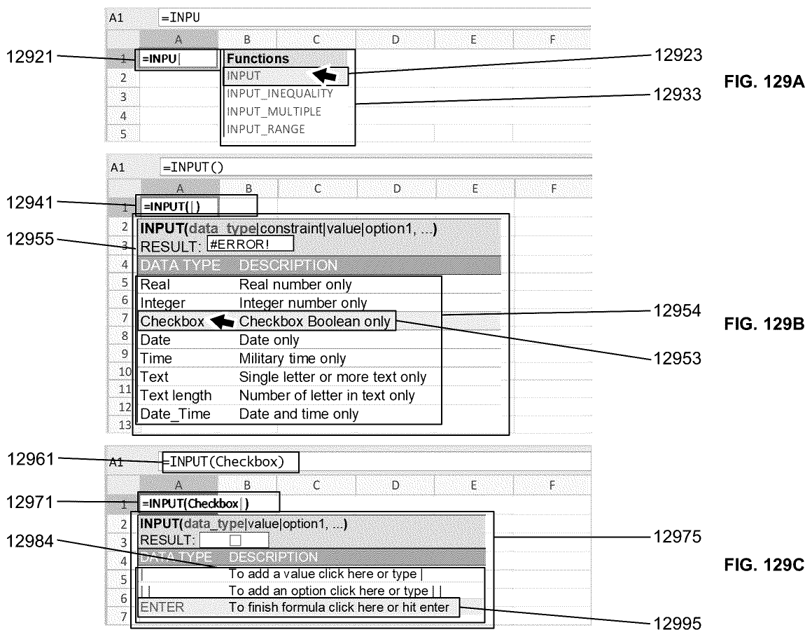

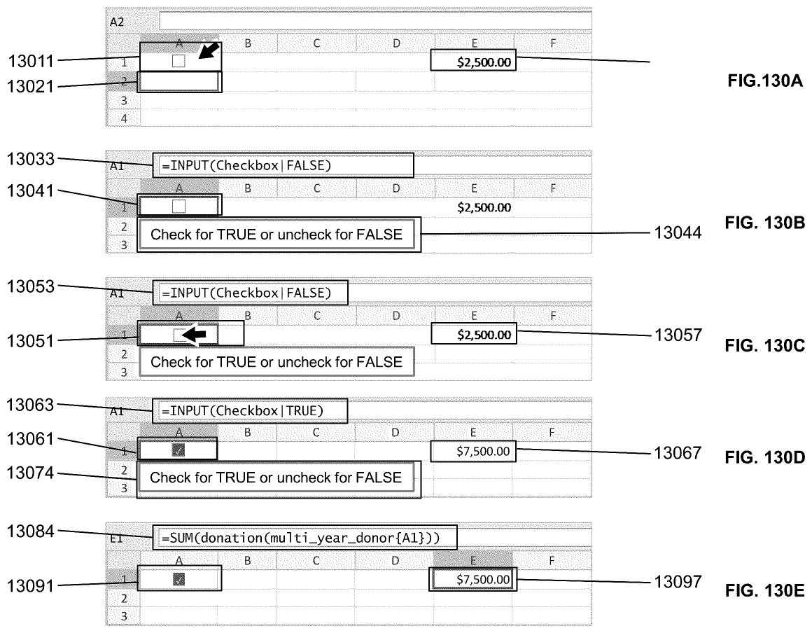

FIG. 129A through FIG. 130E examples a Boolean variant of our differential input validation functions where the Boolean input is provided by a checkbox. FIG. 129A examples a user typing ‘INPU’ in cell ‘A1’ 12921 then selecting the function ‘INPUT’ 12923 from the function selection popup 12933. In our technology this populates the function with both parentheses into cell ‘A1’ 12941 as exampled in FIG. 129B. It also opens a selection popup 12955 with a list of different ‘data_type’ argument options 12954 including the ‘Checkbox’ option that the user selects 12953. This populates ‘Checkbox’ in the formula 12961 in cell ‘A1’ 12971 as exampled in FIG. 129C and opens a selection list 12975 with selections 12984 allowing the user to add additional arguments to the INPUT functional formula or finish the formula. Note, this checkbox embodiment has no value constraint as the checkbox only has two values neither of which will be constrained. The user selects to finish the formula in this instance clicking ‘ENTER’ 12995 to populate the cell ‘A1’ 13011 with a checkbox as exampled in FIG. 130A. In this embodiment the default Boolean setting is unchecked meaning FALSE. This results in the population of cell ‘E1’ 13017 with value of ‘$2,500.00’ calculated referencing the value in ‘A1’ 13011. When the user moves back into the cell ‘A1’ 13041 as exampled in FIG. 130B the cell formula becomes visible in the formula bar 13033. Note this embodiment of the checkbox variant of the ‘INPUT’ function has a simpler argument structure of a “data type” and “value” argument, as the values are constrained by the checkbox to either TRUE or FALSE and there are no options. In this embodiment an automatically generated input message 13044 is generated by our technology informing the user of ‘Check for TRUE or uncheck for FALSE’.

FIG. 130C examples the user then clicking the checkbox in cell ‘A1’ 13051 to get the result in cell ‘A1’ 13061 in FIG. 130D. Where the formula in the formula bar 13063 has changed to display ‘TRUE’. This also resulted in the change in the value ‘$7,500.00’ in cell ‘E1’ 13067 from the formula referencing the value in cell ‘A1’ 13061. That formula is exampled in the formula bar 13084 for cell ‘E1’ 13097 in FIG. 130E. Where the formula 13084 references cell ‘A1’ 13091 containing the checkbox.

While we could example many more mix and match feature combinations of the “Post initial setup differential input validation functions” or the “Start differential input validation functions”, we will instead move on to variants of the differential input validation family which accommodate validation of multiple values stored within a single spreadsheet cell.

Differential Input Validation Function—Range Initial then Differential

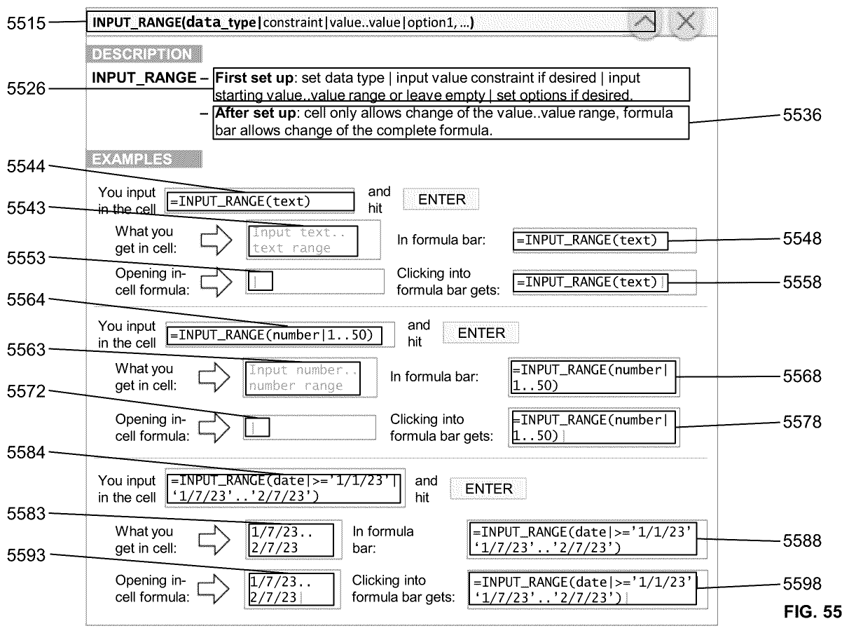

FIG. 55 examples a prebuilt spreadsheet function employing the post initial formula set up differentiation of the cell and formula bar inputs in our technology for a single spreadsheet cell containing multiple validated values in a range. It lays out an embodiment with a function name of ‘INPUT_RANGE’, although it could have any name although ideally one not already used by another spreadsheet function. It has a syntax exampled in 5515 in FIG. 55 employing four argument groups divided by three vertical bars ‘1’. Although it could have easily been three fixed order arguments with a fourth and beyond optional arguments, e.g., INPUT_RANGE. And of course, a variant of the function could be without the optional argument or argument group.

FIG. 55 examples the ‘First set up:’ 5526 instructions of use for creating the formula directly in the cell or indirectly in the cell via the formula bar in this embodiment. It instructs the user to ‘set data type’ in the first argument group, ‘input value constraint if desired’ in the second argument group, ‘input starting value . . . value range or leave empty’ in the third argument group and ‘set options if desired’ in the fourth argument group. It then examples ‘After set up:’ 5536 of the initial formula how the cell direct input and cell indirect input via the formula bar will work differently. The ‘cell only allows change of value . . . value range’ while the ‘formula bar allows change of the complete formula’. This post original formula set as well as the original formula set up is exampled in the three examples that follow in FIG. 55.

In the first example in FIG. 55 the user has typed or otherwise inputted the formula ‘=INPUT_RANGE’ 5544 into a cell and hit ‘ENTER’ to get ‘Input text . . . text range’ 5543 in the cell in light gray text as an instruction as to what to do for the cell input in this embodiment. In the formula bar they get the cell formula ‘=INPUT_RANGE’ 5548. Note, the ‘INPUT_RANGE’ function that the user created limits the inputs to text values. In other embodiments the cell post successful INPUT_RANGE formula instantiation with no specified value could be populated with other text, be blank, and/or as exampled earlier be differentiated in some other way to indicate to the user it is an input function populated cell. If the user then reopens the cell in this embodiment the user gets the cursor in an otherwise empty cell 5553 ready for an input while in the formula bar they can see the formula ‘=INPUT_RANGE’ 5558 which they can then click into to change as shown by the cursor which is the light gray bar at the end of the formula. That cursor could be anywhere in the formula the user positioned it, not just the end.

In the second example in FIG. 55 the user has typed or otherwise inputted the formula ‘=INPUT_RANGE’ 5564 into a cell and hit ‘ENTER’ to get ‘Input number . . . number range’ 5563 displayed in the cell in light gray text as an instruction as to what to do for the cell input. Note, the user has not only limited the input to a number range but to number range within the range ‘1 . . . 50’. In other embodiments the cell could have populated with something else, been blank, and/or as exampled previously be differentiated in some other way to indicate to the user it is an input function populated cell. In the formula bar they get the cell formula ‘=INPUT-RANGE’ 5568. If the user then reopens the cell in this embodiment the user gets the cursor in an otherwise empty cell 5572 while in the formula bar they can see the formula ‘=INPUT_RANGE’ 5568 which they can then click into to change as shown in 5578. The in-cell and the formula bar visible content is different and the changes they will accept are different as will be exampled later.

In the third example in FIG. 55 the user has typed or otherwise inputted the formula ‘=INPUT_RANGE’ 5584 into a cell and hit ‘ENTER’ to get in this embodiment ‘1/7/23 . . . 2/7/23’ 5583 as the existing date range in the cell. Note, the user has not only limited the input to date range inputs but to date ranges starting on or after 1/1/23. Also note, in this embodiment of our technology dates are recognized as dates in cells but require single quotes around the dates when specified in formulas. In the formula bar they get the cell formula ‘=INPUT_RANGE’ 5588. If the user then reopens the cell in this embodiment the user gets the cursor positioned after the value ‘1/7/23 . . . 2/7/23’ range 5593 or wherever they positioned the cursor when they double clicked into the cell. While in the formula bar they can see the formula ‘=INPUT_RANGE’ 5588 which they can then click into to change as shown in 5598.

All the examples in FIG. 55 showed that the user could first set up the multi-value range differential input validation prebuilt functional formula directly in the cell but after completing that formula for the first time then within the cell directly they could only input a value . . . value range while in the formula bar they could access and edit the entire spreadsheet prebuild formula. In this embodiment this creates a spreadsheet cell function with two different input modes, one for the multiple value set presented by the cell for use in other cell calculations and a second where the user can edit the validation formula including the range presented by the cell for use in other cell calculations. However, the function does more than just present the value as we will example next, it limits user inputs to a data type, it can further limit the value range to a subset of value ranges within that data type, it can present input messages to guide the user on what to input, and it can automatically present input error warnings or rejections with automatic or manual adjusting messages when the formula changes. Note, in this embodiment the value range has been inputted by a value . . . value syntax however other syntaxes are supported by our technology.

Differential Input Validation Function—Range Initial then Differential Set Up with Hints

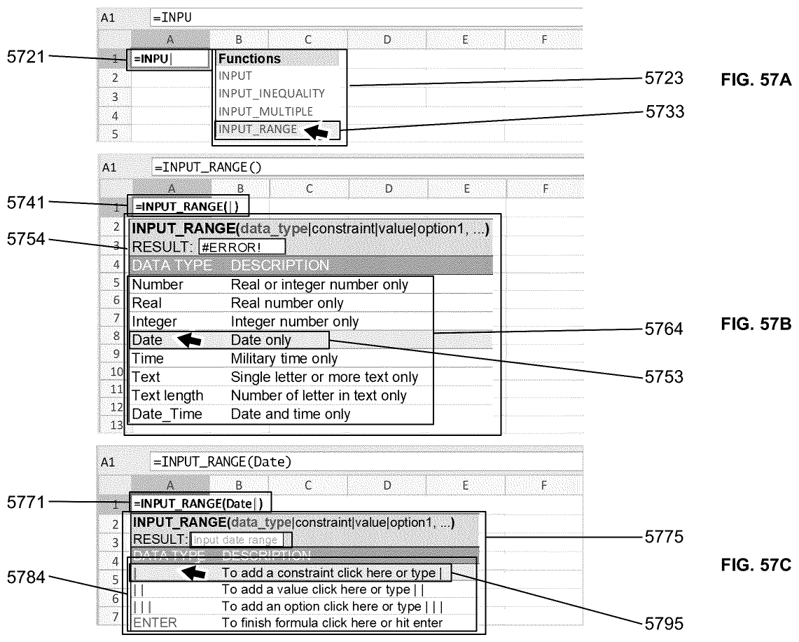

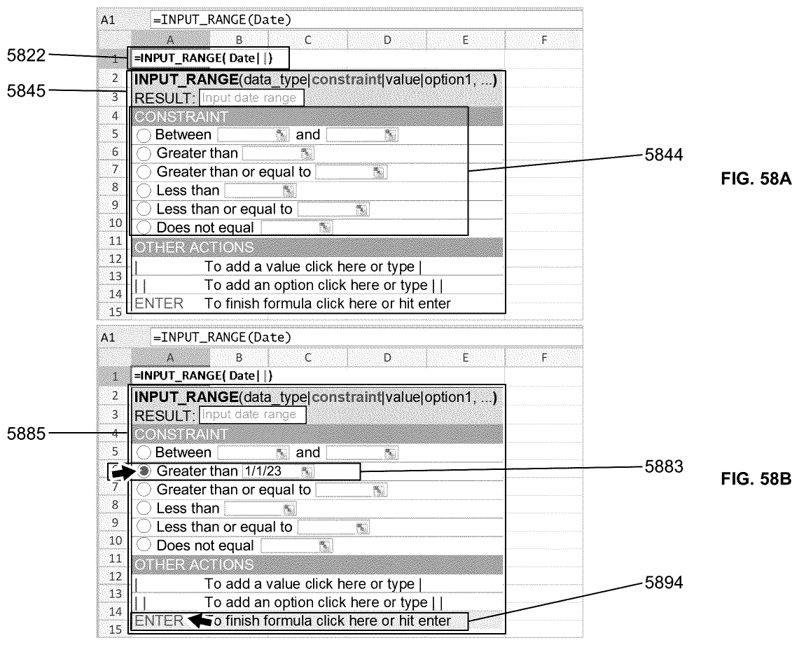

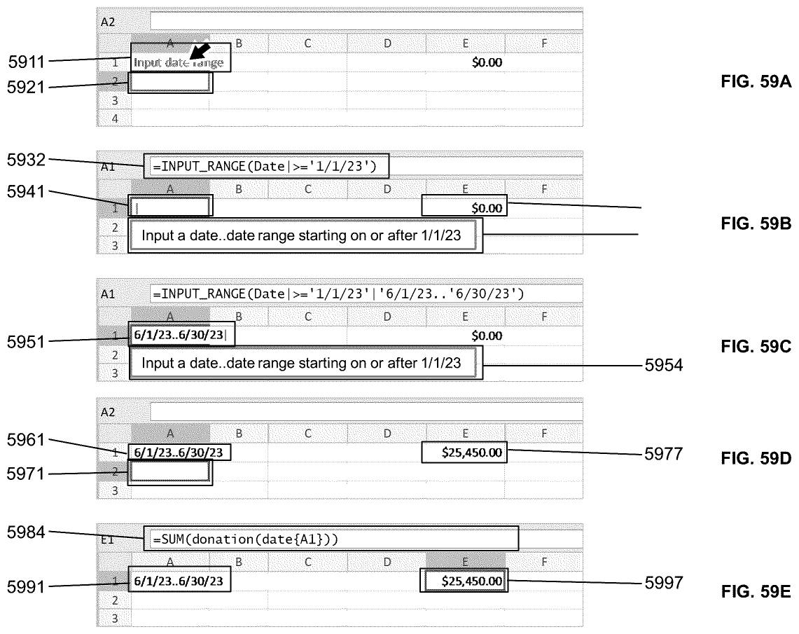

FIG. 57A through FIG. 59E examples the setup of the initial then differential range input validation function with hints and then its usage in a cell referencing formula. FIG. 57A examples a user having typed ‘=INPU’ 5721 into the cell ‘A1’ and getting the traditional style spreadsheet function selection list 5723. They see the differential input validation function they desire ‘INPUT_RANGE’ and click it 5733. That populates the function into cell ‘A1’ 5741 and opens the selection list 5754 for the first argument ‘DATA TYPE’/data type as exampled in FIG. 57B. This data type list 5764 is more extensive than previous data type lists exampled herein and would be applicable to any or all of our INPUT family of functions. The user selects ‘DATA TYPE’ ‘Date’ 5753 which is then populated into the formula as exampled in cell ‘A1’ 5771 in FIG. 57C and automatically opens the selection list 5775 displaying the options 5784 for continuing or finishing the ‘INPUT_RANGE’ functional formula. The user decides to add a constraint and clicks ‘1’ 5795 to input the bar ‘1’ into the cell ‘A1’ formula 5822 in FIG. 58A. It also populates the ‘CONSTRAINT’ alternatives 5844 in the automatically generated selection list 5845. At that point the user clicks the ‘Greater than’ ‘CONSTRAINT’ option 5883 in the selection list 5885 adding in the value ‘1/1/23’ as exampled in FIG. 58B. The user then clicks ‘ENTER’ 5894 in the ‘OTHER ACTIONS’ to finish the formula as exampled in FIG. 59A where ‘Input date range’ in light gray text is populated in the cell ‘A1’ 5911 and the cell focus is moved to the cell below 5921.

The user then re-enters cell ‘A1’ by double clicking it 5911 in FIG. 59A to open the range input 5941 in FIG. 59B with the gray cursor ready for an input. The action also automatically displays the tailored input message 5944 which displays that the input should be a ‘date . . . date range starting on or after 1/1/23’. Thus, telling the user the data type is date, the input should be a range, the syntax for the range is ‘date . . . date’ and that the range should start on or after 1/1/23. A very situationally specific message that automatically changes with any change to the formula function type, the data type constraint and the value constraint in our technology. The action also displays the formula bar formula 5932 which is very different than what is displayed in the cell.

The user inputs a date range ‘6/1/23 . . . 6/30/23’ 5951 as exampled in FIG. 59C and then hits ENTER to populate the revised INPUT_RANGE values in the cell ‘A1’ 5961 as exampled in FIG. 59D. This then leads to the display of a value ‘$25,450.00’ in cell ‘E1’ 5977 which is a formula referencing the value range in cell ‘A1’ 5961. Where before that range input in cell ‘A1’ 5961 ‘E1’ 5977 generated a value of ‘$0.00’. FIG. 59E examples the formula 5984 in cell ‘E1’ 5997 which references a single or multiple dates in cell ‘A1’ in the formulaic data ‘SUM’ function calculation which in our technology supports use of multiple values from a single cell without altering the normal function syntax. Thus, exampling how our technology supports the use of the multi-value differential input validation function results in other cell formulas.

While we could example more range initial then differential input validation function features and functionality, for brevity's sake we will instead move on to range start differential input validation embodiments.

### Differential Input Validation Function—Range Start Differential

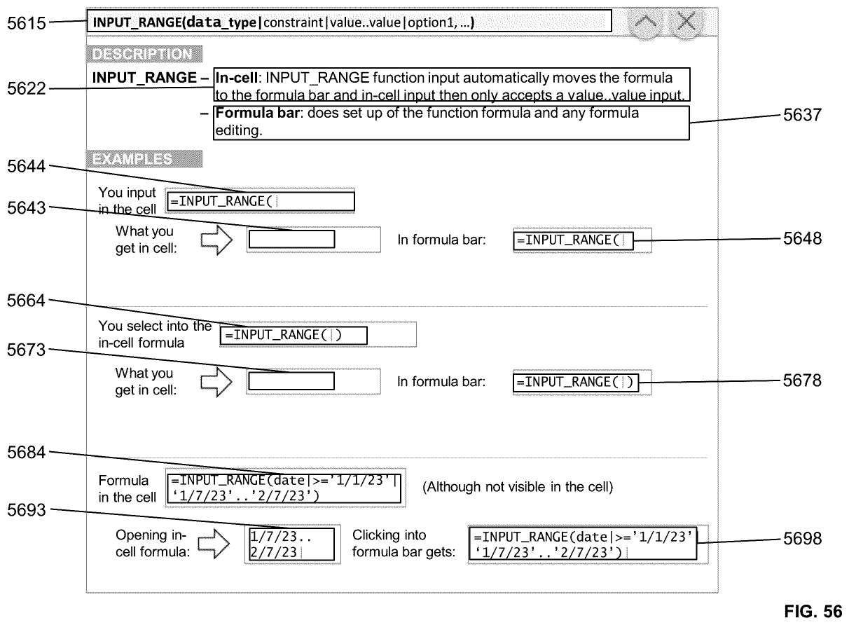

FIG. 56 examples a prebuilt spreadsheet function employing the always differentiation of the cell and formula bar inputs in our technology for a single spreadsheet cell containing multiple validated values in a range. It lays out an embodiment with a function name of ‘INPUT_RANGE’, although it could have any name although ideally one not already used by another spreadsheet function. It has a syntax exampled in 5615 in FIG. 56 employing four argument groups divided by three vertical bars ‘1’. Although it could have easily been three fixed order arguments with a fourth and beyond optional arguments INPUT_RANGE. And of course, a variant of the function could be without the optional argument or argument group or have the arguments or argument groups in a different order.

FIG. 56 examples the ‘In-cell:’ 5622 set up instructions of ‘INPUT_RANGE’ function input automatically moves the formula to the formula bar and in-cell input then only accepts a value . . . value input’. And the ‘Formula bar: does set up of the function formula and any formula editing’ 5637. Where what is meant by the formula is the data type constraint, data value constraint, the value range, and options in this embodiment. Informing the user that this embodiment of the ‘INPUT_RANGE’ function works input wise like the always start differential input ‘INPUT’ functions exampled in FIG. 52A through FIG. 52D and FIG. 54A through FIG. 54E. Also, as previously exampled embodiments are supported where the value range is an invisible argument in the formula bar formula.

In the first example in FIG. 56 the user has typed or otherwise inputted the formula ‘=INPUT RANGE the function ‘=INPUT RANGE’ 5664 into the cell and in this embodiment our technology automatically moves the formula to the formula bar as exampled in 5678 leaving the cell empty as exampled in 5673. The user can then continue to input the formula in the formula bar 5678. In this embodiment, the in-cell and the formula bar capabilities are different once an INPUT family of functions is populated as well as after the formula has been completely entered into the cell as exampled next.

In the third example in FIG. 56 the user has already entered the formula ‘=INPUT_RANGE’ 5684 into a cell and is about to reopen the different inputs. When the user then reopens the cell in this embodiment the user gets the cursor positioned after the value ‘1/7/23 . . . 2/7/23’ range 5693 or wherever they positioned the cursor when they double clicked into the cell. Note, in our technology dates are recognized as dates in cells but require single quotes around the dates when specified in formulas. While when the user clicks into the formula bar, they can position the cursor wherever they want and, in this example, have positioned it at the end of the functional formula ‘=INPUT_RANGE’ 5698 as indicated by the light gray bar. Exampling the difference in the editing capabilities of the two different inputs for this embodiment of the differential input validation function.

While we could example, more range start differential input validation function features and functionality, for brevity's sake we will instead move on another part of our INPUT family of functions handling multiple values, but in these embodiments input as more than one discrete value.

Differential Input Validation Function—Multiple Discrete Values Initial then Differential

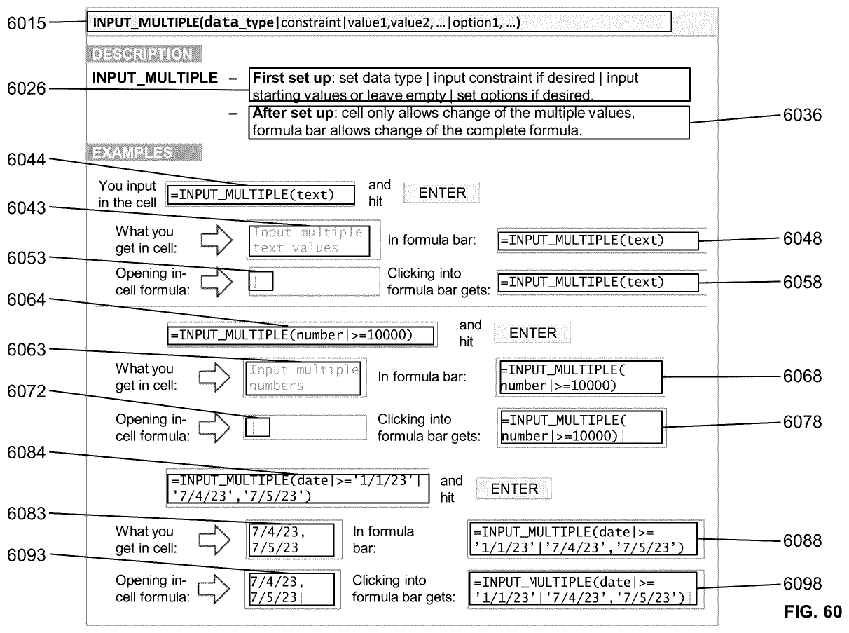

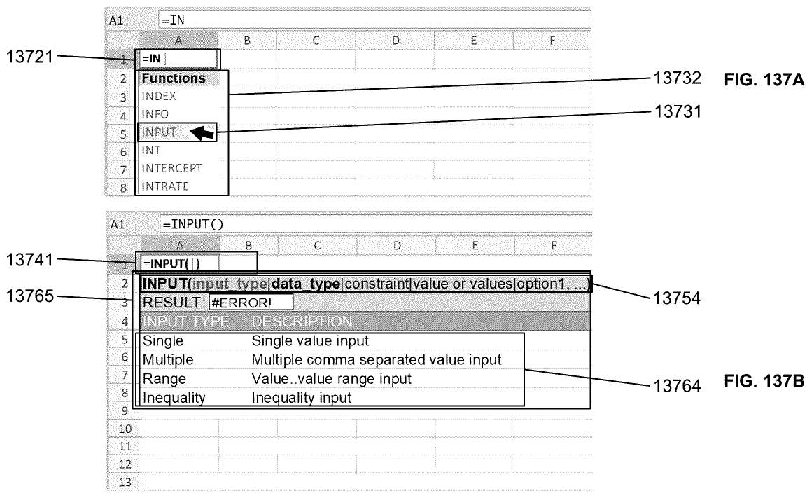

FIG. 60 examples a prebuilt spreadsheet function employing the post initial formula set up differentiation of the cell and formula bar inputs in our technology for a single spreadsheet cell containing multiple validated values entered as discrete values within the single cell. It lays out an embodiment with a function name of ‘INPUT_MULTIPLE’, although it could have any name not already used by another spreadsheet function. It also could be determined by an argument within a general ‘INPUT’ function that supports multiple different types as exampled in FIG. 137A and FIG. 137B. The embodiment being exampled here has a syntax in 6015 in FIG. 60 employing four argument groups divided by three vertical bars ‘|’.

FIG. 60 examples the ‘First set up:’ 6026 instructions of use for creating the formula directly in the cell or indirectly in the cell via the formula bar in this embodiment. It instructs the user to ‘set data type’ in the first argument group, ‘input value constraint if desired’ in the second argument group, ‘input starting values or leave empty’ in the third argument group and ‘set options if desired’ in the fourth argument group. It then examples ‘After set up:’ 6036 of the initial formula how the cell direct input and cell indirect input via the formula bar will work differently. The ‘cell only allows change of the multiple values’ while the ‘formula bar allows change of the complete formula’ 6036. This post original formula set up as well as the original formula set up is exampled in the three examples that follow in FIG. 60.

In the first example in FIG. 60 the user has typed or otherwise inputted the formula ‘=INPUT_MULTIPLE’ 6044 into a cell and hit ‘ENTER’ to get ‘Input multiple text values’ 6043 in the cell in light gray text as an instruction as to what to do for the cell input in this embodiment. In the formula bar they get the cell formula ‘=INPUT_MULTIPLE’ 6048. Note, the ‘INPUT_MULTIPLE’ functional formula that the user created limits the inputs to text values. In other embodiments the cell post formula instantiation with no specified value could be populated with something other wording, be blank, and/or as exampled earlier be differentiated in some other way to indicate to the user it is an input function populated cell. If the user then reopens the cell in this embodiment the user gets the cursor in an otherwise empty cell 6053 ready for an input while in the formula bar they can see the formula ‘=INPUT_MULTIPLE’ 6058 which they can then click into to change as shown by the cursor which is the light gray bar at the end of the formula and could be anywhere the user positioned it in the formula.

In the second example in FIG. 60 the user has typed or otherwise inputted the formula ‘=INPUT_MULTIPLE’ 6064 into a cell and hit ‘ENTER’ to get ‘Input multiple numbers’ 6063 displayed in the cell in light gray text as an instruction as to what to do for the cell input. In other embodiments the cell could have populated with something else, been blank, and/or as exampled in FIG. 48A through FIG. 48D be differentiated in some other way to indicate to the user it is an input function populated cell. Note, the user has not only limited the input to multiple number values but each of those values must be greater than or equal to 10000. In the formula bar they get the cell formula ‘=INPUT_MULTIPLE’ 6068. If the user then reopens the cell in this embodiment the user gets the cursor in an otherwise empty cell 6072 while in the formula bar they can see the formula ‘=INPUT_MULTIPLE’ 6068 which they can then click into to change as shown in 6078. The in-cell and the formula bar visible content is different and the changes they will accept are different as will be exampled later.

In the third example in FIG. 60 the user has typed or otherwise inputted the formula ‘=INPUT_MULTIPLE’ 6084 into a cell and hit ‘ENTER’ to get in this embodiment ‘7/4/23,7/5/23’ 6083 as the existing multiple dates in the cell. Note, the user has not only limited the input to multiple date inputs but to dates starting on or after 1/1/23. Also note, in this embodiment of our technology dates are recognized as dates in cells but require single quotes around the dates when specified in formulas. In the formula bar they get the cell formula ‘=INPUT_MULTIPLE’ 6088. If the user then reopens the cell in this embodiment the user gets the cursor positioned after the multiple values ‘7/4/23,7/5/23’ 6093 or wherever they positioned the cursor when they double clicked into the cell. While in the formula bar they can see the formula ‘=INPUT_MULTIPLE’ 6088 which they can then click into to change as shown in 6098.

All the examples in FIG. 60 showed that the user could first set up the multi-value differential input validation prebuilt functional formula directly in the cell but after completing that formula for the first time then within the cell directly they could only input multiple values while in the formula bar they could access and edit the entire spreadsheet prebuild formula. This creates a spreadsheet cell function with two different input modes, one for the values presented by the cell for use in other cell calculations and a second where the user can edit the validation formula including the value presented by the cell for use in other cell calculations. However, the function does more than just present the value as has been previously exampled for functions in the INPUT family of functions, it limits user inputs to a data type, it can further limit the values to a subset of values within that data type, it can present input messages to guide the user on what to input, and it can automatically present input error warnings or rejections with automatic or manual adjusting messages when the formula changes. Note, in this embodiment the multiple values have been inputted with a comma separation syntax however other syntaxes are supported by our technology, e.g., ‘50;51;52’, or ‘ANY_OF’.

### Differential Input Validation Function—Single Function Supporting Multiple Validations

We have referenced herein how our technology supports different syntaxes for our differential input validation functions and referenced FIG. 137A and FIG. 137B as an example because in that embodiment the first argument specifies the ‘input type, which in our previous embodiments have been separate functions. In this embodiment the function list 13732 in FIG. 137A presents only one ‘INPUT’ function which the user then selects 13731 for cell ‘A1’ 13721 from the selection list 13732. The function syntax 13754, visible in the function argument selection list 13765 in FIG. 137B, shows the first argument/argument group to be the ‘input type’. Those input types 13764 are in the argument selection popup 13765 and are the equivalent of the ‘INPUT’ family of functions discussed herein. Thus, collapsing the multiple functions into one function with an additional argument. Other than the addition of the ‘input type’ argument the respective different arguments work like their previously described function specific equivalents. And the ability to support different argument structures works as previously described for the family of functions. Therefore, rather than repeating all those variations and situations, for brevity's sake we will move onto differential input multiple discrete value validation functions that start differential.

### Differential Input Validation Function—Multiple Discrete Values Starting Differential

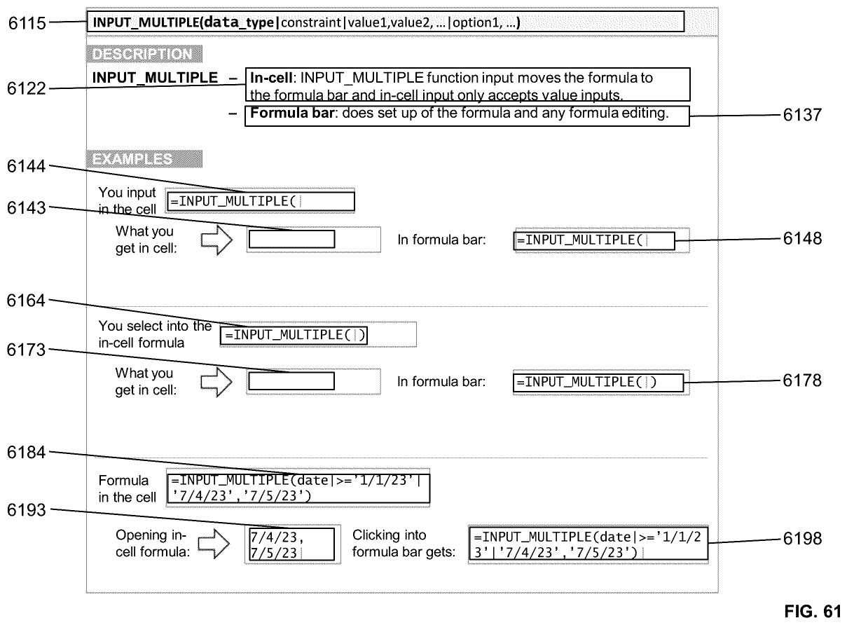

FIG. 61 examples a prebuilt spreadsheet function employing the always differentiation of the cell and formula bar inputs in our technology for a single spreadsheet cell containing multiple validated values entered discretely. It lays out an embodiment with a function name of ‘INPUT_MULTIPLE’, although it could have any name not already used by another spreadsheet function. It has a syntax exampled in 6115 in FIG. 61 employing four argument groups divided by three vertical bars ‘1’. Although it could have easily had a different syntax made up of just arguments and named arguments per our previous filings. And of course, a variant of the function could be without the optional argument group named arguments and/or arguments. The multiple inputs create a set of values which can be discretely specified using different separators by themselves or within a function.

FIG. 61 examples the ‘In-cell:’ 6122 set up instructions of the ‘INPUT_MULTIPLE’ function input that automatically moves the formula to the formula bar and where the in-cell input then only accepts value inputs. And the ‘Formula bar: does set up of the function formula and any formula editing’ 6137. Where what is meant by the formula in this embodiment is the data type constraint, data value constraint, values, and options as per the syntax 6115. Although other embodiments, like those previously discussed and exampled may have invisible argument, different argument orders and/or less arguments. Thus, this embodiment of the ‘INPUT_MULTIPLE’ function works input wise like the always start differential input ‘INPUT’ functions exampled in FIG. 52A through FIG. 52D and FIG. 54A through FIG. 54E.

In the first example in FIG. 61 the user has typed or otherwise inputted the formula ‘=INPUT_MULTIPLE the function ‘=INPUT_MULTIPLE’ 6164 into the cell however in this embodiment our technology automatically moves the function to the formula bar as exampled in 6178 leaving the cell empty as exampled in 6173. The user can then continue to input the formula in the formula bar 6178 as the cursor is between the two parentheses. In this embodiment, the in-cell and the formula bar capabilities are different once an INPUT family of functions is populated as well as after the formula has been completely entered into the cell as exampled next.

In the third example in FIG. 61 the user has already entered the formula ‘=INPUT_MULTIPLE’ 6184 into a cell and is about to reopen the different inputs. When the user then reopens the cell in this embodiment the user gets the cursor positioned after the second value ‘7/4/23’,‘7/5/23’ 6193 or wherever they positioned the cursor when they double clicked into the cell. While when the user clicks into the formula bar, they can position the cursor wherever they want and, in this example, have positioned it at the end of the functional formula ‘=INPUT_RANGE’ 6198 as indicated by the light gray bar. Thus, making the formula ready for editing. Thereby, exampling the difference in the editing capabilities of the two different inputs for this embodiment of the differential input validation function.

While we could example more multiple discrete value validation start differential input validation function features and functionality, for brevity's sake we will instead move on another part of our INPUT family of functions handling multiple values, but embodiments where the set of multiple values is input as an inequality.

Differential Input Validation Function—Inequality Initial then Differential

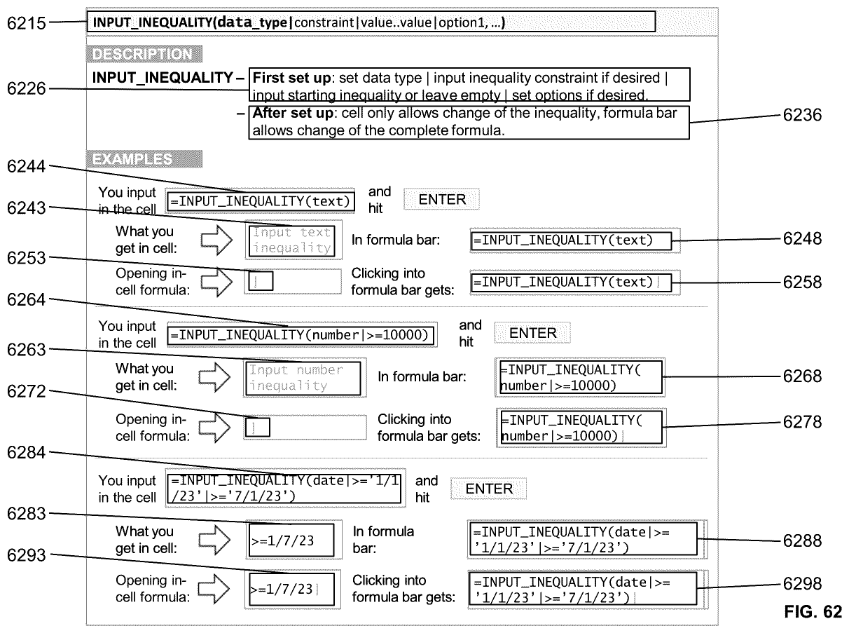

FIG. 62 examples a prebuilt spreadsheet function employing our post initial formula set up differentiation of the cell and formula bar inputs in our technology for a single spreadsheet cell containing multiple validated values entered as an inequality within the single cell. It examples an embodiment with a function name of ‘INPUT_INEQUALITY’, although it could have any name not already used by another spreadsheet function. It also could be determined by an argument within a general ‘INPUT’ function that supports multiple different types as exampled in FIG. 137A and FIG. 137B. The embodiment being exampled here has a syntax in 6215 in FIG. 62 employing four argument groups divided by three vertical bars ‘l’. Our technology supports different function syntaxes as previously described.

FIG. 62 examples the ‘First set up:’ 6226 instructions of use for creating the formula directly in the cell or indirectly in the cell via the formula bar in this embodiment. It instructs the user to ‘set data type’ in the first argument group, ‘input value constraint if desired’ in the second argument group, ‘input starting inequality or leave empty’ in the third argument group and ‘set options if desired’ in the fourth argument group. It then examples ‘After set up:’ 6236 of the initial formula how the cell direct input and cell indirect input via the formula bar will work differently. The ‘cell only allows change of the inequality’ while the ‘formula bar allows change of the complete formula’. This post original formula set as well as the original formula set up is exampled in the three examples that follow in FIG. 62.

In the first example in FIG. 62 the user has typed or otherwise inputted the formula ‘=INPUT_INEQUALITY’ 6244 into a cell and hit ‘ENTER’ to get ‘Input text inequality’ 6243 in the cell in light gray text as an instruction as to what to do for the cell input in this embodiment. In the formula bar they get the cell formula ‘=INPUT_INEQUALITY’ 6248. Note, the ‘INPUT_INEQUALITY’ function formula that the user created limits the inputs to text values. In other embodiments the cell post formula instantiation with no specified value could be populated with something other wording, be blank, and/or as exampled earlier be differentiated in some other way to indicate to the user it is an input function populated cell. If the user then reopens the cell in this embodiment the user gets the cursor in an otherwise empty cell 6253 ready for an input while in the formula bar they can see the formula ‘=INPUT_INEQUALITY’ 6248 which they can then click into to change as shown 6258 by the cursor which is the light gray bar at the end of the formula and could be anywhere the user positioned it in the formula.

In the second example in FIG. 62 the user has typed or otherwise inputted the formula ‘=INPUT_INEQUALITY’ 6264 into a cell and hit ‘ENTER’ to get ‘Input number inequality’ 6263 displayed in the cell in light gray text as an instruction as to what to do for the cell input. In other embodiments the blank cell could have populated with something else, be blank, and/or as exampled later be differentiated in some other way to indicate to the user it is an input function populated cell. Note, the user has not only limited the input to a number inequality but to number inequality ‘>=10000’. In the formula bar they get the cell formula ‘=INPUT_INEQUALITY’ 6268. If the user then reopens the cell in this embodiment the user gets the cursor in an otherwise empty cell 6272 ready for inequality input, while in the formula bar they can see the formula ‘=INPUT_INEQUALITY’ 6268 which they can then click into to change as shown in 6278. The in-cell and the formula bar visible content is different as are the changes they will accept as has been previously exampled in more detail for the INPUT and the INPUT_RANGE function examples.

In the third example in FIG. 62 the user has typed or otherwise inputted the formula ‘=INPUT_INEQUALITY’ 6284 into a cell and hit ‘ENTER’ to get in this embodiment ‘>=7/1/23’ 6283 as the existing inequality in the cell. Note, the user has not only limited the input to date inequality inputs but to dates starting on or after 1/1/23. In the formula bar they get the cell formula ‘=INPUT_INEQUALITY’ 6288. If the user then reopens the cell in this embodiment the user gets the cursor positioned after the inequality ‘>=7/1/23’ 6293 or wherever they positioned the cursor when they double clicked into the cell ready for editing of the inequality. While in the formula bar they can see the formula ‘=INPUT_INEQUALITY’ 6288 which they can then click into to change as shown in 6298.

All the examples in FIG. 62 showed that the user could first set up the inequality differential input validation prebuilt functional formula directly in the cell but after completing that formula for the first time then within the cell directly they could only input an inequality while in the formula bar they could access and edit the entire spreadsheet prebuild formula. This creates a spreadsheet cell function with two different input modes, one for the values presented by the cell for use in other cell calculations and a second where the user can edit the validation formula including the inequality presented by the cell for use in other cell calculations. However, the function does more than just present the value as has been previously exampled for functions in the INPUT family of functions, it limits user inputs to a data type, it can further limits the inequality to a subset of values within that data type, it can automatically present input messages to guide the user on what to input, and it can automatically present input error warnings or rejections with automatic or manual adjusting messages when the formula changes.

### Differential Input Validation Function—Inequality Start Differential

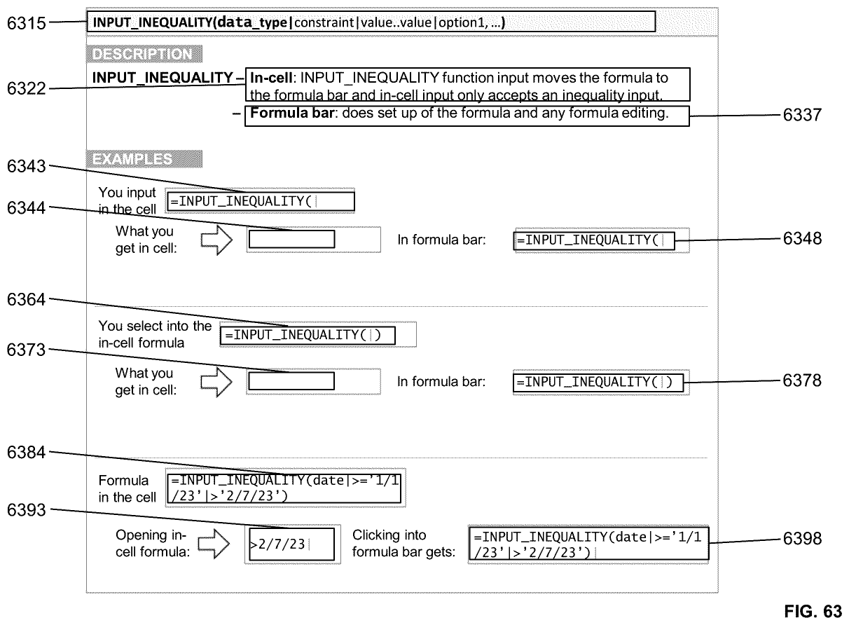

FIG. 63 examples a prebuilt spreadsheet function embodiment employing the always differentiation of the cell and formula bar inputs in our technology for a single spreadsheet cell containing multiple validated values entered via an inequality. It examples an embodiment with a function name of ‘INPUT_INEQUALITY’, although it could have any name not already used by another spreadsheet function. It has a syntax exampled in 6315 in FIG. 63 employing four argument groups divided by three vertical bars ‘1’. Although it could have easily had a different syntax made up of just arguments and named arguments per our previous filings. And of course, a variant of the function could be without the optional argument group, named arguments and/or arguments.

FIG. 63 examples the ‘In-cell:’ 6322 set up instructions of the ‘INPUT_INEQUALITY’ function input that automatically moves the formula to the formula bar and the in-cell input then only accepts inequality input. And the ‘Formula bar: does set up of the function formula and any formula editing’ 6337. Where what is meant by the formula is the data type constraint, data value constraint, and options arguments or argument groups within the function parentheses. Informing the user that this embodiment of the ‘INPUT_INEQUALITY’ function works input wise like the always start differential input ‘INPUT’ functions exampled in more detail in FIG. 52A through FIG. 52D and FIG. 54A through FIG. 54E.

In the first example in FIG. 63 the user has typed or otherwise inputted the formula ‘=INPUT_INEQUALITY the function ‘=INPUT_INEQUALITY’ 6364 into the cell however in this embodiment our technology automatically moves the function to the formula bar as exampled in 6378 leaving the cell empty as exampled in 6373. The user can then continue to input the formula in the formula bar 6378. In this embodiment, the in-cell and the formula bar capabilities are different once an INPUT family of functions is populated as well as after the formula has been completely entered into the cell as exampled next.

In the third example in FIG. 63 the user has already entered the formula ‘=INPUT_INEQUALITY’ 6384 into a cell and is about to reopen the different inputs. When the user then reopens the cell in this embodiment the user gets the cursor positioned after the inequality ‘>2/7/23’ 6393 or wherever they positioned the cursor when they double clicked into the cell. Note, in our technology dates are recognized as dates in cells but require single quotes around the dates when specified in formulas. While when the user clicks into the formula bar, they can position the cursor wherever they want and, in this example, have positioned it at the end of the functional formula ‘=INPUT_INEQUALITY’ 6398 as indicated by the light gray bar. Thereby, exampling the difference in the editing capabilities of the two different inputs for this embodiment of the differential input validation function where in-cell the user can edit the inequality value and in the formula bar the user can edit the entire formula.

While we could example, more inequality start differential input validation function features and functionality, for brevity's sake we will instead move on to exampling the partial locking of our INPUT family of functions.

### Differential Input Validation Function—Partial Locking

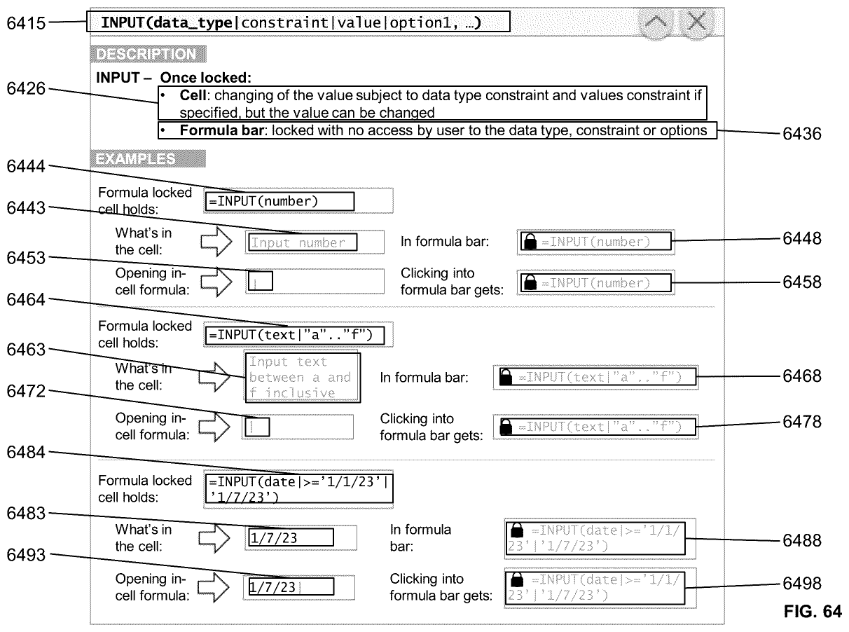

As described in the prior art, spreadsheet locking functional formulas in regular spreadsheet cells are binary, locked or unlocked with no partial locking. FIG. 64 contains multiple examples and description of how our new spreadsheet cell locking technology partially locks our “Differential input validation functions”.

FIG. 64 examples our partial locking capability for the single value INPUT differential input validation function. However, as we will example later it works in a similar way for the entire family of our dual input validation functions. It describes about once the cell is locked how it differentially impacts the cell and the formula bar content. Locking the formula bar so that users cannot change the functional formula data type constraint, data values constraint if there is one, and any options specified. However, the user can change the input value and for that reason we call the functional formula partially locked. This is described in 6426 ‘Cell: can change the value subject to data type constraint and values constraint if specified,’. Described in 6436 is the ‘Formula bar: locked with no access by user to the data type, constraint or options’. Thus, describing the partial locking which is then exampled in the three examples that follow in FIG. 64.

In the first example in FIG. 64 the user has locked the formula ‘=INPUT’ 6444. In the cell the user then sees the same ‘Input number’ 6443 instruction they saw before the locking. However, in the formula bar 6448 they see the formula ‘=INPUT’ changed to light grey and accompanied by a lock, both indicating in this embodiment that the user cannot change them. This is different than their ability to change the formula pre-locking. Note, our technology supports other ways of informing the user of what is locked but for clarity of demonstrating the functionality we will consistently uses the greying and the lock throughout the filing. When the user attempts to reopen the cell in this embodiment the user gets the cursor in an otherwise empty cell 6453 ready for an input just like it functioned before locking. However, they are unable to click into the formula bar 6458 and in embodiments later exampled get a locking alert.

In the second example in FIG. 64 the user has locked the formula ‘=INPUT’ 6464. In the cell the user then sees the same ‘Input text between a and f inclusive’ 6463 instruction they saw before the locking. However, in the formula bar 6468 they see the formula ‘=INPUT’ changed to light gray and accompanied by a lock both indicating in this embodiment that the user cannot change them. When the user attempts to reopen the cell in this embodiment the user gets the cursor in an otherwise empty cell 6472 ready for an input just like it functioned before locking. However, they are unable to click into the formula bar 6478 and in embodiments later exampled get a locking alert. As with the previous example, demonstrating the partial locking where the cell input of only the value is unlocked while the formula bar input of the entire formula is locked.

In the third example in FIG. 64 the user has locked the formula ‘=INPUT’ 6484. In the cell the user then sees the same date ‘1/7/23’ 6483 that they saw before the locking. However, in the formula bar 6488 they see the formula ‘=INPUT’ changed to light grey and accompanied by a lock, both indicating in this embodiment that the user cannot change them. When the user attempts to reopen the cell in this embodiment the user gets the cursor with the current value ‘1/7/23’ 6493 ready for changing just like it functioned before locking. However, they are unable to click into the formula bar 6498 and in embodiments later exampled get a locking alert.

All the examples in FIG. 64 showed that post locking of an existing one of our differential input validation functions that the cell input of the value was unchanged by the locking however the formula bar was locked so that the user could not change the data type constraint, value constraint if there was one, and any options that were specified pre locking. We call this partial locking where one or more of the inputs or one or more of the function arguments are locked with one or more input or function arguments left unlocked by locking. With this embodiment being where the locking locks the formula bar input but not the direct in-cell input. However, another embodiment supported by our technology in our differential input validation functions locks all the function arguments except the value argument, thereby leaving the in-cell input unlocked and leaving all the arguments in the formula bar input locked except the argument for the value.

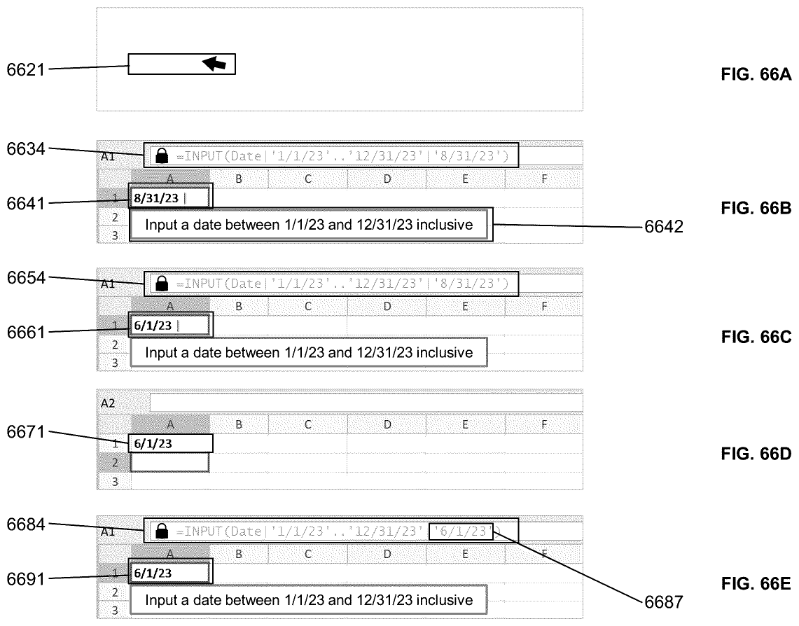

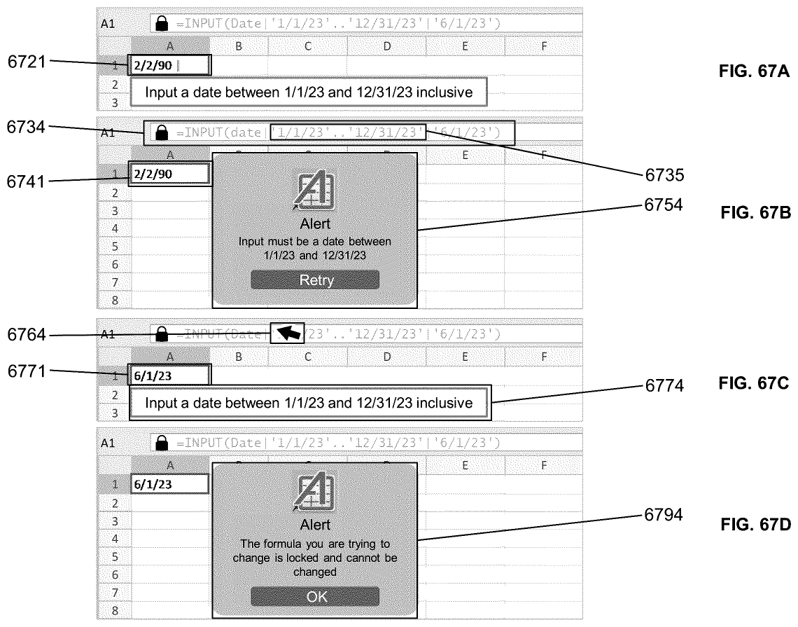

FIG. 66A through FIG. 67D examples in greater depth some of the feature and functionality of the “Differential input validation functions” locking. It starts with a user double clicking into cell ‘A1’ 6621 in FIG. 66A which contains one of our differential input validation functions locked with the formula ‘=INPUT’ 6634 as exampled in FIG. 66B. That functional formula presents the automatically generated tailored input message 6642 and allows the user to enter the cell ‘A1’ 6641 despite the formula bar formula 6634 displaying the locking lock and disabled formula. The user then changes the date ‘8/31/23’ 6641 in FIG. 66B to ‘6/1/23’ 6661 in FIG. 66C just as they would do in an unlocked cell/formula and hits ENTER to get the changed value exampled in 6671 in FIG. 66D. When the user re-highlights the cell ‘A1’ 6691 in FIG. 66E you can see that the changed value ‘6/1/23’ 6687 was also reflected in the formula bar formula 6684.

FIG. 67A and FIG. 67B example how post locking the validation rejection or warning alert work just as they did before locking. In this embodiment if the user attempts in FIG. 67A to enter the date ‘2/2/90’ 6721 into the cell ‘A1’ which previously contained the value 6691 and formula 6684 from FIG. 66E it fails the data values validation of “1/1/23’ . . . ‘12/31/23” 6735 in the formula 6734 and automatically generates the rejection ‘Alert’ 6754 with the automatically constraint validation tailored text ‘Input must be a date between 1/1/23 an 12/31/23’. This is just as it would if it were unlocked. Leaving the user to ‘Retry’ the input until they get a validate date or leave the date blank.

FIG. 67C and FIG. 67D examples one embodiment of what happens post locking if the user attempts to enter the formula bar. In this embodiment when the user attempts to enter the formula bar 6764 in FIG. 67C it automatically triggers an ‘Alert’ popup 6794 in FIG. 67D with a message telling the user “The formula you are trying to change is locked and cannot be changed” or something similar informing them of the locking and possibly telling them how to unlock the cell.

The overall takeaway on our partial locking of our differential input validation family of functions is that the value or value inputs work just as they did before locking and the formula input does not work as before locking but is instead locked.

### Differential Input Validation Function—Partial Locking Setup

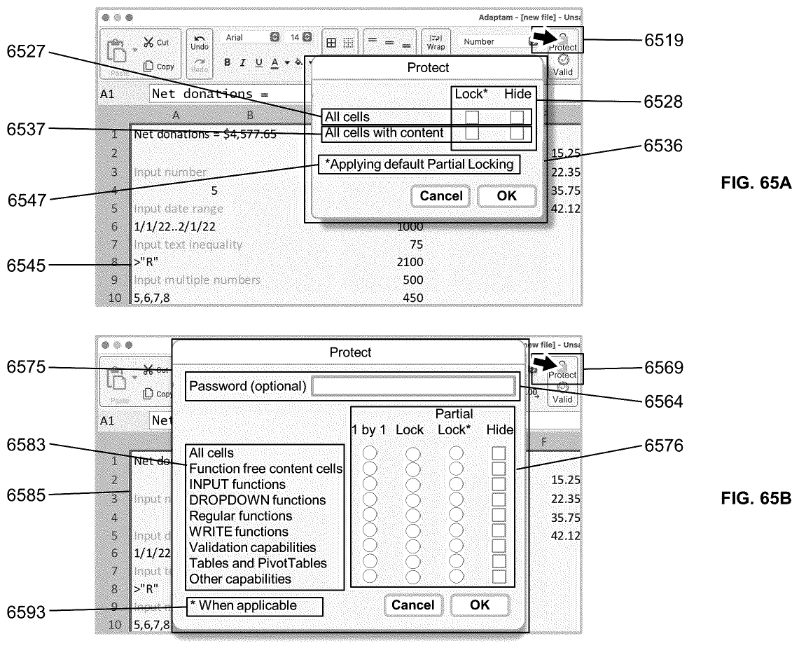

FIG. 65A and FIG. 65B example two of the many different ways of setting up the partial locking in our technology. FIG. 65A examples an embodiment where the spreadsheet application does most of the set-up with the user making very few decisions. The user has highlighted 6545 all the cells in the spreadsheet and clicked the ‘Protect’ ribbon button 6519. This opens the popup 6536 which gives the user the selections 6528 to ‘Lock*’ and/or to ‘Hide’ cell formulas and inputs in our technology. In this embodiment if the user selects ‘Lock*’ our technology will automatically ‘Apply default Partial Locking’ 6547 as predetermined by our spreadsheet. In this embodiment clicking ‘Lock*’ will partially lock the appropriate functions and cells and fully lock the other cells and functions. In this embodiment the user is given just two selections for applying the locking and/or hiding, ‘All cells’ 6527 or ‘All cells with content’ 6537. There are more combinations of cell and function selection and locking and hiding specifications that our technologies support as we example next.

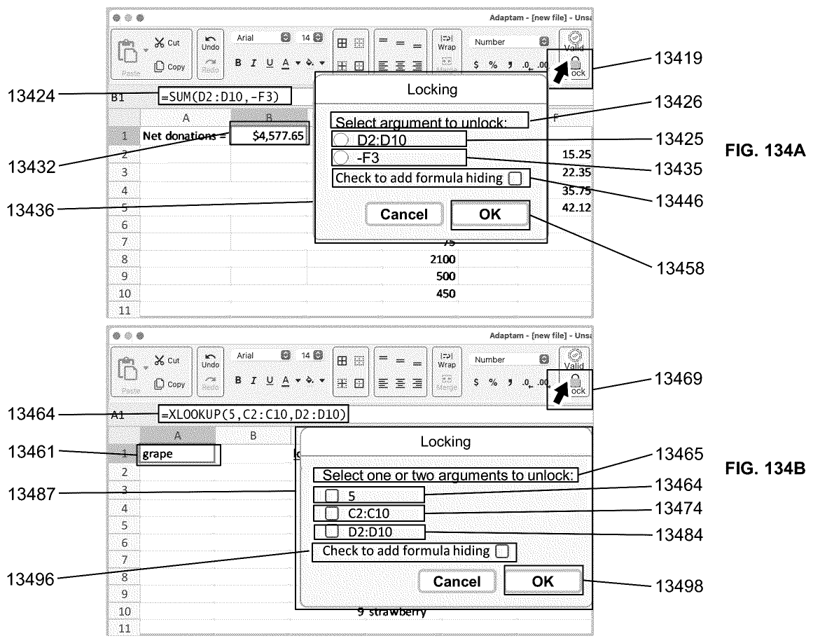

FIG. 65B examples an embodiment where the user is given many more options to decide what they want to lock, partially lock, and/or hide. Again, the user has highlighted 6585 all the cells in the spreadsheet and clicked the ‘Protect’ ribbon button 6569. Although they could initiate this using menu selections or other modes. This opens the popup 6575 which gives the user a larger set of selections 6583 and a larger set locking and hiding selection options 6576. The first option ‘1 by 1’ will take the user through all the cells with content and allow them to decide down to the specificity exampled in FIG. 134A and FIG. 134B. It will allow users to decide whether to utilize partial locking in all applicable prebuilt functions and cell capabilities. Where all applicable 6593 prebuilt functions are those functions delivered prebuilt as part of the spreadsheet directly or via add-ins that have two or more arguments. Where the applicable prebuilt functions includes all prebuilt functions which have one argument that can be locked and at least one argument unlocked. Where the applicable capabilities are those delivered prebuilt with the spreadsheet that have more than one user input delivering or validating the cell content, where at least one of the inputs can be locked and at least one of the inputs unlocked. Where our technology supports capabilities working for single cells.

We have separately listed functions which have differential inputs and have differential input and selections from “Regular functions” where the in-cell and formula bar inputs always work the same way. We singled out our ‘WRITE’ functions because of their sophisticated inputs recognizing that they fall into the regular functions grouping. We have also focused on the single cell capabilities, as single cell capabilities have previously had no partial locking functionality. ‘Table’ and ‘PivotTables’ are included as the two situations where at least one spreadsheet supports changes of selections post locking. Note, they only support changes of selections within existing lists no form of other changes. We support changes to capabilities where the user can make changes other than selecting from a list where there is more than one input ‘When applicable’ 6593 to other capabilities such as chart ranges, conditional formatting rules, and our visualizer formulas. The user simply checks the radio buttons for ‘1 by 1’, ‘Lock’ or ‘Partial Lock*’ to trigger their selections and/or checks the boxes for hiding 6576.

Note FIG. 65A has no password protection and instead employs a password free building of the spreadsheet for use by others where that usage disables any user's ability to change the locking, partial locking, and/or the hiding of the formula or capability selections. FIG. 65B examples the normally used approach of giving the person specifying the protection the ability to password protect 6564 those specifications such that it requires the password to change or eliminate those settings. Or to leave it unprotected from change thereby allowing subsequent users of the spreadsheet the ability to undo the locking and/or hiding.

### Differential Input Validation Function—Partial Locking and Formula Hiding

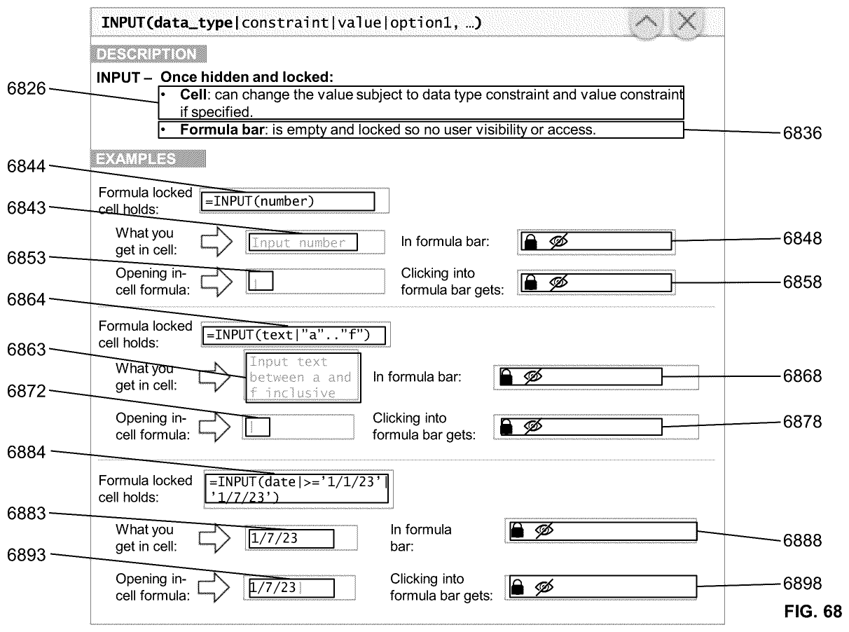

FIG. 68 examples our partial locking capability for a single value differential input validation function with formula hiding. However, as we will example later it works in a similar way for the entire family of our INPUT functions. It describes and examples how once the cell is locked it differentially impacts the cell and the formula bar content and, in this embodiment, hiding the formula bar content. Thus, offering the user no opportunity to change the formula content. This is described in 6826 ‘Cell: can change the value subject to data type constraint and values constraint if specified. Described in 6836 is the ‘Formula bar: is empty and locked so no user visibility or access’. Thus, describing the partial locking with the formula hiding which is then exampled in the three examples that follow in FIG. 68.

In the first example in FIG. 68 the user has locked and hidden the formula ‘=INPUT’ 6844. In the cell the user then sees the same ‘Input number’ 6843 instruction they saw before the locking and hiding. However, in the formula bar 6848 they see nothing but lock and slash eye icons, the first indicating the locking and the second the hiding. Note, our technology supports other ways of informing the user of what is locked and hidden but for clarity of demonstrating the functionality we will consistently uses the lock and slash eye icons throughout the filing. When the user attempts to reopen the cell in this embodiment the user gets the cursor in an otherwise empty cell 6853 ready for an input just like it functioned before locking and hiding. However, they are unable to click into the formula bar 6858 and in embodiments later exampled get a locking and hiding alert.

In the second example in FIG. 68 the user has locked and hidden the formula ‘=INPUT’ 6864. In the cell the user then sees the same ‘Input text between a and f inclusive’ 6863 instruction they saw before the locking and hiding. However, in the formula bar 6868 they see nothing but lock and slash eye icons, the first indicating the locking and the second the hiding. When the user attempts to reopen the cell in this embodiment the user gets the cursor in an otherwise empty cell 6872 ready for an input just like it functioned before locking and hiding. However, they are unable to click into the formula bar 6878 and continue to see no formula and in embodiments later exampled get a locking and hiding alert.

In the third example in FIG. 68 the user has locked the formula ‘=INPUT’ 6884. In the cell the user then sees the same date ‘1/7/23’ 6883 that they saw before the locking and hiding. However, in the formula bar 6888 they see nothing but lock and slash eye icons, the first indicating the locking and the second the hiding. They see no formula. When the user attempts to reopen the cell in this embodiment the user gets the cursor with the current value ‘1/7/23’ 6893 ready for changing just like it functioned before locking and hiding. However, they are unable to click into the formula bar 6898 and continue to see no formula and in embodiments later exampled get a locking and hiding alert.

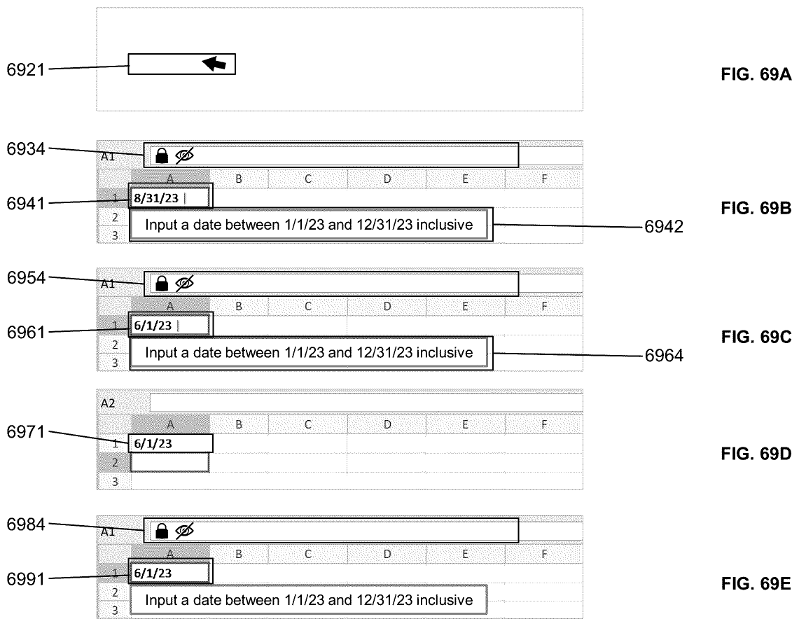

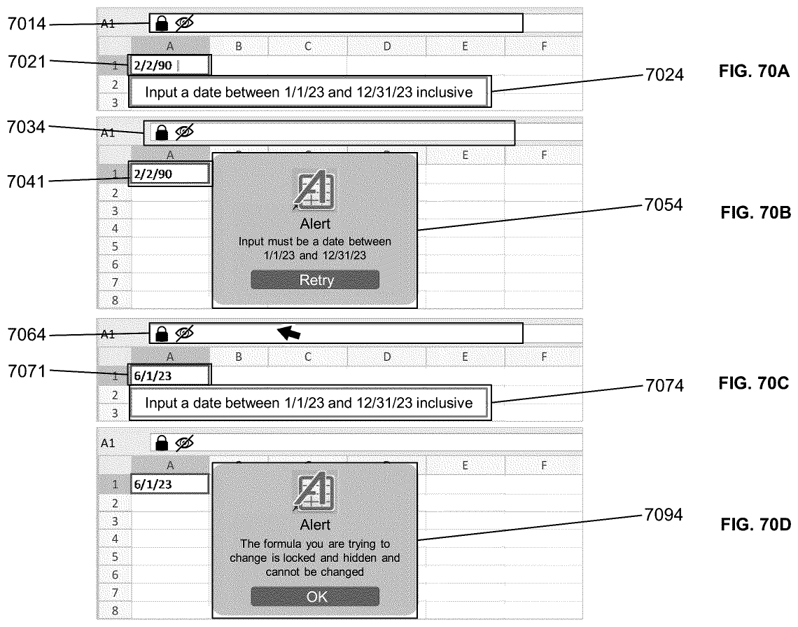

FIG. 69A through FIG. 70D examples in greater depth some of the feature and functionality of the “INPUT” function hiding and locking. It starts with a user double clicking into cell ‘A1’ 6921 in FIG. 69A which contains one of our differential input validation functions locked and hidden with the formula ‘=INPUT’ 6634 as was exampled in FIG. 66B. However, in this situation they only see the lock and slash eye icons in the formula bar 6934 in FIG. 69B. This heightens the value of our automatically generated validation tailored input message 6942 which allows the user to understand this is a validation cell and what the validation constraints are. The user then enters the cell ‘A1’ 6941 despite the formula bar formula 6934 displaying nothing but the lock and the slash eye. The user then changes the date ‘8/31/23’ 6941 in FIG. 69B to ‘6/1/23’ 6961 in FIG. 69C just as they would do in an unlocked and unhidden cell/formula and hits ENTER to get the changed value exampled in 6971 in FIG. 69D. When the user re-highlights the cell ‘A1’ 6991 in FIG. 69E you can see the changed value ‘6/1/23’ in the cell ‘A1’ 6991 but still see nothing other than the lock and the slash eye in the formula bar 6984.

FIG. 70A and FIG. 70B example how post locking and hiding the validation rejection or warning alert work just as they did before locking. In this embodiment if the user attempts in FIG. 70A to enter the date ‘2/2/90’ 7021 into the cell ‘A1’ 6991 from FIG. 69E it fails the data values validation of “1/1/23’ . . . ‘12/31/23” and automatically generates the rejection ‘Alert’ 7054 for cell ‘A1’ 7041 with the automatically constraint validation tailored text ‘Input must be a date between 1/1/23 an 12/31/23’ as it would if it were unlocked and unhidden. Leaving the user to ‘Retry’ the input until they get a validate date and making it more important to have a validation tailored Alert message.

FIG. 70C and FIG. 70D examples one embodiment of what happens post locking and hiding if the user attempts to enter the formula bar. In this embodiment when the user attempts to enter the formula bar 7064 for cell ‘A1’ 7071 in FIG. 70C it automatically triggers an ‘Alert’ popup 7094 in FIG. 70D with a message telling the user “The formula you are trying to change is locked and cannot be changed” or something similar informing them of the locking and possibly telling them how to unlock an unhide the formula/cell.

The overall takeaway on our partial locking and formula hiding of our differential input validation family of functions is that the value or value inputs work just as they did before locking and the formula input does not and is locked and hidden. Rather than exampling that further for the single value input “INPUT” function we will move on examples of how locking and hiding works for the other functions in our family of INPUT functions.

### Differential Input Range Validation Function—Partial Locking

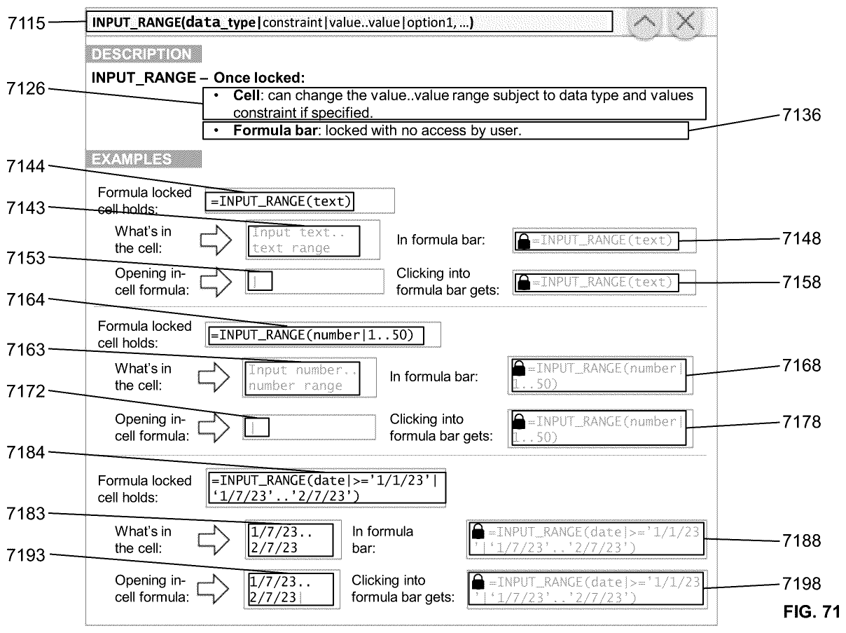

FIG. 71 examples our partial locking capability for the range differential input validation function. It works in a similar way to the partial locking of the previously exampled INPUT functions. It describes about once the cell is locked how the locking differently impacts the cell and the formula bar content. Locking the formula bar so that users cannot change the functional formula data type constraint, data values constraint if specified, and any options specified. However, the user can change the range input values in the cell and for that reason we call the functional formula partially locked. This is described in 7126 ‘Cell: can change the value . . . value range subject to data type constraint and values constraint if specified’. Described in 7136 is the locking of the ‘Formula bar: locked with no access by user’. Thus, describing the partial locking which is then exampled in the three examples that follow in FIG. 71. Note a different embodiments of our technology would allow locked user access to only the ‘value . . . value’ argument, and its equivalent argument in the other INPUT family of functions, in the formula bar but not to the other arguments or argument groups.

In the first example in FIG. 71 the user has locked the formula ‘=INPUT RANGE’ 7144. In the cell the user then sees the same ‘Input text . . . text range’ 7143 instruction they saw before the locking. However, in the formula bar 7148 they see the formula ‘=INPUT_RANGE’ changed to light grey and accompanied by a lock, both indicating in this embodiment that the user cannot change them. Note, our technology supports other ways of informing the user of what is locked but for clarity of demonstrating the functionality we will consistently uses the greying and the lock throughout the filing. When the user attempts to reopen the cell, in this embodiment, the user gets the cursor in an otherwise empty cell 7153 ready for an input just like it functioned before locking. However, they are unable to click into the formula bar 7158 and in embodiments later exampled get a locking alert.

In the second example in FIG. 71 the user has locked the formula ‘=INPUT_RANGE’ 7164. In the cell the user then sees the same ‘Input number . . . number range’ 7163 instruction they saw before the locking. However, in the formula bar 7168 they see the formula ‘=INPUT_RANGE’ changed to light gray and accompanied by a lock both indicating in this embodiment that the user cannot change them. When the user attempts to reopen the cell in this embodiment the user gets the cursor in an otherwise empty cell 7172 ready for an input just like it functioned before locking. However, they are unable to click into the formula bar 7178 and in embodiments later exampled get a locking alert.

In the third example in FIG. 71 the user has locked the formula ‘=INPUT_RANGE’ 7184. In the cell the user then sees the same date range ‘1/7/2’ . . . 2/7/23’ 7183 that they saw before the locking. However, in the formula bar 7188 they see the formula ‘=INPUT_RANGE’ changed to light grey and accompanied by a lock, both indicating in this embodiment that the user cannot change them. When the user attempts to reopen the cell in this embodiment the user gets the cursor with the current value ‘1/7/23 . . . 2/7/23’ 7193 ready for changing just like it functioned before locking. However, they are unable to click into the formula bar 7198 and in embodiments later exampled get a locking alert.

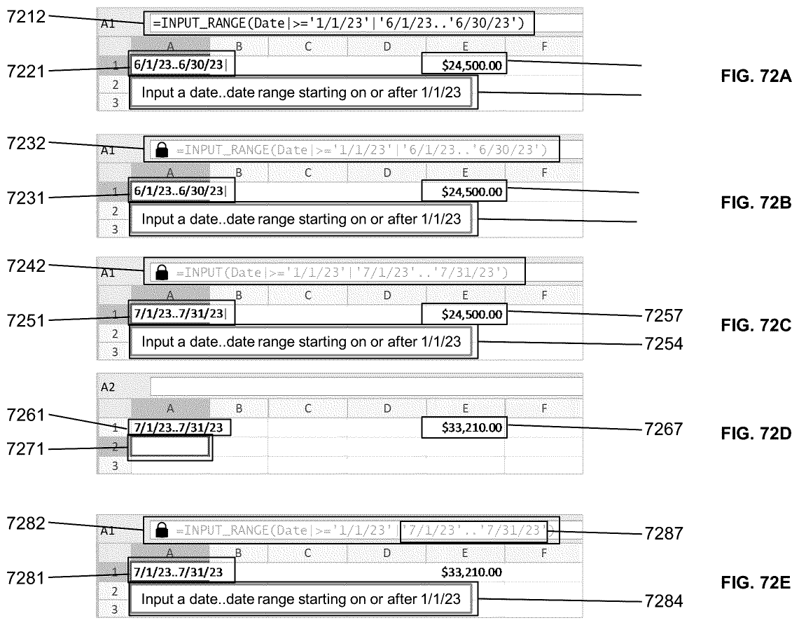

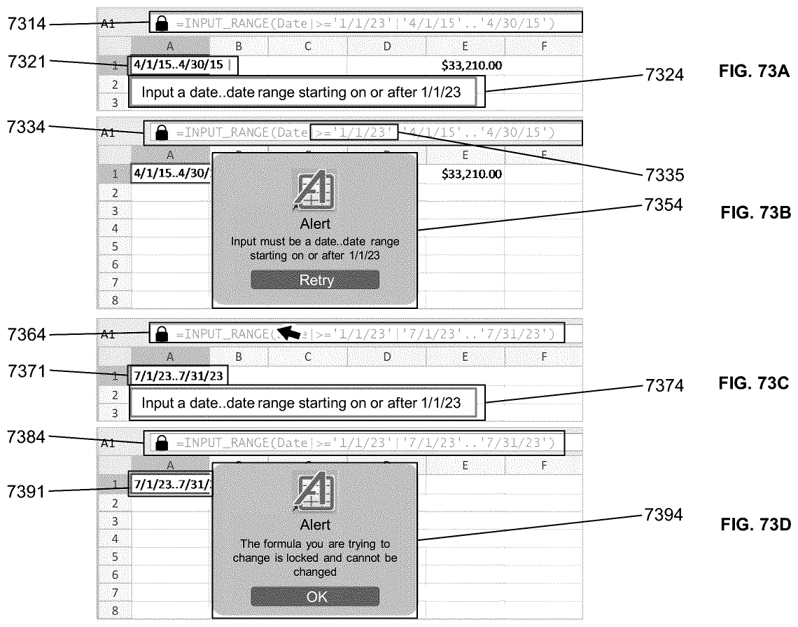

FIG. 72A through FIG. 73D examples in greater depth some of the feature and functionality of the range differential input validation function locking. It starts with a user locking cell ‘A1’ 7221 in FIG. 72A which contains one of our differential input range validation functions with the formula ‘=INPUT_RANGE’ 7221. There are many ways for a user to lock a formula, such as those exampled in FIG. 65A and FIG. 65B, and one of those or a similar set of actions resulted in the partial locking of the functional formula 7232 in cell ‘A1’ 7231 in FIG. 72B. That locked functional formula presents the automatically generated tailored input message 7234 which is identical the input message 7224 in FIG. 72A of the formula before it was locked. The locking does also not impact the usage of the range values in the locked cell ‘A1’ 7231 in FIG. 72B by the functional formula in cell ‘E1’ 7237 which generates the same value ‘$24,500.00’ post the locking of cell ‘A1’ 7231 as it in did ‘E1’ 7227 in FIG. 72A pre the locking of cell ‘A1’. Where our partial locking does not alter the ability of other locked or unlocked cells to successfully reference the locked differential input validation function value or values for use in cell formulas.

The partial locking allows the user to change the range values in cell ‘A1’ 7231 in FIG. 72B despite the formula bar formula 7232 displaying the locking lock and the formula being disabled. The user then changes the date range ‘6/1/23 . . . 6/30/23′ 7231 in FIG. 72B to ‘7/1/23 . . . 7/31/23′ 7252 in FIG. 72C, and hits ENTER to get the changed value exampled in 7261 in FIG. 72D. That change has then automatically propagated to the formula in ‘E1’ using the now changed value in ‘A1’, so that the ‘E1’ value changes to ‘$33,210.00’ 7267 from the value ‘$24,500.00’ 7257 in FIG. 72C pre the change. Exampling how the partially locked cell with our differential input validation function supports changed values which then can be used in the cell formulas in other locked or unlocked cell. The differential input validation function range values constitute a set of values which can be used in other cell formulas by referencing the cell. When the user re-highlights the cell ‘A1’ 7281 in FIG. 72E you can see that the changed range values ‘7/1/23 . . . 7/31/23’ 7281 in the cell ‘A1’ have also been automatically changed 7287 in the formula bar formula 7282. Note, our technology supports locked versions of our INPUT family of functions with invisible value arguments in the formula bar formula is/are only visible in the cell).

FIG. 73A and FIG. 73B example how post locking our differential input range validation function rejection or warning alert work just as they did before locking. In this embodiment if the user attempts in FIG. 73A to enter the date range ‘4/1/15 . . . 4/20/15’ 7321 into the cell ‘A1’ 7231 which started as cell ‘A1’ 7281 from FIG. 72E it fails the data values validation of ‘>=‘1/1/23’’ 7335 and automatically generates the rejection ‘Alert’ 7354 with the automatically constraint validation tailored text ‘Input must be a date range starting on or after 1/1/23’ as it would if it were unlocked. Leaving the user to ‘Retry’ the input until they get a validate date as they would be doing if the formula were unlocked. Thus, the unlocked part of the partial locking.

FIG. 73C and FIG. 73D examples one embodiment of what happens post locking if the user attempts to enter the formula bar. In this embodiment when the user attempts to enter the formula bar 7364 in FIG. 73C it automatically triggers an ‘Alert’ popup 7394 in FIG. 73D with a message telling the user “The formula you are trying to change is locked and cannot be changed’ or something similar informing them of the locking and possibly telling them how to unlock the cell. This is very different than what would happen in the unlock state and blocks the user from changing the formula, thus the locked part of the partial locking.

The overall takeaway on our partial locking of our differential input validation family of functions is that the value or value inputs work just as they did before locking and the formula input does not and is locked. Rather than exampling that further we will move on to how formula hiding works in combination with our partial locking for a multiple values set differential input validation function, in this example the range version.

### Differential Input Range Validation Function—Partial Locking and Formula Hiding

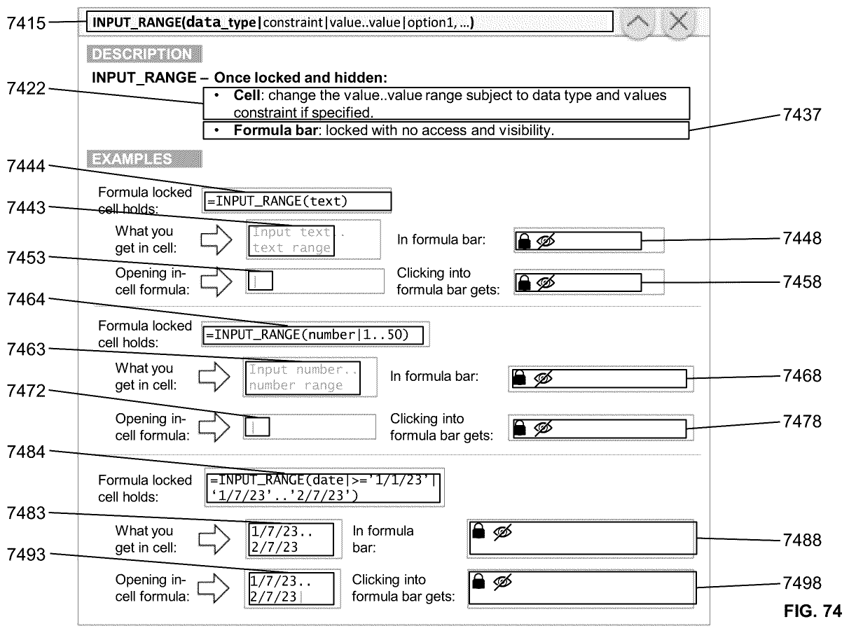

FIG. 74 examples our partial locking capability for the multiple values set range differential input validation function with formula hiding. It describes about once the cell is locked and hidden how it differentially impacts the cell and the formula bar content and, in this embodiment, hiding and locking the formula bar content. Thus, offering the user no opportunity to see or change the formula content. This is described in 7422 ‘Cell: can change the value . . . value range subject to data type constraint and values constraint if specified. Described in 7437 is the ‘Formula bar: locked with no access and visibility.’. Thus, describing the partial locking with the formula hiding which is then exampled in the three examples that follow in FIG. 74.

In the first example in FIG. 74 the user has locked and hidden the formula ‘=INPUT_RANGE’ 7444. In the cell the user then sees the same ‘Input text . . . text range’ 7443 instruction they saw before the locking and hiding. However, in the formula bar 7448 they see nothing but lock and slash eye icons, the first indicating the locking and the second indicating the hiding. This is different than what they saw pre-locking and hiding where they instead saw the functional formula and where able to change it. Note, our technology supports other ways of informing the user of what is locked and hidden but for clarity of demonstrating the functionality we are consistently using the lock and slash eye icons throughout the filing. When the user attempts to reopen the cell in this embodiment the user gets the cursor in an otherwise empty cell 7453 ready for a range input just like it functioned before locking and hiding. However, they are unable to click into the formula bar 7458 and like the similar single value input embodiments previously exampled in FIG. 70C and FIG. 70D get a locking and hiding alert. They do not see the validation formula which makes the automatically generated validation input message even more valuable to the user.

In the second example in FIG. 74 the user has locked and hidden the formula ‘=INPUT_RANGE’ 7464. In the cell the user then sees the same ‘Input number . . . number range’ 7463 instruction they saw before the locking and hiding. However, in the formula bar 7468 they see nothing but lock and slash eye icons, the first indicating the locking and the second the hiding. When the user attempts to reopen the cell in this embodiment the user gets the cursor in an otherwise empty cell 7472 ready for an input just like it functioned before locking and hiding. However, they are unable to click into the formula bar 7478 and continue to see no formula and in embodiments previously exampled get a locking and hiding alert.

In the third example in FIG. 74 the user has locked the formula ‘=INPUT_RANGE’ 7484. In the cell the user then sees the same date range ‘1/7/23 . . . 2/7/23’ 7483 that they saw before the locking and hiding. However, in the formula bar 7488 they see nothing but lock and slash eye icons, the first indicating the locking and the second the hiding. They see no formula. When the user attempts to reopen the cell in this embodiment the user gets the cursor with the currently populate date range ‘1/7/23 . . . 2/7/23’ 7493 ready for changing just like it functioned before locking. However, they are unable to click into the formula bar 7498 and continue to see no formula and like in embodiments previously exampled get a locking alert.

### Differential Input Multiple Value Validation Function—Partial Locking

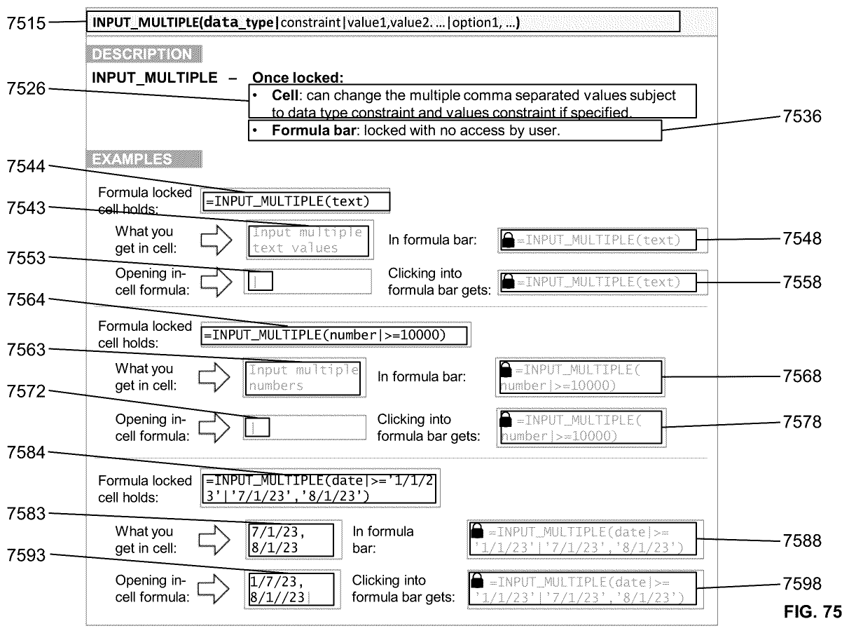

FIG. 75 examples our partial locking capability for the multi value differential input validation function. It works in a similar way to the partial locking of the previously exampled INPUT functions. It describes about how once the cell is locked the locking differently impacts the cell and the formula bar content. Locking the formula bar so that users cannot change the functional formula data type constraint, data values constraint if specified, and any options specified. However, the user can change the range input values in the cell and for that reason we call the functional formula partially locked. This is described in 7526 ‘Cell: can change the multiple comma separated values subject to data type constraint and values constraint if specified’. Described in 7536 is the locking of the ‘Formula bar: locked with no access by user’. Thus, describing the partial locking which is then exampled in the three examples that follow in FIG. 75. Note a different embodiments of our technology would allow locked cell/functional formula user access to only the ‘value1, value2, . . . ’ multiple values argument in the formula bar but not to the other arguments/argument groups. Thus, maintaining the partial locking but in this embodiment locking some but not all of the functional formula arguments.

In the first example in FIG. 75 the user has locked the formula ‘=INPUT_MULTIPLE’ 7544. In the cell the user then sees the same ‘Input multiple text values’ 7543 instruction they saw before the locking. However, in the formula bar 7548 they see the formula ‘=INPUT_MULTIPLE’ changed to light grey and accompanied by a lock, both indicating in this embodiment that the user cannot change them. This is different than what they saw pre-locking where they instead saw the functional formula and where able to change it. Note, our technology supports other ways of informing the user of what is locked but for clarity of demonstrating the functionality we have consistently used the greying and the lock throughout the filing. When the user attempts to reopen the cell, in this embodiment, the user gets the cursor in an otherwise empty cell 7553 ready for multiple text inputs comma separated just like it functioned before locking. However, they are unable to click into the formula bar 7558 and in other embodiments get a locking alert as previously exampled for the INPUT and INPUT_RANGE locked functions.

In the second example in FIG. 75 the user has locked the formula ‘=INPUT_MULTIPLE’ 7564. In the cell the user then sees the same ‘Input multiple numbers’ 7563 instruction they saw before the locking. However, in the formula bar 7568 they see the formula ‘=INPUT_MULTIPLE’ changed to light gray and accompanied by a lock both indicating in this embodiment that the user cannot change them. When the user attempts to reopen the cell in this embodiment the user gets the cursor in an otherwise empty cell 7572 ready for multiple number inputs comma separated just like it functioned before locking. However, they are unable to click into the formula bar 7578 and in other embodiments get a locking alert as previously exampled for the INPUT and INPUT_RANGE locked functions.

In the third example in FIG. 75 the user has locked the formula ‘=INPUT_MULTIPLE’ 7584. In the cell the user then sees the same set of two dates ‘1/7/23,8/1/23’ 7583 that they saw before the locking. However, in the formula bar 7588 they see the formula ‘=INPUT_MULTIPLE’ changed to light grey and accompanied by a lock, both indicating in this embodiment that the user cannot change them. When the user attempts to reopen the cell in this embodiment the user gets the cursor with the current values ‘1/7/23,8/1/23’ 7593 ready for changing just like it functioned before locking. However, they are unable to click into the formula bar 7598 and in embodiments similar to those previously exampled, for the INPUT and INPUT_RANGE functions, get a locking alert.

### Differential Input Multiple Value Validation Function—Partial Locking and Formula Hiding

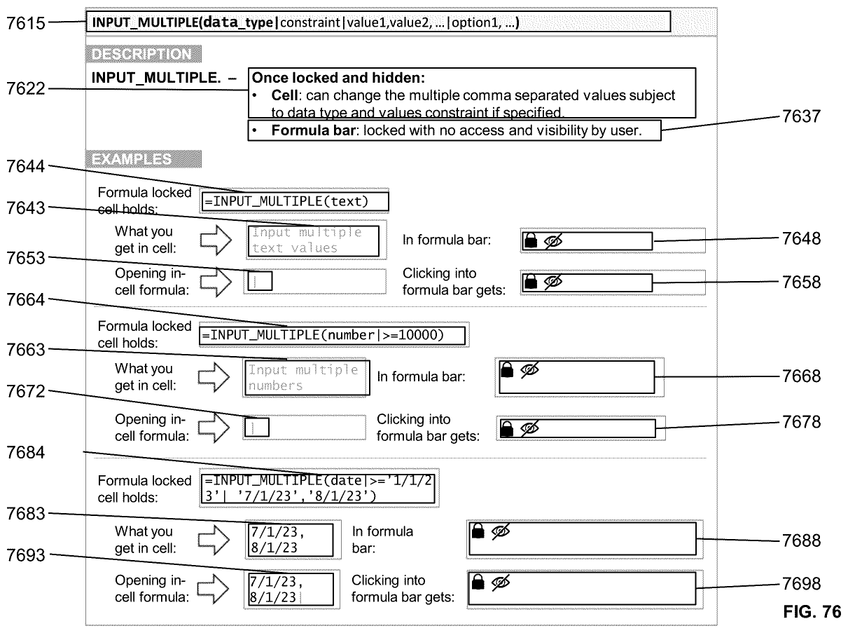

FIG. 76 examples our partial locking and formula hiding capability for the inequality differential input validation function. It describes about once the cell is locked how it differentially impacts the cell and the formula bar content and, in this embodiment, hiding and locking the formula bar content. Thus, offering the user no opportunity to see or change the formula content. This is described in 7622 ‘Cell: can change the multiple comma separated values subject to data type constraint and values constraint if specified’. Described in 7637 is the ‘Formula bar: locked with no access and visibility by user.’. Thus, describing the partial locking with the formula hiding which is then exampled in the three examples that follow in FIG. 76.

In the first example in FIG. 76 the user has locked and hidden the formula ‘=INPUT_MULTIPLE’ 7644. In the cell the user then sees the same ‘Input multiple text values’ 7643 instruction they saw before the locking. However, in the formula bar 7648 they see nothing but lock and slash eye icons, the first indicating the locking and the second indicating the hiding. This is different than what they saw pre-locking and hiding where they instead saw the functional formula and where able to change it. Note, our technology supports other ways of informing the user of what is locked and hidden but for clarity of demonstrating the functionality we are consistently using the lock and slash eye icons throughout the filing. When the user attempts to reopen the cell in this embodiment the user gets the cursor in an otherwise empty cell 7653 ready for a multiple value input just like it functioned before locking and hiding. However, they are unable to click into the formula bar 7658, and like the similar single value input embodiments previously exampled in FIG. 70C and FIG. 70D, get a locking and hiding alert. They do not see the validation formula, thus making the automatically generated validation input message very valuable to the user.

In the second example in FIG. 76 the user has locked and hidden the formula ‘=INPUT_MULTIPLE’ 7664. In the cell the user then sees the same ‘Input multiple numbers’ 7663 instruction they saw before the locking and hiding. However, in the formula bar 7668 they see nothing but lock and slash eye icons, the first indicating the locking and the second the hiding. When the user attempts to reopen the cell in this embodiment the user gets the cursor in an otherwise empty cell 7672 ready for an input just like it functioned before locking and hiding. However, they are unable to click into the formula bar 7678 and continue to see no formula and in embodiments previously exampled get a locking and hiding alert.

In the third example in FIG. 76 the user has locked the formula ‘=INPUT_MULTIPLE’ 7684. In the cell the user then sees the same two comma separated dates ‘1/7/23,8/1/23’ 7683 that they saw before the locking and hiding. However, in the formula bar 7688 they see nothing but lock and slash eye icons, the first indicating the locking and the second the hiding. They see no formula. When the user attempts to reopen the cell in this embodiment the user gets the cursor with the currently populated two dates ‘1/7/23,8/1/23’ 7693 ready for changing just like it functioned before locking and hiding. However, they are unable to click into the formula bar 7698 and continue to see no formula, and as in the embodiments previously exampled get a locking alert.

### Differential Input Inequality Validation Function—Partial Locking

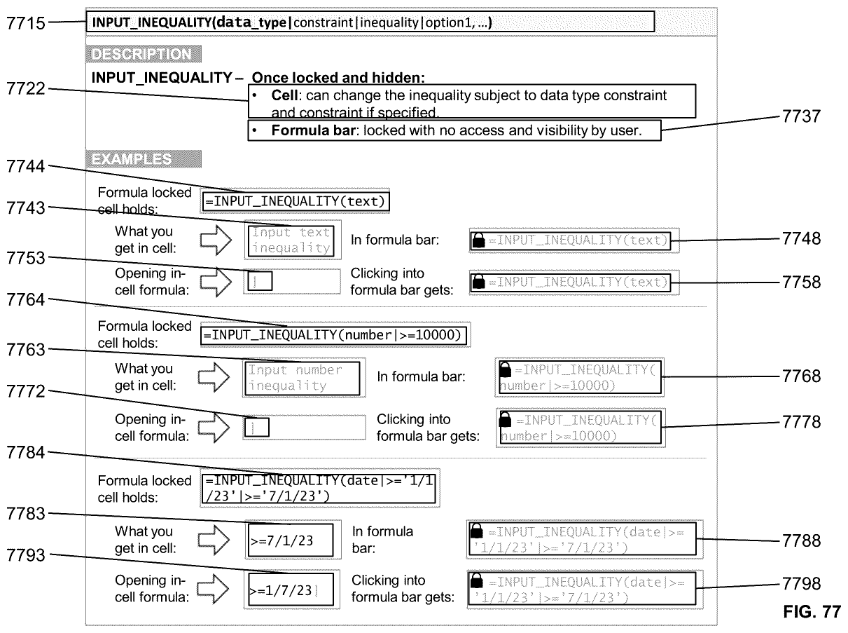

FIG. 77 examples our partial locking capability for the inequality differential input validation function. It works in a similar way to the partial locking of the previously exampled INPUT functions. It describes about how once the cell is locked the locking differently impacts the cell and the formula bar content. Locking the formula bar so that users cannot change the functional formula data type constraint, data values constraint if specified, and any options specified. However, the user can change the inequality value being validated in the cell and for that reason we call the functional formula partially locked. This is described in 7722 ‘Cell: can change the inequality subject to data type constraint and values constraint if specified’. Described in 7737 is the locking of the ‘Formula bar: locked with no access by user’. Thus, describing the partial locking which is then exampled in the three examples that follow in FIG. 77. Note a different embodiments of our technology would allow locked cell/functional formula user access to only the ‘inequality’ argument in the formula bar but not to the other arguments/argument groups. Thus, maintaining the partial locking but in that embodiment locking some but not all of the functional formula arguments.

In the first example in FIG. 77 the user has locked the formula ‘=INPUT_INEQUALITY’ 7744. In the cell the user then sees the same ‘Input text inequality’ 7743 instruction they saw before the locking. However, in the formula bar 7748 they see the formula ‘=INPUT_INEQUALITY’ changed to light grey and accompanied by a lock, both indicating in this embodiment that the user cannot change them. This is different than what they saw pre-locking where they were able to change the formula. Note, our technology supports other ways of informing the user of what is locked but for clarity of demonstrating the functionality we consistently use the greying and the lock throughout the filing. When the user attempts to reopen the cell, in this embodiment, the user gets the cursor in an otherwise empty cell 7753 ready for input of an inequality just like it functioned before locking. However, they are unable to click into the formula bar 7758 and get a locking alert as previously exampled for the INPUT and INPUT_RANGE locked functions.

In the second example in FIG. 77 the user has locked the formula ‘=INPUT_INEQUALITY’ 7764. In the cell the user then sees the same ‘Input number inequality’ 7763 instruction they saw before the locking. However, in the formula bar 7768 they see the formula ‘=INPUT_INEQUALITY’ changed to light gray and accompanied by a lock both indicating in this embodiment that the user cannot change them. When the user attempts to reopen the cell in this embodiment the user gets the cursor in an otherwise empty cell 7772 ready for an inequality input just like it functioned before locking. However, they are unable to click into the formula bar 7778 and in other embodiments get a locking alert as previously exampled for the INPUT and INPUT_RANGE locked functions.

In the third example in FIG. 77 the user has locked the formula ‘=INPUT_INEQUALITY’ 7784. In the cell the user then sees the same inequality ‘>=1/7/23’ 7783 that they saw before the locking. However, in the formula bar 7788 they see the formula ‘=INPUT_INEQUALITY’ changed to light grey and accompanied by a lock, both indicating in this embodiment that the user cannot change them. When the user attempts to reopen the cell in this embodiment the user gets the cursor with the inequality value ‘>=1/7/23’ 7793 ready for changing just like it functioned before locking. However, they are unable to click into the formula bar 7798 and, as previously exampled for the INPUT and INPUT_RANGE functions, get a locking alert.

### Differential Input Inequality Validation Function—Partial Locking and Formula Hiding

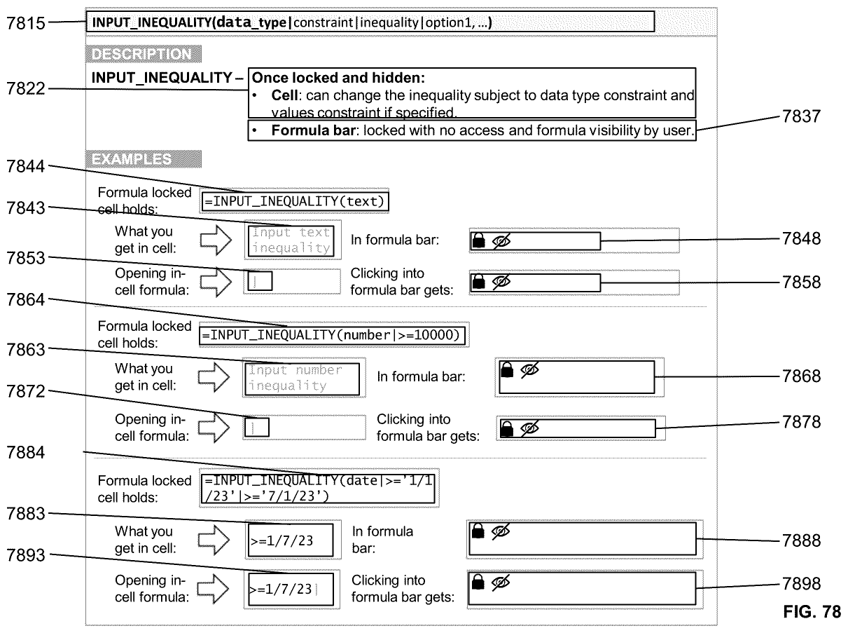

FIG. 78 examples our partial locking and formula hiding capability for the discretely entered multiple values set differential input validation function. It describes how once the cell is locked and formula hidden, how it differentially impacts the cell and the formula bar content. Thus, offering the user no opportunity to see or change the formula content. This is described in 7822 ‘Cell: can change the inequality subject to data type constraint and values constraint if specified’. Described in 7837 is the ‘Formula bar: locked with no access and formula visibility by user.’. Thus, describing the partial locking with the formula hiding which is then exampled in the three examples that follow in FIG. 78.

In the first example in FIG. 78 the user has locked and hidden the formula ‘=INPUT_INEQUALITY’ 7844. In the cell the user then sees the same ‘Input text inequality’ 7843 instruction they saw before the locking and hiding. However, in the formula bar 7848 they see nothing but lock and slash eye icons, the first indicating the locking and the second indicating the hiding. This is different than what they saw pre-locking and hiding where they instead saw the functional formula and where able to change it. Note, our technology supports other ways of informing the user of what is locked and hidden but for clarity of demonstrating the functionality we have consistently used the lock and slash eye icons throughout the filing. When the user attempts to reopen the cell in this embodiment the user gets the cursor in an otherwise empty cell 7853 ready for inequality input just like it functioned before locking and hiding. However, they are unable to click into the formula bar 7858 and like the similar single value input embodiments previously exampled in FIG. 70C and FIG. 70D get a locking and hiding alert. They do not see the validation formula, thus making the automatically generated validation input message very valuable to the user.

In the second example in FIG. 78 the user has locked and hidden the formula ‘=INPUT_INEQUALITY’ 7864. In the cell the user then sees the same ‘Input number inequality’ 7863 instruction they saw before the locking and hiding. However, in the formula bar 7868 they see nothing but lock and slash eye icons, the first indicating the locking and the second the hiding. When the user attempts to reopen the cell in this embodiment the user gets the cursor in an otherwise empty cell 7872 ready for an input just like it functioned before locking and hiding. However, they are unable to click into the formula bar 7878 and continue to see no formula and in embodiments previously exampled get a locking and hiding alert.

In the third example in FIG. 78 the user has locked the formula ‘=INPUT_INEQUALITY’ 7884. In the cell the user then sees the same inequality ‘>=1/7/23’ 7883 that they saw before the locking and hiding. However, in the formula bar 7888 they see nothing but lock and slash eye icons, the first indicating the locking and the second the hiding. They see no formula. When the user attempts to reopen the cell in this embodiment the user gets the cursor with the currently populated inequality ‘>=1/7/23’ 7893 ready for changing just like it functioned before locking and hiding. However, they are unable to click into the formula bar 7898 and continue to see no formula and as in the embodiments previously exampled get a locking alert.

While we could example many more differential input validation function situations and mix and match combination of features, we will instead move on to how our regular input validation function operates.

### Regular Input Validation Family of Functions

Our technology supports regular versions of our family of prebuilt input validation functions which at the slight risk of confusion we will also name INPUT, INPUT_RANGE, INPUT_MULTIPLE, and INPUT_INEQUALITY. We do that because while they operate differently, they produce the same desired input validation end result. However, they clearly could be named differently and certainly would be named differently if they were to coexist in a spreadsheet with the differential input validation functions. They operate like a regular spreadsheet function where both the in-cell and formula bar inputs accept the same formula input all the time. However, beyond that difference in how the inputs operate, the formula arguments function in the same way with similar mix and match features.

### Regular Input Validation Family of Functions—Single Value

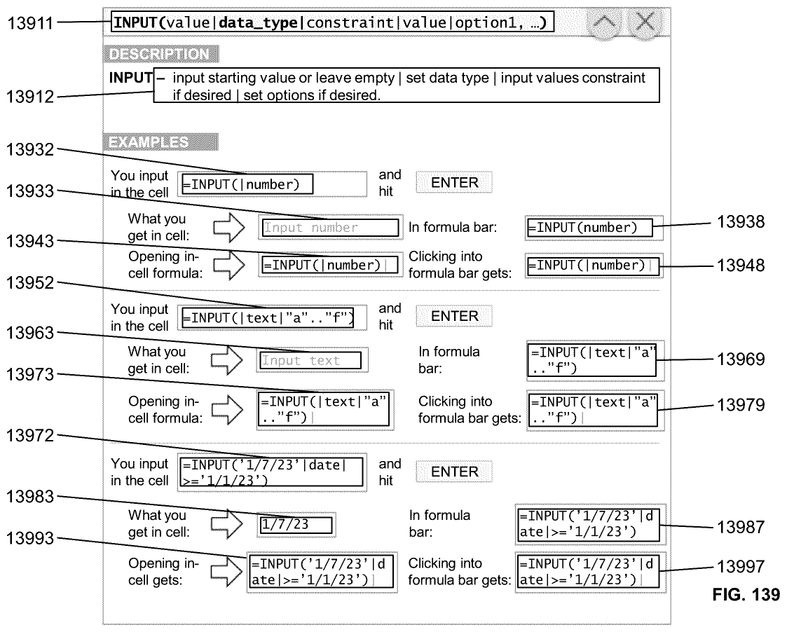

FIG. 139 examples our single value regular input validation prebuilt spreadsheet function. It lays out an embodiment with a function name of ‘INPUT’, although it could have any name although one not already used by another spreadsheet function. It has a syntax exampled in 13911 in FIG. 139 employing four argument groups divided by three vertical bars ‘1’. Although it could have easily been three fixed order arguments with a fourth and beyond optional arguments, e.g., INPUT. And of course, a variant of the function could be without the optional argument group or arguments. As mentioned previously our technologies support the arguments in a different order.

FIG. 139 examples the function setup ‘DESCRIPTION’ 13912 instructions of use for creating the formula directly in the cell or indirectly in the cell via the formula bar in this embodiment. It instructs the user to ‘input starting value or leave empty’ in the first argument group, ‘set data type’ in the second argument group, ‘input value constraint if desired’ in the third argument group and ‘set options if desired’ in the fourth argument group. It bolds the ‘data type’ argument in the syntax 13911 as the only required argument/argument group although the ‘value’ argument/argument group could also be required. FIG. 139 then displays three examples showing our regular input validation functions operate in-cell/formula bar input-wise like a typical current spreadsheet function where both of those inputs always accept the same formula input.

In the first example in FIG. 139 the user has typed or otherwise inputted the formula ‘=INPUT’ 13932 into a cell and hit ‘ENTER’ to get ‘Input number’ 13933 in the cell in light gray text as an instruction as to what to do for the cell input in this embodiment. In the formula bar they get the cell formula ‘=INPUT’ 13938. Note, the ‘INPUT’ function that the user created limits the inputs to number values. In other embodiments the cell post formula with no specified value could have populated with something else, been blank, or as previously exampled be differentiated in some other way to indicate to the user it is an input function populated cell. Different embodiments would make an initial value input required eliminating the empty option. In this embodiment, if the user then reopens the cell in this embodiment the user gets the formula ‘=INPUT’ 13943 with the cursor wherever the user positioned it. This is identical to what the user gets if they click into the formula bar 13948. In both situations the user is ready to edit the formula.

In the second example in FIG. 139 the user has typed or otherwise inputted the formula ‘=INPUT’ 13952 into a cell and hit ‘ENTER’ to get ‘Input text’ 13963 displayed in the cell in light gray text as an instruction as to what to do for the cell input. In other embodiments the cell could have populated with something else, been blank, or as previously exampled be differentiated in some other way to indicate to the user it is an input function populated cell. Note, the user has not only limited the input to text but to text within the range ‘“a” . . . “f”. In the formula bar they get the cell formula ‘=INPUT’ 13969. If the user then reopens the cell in this embodiment the user gets the formula ‘=INPUT’ 13973 with the cursor wherever the user positioned it. This is identical to what the user gets if they click into the formula bar 13979. In both situations the user is ready to edit the formula.

In the third example in FIG. 139 the user has typed or otherwise inputted the formula ‘=INPUT’ 13972 into a cell and hit ‘ENTER’ to get in this embodiment ‘1/7/23’ 13983 as the existing value in the cell. Note, the user has not only limited the input to date inputs but to dates starting on or after ‘1/1/23’. In the formula bar they get the cell formula ‘=INPUT’ 13987. If the user then reopens the cell in this embodiment the user gets the formula ‘=INPUT’ 13993 with the cursor wherever the user positioned it. This is identical to what the user gets if they click into the formula bar 13997. In both situations the user is ready to edit the formula, and those edits will be replicated in the other input like in a regular spreadsheet function.

All the examples in FIG. 139 showed how this set of embodiments of our validate functions operate like a regular function from an in-cell and formula bar input standpoint. We will now example how they work similar to our differential input validation functions in their validation responses to invalid value inputs.

### Regular Input Validation Function—Input Error Alert

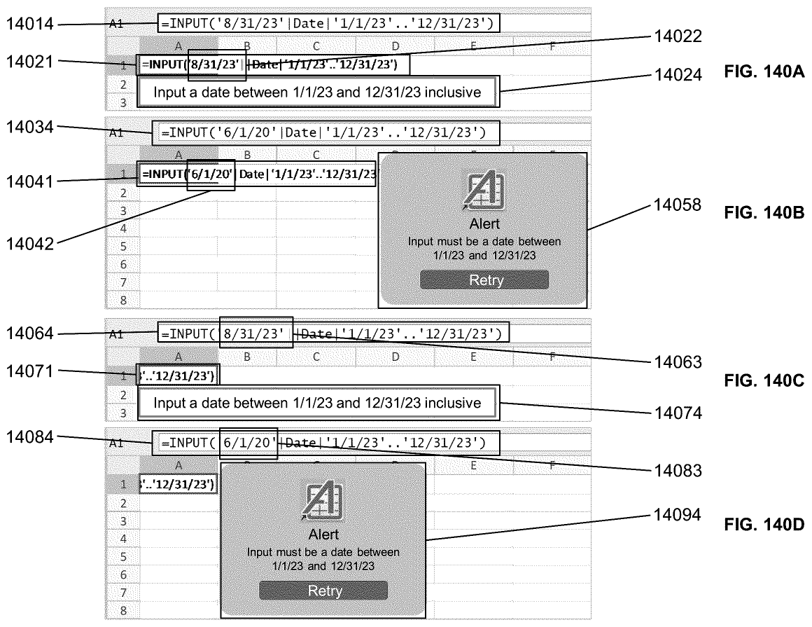

FIG. 140A examples the user reopening the cell ‘A1’ 14021 populated with the formula shown in the cell 14021 and in the formula bar 14014. The cell has the automatically generated input message 14024 adjacent to the cell. However, despite this message the user inputs a replacement date ‘6/1/20’ 14042 into the in-cell formula in cell ‘A1’ 14041 in FIG. 140B attempting to replace the date ‘8/31/23’ 14022 in the in-cell formula 14021 in cell ‘A1’ in FIG. 140A. But because that date violates the value constraint date range of ‘1/1/23’ . . . ‘12/31/23’ the automatic rejection alert 14058 displays in FIG. 140B giving an automatically situationally specific message ‘Input must be a date between 1/1/23 and 12/31/23’. At which point the user must ‘Retry’ until they input a date within the values constraint or remove the date and have no date in the cell. Note, in this embodiment the changed in-cell input of ‘6/1/20’ 14042 replicates immediately into the formula bar formula 14034, however in other embodiments the change in the formula could occur after the input is validated. Our technology has exampled its automatic situationally tailored Alert message, tailoring the message to the constraints specified in the formula. In this example ‘date’ and ‘between 1/1/23 and 12/31/23’. And where those alert messages automatically change with any changes to the data type and value constraint changes in the formula.

FIG. 140C examples the user again reopening cell ‘A1’ 14071 in the formula bar 14064. This opens the cell formula in cell ‘A1’ 14071 but like some other spreadsheets not expanding out over the other cells and showing the end of the formula. The cell has the automatically generated input message 14074 adjacent to the cell. However, despite this message the user inputs a replacement date ‘6/1/20’ 14083 into the formula bar formula 14084 for cell ‘A1’ in FIG. 14D attempting to replace the date ‘8/31/23’ 14063 in the formula bar formula 14064 for cell ‘A1’ in FIG. 140C. But because that date violates the value constraint date range of ‘1/1/23’ . . . ‘12/31/23’ the automatic rejection alert 14094 displays giving an automatically situationally specific message ‘Input must be a date between 1/1/23 and 12/31/23’. At which point the user must ‘Retry’ until they input a date within the values constraint or remove the date to have no date in the cell. Note, our technology has again exampled its automatic situationally tailored Alert message, tailoring the message to the constraints specified in the formula. In this example ‘date’ and ‘between 1/1/23 and 12/31/23’. And where those alert messages automatically change with any changes to the data type and value constraint changes in the formula.

### Regular Input Validation Function—Partial Locking

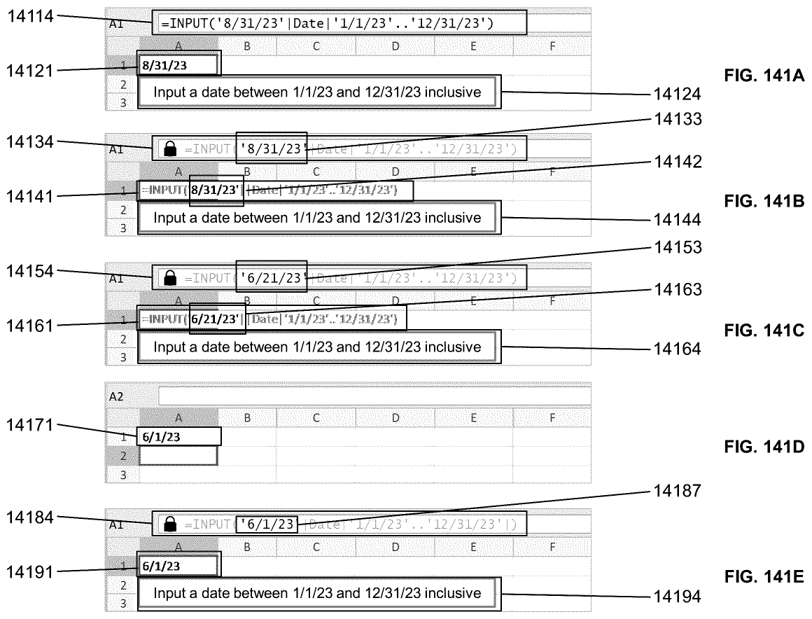

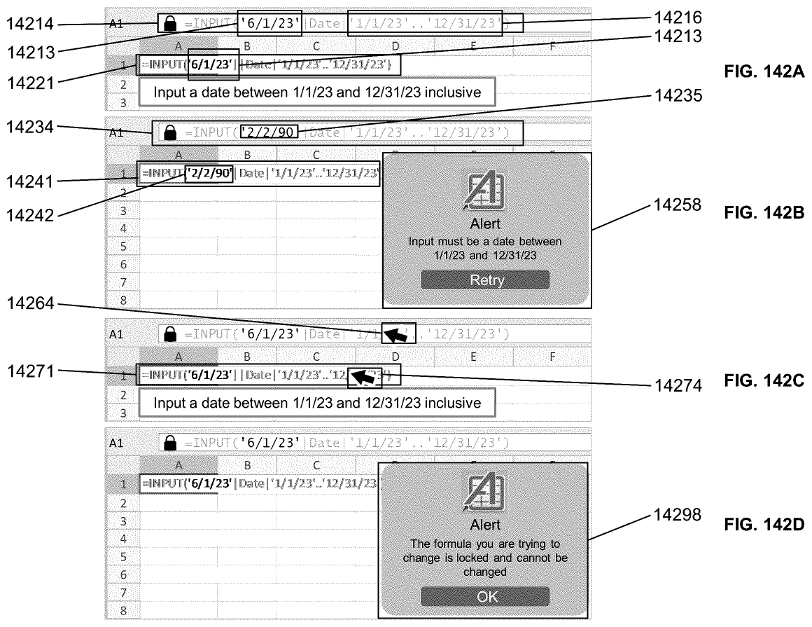

FIG. 141A through FIG. 142D examples the partial locking of our regular input validation functions. It starts with the pre-locking of cell ‘A1’ 14121 in FIG. 141A which contains one of our regular input validation functions the formula ‘=INPUT’ 14114. That functional formula presents the automatically generated tailored input message 14124. FIG. 141B examples the post partial locking of cell ‘A1’ 14141 where the user has double clicked into the in-cell formula putting the cursor just after the ‘‘8/31/23’’ 14142 black argument in the formula 14141. Where the rest of the formula 14141 is grayed out to inform the user that it is locked while the black argument ‘‘8/31/23’’ 14142 is unlocked and changeable. The same is true in the formula bar that the ‘‘8/31/23’’ 14133 black argument is unlocked and changeable while the rest of the formula 14134 is grayed out telling the user it is locked and not changeable. The user then changes the date ‘8/31/23’ 14142 in FIG. 141B to ‘6/1/23’ 14163 in FIG. 141C just as they would do in an unlocked cell/formula and hits ENTER to get the changed value exampled in 14171 in FIG. 141D. Note, in this embodiment the change of the date ‘6/21/23’ 14163 in FIG. 141C automatically replicates in the formula bar formula 14154 date ‘6/21/23’ 14153 although in other embodiments that replication occurs after the value passes validation. When the user re-highlights the cell ‘A1’ 14191 in FIG. 141E you can see that the changed value ‘6/1/23’ 14191 was also changed and saved in the formula bar formula 14184 ‘6/1/23’ 14187. The same change would have occurred had the user made the change in the formula bar from the value ‘‘8/31/23’’ 14133 in FIG. 141B to the formula bar value ‘‘6/21/23’’ 14153 in FIG. 141C as the value argument in both the in-cell formula and the formula bar formula is unlocked.

FIG. 142A and FIG. 142B example how post locking the validation rejection or warning alert work just as they did before locking for our regular input validation functions. In this embodiment if the user attempts in FIG. 142B to enter the date ‘2/2/90’ 14242 into the in-cell formula in cell ‘A1’ 14241 replacing the value ‘6/1/23’ 14223 in formula 14221 in FIG. 142A it fails the data values validation of ‘1/1/23’ . . . ‘12/31/23’ 14216 in the formula 14214 and automatically generates the rejection ‘Alert’ 14258 exampled in FIG. 142B with the automatically constraint validation tailored text ‘Input must be a date between 1/1/23 an 12/31/23’. This is just as it would operate if the cell/formula were unlocked. Leaving the user to ‘Retry’ the input until they get a validate date. The same result would occur if the user attempted to enter the date ‘2/2/90’ 14235 in FIG. 142B into the formula bar formula 14234 for cell ‘A1’ 14241 replacing the value ‘6/1/23’ 14213 in the formula bar 14214 in FIG. 142A.

FIG. 142C and FIG. 142D examples one embodiment of what happens post locking if the user attempts to enter the locked arguments in the formula bar. In this embodiment when the user attempts to enter the formula bar grayed locked argument 14264 in FIG. 142C our technology automatically triggers an ‘Alert’ popup 14298 in FIG. 142D with a message telling the user “The formula you are trying to change is locked and cannot be changed” or something similar informing them of the locking and possibly telling them how to unlock the cell. The same result would occur if the user attempted to enter the in-cell formula 14271 grayed locked argument 14274 in FIG. 142C. The user would trigger the ‘Alert’ popup 14298 in FIG. 142D with a message telling the user “The formula you are trying to change is locked and cannot be changed” or something similar informing them of the locking and possibly telling them how to unlock the cell.

While we could example many more regular single value input validation function situations and mix and match combination of features, we will instead move on to how our regular multi-value input validation functions work.

### Regular Input Validation Function—Range Input

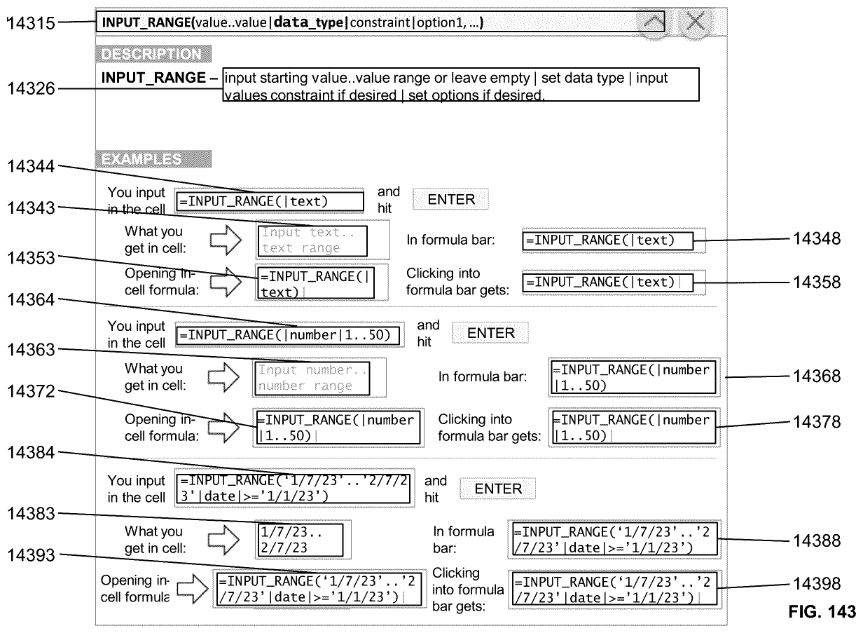

FIG. 143 examples our multiple set of values regular range input validation prebuilt spreadsheet function. It lays out an embodiment with a function name of ‘INPUT_RANGE’, although it could have any name although preferably one not already used by another spreadsheet function. It has a syntax exampled in 14315 in FIG. 143 employing four argument groups divided by three vertical bars ‘1’. Although it could have easily been three fixed order arguments with a fourth and beyond optional arguments, e.g., INPUT_RANGE. And of course, a variant of the function could be without the optional argument group or arguments. As mentioned previously the arguments could be in a different order. Note the range input function could be an option within a single function accepting all the different types of inputs, e.g., the single input, the range input, multiple discrete values inputs, and the inequality input.

FIG. 143 examples the function setup ‘DESCRIPTION’ 14326 instructions of use for creating the formula directly in the cell or indirectly in the cell via the formula bar in this embodiment. It instructs the user to ‘input starting value . . . value range or leave empty’ in the first argument group, ‘set data type’ in the second argument group, ‘input value constraint if desired’ in the third argument group and ‘set options if desired’ in the fourth argument group. It bolds the ‘data type’ argument in the syntax 14315 as the only required argument/argument group although the ‘value . . . value’ argument/argument group could also be required. FIG. 143 then displays three examples showing our regular range input validation functions operate in-cell/formula bar input-wise like a typical current spreadsheet function where both of those inputs always accept the same formula input.

In the first example in FIG. 143 the user has typed or otherwise inputted the formula ‘=INPUT_RANGE’ 14334 into a cell and hit ‘ENTER’ to get ‘Input text . . . text range’ 14343 in the cell in light gray text as an instruction as to what to do for the cell input in this embodiment. Note, the ‘INPUT_RANGE’ function that the user created limits the inputs to text values. In other embodiments the cell post a completed formula with no specified value could be populated with something else, be blank, or as previously exampled be differentiated in some other way to indicate to the user it is an input function populated cell. Different embodiments would make an initial value input required eliminating the empty option. In the formula bar they get the cell formula ‘=INPUT_RANGE’ 14348. In this embodiment, if the user then reopens the cell in this embodiment the user gets the formula ‘=INPUT_RANGE’ 14353 with the cursor wherever the user positioned it. This is identical to what the user gets if they click into the formula bar 14358. In both situations the user is ready to edit the entire formula.

In the second example in FIG. 143 the user has typed or otherwise inputted the formula ‘=INPUT_RANGE’ 14364 into a cell and hit ‘ENTER’ to get ‘Input number . . . number range’ 14363 displayed in the cell in light gray text as an instruction as to what to do for the cell input. In other embodiments the cell could have populated with something else, been blank, or as previously exampled be differentiated in some other way to indicate to the user it is an input function populated cell. Note, the user has not only limited the input to numeric ranges but to numeric ranges within the range ‘1 . . . 50’. In the formula bar they get the cell formula ‘=INPUT_RANGE’ 14368. If the user then reopens the cell in this embodiment the user gets the formula ‘=INPUT_RANGE’ 14372 with the cursor wherever the user positioned it. This is identical to what the user gets if they click into the formula bar 14378. In both situations the user is ready to edit the entire formula.

In the third example in FIG. 143 the user has typed or otherwise inputted the formula ‘=INPUT’ 14384 into a cell and hit ‘ENTER’ to get in this embodiment ‘1/7/23 . . . 2/7/23’ 14383 as the existing values in the cell. Note, the user has not only limited the input to date inputs but to dates starting on or after 1/1/23. In the formula bar they get the cell formula ‘=INPUT’ 14388. If the user then reopens the cell in this embodiment the user gets the formula ‘=INPUT’ 14393 with the cursor wherever the user positioned it. This is identical to what the user gets if they click into the formula bar 14398. In both situations the user is ready to edit the entire formula, and those edits will be replicated in the other input like in a regular spreadsheet function. Note the range within the cell could be populated in some other manner than just the ‘1/7/23 . . . 2/7/23’, it could be populated in an “RANGE” function such as ‘RANGE’ as a further way of differentiating it from what otherwise could be mistaken for text ‘1/7/23 . . . 2/7/23’.

All the examples in FIG. 143 showed how this set of embodiments of our validate functions operate like a regular function from an in-cell and formula bar input standpoint. We will now example how they when locked.

### Regular Input Validation Function—Range Input Partial Locking

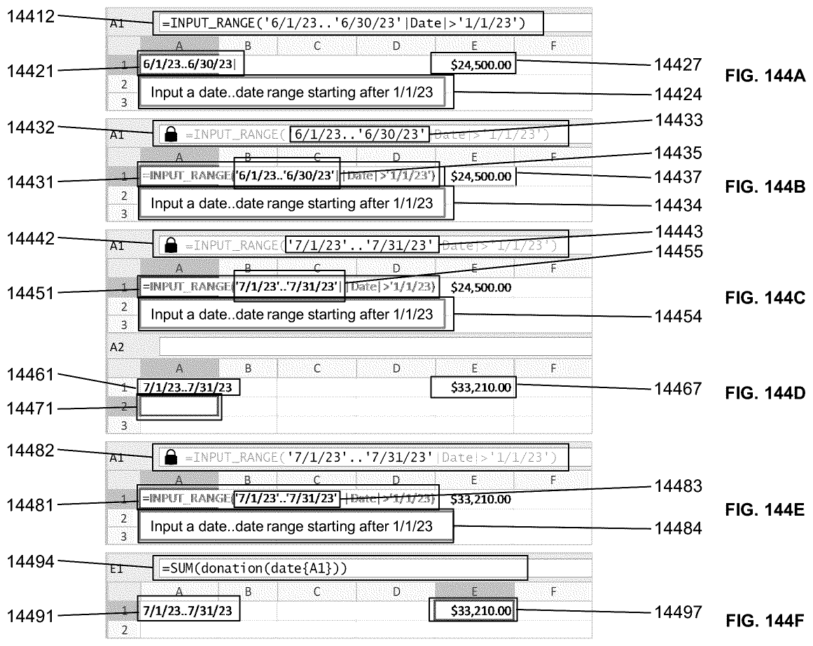

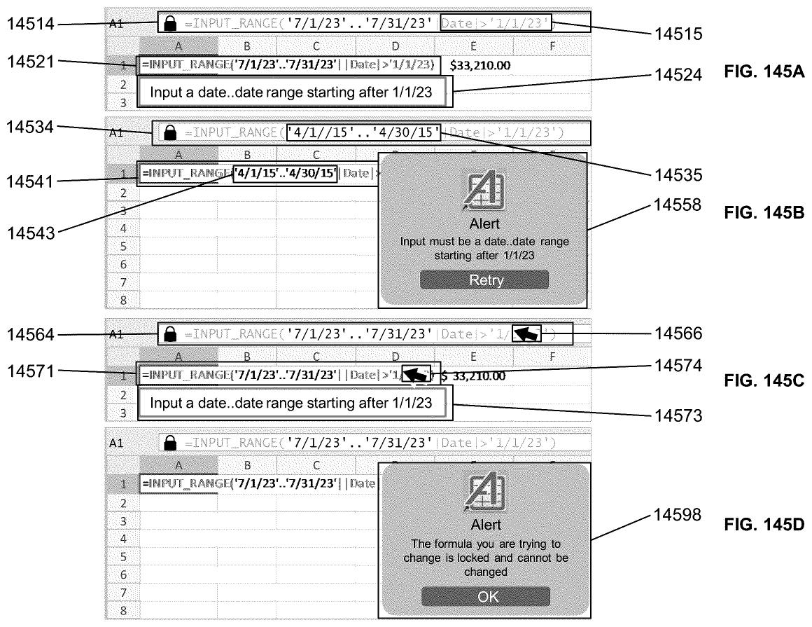

FIG. 144A through FIG. 145D examples the partial locking of our regular range input validation functions. It starts with the pre-locking of cell ‘A1’ 14421 in FIG. 144A which contains one of our regular input validation functions the formula ‘=INPUT’ 14412. That functional formula presents the automatically generated tailored input message 14424. FIG. 144B examples the post partial locking of cell ‘A1’ 14431 where the user has double clicked into the cell to get the in-cell formula putting the cursor just after the ‘6/1/23’ . . . ‘6/30/23’ 14435 black argument in the formula 14431. Where the rest of the formula 14431 is grayed out to inform the user that it is locked while the black argument ‘6/1/23’ . . . ‘6/30/23’ 14435 is unlocked and changeable. The same is true in the formula bar that the ‘‘6/1/23’ . . . ‘6/30/23’’ 14433 black argument is unlocked and changeable while the rest of the formula 14432 is grayed out telling the user it is locked and not changeable. The user then changes the date range ‘‘6/1/23’ . . . ‘6/30/23’’ 14435 in FIG. 144B to ‘‘7/1/23’ . . . ‘7/31/23’’ 14455 within the cell formula 14451 in FIG. 144C just as they would do in an unlocked cell/formula and hits ENTER to get the changed values exampled in 14461 in FIG. 144D. When the user double clicks into the cell ‘A1’ 14481 in FIG. 144E you can see that the changed values ‘‘7/1/23’ . . . ‘7/31/23’’ 14483 were also changed in the formula bar formula 14482. The same change would have occurred had the user made the change in the formula bar formula 14442 from the values ‘‘6/1/23’ . . . ‘6/30/23’’ 14433 in FIG. 144B to the formula bar formula 14451 values ‘‘7/1/23’ . . . ‘7/31/23’’ 14443 in FIG. 144C as the values argument in both the in-cell formula and the formula bar formula is unlocked.

FIG. 144F examples how the partially locked values are referenceable for use in other cells just as if they were unlocked. Cell ‘E1’ 14497 contains the formula ‘=SUM) 14494 referencing cell ‘A1’ 14491 containing the partially locked ‘INPUT_RANGE’ formula. FIG. 144B and FIG. 144D examples its value changing from ‘$24,500.00’ for ‘E1’ 14437 in FIG. 144B to ‘$33,210.00’ for ‘E1’ 14467 in FIG. 144D with the change in the respective ‘A1’ values. Also note that the locking of the cell ‘A1’ in FIG. 144b did not change the value of the formula in cell ‘E1’.

FIG. 145A and FIG. 145B example how post locking the validation rejection or warning alert work just as they did before locking for our regular multi value set range input validation functions. In this embodiment if the user attempts in FIG. 145B to enter the date range ‘‘4/1/15’ . . . ‘4/30/15’’ 14543 into the in-cell formula 14541 in cell ‘A1’ 14541 replacing the value ‘‘7/1/23’ . . . ‘7/31/23’’ in the in-cell formula 14521 in FIG. 145A. That entry fails the data values validation of ‘‘1/1/23’’ 14515 in the formula 14514 and automatically generates the rejection ‘Alert’ 14558 exampled in FIG. 145B with the automatically constraint validation tailored text ‘Input must be a date . . . date range starting after 1/1/23’. This is just as it would operate if the cell/formula were unlocked. Leaving the user to ‘Retry’ the input until they get a validate date. The same result would occur if the user attempted to enter the date range ‘‘4/1/15’ . . . ‘4/30/15’’ 14535 in FIG. 145B into the formula bar formula 14534 for cell ‘A1’ 14541 replacing the date range ‘‘7/1/23’ . . . ‘7/31/23’’ in the formula bar formula 14514 in FIG. 145A.

FIG. 145C and FIG. 145D examples one embodiment of what happens post locking if the user attempts to enter the locked arguments in the formula bar. In this embodiment when the user attempts to enter the formula 14564 bar grayed locked argument 14566 in FIG. 145C our technology automatically triggers an ‘Alert’ popup 14598 in FIG. 145D with a message telling the user “The formula you are trying to change is locked and cannot be changed” or something similar informing them of the locking and possibly telling them how to unlock the cell. The same result would occur if the user attempted to enter the in-cell formula 14571 grayed locked argument 14574 in FIG. 145C. The user would trigger the ‘Alert’ popup 14598 in FIG. 145D with a message telling the user “The formula you are trying to change is locked and cannot be changed” or something similar informing them of the locking and possibly telling them how to unlock the cell.

### Regular Input Validation Function—Multiple Inputs

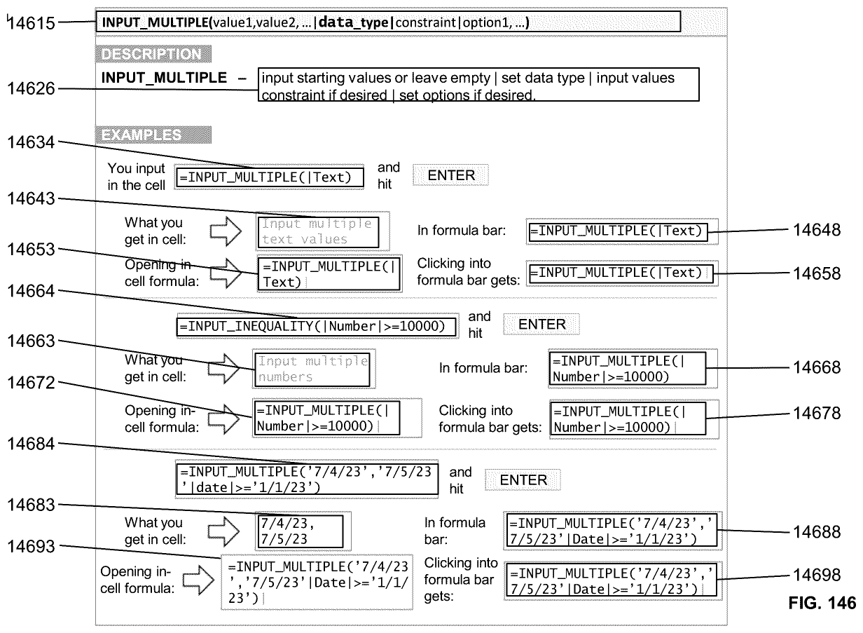

FIG. 146 examples our multiple set of values regular multiple inputs validation prebuilt spreadsheet function. It lays out an embodiment with a function name of ‘INPUT_MULTIPLE’, although it could have any name although preferably one not already used by another spreadsheet function. It has a syntax exampled in 14615 in FIG. 146 employing four argument groups divided by three vertical bars ‘1’. And of course, a variant of the function could be without the optional argument group or arguments. As mentioned previously the arguments could be in a different order. Note the multiple discrete value input function could be part of a single function accepting all the different types of inputs, e.g., the single input, the range input, multiple discrete values inputs, and the inequality input.

FIG. 146 examples the function setup ‘DESCRIPTION’ 14626 instructions of use for creating the formula directly in the cell or indirectly in the cell via the formula bar in this embodiment. It instructs the user to ‘input starting values or leave empty’ in the first argument group, ‘set data type’ in the second argument group, ‘input value constraint if desired’ in the third argument group and ‘set options if desired’ in the fourth argument group. It bolds the ‘data type’ argument in the syntax 14615 as the only required argument/argument group although the ‘value1,value2’ arguments could also be required. FIG. 146 then displays three examples showing our regular multiple discreet values input validation functions operate in-cell/formula bar input-wise like a typical current spreadsheet function where both of those inputs always accept the same formula input.

In the first example in FIG. 146 the user has typed or otherwise inputted the formula ‘=INPUT_MULTIPLE’ 14634 into a cell and hit ‘ENTER’ to get ‘Input multiple text values’ 14643 in the cell in light gray text as an instruction as to what to do for the cell input in this embodiment. In the formula bar they get the cell formula ‘=INPUT_MULTIPLE’ 14648. Note, the ‘INPUT_MULTIPLE’ function that the user created limits the inputs to text values. In other embodiments the cell post a completed formula with no specified value could be populated with something else, be blank, or as previously exampled be differentiated in some other way to indicate to the user it is an input function populated cell. Different embodiments would make an initial value input required eliminating the empty option. In this embodiment, if the user then reopens the cell the user gets the formula ‘=INPUT_MULTIPLE’ 14653 with the cursor wherever the user positioned it. This is identical to what the user gets if they click into the formula bar 14658. In both situations the user is ready to edit the entire formula.

In the second example in FIG. 146 the user has typed or otherwise inputted the formula ‘=INPUT_MULTIPLE’ 14664 into a cell and hit ‘ENTER’ to get ‘Input multiple numbers’ 14663 displayed in the cell in light gray text as an instruction as to what to do for the cell input. In other embodiments the cell could have populated with something else, been blank, or as previously exampled be differentiated in some other way to indicate to the user it is an input function populated cell. Note, the user has not only limited the input to numeric values but to numeric values greater than or equal to 10000. In the formula bar they get the cell formula ‘=INPUT_MULTIPLE’ 14668. If the user then reopens the cell in this embodiment the user gets the formula ‘=INPUT_MULTIPLE’ 14672 with the cursor wherever the user positioned it. This is identical to what the user gets if they click into the formula bar 14678. In both situations the user is ready to edit the entire formula.

In the third example in FIG. 146 the user has typed or otherwise inputted the formula ‘=INPUT’ 14684 into a cell and hit ‘ENTER’ to get in this embodiment ‘7/4/23,7/5/23’ 14683 as the existing values in the cell. Note, that in this embodiment dates input in a formula are within single quotes while the single quotes are not used in the cell Also note, the user has not only limited the input to date inputs but to dates starting on or after 1/1/23. In the formula bar they get the cell formula ‘=INPUT’ 14688. If the user then reopens the cell in this embodiment the user gets the formula ‘=INPUT’ 14693 with the cursor wherever the user positioned it. This is identical to what the user gets if they click into the formula bar 14698. In both situations the user is ready to edit the entire formula, and those edits will be replicated in the other input like in a regular spreadsheet function.

All the examples in FIG. 146 showed how this set of embodiments of our validate functions operate like a regular function from an in-cell and formula bar input standpoint. They operate similar to the examples shown in FIG. 144A through FIG. 145D and have the applicable features otherwise discussed herein, so for brevity's sake we will move on to exampling our regular inequality input validation function.

### Regular Input Validation Function—Inequality Input

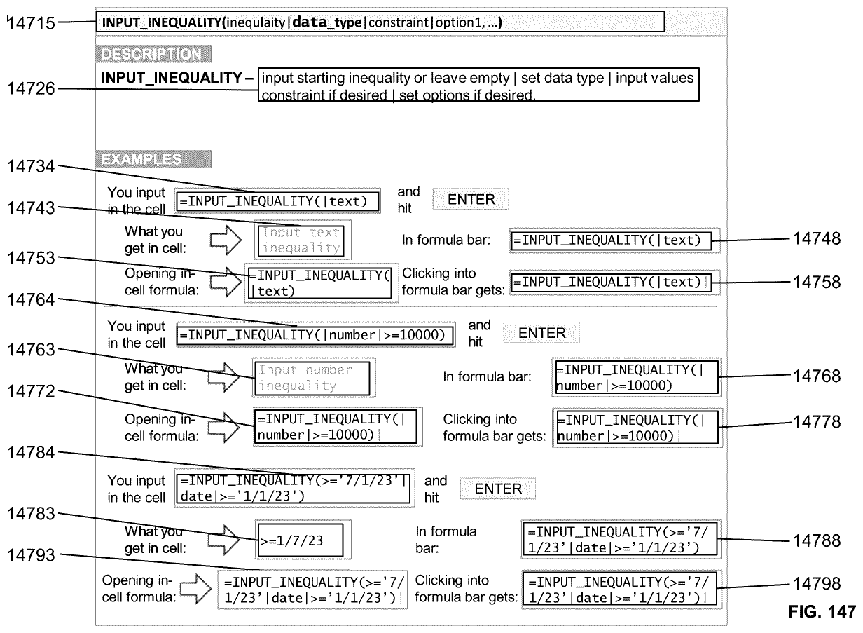

FIG. 147 examples our multiple set of values regular inequality input validation prebuilt spreadsheet function. It lays out an embodiment with a function name of ‘INPUT_INEQUALITY’, although it could have any name although preferably one not already used by another spreadsheet function. It has a syntax exampled in 14715 in FIG. 147 employing four argument groups divided by three vertical bars ‘1’. Although it could have easily been three fixed order arguments with a fourth and beyond optional arguments, e.g., INPUT_INEQUALITY. And of course, a variant of the function could be without the optional argument group or arguments. As mentioned previously the arguments could be in a different order. Note the inequality input function could be an option with a single function accepting all the different types of inputs, e.g., the single input, the range input, multiple discrete values inputs, and the inequality input.

FIG. 147 examples the function setup ‘DESCRIPTION’ 14726 instructions of use for creating the formula directly in the cell or indirectly in the cell via the formula bar in this embodiment. It instructs the user to ‘input starting inequality or leave empty’ in the first argument group, ‘set data type’ in the second argument group, ‘input value constraint if desired’ in the third argument group and ‘set options if desired’ in the fourth argument group. It bolds the ‘data type’ argument in the syntax 14715 as the only required argument/argument group although the ‘inequality’ argument/argument group could also be required. FIG. 147 then displays three examples showing our regular inequality input validation functions operate in-cell/formula bar input-wise like a typical current spreadsheet function where both of those inputs always accept the same formula input.

In the first example in FIG. 147 the user has typed or otherwise inputted the formula ‘=INPUT_INEQUALITY’ 14734 into a cell and hit ‘ENTER’ to get ‘Input text inequality’ 14743 in the cell in light gray text as an instruction as to what to do for the cell input in this embodiment. In the formula bar they get the cell formula ‘=INPUT_INEQUALITY’ 14748. Note, the ‘INPUT_INEQUALITY’ function that the user created limits the inputs to text values. In other embodiments the cell post a completed formula with no specified value could be populated with something else, be blank, or as previously exampled be differentiated in some other way to indicate to the user it is an input function populated cell. Different embodiments would make an initial inequality input required eliminating the empty option. In this embodiment, if the user then reopens the cell in this embodiment the user gets the formula ‘=INPUT_INEQUALITY’ 14753 with the cursor wherever the user positioned it. This is identical to what the user gets if they click into the formula bar 14758. In both situations the user is ready to edit the entire formula.

In the second example in FIG. 147 the user has typed or otherwise inputted the formula ‘=INPUT_INEQUALITY’ 14764 into a cell and hit ‘ENTER’ to get ‘Input number inequality’ 14763 displayed in the cell in light gray text as an instruction as to what to do for the cell input. In other embodiments the cell could have populated with something else, been blank, or as previously exampled be differentiated in some other way to indicate to the user it is an input function populated cell. Note, the user has not only limited the input to numeric inequalities but to numeric inequalities' greater than or equal to 10000. In the formula bar they get the cell formula ‘=INPUT_INEQUALITY’ 14768. If the user then reopens the cell in this embodiment the user gets the formula ‘=INPUT_INEQUALITY’ 14772 with the cursor wherever the user positioned it. This is identical to what the user gets if they click into the formula bar 14778. In both situations the user is ready to edit the entire formula.

In the third example in FIG. 147 the user has typed or otherwise inputted the formula ‘=INPUT’ 14784 into a cell and hit ‘ENTER’ to get in this embodiment ‘>=1/7/23’ 14783 as the existing value in the cell. Note, the user has not only limited the input to date inputs but to dates starting on or after 1/1/23. In the formula bar they get the cell formula ‘=INPUT’ 14788. If the user then reopens the cell in this embodiment the user gets the formula ‘=INPUT’ 14793 with the cursor wherever the user positioned it. This is identical to what the user gets if they click into the formula bar 14798. In both situations the user is ready to edit the entire formula, and those edits will be replicated in the other input like in a regular spreadsheet function. Note the inequality within the cell could be populated in some other manner than just the inequality, it could be populated in an “INEQULITY” function such as ‘INEQUALITY’ as a further way of differentiating it from what otherwise could be mistaken for text>=1/7/23.

Before we leave our regular input validation family of functions, we will example how they work when locked with hiding.

### Regular Input Validation Function—Partial Locking and Partial Hiding

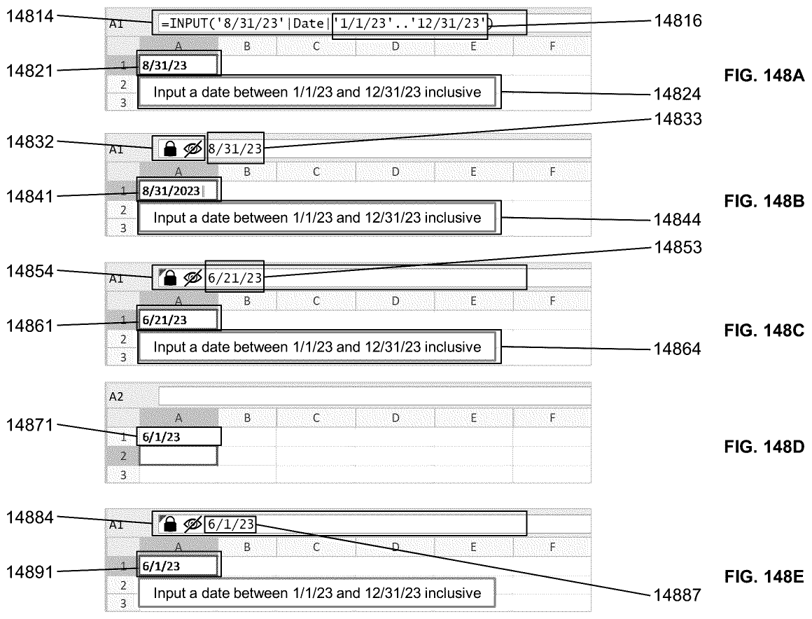

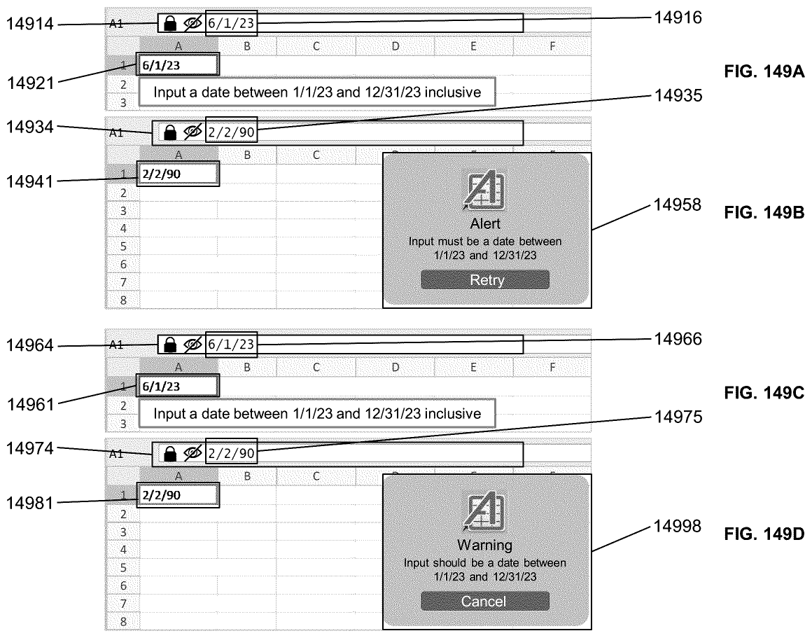

FIG. 148A through FIG. 149D examples the partial locking and partial hiding of our regular input validation functions. It starts with the pre-locking and hiding of cell ‘A1’ 14821 in FIG. 148A which contains one of our regular input validation functions the formula ‘=INPUT’ 14814. That functional formula presents the automatically generated tailored input message 14824 when the cell is highlighted or opened. FIG. 148B examples the post partial locking and hiding of cell ‘A1’ 14841 where the user has double clicked into the in-cell formula putting the cursor just after the ‘8/31/23’. Note, that when they click into the cell instead of seeing the formula they see only the unlocked argument value, not seeing any of the locked arguments which are hidden as well as in this embodiment the INPUT function is hidden. The same is true in the formula bar where the user sees the lock and hidden icons 14832 but none of the locked arguments and the formula and just see the date value ‘8/31/23’ 14834 in black, which is both visible and changeable. So, in this embodiment of our technology hiding hides the locked arguments and the formula but does not hide the unlocked argument. The user then changes the date ‘8/31/23’ 14841 in FIG. 148B to ‘6/1/23’ 14861 in FIG. 148C and hits ENTER to get the changed value exampled in 14871 in FIG. 148D. When the user re-highlights the cell ‘A1’ 14891 in FIG. 148E you can see that the changed value ‘6/1/23’ 14887 was also changed in the formula bar 14884. The same change would have occurred had the user made the change in the formula bar from the value ‘8/31/23’ 14833 in FIG. 148B to the formula bar value ‘6/21/23’ 14853 in FIG. 148C as the value argument in both the in-cell formula and the formula bar are unlocked.

FIG. 149A and FIG. 149B example how post locking and hiding the validation rejection works just as it did before locking and hiding for our regular input validation functions. In this embodiment if the user attempts in FIG. 149B to enter the date ‘2/2/90’ 14941 into the in-cell formula in cell ‘A1’ 14941 replacing the value ‘6/1/23’ 14921 in FIG. 149A it fails the data values validation of ‘‘1/1/23’ . . . ‘12/31/23’’ 14816 set up in the formula 14814 in FIG. 148A of the formula pre-locking and hiding. It therefore automatically generates the rejection ‘Alert’ 14958 example in FIG. 149B with the automatically constraint validation tailored text ‘Input must be a date between 1/1/23 an 12/31/23’. This is just as it would operate if the cell/formula were unlocked and unhidden. Leaving the user to ‘Retry’ the input until they get a validate date. The same result would occur if the user attempted to enter the date ‘2/2/90’ 14935 in FIG. 149B into the formula bar formula 14934 for cell ‘A1’ 14941 replacing the value ‘6/1/23’ 14916 in the formula bar 14914 in FIG. 149A.

FIG. 149C and FIG. 149D example how post locking and hiding the validation warning alert works just as it did before locking and hiding for our regular input validation functions. In this embodiment if the user attempts in FIG. 149D to enter the date ‘2/2/90’ 14981 into the in-cell formula in cell ‘A1’ 14981 replacing the value ‘6/1/23’ 14961 in FIG. 149C it fails the data values validation of ‘‘1/1/23’ . . . ‘12/31/23’’ 14816 in the formula 14814 in FIG. 148A of the formula pre-locking and hiding. Therefore, in this embodiment it automatically generates the rejection ‘Warning’ 14998 exampled in FIG. 149D with the automatically constraint validation tailored text ‘Input should be a date between 1/1/23 an 12/31/23’. This is just as it would operate if the cell/formula were unlocked and unhidden. The same result would occur if the user attempted to enter the date ‘2/2/90’ 14975 in FIG. 149D into the formula bar formula 14974 for cell ‘A1’ 14981 replacing the value ‘6/1/23’ 14966 in the formula bar 14964 in FIG. 149C.

While we could example many more regular single value input validation function situations and mix and match combination of features, we will instead move on to how our partial locking and hiding technology works for regular multiple set of values input validation spreadsheet functions.

### Regular Input Validation Function—Range Input Partial Locking and Partial Hiding

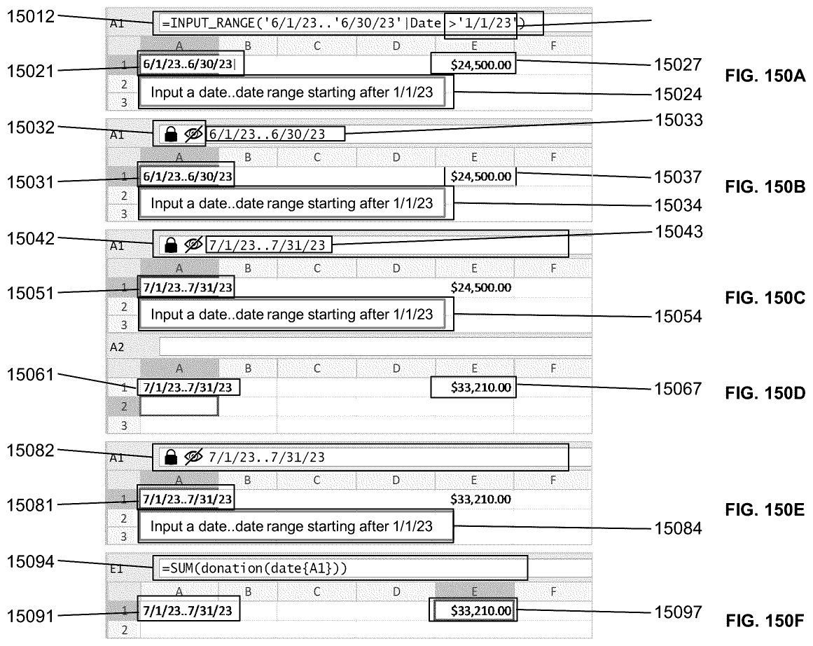

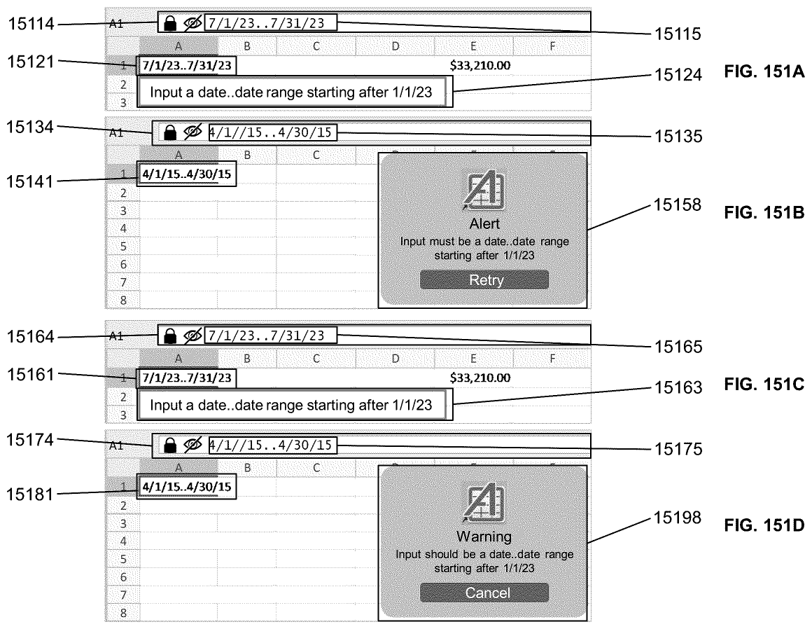

FIG. 150A through FIG. 151D examples the partial locking and partial hiding of our regular range input validation functions. It starts with the pre-locking and pre-hiding of cell ‘A1’ 15021 in FIG. 150A which contains one of our regular input validation functions with the formula ‘=INPUT’ 15012. That functional formula presents the automatically generated tailored input message 15024 when the cell is highlighted or opened. FIG. 150B examples the post partial locking and hiding of cell ‘A1’ 15031 where the user has double clicked into the cell to get the unlocked and unhidden argument value ‘‘6/1/23’ . . . ‘6/30/23’’ 15031. Where the rest of the formula is both locked and hidden and therefore not visible to the user. The same is true in the formula bar that the ‘‘6/1/23’ . . . ‘6/30/23’’ 15033 black argument is unlocked and visible while the rest of the formula in this embodiment is replaced by the locked and hidden icons 15032. The user then changes the date range ‘6/1/23’ . . . ‘6/30/23’ 15031 in FIG. 150B to ‘7/1/23’ . . . ‘7/31/23’ 15051 in FIG. 150C and hits ENTER to get the changed values ‘7/1/23’ . . . ‘7/31/23’ which have passed the validation as exampled in 15061 in FIG. 150D. When the user double clicks into the cell ‘A1’ 15081 in FIG. 150E you can see that the changed values ‘7/1/23’ . . . ‘7/31/23’ were also changed in the formula bar formula 15082. The same change would have occurred had the user made the change in the formula bar from the values ‘‘61l/23’ . . . ‘6/30/23’’ 15033 in FIG. 150B to the formula bar values ‘‘7/1/23’ . . . ‘7/31/23’’ 15043 in FIG. 150C as the range value argument in both the in-cell formula and the formula bar formula are unlocked and unhidden.

FIG. 150F examples how the partially locked and partially hidden values are referenceable for use in other cells just as if they were unlocked and unhidden. Cell ‘E1’ 15097 contains the formula ‘=SUM) 15094 referencing cell ‘A1’ 15091 containing the partially locked and partially hidden ‘INPUT_RANGE’ formula. FIG. 150B and FIG. 150D examples its value changing from ‘$24,500.00’ for ‘E1’ 15037 in FIG. 150B to ‘$33,210.00’ for ‘E1’ 15067 in FIG. 150D with the change in the respective ‘A1’ values. FIG. 150A 15027 and FIG. 150B 15037 also example how the locking and hiding of cell ‘A1’ has no impact on the other cells referencing that cell in their formula calculations.

FIG. 151A and FIG. 151B example how post locking and hiding the validation rejection alert works just as it did before locking for our regular multi value set range input validation functions. In this embodiment when the user attempts in FIG. 151B to enter the date range ‘‘4/1/15’ . . . ‘4/30/15’’ 15141 into the in-cell formula 15141 in cell ‘A1’ replacing the value ‘‘7/1/23’ . . . ‘7/31/23’’ 15121 in FIG. 151A it fails the data values validation of ‘‘>1/1/23’’ and automatically generates the rejection ‘Alert’ 15158 example in FIG. 151B with the automatically constraint validation tailored text ‘Input must be a date . . . date range starting after 1/1/23’. This is just as it would operate if the cell/formula were unlocked and unhidden. Leaving the user to ‘Retry’ the input until they get a validate date. The same result would occur if the user attempted to enter the date range ‘‘4/1/15’ . . . ‘4/30/15’’ 15135 in FIG. 151B into the formula bar formula 15134 for cell ‘A1’ 15141 replacing the date range ‘‘7/1/23’ . . . ‘7/31/23’’ 15115 in the formula bar 15114 in FIG. 151A.

FIG. 151C and FIG. 151D example how post locking and full or partial hiding the validation warning works just as it did before locking and hiding for our regular multi value set range input validation functions. In this embodiment when the user attempts in FIG. 151D to enter the date range ‘‘4/1/15’ . . . ‘4/30/15’’ 15181 into the in-cell formula in cell ‘A1’ 15181 replacing the value ‘‘7/1/23’ . . . ‘7/31/23’’ 15161 in FIG. 151C it fails the data values validation of ‘‘>1/1/23>’ and automatically generates the ‘Warning’ 15198 exampled in FIG. 151D with the automatically constraint validation tailored text ‘Input should be a date . . . date range starting after 1/1/23’. This is just as it would operate if the cell/formula were unlocked and unhidden. The same result would occur if the user attempted to enter the date range ‘‘4/1/15’ . . . ‘4/30/15’’ 15175 in FIG. 151D into the formula bar formula 15174 for cell ‘A1’ 15181 replacing the date range ‘‘7/1/23’ . . . ‘7/31/23’’ 15165 in the formula bar 15164 in FIG. 151C.

While we have not exampled for the regular input validation family of functions the use of the options arguments and the fact that those arguments can be locked or unlocked by our partial locking technology. Those arguments, like any of the other argument can be locked or unlocked and can be hidden or not hidden. And our partial locking and full or partial hiding technologies support any combinations of locked and unlocked arguments provided at least one argument is locked and at least one argument is unlocked. For brevity's sake we will not attempt to example all those different combinations for our family of regular input validation functions or further permutations for our differential input family of input validation functions, but we will move on to how our partial locking and partial hiding technology works for other spreadsheet functions.

### Partial Locking of Our DROPDOWN Family of Functions

We will start with the partial locking of a family of spreadsheet functions that were the subject of our U.S. application Ser. No. 17/359,418 titled “Methods and Systems for Presenting Drop-Down, Pop-Up or Other Presentation of a Multi-Value Data Set in a Spreadsheet Cell,” filed 25 Jun. 2021, now U.S. Pat. No. 11,657,217, issued 25 May 2023, before proceeding to the typical spreadsheet prebuilt functions. We will first example the partial locking of a single value selection variant our multi-value data set presenting functions before exampling the multi-value selection variant.

### Partial Locking of Our DROPDOWN Family of Functions—Single Selection Variant

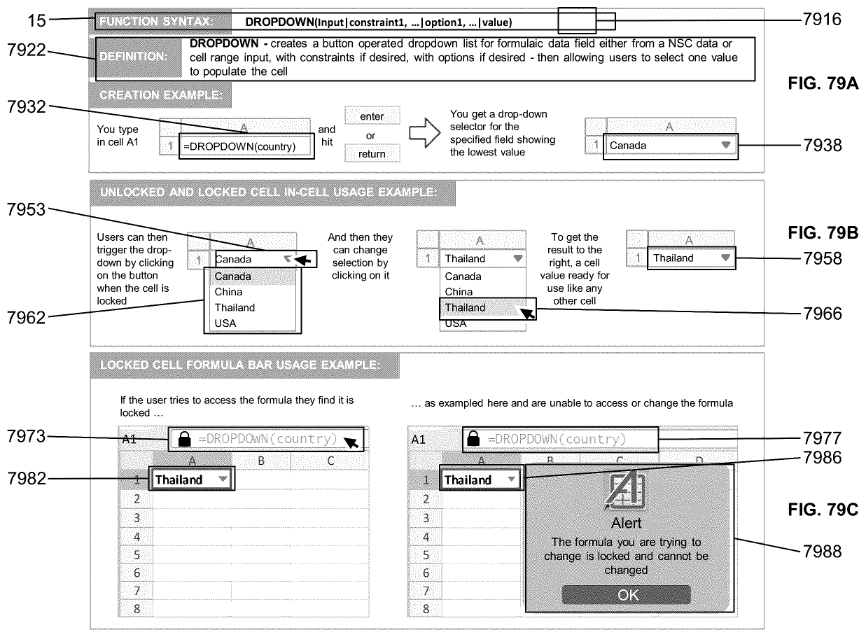

FIG. 79A examples the setup of a single value selection variant of our multi-value data set presenting prebuilt spreadsheet function in this embodiment is called ‘DROPDOWN’. The prebuild function syntax 7915 has one required argument, ‘Input’ and three optional to start arguments/argument groups. The ‘Input’ specifies the formulaic data field sourced from ‘Non-Spreadsheet Cell external data or an in-cell range. Typically, those formula data fields have text label names but in the case of the in-cell sourced data can also use the cell ranges where the data is found as the formulaic data field name as mentioned in the ‘DEFINITION’ 7922. The functions can then constrain/filter the data set, if desired, to a subset of the data in the formulaic data field. There are various options available on the presentation of the values in selection UI and the value selected can be presented in an argument in the formula or hidden as described in our U.S. application Ser. No. 18/142,560 titled “Methods and Systems for Spreadsheet Function and Flex Copy-Paste Control of Formatting and Use of Selection List Panels,” filed 2 May 2022. We example the creation of a ‘=DROPDOWN’ formula 7932 in FIG. 79A to example the difference in the ‘dropdown’ formula 7932, the in-cell result/starting UI 7938 and the in-cell selection UI that it creates 7962 in FIG. 79B.

FIG. 79B then examples how that value selection UI works in both the unlocked and our partially locked states. When the user clicks the dropdown arrow 7953 or clicks into the cell 7953 it opens the selection list of the formulaic data field ‘country’ values 7962. Note, those values could be from NSC external data or from an in-cell range somewhere else in the spreadsheet. Then in either the unlocked or partially locked cell state the user can select a different value, for example ‘Thailand’ 7966 which will then be populated in the cell as exampled in 7958. However, in the partially locked state in our technology if the user attempts to access the formula creating the selection list, for example ‘=DROPDOWN’ 7973 in the formula bar in FIG. 79C, then the user is blocked from making any change. In this embodiment, consistent with our previous examples, that is indicated by the lock and the light gray coloring of the formula in the formula bar 7973. This embodiment goes further to automatically generate a message alert 7988 which informs the user ‘The formula you are trying to change is locked and cannot be changed’. Making it even more clear that the formula 7977 is locked while the value selector 7986 is unlocked and the value can be changed. Thus, allowing the post locking user to change values but to not change the cell formula and thereby break the usage of this input into locked cells. As with our previous partially locked cells the value and any changes to the value works in cell formulas referencing the cell and using its value.

### Partial Locking and Formula Hiding of Our DROPDOWN Family of Functions—Single Selection Variant

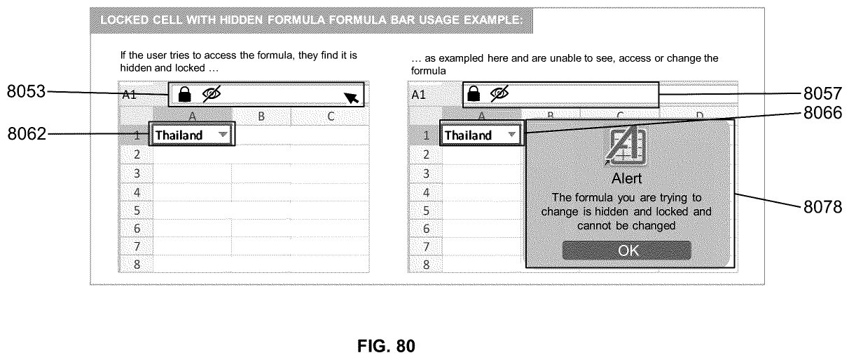

FIG. 80 examples how our partially locking and formula hiding technology works for our single value selection variant of our multi-value data set presenting prebuilt spreadsheet function in this embodiment called ‘DROPDOWN’. The user is unable to see the formula post locking and hiding, as exampled by the formula bar displaying only the lock and slash eye 8053 while they can still see and change the selected value in the cell ‘A1’ 8062. If the user attempts to access the formula as they do with the click into the formula bar 8053, they are blocked from gaining access to the formula and in this embodiment automatically generating a message alert 8078 which informs the user ‘The formula you are trying to change is hidden and locked and cannot be changed’. Making it even more clear that the formula 8057 is locked while the value selector 8066 is unlocked and the value can be changed. Thus, allowing the post locking and hiding user to change values but to not see or change the cell formula and thereby break the usage of this input into locked cells. As with our previous partially locked and hidden formula cells, the value and any changes to the value works in cell formulas referencing the cell and using its value.

### Partial Locking of Our DROPDOWN Family of Functions—Multi-Value Selection Variant

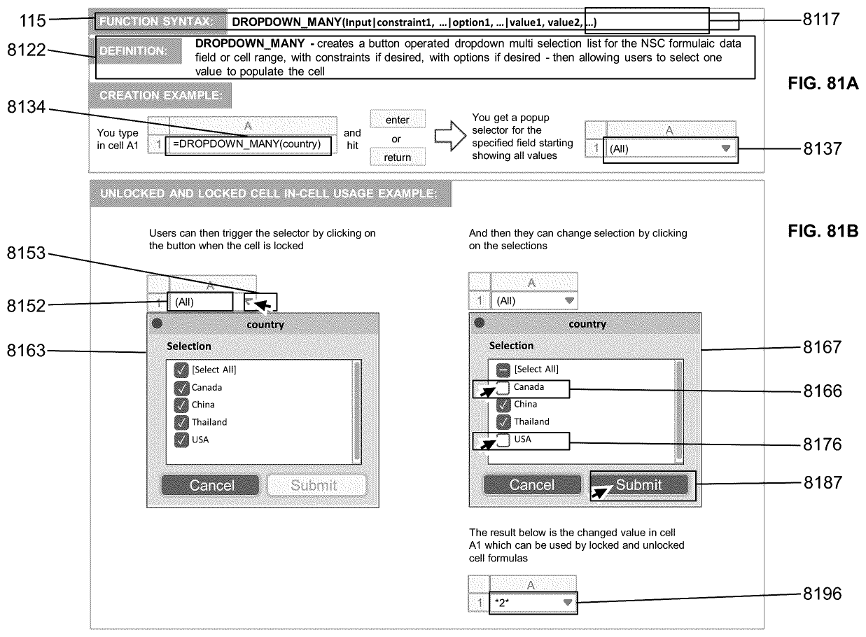

FIG. 81A examples the setup of a multi-value selection variant of our multi-value data set presenting prebuilt spreadsheet function in this embodiment called ‘DROPDOWN_MANY’. The prebuild function syntax 8115 has one required argument, ‘Input’ and three optional to start arguments/argument groups. The ‘Input’ specifies the formulaic data field sourced from ‘Non-Spreadsheet Cell external data or an in-cell range. Typically, those formula data fields have text label names but in the case of the in-cell sourced data can also use the cell ranges where the data is found as the formulaic data field name as mentioned in the ‘DEFINITION’ 8122. The functions can then constrain/filter the data set, if desired, to a subset of the data in the formulaic data field. There are various options available on the presentation of the values in selection UI and the values selected can be presented in arguments/argument group in the formula or hidden as described in our U.S. application Ser. No. 18/142,560 titled “Methods and Systems for Spreadsheet Function and Flex Copy-Paste Control of Formatting and Use of Selection List Panels,” filed 2 May 2022. We example the creation of a ‘=DROPDOWN_MANY’ formula 8134 to example the difference in the ‘multi-value’ formula 8134 and the in-cell selection starting in-cell starting selection/result UI that it creates 8137.

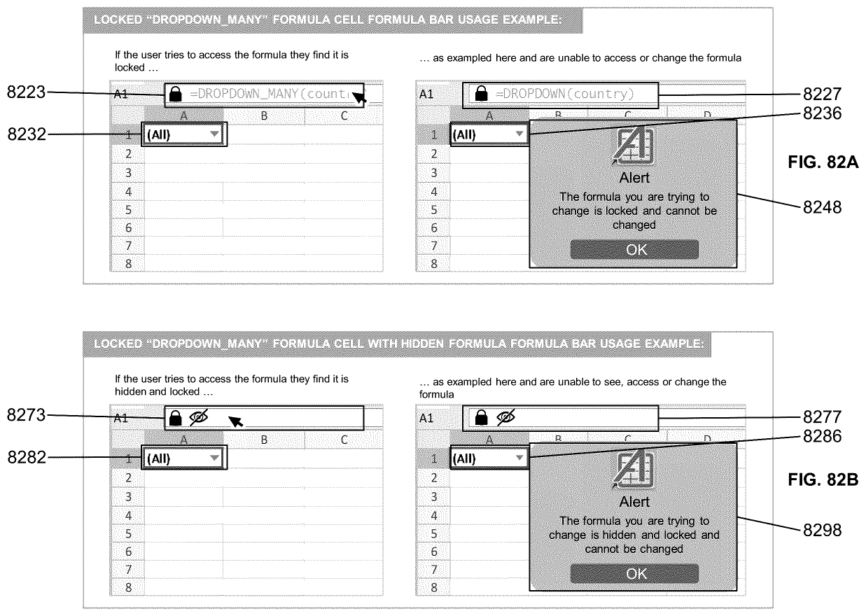

FIG. 81B then examples how that value selection UIs works in both the unlocked and our partially locked states. When the user clicks the dropdown arrow 8153 or clicks into the cell 8152 it opens the selection list of the formulaic data field ‘country’ values 8163. Note, those values could be from NSC external data or from an in-cell range somewhere else in the spreadsheet. Then in either the unlocked or partially locked cell state the user can select a different values starting in this example from the “value displayed in the cell 8152 and the ‘ ’ displayed in the selection list 8163. In this example the user selects ‘China’ and ‘Thailand’ by unclicking ‘Canada’ 8166 and ‘USA’ 8176 and then clicking ‘Submit’ 8187 in the selection UI 8167 to populate the cell 8196. In this embodiment those two values populate into the cell with a placeholder ‘*2*’ 8196 informing the user there are two values in the cell. In other embodiments the values could populate in the cell comma separated, the placeholder could be a ‘ . . . ’ informing the user there is more than one value in the cell, or some other way of representing the multiple selections. In any of those situations the unlocked and partially locked situations operate the same way allowing the user to change the values. However, in the partially locked state in our technology if the user attempts to access the formula creating the selection list, for example the ‘=DROPDOWN_MANY’ 8223 in the formula bar in FIG. 82A, then the user is blocked from making any change. In this embodiment, consistent with our previous examples that is indicated by the lock and the light gray coloring of the formula in the formula bar 8223. This embodiment goes further to automatically generate a message alert 8248 which informs the user ‘The formula you are trying to change is locked and cannot be changed’. Making it even more clear that the formula 8227 is locked while the value selector starting UI 8236 and the multi-value selector is unlocked and the values can be changed as done in 8167 in FIG. 81B. Thus, allowing the post locking user to change values but to not change the cell formula and thereby alter the selection list source, any constraints, or any options. As with our previous partially locked cells the values and any changes to the values works in cell formulas referencing the cell and using its value as also exampled in our U.S. application Ser. No. 17/359,418 titled “Methods and Systems for Presenting Drop-Down, Pop-Up or Other Presentation of a Multi-Value Data Set in a Spreadsheet Cell,” filed 25 Jun. 2021, now U.S. Pat. No. 11,657,217, issued 25 May 2023.

### Partial Locking and Formula Hiding of Our DROPDOWN Family of Functions—Multi-Value Selection Variant

FIG. 82B examples how our partially locking and formula hiding technology works for our multi-value selection variant of our multi-value data set presenting prebuilt spreadsheet function in this embodiment called ‘DROPDOWN_MANY’. The user is unable to see the formula post locking and hiding, as exampled by the formula bar displaying only the lock and slash eye 8273 while they can still see and change the selected values in the cell ‘A1’ 8282. If the user attempts to access the formula as they do with the click into the formula bar 8273, they are blocked from seeing and gaining access to the formula and in this embodiment automatically generating a message alert 8298 which informs the user ‘The formula you are trying to change is hidden and locked and cannot be changed’. Making it even more clear that the formula 8277 is locked while the initial values selector UI 8286 and the multi-value selector is unlocked and the values can be changed as done in 8167 in FIG. 81B. Thus, allowing the post locking and hiding user to change values but to not see or change the cell formula. As with our previous partially locked and hidden formula cells, the values and any changes to the values works in cell formulas referencing the cell and using its values.

### Partial Locking of Typical Spreadsheet Prebuilt Functions—e.g., SUM

Thus far we discussed the partial locking of different embodiments of our specialized functions with differential formula input from the value input or value selection of the function output. We will now discuss how our partial locking technology applies to regular prebuilt spreadsheet functions that are prebuilt/delivered as part of the spreadsheet application. We are talking about a large subset of those functions which are the ones with two or more arguments, so that a minimum of one argument can be locked and a minimum of one argument unlocked by our partial locking technology. This group of regular functions entails a large fraction of the over four hundred prebuilt functions supplied in the typical spreadsheet and therefore presents a challenge to example, so we have selected to example them using probably the most used function by typical users and then a much more advanced function typically used by more advanced users. For brevity's sake we will use those two functions to example the key elements of our partial locking technology application to typical prebuilt spreadsheet functions.

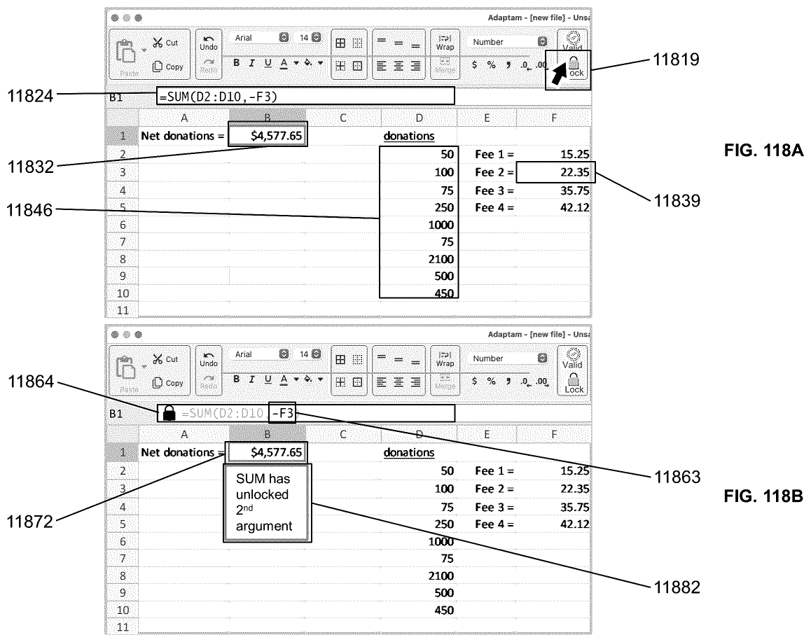

FIG. 118A examples a two argument ‘SUM’ prebuilt function formula 11824 in cell ‘B1’ 11832. One argument references the cell range ‘D2:D10’ 11846 while the other argument references ‘-F3’ 11839. These arguments could have been any of the type accepted by a ‘SUM’ function. The user then starts the locking in this embodiment by clicking the ‘Lock’ ribbon button 11819, although it could have been done with menu selections or other modes. There are many ways to lock the function, FIG. 134A examples one such way. In this embodiment the clicking of the ‘Lock’ button 13419 for the cell ‘B1’ 13432 with the formula 13424 displays the ‘Locking’ selection UI 13436. It presents the user with two radio button selectors 13425/13435 for the user to ‘Select argument to unlock:’ 13426. This ensures that at least one of the arguments is locked and at least one is unlocked thereby creating a partial lock. In this example the user clicks the ‘-F3’ 13435 radio button and then clicks ‘OK’ 13458 to get the partially locked ‘SUM’ formula 11864 for the value ‘$4,577.65’ in cell’B1’ 11872 in FIG. 118B. It also changes the formula bar formula 11864 to contain a lock and greys the argument that are locked leaving only the argument that are unlocked black 11863. The black unlocked argument are then changeable while the greyed argument are locked and unchangeable in this embodiment. Our technology also automatically generates a locking input message 11882 informing the user in a UI ‘SUM has unlocked 2^{nd} argument’. Thereby, informing the user of what they can change and what they cannot change. There are many ways our technology can communicate what is locked and what is not, and our technology automatically generates that message and will automatically change it should the locking be altered. While there are many different ways to differentiate the locked arguments from the unlocked arguments for simplicity of focusing on the functionality of what is being done, we are using the approach previously used.

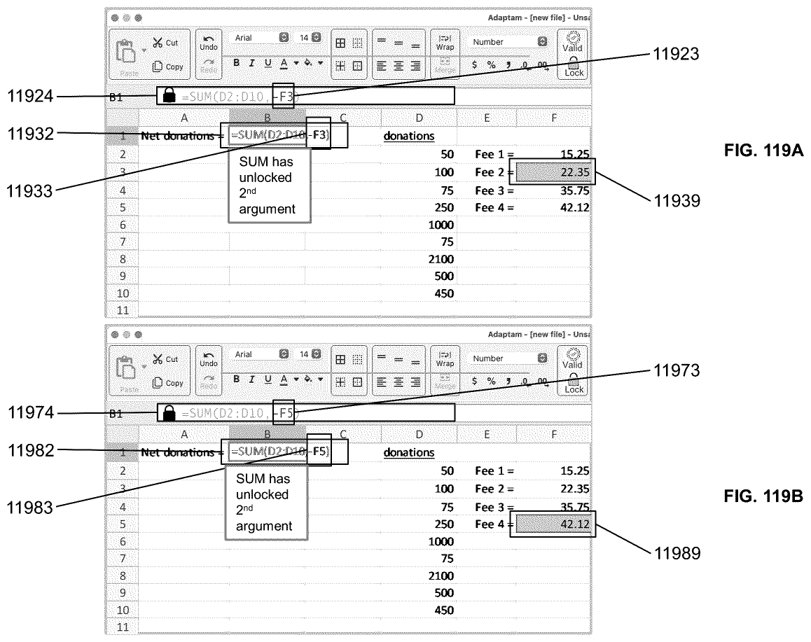

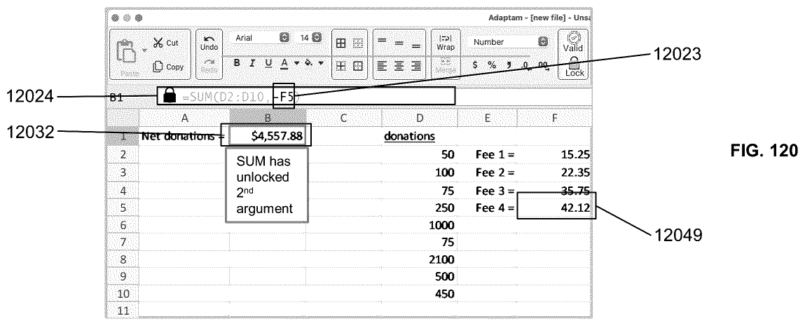

FIG. 119A examples a slightly different locking/unlocking highlighting approach along the lines of color coding of highlighted cell and cell ranges found in typical spreadsheets. In this embodiment the changeable unlocked argument are color coded to their referenced cell or cell ranges once the user double clicks into the cell formula. In this example double clicking into the cell ‘B1’ 11932. At that point the in-cell formula color codes the changeable argument ‘-F3’ 11933 red and highlights the cell ‘F3’ 11939 red. It also highlights the changeable argument ‘-F3’ 11923 red in the formula bar. Note, in this embodiment when the user double clicked to open the in-cell formula 11932 it did not populate a lock in that in-cell formula 11932 but it could have. It did however grey and disable the locked argument. When the user replaces the ‘-F3’ argument 11933 in the in-cell formula 11932 or with ‘-F5’ 11983 in the in-cell formula 11982 in FIG. 119B it automatically changes the value to ‘-F5’ 11973 in the formula bar formula 11974 and highlights the cell ‘F5’ 11989 red. When they hit ENTER they then get the changed ‘SUM’ formula cell value ‘$4,557.88’ 12032 in FIG. 120. The partially locked formula shows the change to the ‘-F5’ argument 12023 in the formula bar 12024. Thus, exampling our partial locking of the regular ‘SUM’ function. Note, the changed ‘SUM’ value is usable by other cells and cell formulas within the spreadsheet referencing it whether those cells are fully locked, partially locked or unlocked. Note the same change in outcome would have occurred had the user changed the ‘-F5’ 11973 in the formula bar formula 11974 in FIG. 119B from the value ‘-F3’ 11923 in the formula bar formula 11924 in FIG. 119A.

### Partial Locking of Typical Spreadsheet Prebuilt Functions—XLOOKUP

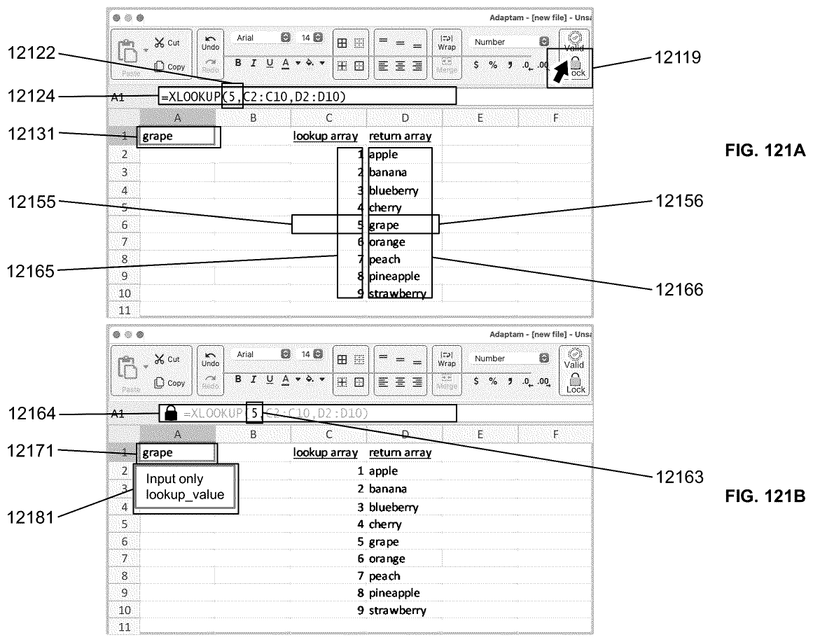

FIG. 121A examples a three argument ‘XLOOKUP’ prebuilt function formula 12124 in cell ‘A1’ 12131. The first argument is the value ‘5’, the second argument references the cell range ‘C2:C10’ 12165 while the third argument references the cell range ‘D2:D10’ 12166. These arguments could have been any of the type accepted by an ‘XLOOKUP’ function and generate the value ‘grape’ 12131 from the ‘grape’ value 12156 in the range ‘D2:D10’ 12166 corresponding to the value ‘5’ 12155 matching the first argument value ‘5’ 12122 found in the range ‘C2:C10’ 12165. The user then starts the locking in this embodiment by clicking the ‘Lock’ ribbon button 12119, although it could have been done with menu selections or other modes. There are many ways to lock the function, FIG. 134B examples one such way. In this embodiment the clicking of the ‘Lock’ button 13469 displays the ‘Locking’ selection UI 13487 for the cell ‘A1’ 13461 with the cell formula 13464. It presents the user with three check box selectors 13464/13474/13484 for the user to ‘Select one or two arguments to unlock:’ 13465. This ensures that at least one of the arguments is locked and at least one is unlocked thereby creating a partial lock. In this example the user clicks the ‘5’ 13464 check box and then clicks ‘OK’ 13498 to get the partially locked ‘XLOOKUP’ formula 12164 for the cell ‘B1’ ‘grape’ 12171 value in FIG. 121B. It also automatically changes the formula bar formula 12164 to contain a lock and greys the argument that are locked leaving only the argument ‘5’ 12163 that are unlocked black. The black unlocked argument are then changeable while the greyed argument are locked and unchangeable in this embodiment. Our technology also automatically generates a locking input message 12181 informing the user in a UI ‘Input only lookup value’. Thereby, informing the user of what they can change and what they cannot change by in this situation telling the user what they can only change. There are many ways to communicate what is locked and what is not, and our technology automatically generates that message and will automatically change it should the locking be altered. While there are many different ways to differentiate the locked arguments from the unlocked arguments for simplicity of focusing on the functionality of what is being done by our technology, we are using an approach previously discussed.

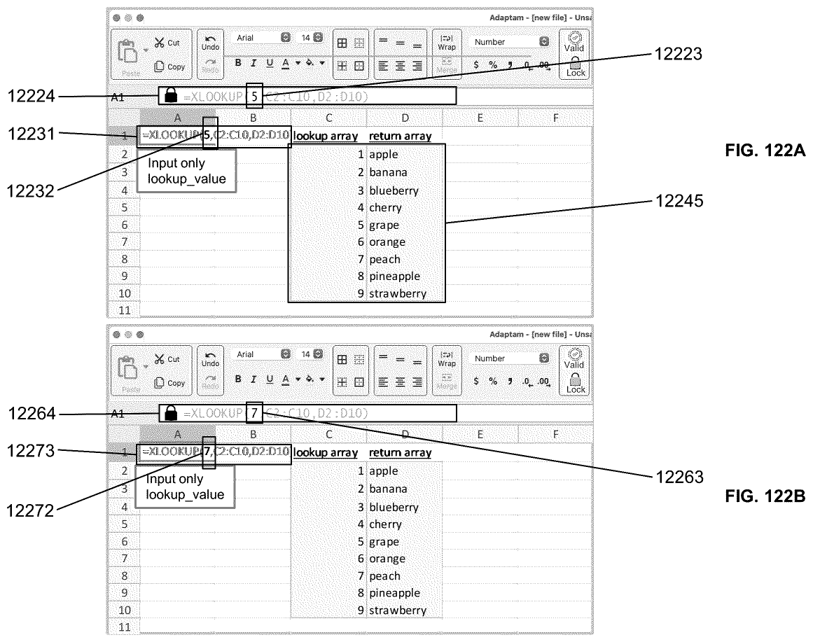

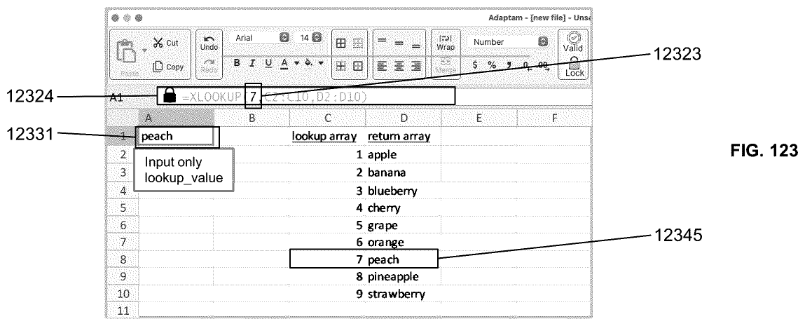

FIG. 122A and FIG. 122B example the user then changing the unlocked argument values in the partially locked ‘XLOOKUP’ formula setup in FIG. 121B. In this example the user double clicks into the cell ‘A1’ 12231 to open the cell formula ‘=XLOOKUP’ which has only the first argument 12232 shown in black indicating it is changeable and the other arguments are greyed out. The user could have clicked into the formula bar formula 12224 to change the first argument 12223 also shown in black indicating it is changeable with the other arguments greyed out. In FIG. 122B the user changes the first argument value to ‘7’ 12272 in the in-cell formula 12273 and when they hit ENTER they then get the changed ‘XLOOKUP’ formula cell value ‘peach’ 12331 in FIG. 123. Note the ‘7’ within the ‘C2:C10’ range gives the ‘peach’ value in the ‘D2:D10’ cell range 12345. The partially locked formula shows the change to the first argument 12323 in the formula bar 12324. Thus, exampling our partial locking of the regular ‘XLOOKUP’ function. Note, the changed ‘XLOOPUP’ value is the usable by other cell formulas within the spreadsheet referencing whether those cells are fully locked, partially locked or unlocked. Note the same change in outcome would have occurred had the user changed the ‘7’ 12263 in the formula bar formula 12264 in FIG. 122B from the value ‘5’ 12223 in the formula bar formula 12224 in FIG. 122A

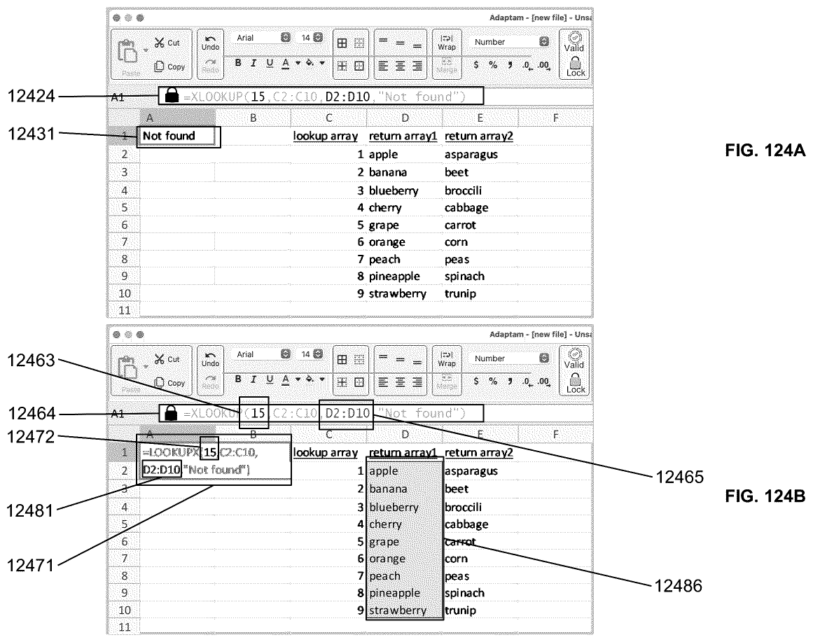

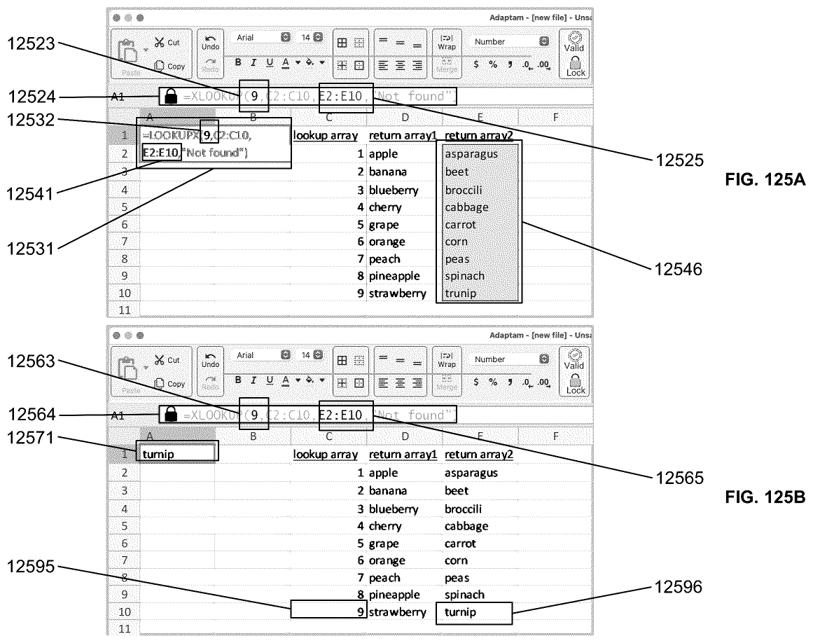

FIG. 124A examples two unlocked arguments in a partially locked cell formula and a slightly different locking/unlocking highlighting approach changing the color coding to match the referenced unlocked cell or cell ranges within the partially locked formula. This color coding, similar to existing spreadsheets, happens once the user double clicks in this example into the cell ‘A1’ 12431. Or clicks into the formula bar formula 12424. At that point the in-cell formula color codes the changeable arguments that reference a cell or a cell range, in this example the ‘D2:D10’ arguments 12481 in the in-cell formula 12471 and 12465 in the formula bar formula 12464 red and highlights the spreadsheet cell range 12486 red. In this embodiment our technology did not color code differently from black the changeable argument ‘15’ 12472/12463 which did not reference a cell as there was no spreadsheet cell to color code but did gray the locked argument. Note, in this embodiment when the user double clicked to open the in-cell formula 12471 it did not populate a lock in that formula 12471 but it could have. It did however display the two locked arguments grey and disabled. When the user replaces the first unlocked argument value of ‘15’ 12472/12463 in FIG. 124B with ‘9’ 12532/12523 in FIG. 125A and the second unlocked argument value of ‘D2:D10’ in the in-cell formula 12471 and 12465 in the formula bar formula 12464 in FIG. 124B with ‘E2:E10’ in the in-cell formula 12541 and 12525 in the formula bar formula 12524 in FIG. 125A our technology automatically changes the cell red highlighting 12486 in FIG. 124B to the red highlighting 12546 in FIG. 125A. When the user hits ENTER they then get the changed ‘XLOOPUP’ formula cell value ‘turnip’ 12571. The partially locked formula shows the changes to the two changeable arguments, the first argument ‘9’ 12563 and the third argument ‘E2:E10’ 12565 in the formula bar 12564. Thus, exampling our partial locking of the regular ‘XLOOKUP’ function, in this example locking two arguments and leaving unlocked two arguments. Note, the changed ‘XLOOKUP’ value is usable by other cells and cell formulas within the spreadsheet referencing it whether those cells are fully locked, partially locked or unlocked. Also note that change to both arguments is reflected in the ‘turnip’ value in cell ‘A1’ 12571 being generated the matching of the ‘turnip’ value in cell ‘E10’ 12596 to the ‘9’ value in cell ‘C10’ 12595.

While we could example the partial locking of many more existing spreadsheet functions having two or more arguments, for brevity's sake we will move on to exampling our partial locking of the cell validation capability in our technology.

### Partial Locking—Cell Validation Capability

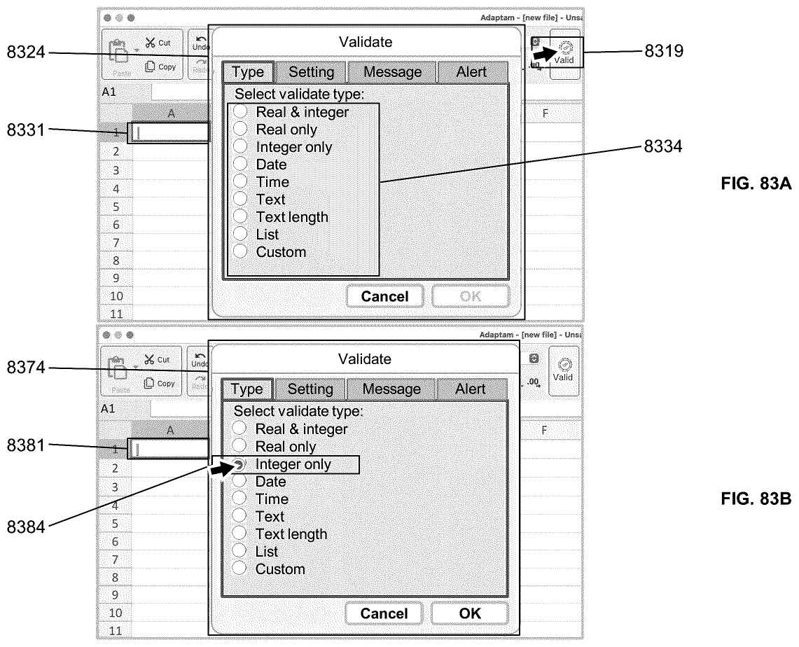

Thus far we have exampled our partial locking capability for locking in cell formulas, however it is applicable to the cell validation capability available in typical spreadsheets and exampled in our prior art examples FIG. 24A through FIG. 39B. In those examples we demonstrated how today's spreadsheets do either lock or unlock validated cells but have no partial locking. In FIG. 83A through FIG. 88D we will example how our partial locking technology works for a representative cell validation capability.

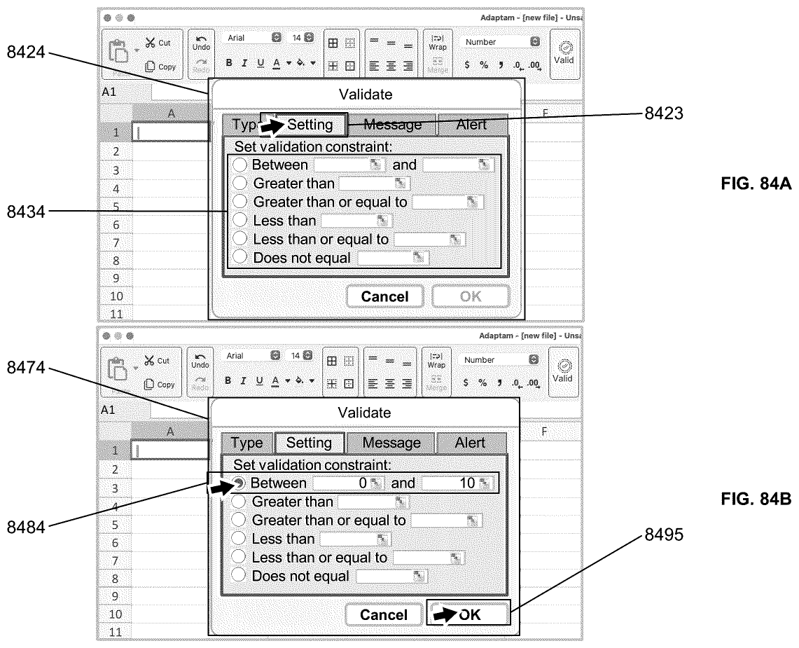

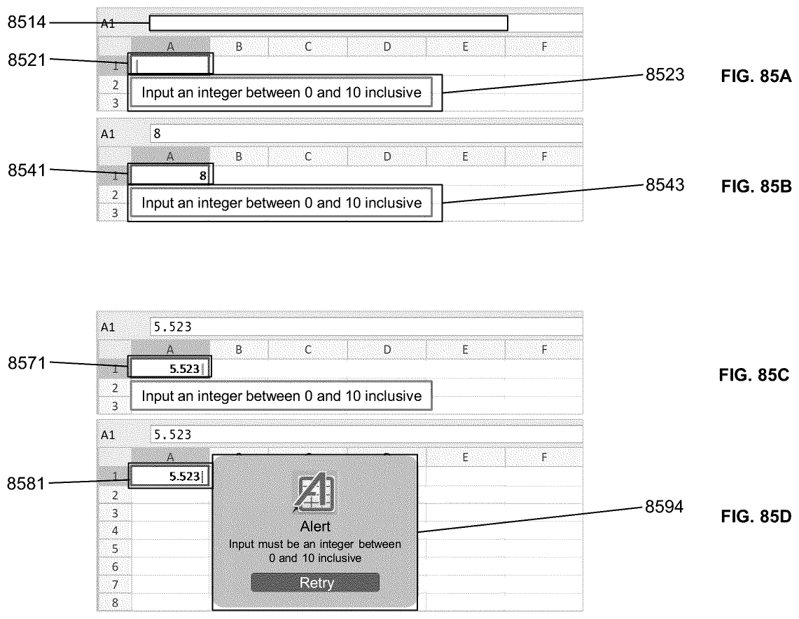

FIG. 83A and FIG. 83B examples a user setting up an integer cell validation in our technology, in a manner similar to other spreadsheets. In this example the user highlights the cell ‘A1’ 8331 and clicks the ‘Valid’ button 8319 on the spreadsheet ribbon to open the ‘Validate’ popup 8324 with the ‘Type’ selection list 8334 open. That selection list 8334 contains a number of numeric, text, date/time, list, and custom example options but could contain any other type of option employed by the other spreadsheets. In this example the user selects the ‘Integer only’ option 8384 for cell ‘A1’ 8381 in the ‘Type’ selection list within the Validate’ popup 8374 and then clicks the ‘Setting’ tab 8423 in FIG. 84A. This opens the ‘Set validation constraint’ options 8434, which like in other spreadsheets gives a set of validation constraints the user can set. We put in a representative set of validation options 8434 but support all those done by other spreadsheets. The user then selects the ‘Between’ option 8484 in the selection list 8474 in FIG. 84B and fills in the two between values ‘0’ and ‘10’ 8484. When the user clicks ‘OK’ 8495 they get the outcome in FIG. 85A. Our technology automatically generates an input message ‘Input an integer between 0 and 10 inclusive’ 8523 that tells the user both the data type constraint and the values constraint. Because the user has still put no value in cell ‘A1’ 8521 the only thing there is the cursor and because it is a capability the formula bar 8514 has no formula. In FIG. 85B when the user inputs ‘8’ into cell ‘A1’ 8541 and the input is accepted because it passes the validation constraints. However, if the user instead tries to enter ‘5.523’ in cell ‘A1’ 8571 in FIG. 85C then the validation constraint of integer is violated and instead of accepting the value the user gets an error ‘Alert’ 8594 as exampled in FIG. 85D with an automatic message of what the input needs to be in this embodiment ‘Input must be an integer between 0 and 10 inclusive’. And they are asked to ‘Retry’ until they enter a valid input into cell ‘A1’ 8581.

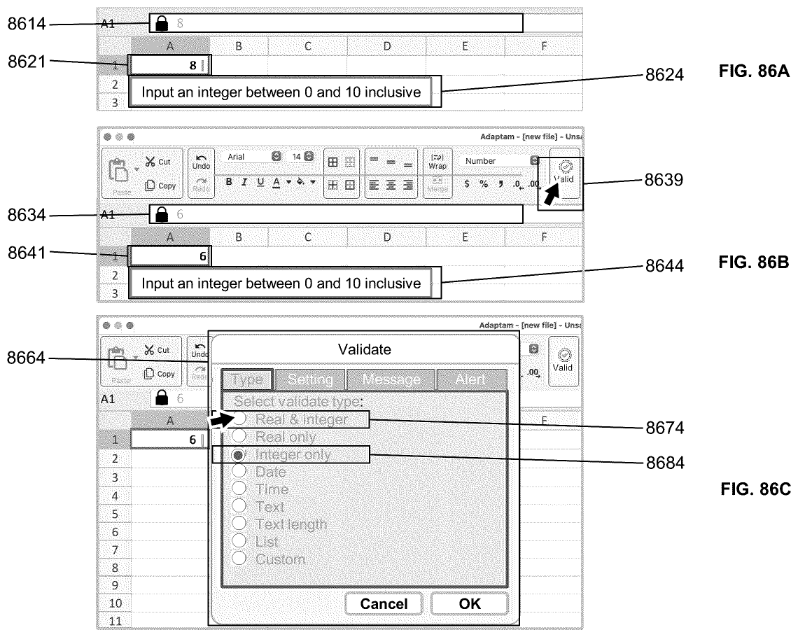

Having exampled how our cell validation capability works the user employs our partially locking technology to lock ‘A1’ 8621 in FIG. 86A which was previously the validated cell ‘A1’ 8541 in FIG. 85B. In this embodiment, like our previous partially locking embodiments, a lock shows up in the formula bar 8614 and the value there of ‘8’ is greyed, while the value in the cell looks like normal and is changeable like it were unlocked. This could be done differently with the formula bar value also accepting changes to the value ‘8’ as what is locked are the validation constraints, ‘Message’, and ‘Alert’ specifications specified before the locking.

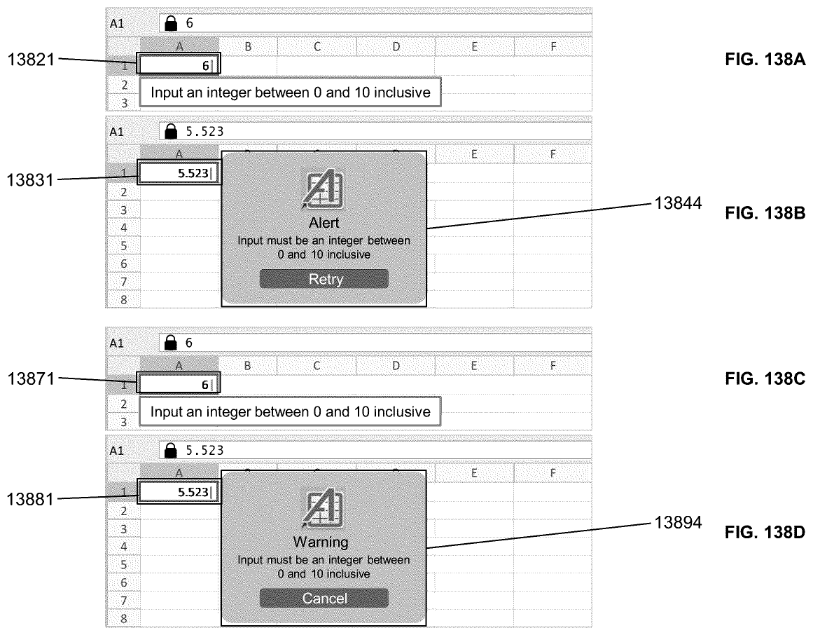

Once the cell is partially locked in our technology the value inputted can be changed as exampled in FIG. 86B where the user changed the value ‘8’ 8621 in FIG. 86A to ‘6’ 8641 in FIG. 86B which was accepted because it passed the validation constraints, and the value input is unlocked while the validation type, setting, message and alert specifications are locked. As in the unlocked state in the partially locked state if the user inputs a value that does not pass the validation constraint or constraints, they get the value rejected ‘Alert’ as exampled in 13844 in FIG. 138B when the user attempted to input ‘5.523’ 13831 into the partially locked validation cell ‘A1’ 13821 in FIG. 138A, which is the cell ‘A1’ in 8634 in FIG. 86B. In a slightly different embodiment or the same embodiment where the user has selected a warning instead of rejection, they get a “Warning” 13894 in FIG. 138D as when the user attempts to input ‘5.523’ 13881 into the partially locked validation cell ‘A1’ 13871 in FIG. 138C, which is the cell ‘A1’ in 8634 in FIG. 86B.

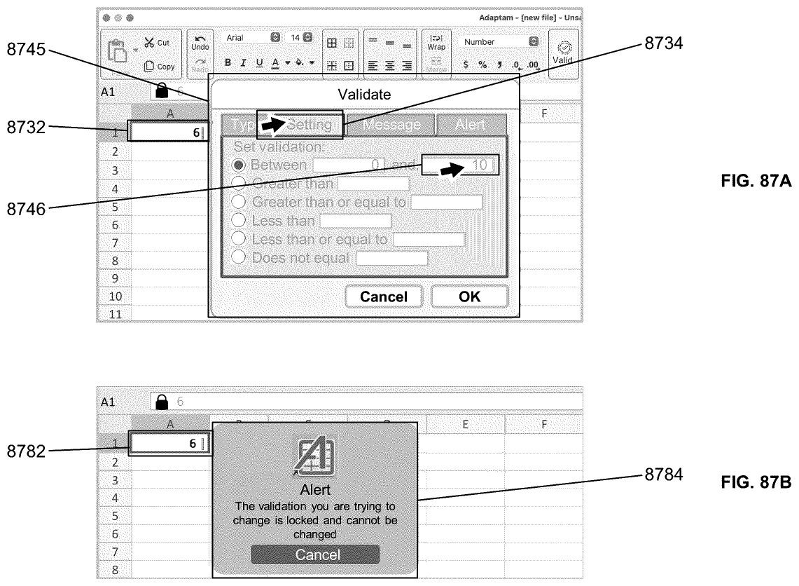

Returning back to FIG. 86B the user then attempts to change the validation by clicking for cell ‘A1’ 8641 in and then clicking the ‘Valid’ button 8639 in the ribbon. In this embodiment this opens the ‘Validate’ popup 8664 in FIG. 86C however with the content of all of the tabs locked as the user finds out when they attempt to change the ‘Integer only’ selection 8684 to the ‘Real and integer’ selection 8674. Instead of recording and making the change our technology gives then the error ‘Alert’ 8784 in FIG. 87B which tells the user ‘The validation you are trying to change is locked and cannot be changed’. Therefore, not allowing them to change the validation for cell ‘A1’ 8782 in FIG. 87B. Thus, exampling the partial locking where the validation is locked but the value input is unlocked. FIG. 87A examples the same result if a user attempts to make a change 8746 on the ‘Setting’ tab 8734 in the ‘Validate’ popup 8745 for cell ‘A1’ 8732 which in this embodiment delivers the same error ‘Alert’ 8784 in FIG. 87B which tells the user ‘The validation you are trying to change is locked and cannot be changed’. Therefore, also not allowing them to change the validation for cell ‘A1’ 8782 in FIG. 87B. In this embodiment attempting to make changes on the ‘Validate’ ‘Type’, ‘Setting’, ‘Message’ and ‘Alert’ tabs would generate the same error outcome as exampled in FIG. 87B. Other embodiments or our technology would support the unlocking of one or more of those tabs as long as at least one tab is locked, thus resulting in partial locking of the validation capability.

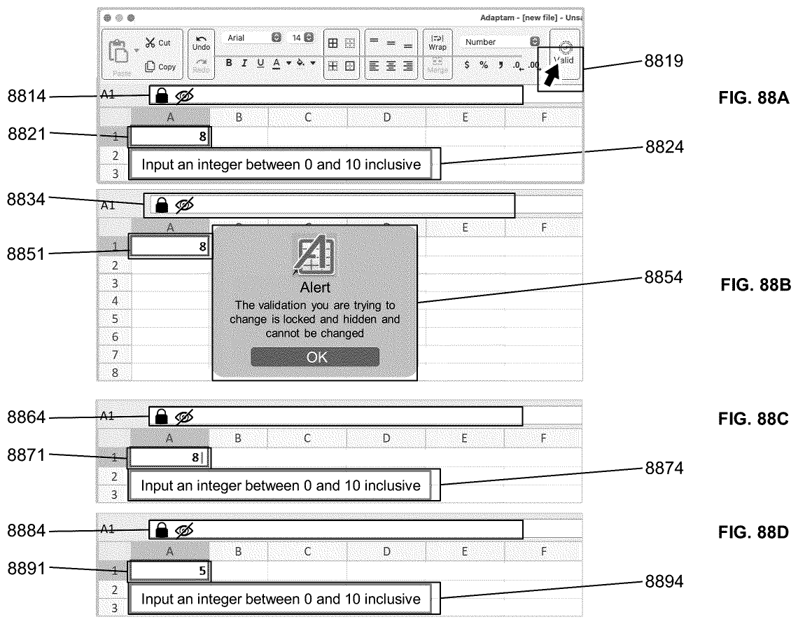

FIG. 88A and FIG. 88B examples what happens if the user employs our technology to partially lock and hide the cell ‘A1’ 8821 in FIG. 88A which previously was the validated cell ‘A1’ 8541 in FIG. 85B. As we have previously exampled the cell input value ‘8’ can be changed by any input that fulfils the validation constraints as laid out in the input message 8824. However, if the user tries to change the validation as they attempt to do for cell ‘A1’ 8821 clicking the ‘Valid’ button 8819 in the ribbon in FIG. 88A, they immediately get the error Alert’ 8854 in FIG. 88B which tells them ‘The validation you are trying to change is locked and hidden and cannot be changed’. Therefore, not allowing them to change the validation for cell ‘A1’ 8851 in FIG. 88B. They also were unable to see any of the validation set up which was hidden and, in this embodiment, that is communicated to the user via the slash eye accompanying the lock in the formula bar and the ‘hidden’ in the error Alert’ 8854 in FIG. 88B. The value ‘8’ was also hidden in the formula bar by the hiding although in other embodiments the value ‘8’ is not hidden in the formula bar. Other modes could be employed to communicate the locking and the hiding, but we have kept our examples simple employing a common approach across all.

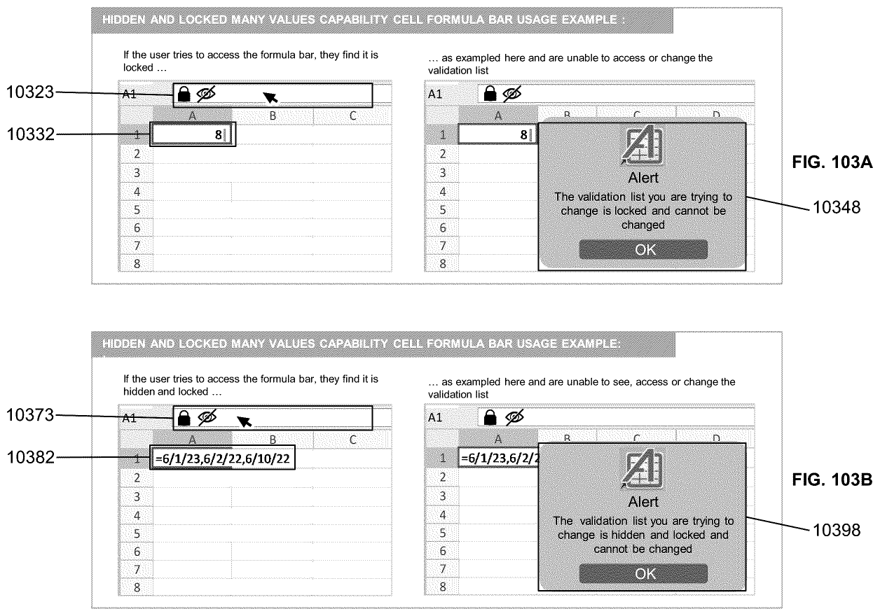

FIG. 103A examples a similar locking and hiding outcome if the user attempts to access the validation setup by clicking into the formula bar 10323 for cell ‘A1’ 10332, Instead of gaining access to the validation setup the user immediately gets the error Alert’ 10348 in FIG. 103A telling the user that ‘The validation you are trying to change is locked and cannot be changed’. In other embodiments clicking into the formula which only shows the value allows the user to change that value, subject to validation, but also allows no access to the validation setup which is hidden.

FIG. 88C and FIG. 88D example the validation working correctly post locking and hiding by allowing the changing of the value ‘8’ in the partially locked and hidden validation cell ‘A1’ 8871 in FIG. 88C to the value ‘5’ in cell ‘A1’ 8891 in FIG. 88D. It of course would warn and/or reject an invalid input if for example the user inputted ‘50’ which is clearly not within the validation constraints visible in the message accompanying the cell 8874 in FIG. 88C and 8894 in FIG. 88D. While we could example our partial locking and partial locking and formula hiding technology for all of the different validation types, but because they work in a similar manner to the examples in FIG. 83A through FIG. 88D we will move on to exampling a new type of validation supported by our technology.

### Cell Multi-Value Validation Capability

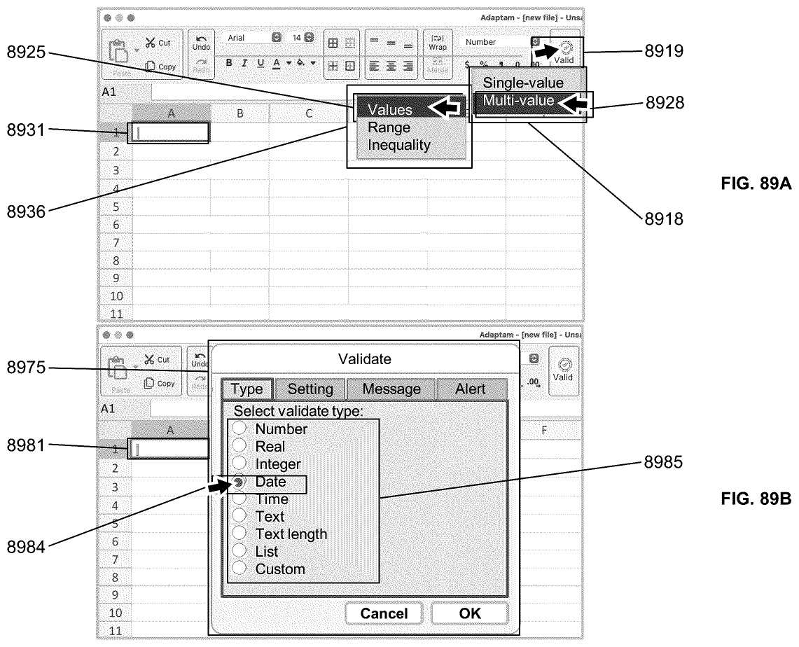

Our U.S. application Ser. No. 17/359,418 titled “Methods and Systems for Presenting Drop-Down, Pop-Up or Other Presentation of a Multi-Value Data Set in a Spreadsheet Cell,” filed 25 Jun. 2021, now U.S. Pat. No. 11,657,217, issued 25 May 2023 created prebuilt functions populating within a cell more than one value selected from a list. Those multiple values where then usable in other cell formulas referencing the cell, e.g., a summation formula summing the values. Our new technology supports a user entering in different forms a set of multiple values with a cell that are validated by a new multi-value validating capability. Those sets of multiple values can be entered into a cell directly or in a prebuilt function as individual values, a range, or an inequality as exampled in FIG. 89A through FIG. 117B.

### Cell Multi-Value Validation Capability—Individual Values Input

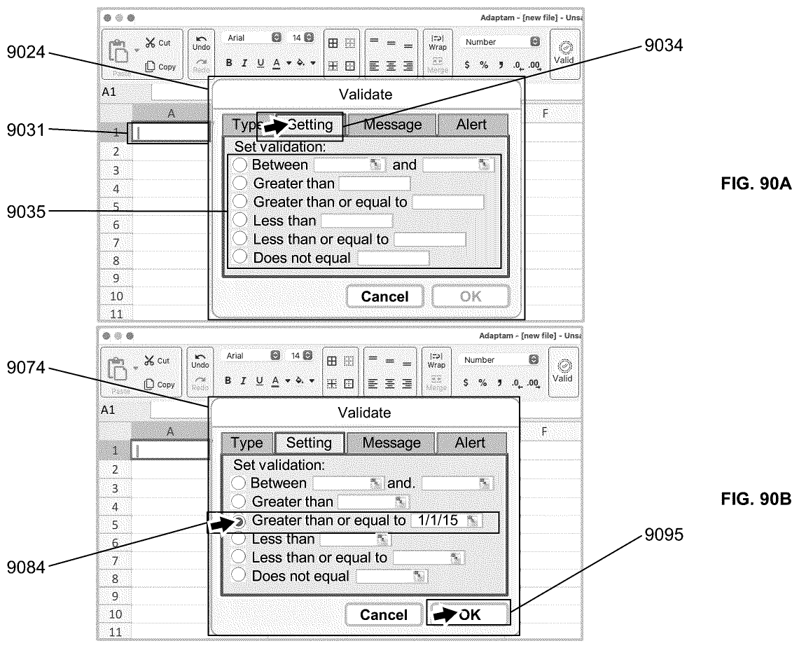

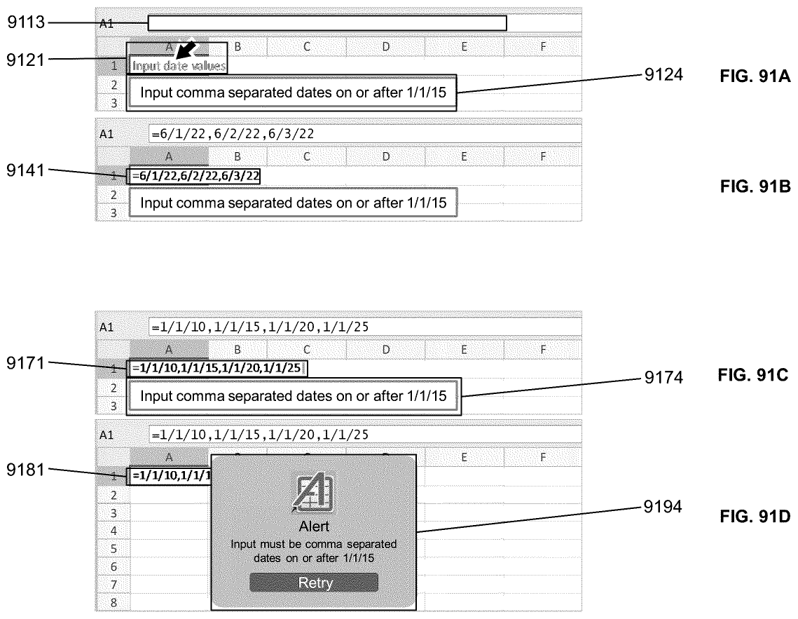

FIG. 89A examples a user beginning the set up a multi-value validation cell capability in our technology. In this embodiment they start by clicking the ‘Valid’ button 8919 on the spreadsheet ribbon for the cell ‘A1’ 8931. However, they could have started many other ways, such as from a menu selection. The click 8919 opens a popup selector 8918 which gives the user two options, ‘Single value’ and ‘Multi-value. The user clicks the ‘Multi-value’ selection 8928 to open the multi-value options popup 8936 where the user selects the ‘Values’ selection 8925 to open to open the ‘Validate’ popup 8975 with the ‘Type’ selection list open in FIG. 89B. That ‘Type’ selection list 8985 contains a number of numeric, text, date/time, list, and custom example options but like our previous example list could contain any other type of option employed by the other spreadsheets. The difference in this situation is the data type constraint will be applied to more than one value populated in the spreadsheet cell. In this example the user selects the ‘Date’ option 8984 in the ‘Type’ selection list within the Validate’ popup 8975 for cell ‘A1’ 8981 and then clicks the ‘Setting’ tab 9034 in FIG. 90A for cell ‘A1’ 9031. This opens the ‘Setting’ ‘Set validation:’ options 9035, which like in other spreadsheets gives a set of validation constraints the user can set. We put in a representative set of validation options 9035 but our multiple value in a single cell validate technology supports all those done by other spreadsheets. The user then selects the ‘Greater than or equal to’ option 9084 in the selection list 9074 in FIG. 90B and fills in the date ‘1/1/15’. When the user clicks ‘OK’ 9095 they get the outcome in FIG. 91A. Our technology automatically generates an input message ‘Input comma separated dates on or after 1/1/15’ 9124 that tells the user both the data type constraint and the values constraint and the input syntax. Because the user has still put no values in cell ‘A1’ 9121 the only thing there is the placeholder ‘Input date values’ and because it is a capability the formula bar 9113 has no formula. In FIG. 91B when the user inputs three comma separated dates ‘=6/1/22,6/2/22,6/3/22’ into cell ‘A1’ 9141 and the input is accepted because it passes the validation constraints. However, if the user instead tries to enter ‘=1/1/10,1/1/15,1/1/20,1/1/25’ in cell ‘A1’ 9171 as exampled in FIG. 91C then the validation value constraint of date on or after 1/1/15 is violated and instead of accepting the values the user gets an error ‘Alert’ 9194 exampled in FIG. 91D with an automatic message of what the input needs to be in this embodiment ‘Input must be comma separated dates on or after 1/1/15’. And they are asked to ‘Retry’ until they enter a valid input into cell ‘A1’ 9181. Note, in this embodiment the multiple values were entered with an equals sign comma separated however other embodiments support different entry of the multiple values “within the cell or just “6/1/22,6/2/22,6/3/22” without the equals sign within the cell).

### Cell Multi-Value Validation Capability—Individual Values Input Partial Locking

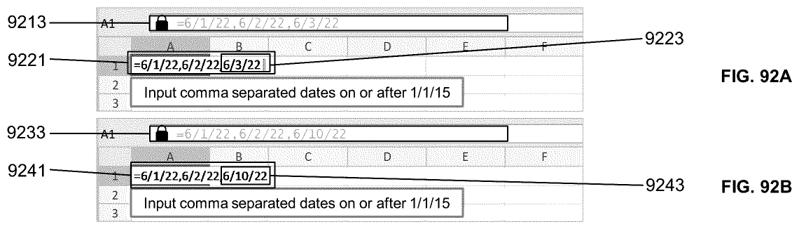

Having exampled how our cell validation capability works the user employs our partially locking technology to lock ‘A1’ 9221 in FIG. 92A which previously was the validated cell ‘A1’ 9141 in FIG. 91B. In this embodiment, like our previous partially locking embodiments, a lock shows up in the formula bar 9213 and the values there of ‘=6/1/22,6/2/22,6/3/22’ are greyed, while the value in the cell ‘A1’ 9221 looks like normal and is changeable like it were unlocked. This could be done differently with the formula bar value also accepting changes as what is locked is the validation constraints, ‘Message’ and ‘Alert’ and those are not a formula visible in the formula bar.

Once the cell is partially locked in our technology the values inputted can be changed as exampled in FIG. 92B where the user changed the value ‘6/3/22’ 9223 in cell ‘A1’ 9221 in FIG. 92A to ‘6/10/22’ 9243 in cell ‘A1’ 9241 FIG. 92B which was accepted because it passed the validation constraints, and the value input is unlocked while the validation constraints and other validation settings are locked. Note, the user could have changed more than one value, added values, or removed values as long as they did them within the unlocked part of the partial locking in this embodiment.

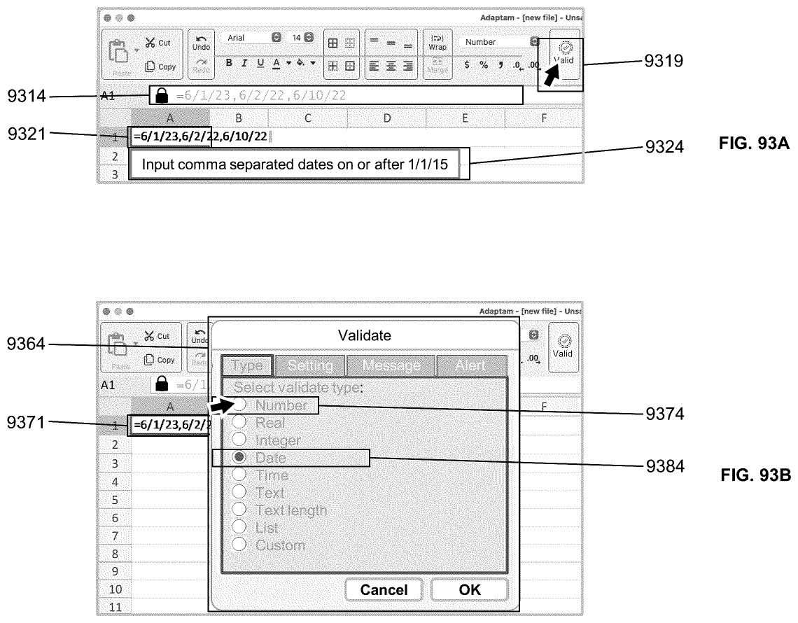

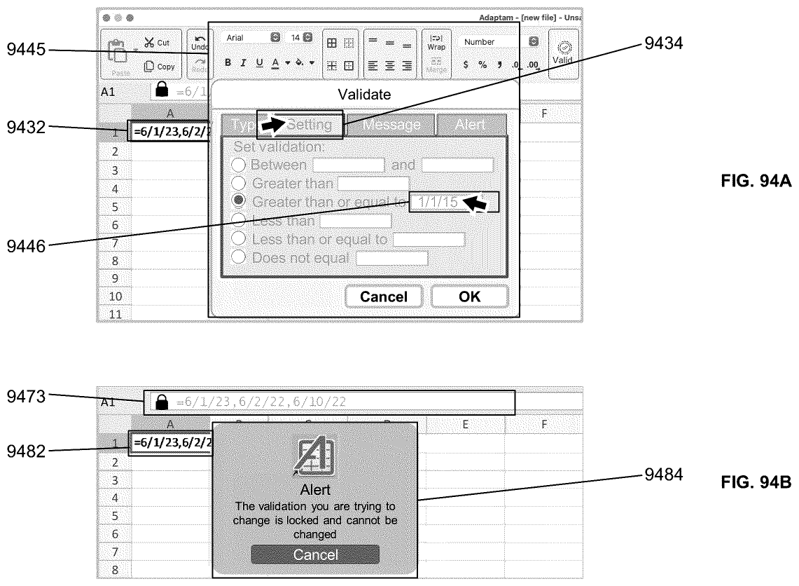

However, if the user then attempts to change the validation by clicking for cell ‘A1’ 9321 in FIG. 93A the ‘Valid’ button 9319 in the ribbon this embodiment opens the ‘Validate’ popup 9364 in FIG. 93B however with the content of all of the tabs locked as the user finds out when they attempt to change the ‘Date’ selection 9384 to the ‘Number’ selection 9374. Instead of recording and making the change our technology gives them the error ‘Alert’ 9484 in FIG. 94B which tells the user ‘The validation you are trying to change is locked and cannot be changed’. Therefore, also not allowing them to change the validation for cell ‘A1’ 9482/9371 in FIG. 94B/93B. Thus, exampling the partial locking where the validation is locked but the input is unlocked. FIG. 94A examples the same result if a user attempts to make a change 9446 on the ‘Setting’ tab 9434 in the ‘Validate’ popup 9445 which in this embodiment delivers the same error ‘Alert’ 9484 in FIG. 94B which tells them ‘The validation you are trying to change is locked and cannot be changed’. Therefore, also not allowing them to change the validation for cell ‘A1’ 9482/9432 in FIG. 94B/94A. In this embodiment attempting to make changes on the ‘Validate’ ‘Message’ and ‘Alert’ tabs would also generate the same error outcome in FIG. 94B. Note, other embodiments of our technology support unlocking one or more of those ‘Validate’ tabs provided at least one tab is locked so that there is partial locking.

### Cell Multi-Value Validation Capability—Individual Values Input Partial Locking and Hiding

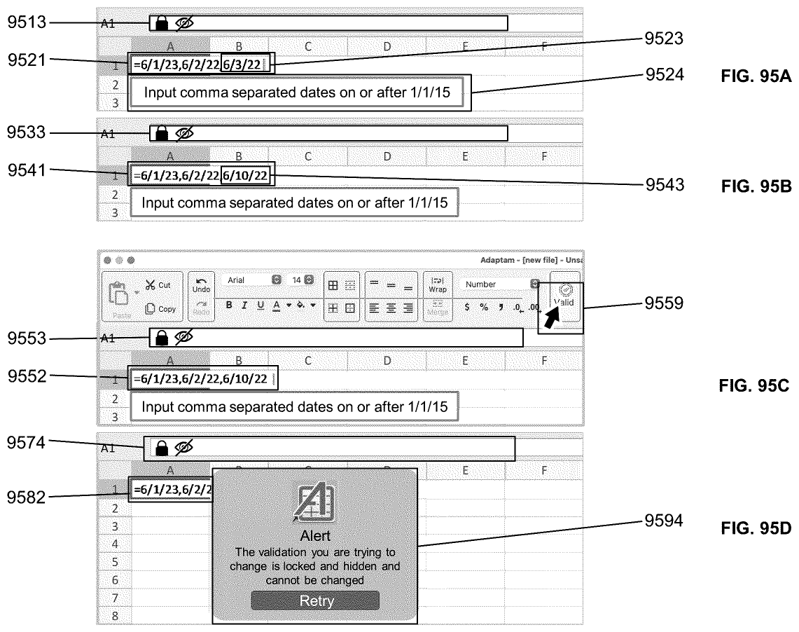

FIG. 95A and FIG. 95B examples what happens if the user employs our technology to partially lock and hide the formula of cell ‘A1’ 9521 in FIG. 95A which previously was the validated cell ‘A1’ 9141 in FIG. 91B. As we have previously exampled the cell input values can still be changed by any input that fulfils the validation constraints as laid out in the input message 9524. FIG. 95B examples where the user changed the value ‘6/3/22’ 9523 in cell ‘A1’ 9521 in FIG. 95A to ‘6/10/22’ 9543 in cell ‘A1’ 9541 in FIG. 95B the change was accepted because it passed the validation constraints, and the value input is unlocked while the validation constraints and other validation settings are locked and hidden. The user in this embodiment gets an indication that the validation is locked and hidden from the lock and the slash eye in the formula bar 9513/9533 in FIG. 95A/95B. The hiding becomes more obvious when the user tries to change the validation as they attempt to do for cell ‘A1’ 9552 clicking the ‘Valid’ button 9559 in the ribbon in FIG. 95C, they immediately get the error Alert’ 9594 in FIG. 95D which tells them ‘The validation you are trying to change is locked and hidden and cannot be changed’. Therefore, not allowing them to change the validation for cell ‘A1’ 9552/9582 in FIG. 95C/95D. They also were unable to see any of the validation set up which was hidden and, in this embodiment, that is communicated to the user via the slash eye accompanying the lock in the formula bar and the ‘hidden’ in the error Alert’ 9594 in FIG. 95D. The values ‘=6/1/22,6/2/22,6/3/22’ were also hidden in the formula bar by the hiding setup. However, in other embodiments those values are visible in the formula bar as what is hidden here are the Validate specifications. Other modes could be employed to communicate the locking and the hiding, but we have kept our examples simple employing a common approach across all.

FIG. 103B examples a similar locking and hiding outcome if the user attempts to access the validation setup by clicking into the formula bar 10373 for cell ‘A1’ 10382, instead of gaining access to the validation setup the user immediately gets the error Alert’ 10398 in FIG. 103B telling the user that ‘The validation you are trying to change is hidden and locked and cannot be changed’.

While we could example our partial locking and partial locking and formula hiding technology for all of the different validation data types, we will instead example one of the data types ‘List’ which has a different type of set up and use, as once set up the input is not an input of values but a selection of values and then a text example before moving to other types of multi-value validation capabilities in our technology.

### Cell Multi-Value Validation Capability—Individual Values Selection

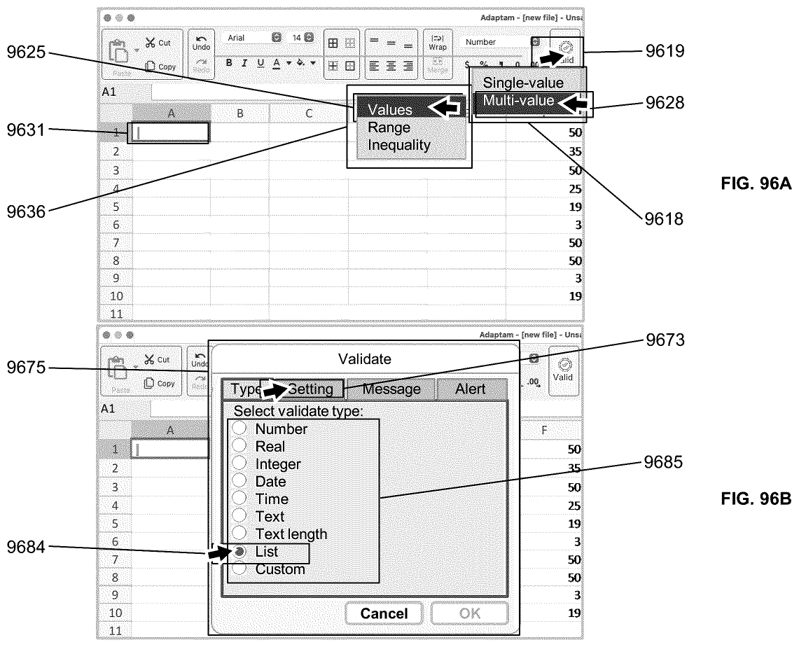

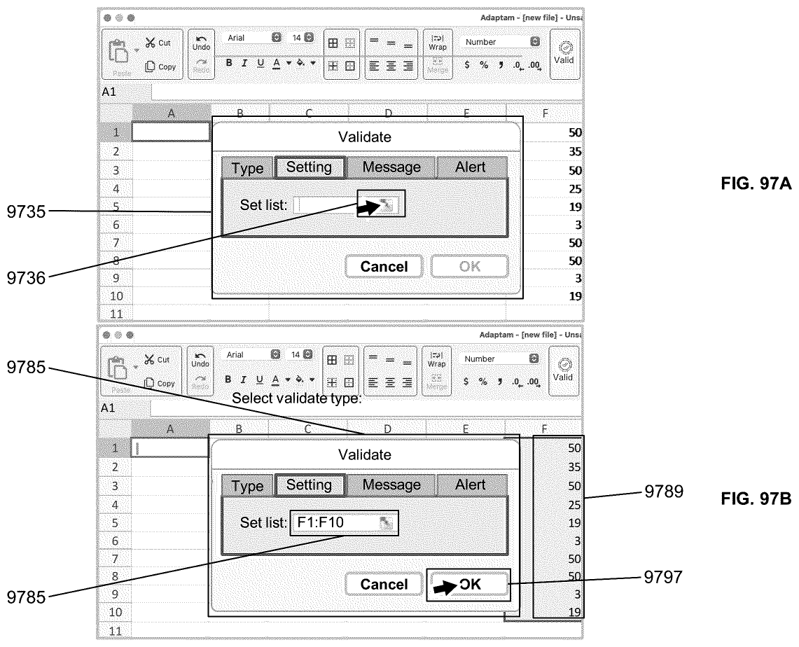

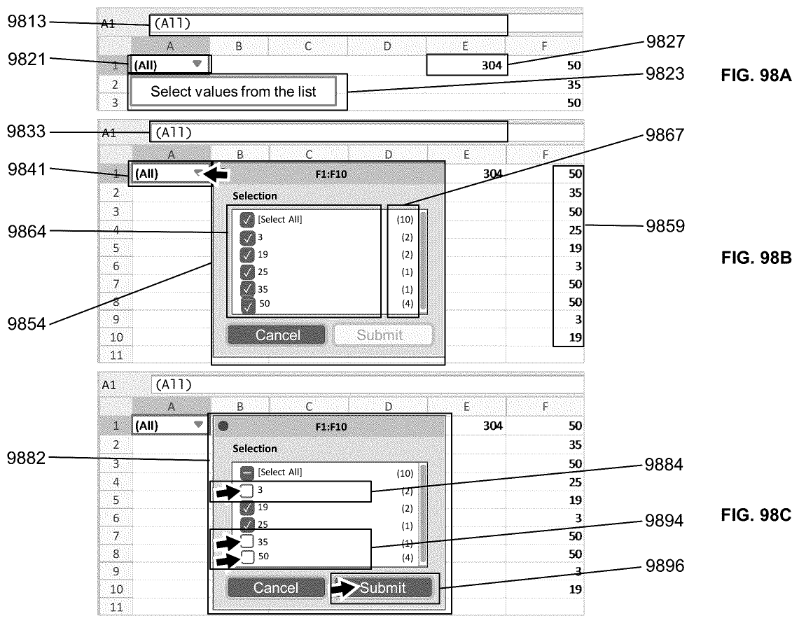

FIG. 96A starts like FIG. 89A with the user clicking the ‘Valid’ button 9619 on the spreadsheet ribbon for the cell ‘A1’ 9631. The click 9619 opens a popup selector 9618 which gives the user two options, ‘Single-value’ and ‘Multi-value. The user clicks the ‘Multi-value’ selection 9628 to open the multi-value options popup 9636 where the user selects the ‘Values’ selection 9625 to open the ‘Validate’ popup 9675 with the ‘Type’ selection list open in FIG. 97A. That ‘Type’ tab selection list 9685 contains a number of data type options including the ‘List’ option which the user selects 9684. The user then clicks the ‘Setting’ tab 9673 to open the ‘Setting’ tab of the ‘Validate’ popup 9735 as exampled in FIG. 97A. The user then elects to use the cell selector in the ‘Set list:’ box by clicking it 9736 and then highlighting the cell range ‘F1:F10’ 9789 to populate it in the ‘Set list:’ box 9785 in FIG. 97B. Once they click ‘OK’ 9797, in this embodiment, the cell ‘A1’ 9821 is populated with a set of “values in the list as exampled in FIG. 98A. The cell could have had a default ‘Select values’ or other starting population of the cell. Our technology automatically generates a “input” message ‘Select values from the list’ 9823 that tells they are selecting values rather than inputting values. The validation in this data type is that the user is limited to selecting values from the list and the cell will not accept any other values.

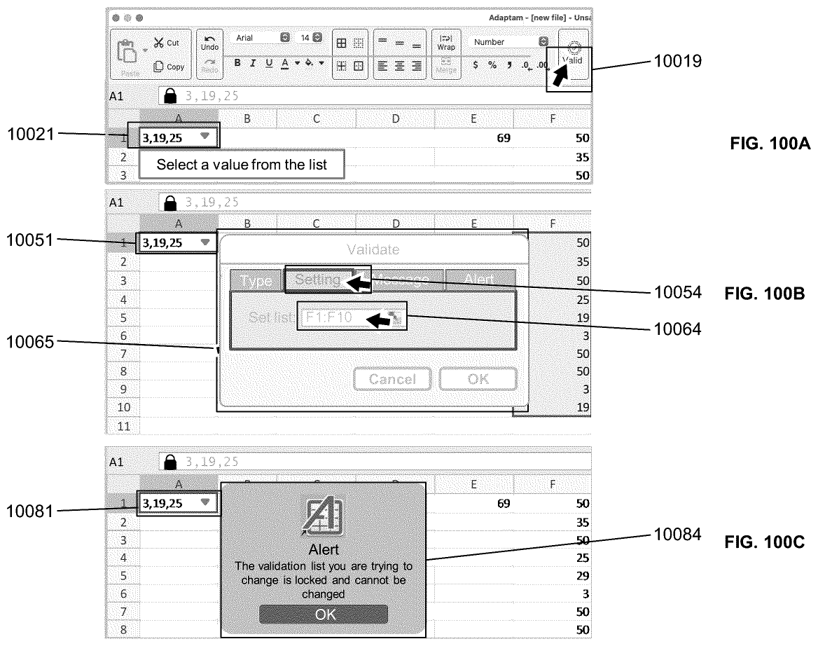

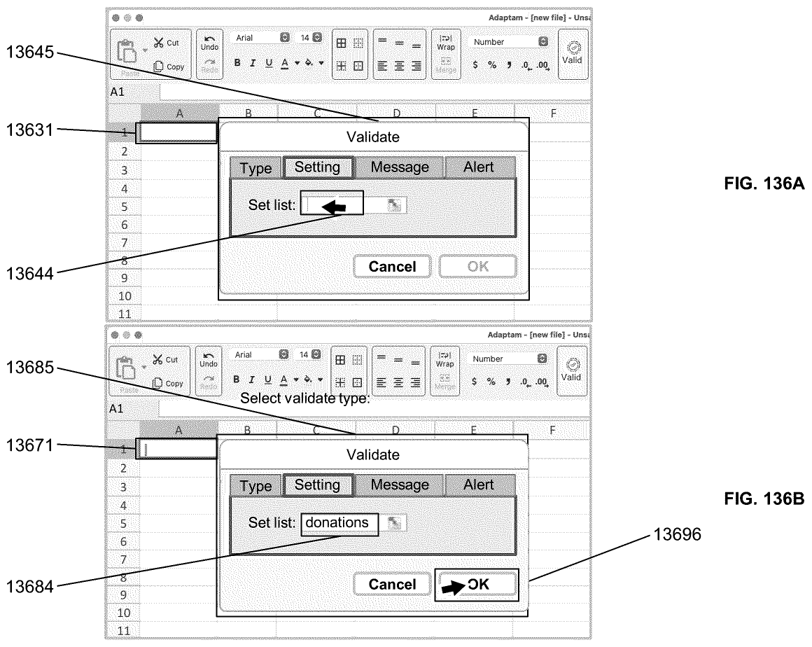

Note, our technology also works where instead of selecting a cell range to populate into the ‘Validate’ popup 13645 exampled in FIG. 136A the user places the cursor 13644 into the ‘Set list:’ box and populates one of our formulaic data fields as they have done with ‘donations’ 13684 in FIG. 136B. If ‘donations’ holds the same data as the cells referenced by ‘F1’‘F10’ 9785 in FIG. 97B then when the user hits ‘OK’ 13696 in FIG. 136B the user will get the same results as shown for cell ‘A1’ in FIG. 98A through FIG. 101B other than FIG. 100B 10064 will say ‘donations’ instead of ‘F1:F10’ because this example is working for the same cell ‘A1’ 13671 in FIG. 136B/13631 in FIG. 136A.

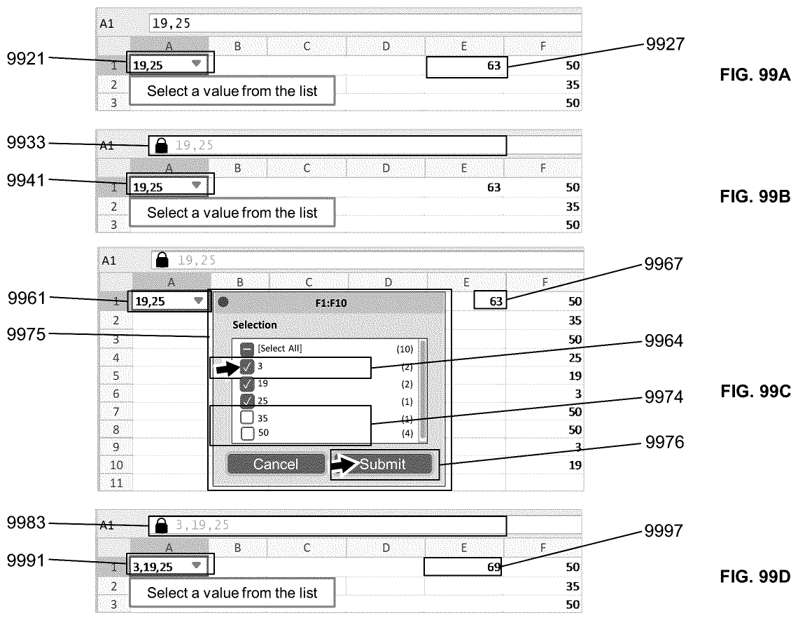

In FIG. 98B the user clicks into the cell ‘A1’ 9841 selection list to open the popup 9854 showing in this embodiment a sorted and deduped list of the selection list values. In FIG. 98C the user unclicks three of the values 9894/9894 and then clicks ‘Submit’ to populate the two values ‘19,25’ 9921 in cell ‘A1’ in FIG. 99A. In this embodiment those cell values are populated comma delimited with no equals sign, although they could be populated in other manners that our spreadsheet recognizes as individual numeric values not text. These values are then usable by other cells in formulas referencing the cell. For example, a cell with a SUM function referencing the cell ‘A1’ 9921 in FIG. 99A would sum all the values of ‘19’ and ‘25’ in the list in cells ‘F1:F10’ 9789 in FIG. 97B giving a result of 63 in cell ‘E1’ 9927. A COUNT formula referencing cell ‘A1’ 9921 would generate an answer of 3 while a COUNT UNIQUE formula referencing cell ‘A1’ 9921 would generate an answer of 2. Exampling that the values can be used by our functions described in U.S. application Ser. No. 17/359,418 titled “Methods and Systems for Presenting Drop-Down, Pop-Up or Other Presentation of a Multi-Value Data Set in a Spreadsheet Cell,” filed 25 Jun. 2021, now U.S. Pat. No. 11,657,217, issued 25 May 2023 which can utilize multiple value inputs from a single cell.

### Cell Multi-Value Validation Capability—Individual Values Selection Partial Locking

Having exampled how our cell list multiple value validation capability works the user employs our partially locking technology to lock ‘A1’ 9941 in FIG. 99B which previously was the validated cell ‘A1’ 9921 in FIG. 99A. In this embodiment, like our previous partially locking embodiments a lock shows up in the formula bar 9933 and the values there of ‘19.25’ are greyed, while the values in the cell ‘A1’ 9241 looks normal and are changeable like they were when the cell was unlocked. This could be done differently with the formula bar value also accepting changes as what is locked is the validation constraints and validation ‘Message’ and ‘Alert’ setup and those are not a formula visible in the formula bar.

Once the cell is partially locked in our technology the value inputted can be changed as exampled in FIG. 99C where the user clicked to add the population of the value ‘3’ 9964 in cell ‘A1’ 9961 which was accepted as exampled in cell ‘A1’ 9991 ‘3,19,25’ in FIG. 99D after the use clicks ‘Submit’ 9976 in FIG. 99C. The selection from the list works as it did before the cell was locked because it is the unlocked part of the partial locking. This is exampled by the summation formula in cell ‘E1’ 9997 referencing cell ‘A1’ 9991 in FIG. 99D changing its value to ‘69’ 9997 from ‘63’ 9967 pre the change of value in ‘A1’ 9961 in FIG. 99C.

However, if the user then attempts to change the selection list by clicking the ‘Valid’ button 10019 for cell ‘A1’ 10021 in FIG. 100A it opens ‘Validate’ popup 10065 but with the content of all of the tabs locked as the user finds out when they attempt to change the ‘Setting’ tab 10054 ‘Set list:’ specification of the list range ‘F1:F10’ 10064 and then gets the error ‘Alert’ 10084 in FIG. 100C. This error alert tells the user ‘The validation you are trying to change is locked and cannot be changed’. Therefore, also not allowing them to change the validation for cell ‘A1’ 10081/10051 in FIG. 100C/100B. Thus, exampling the partial locking where the list setting is locked but the selection from the list is unlocked.

### Cell Multi-Value Validation Capability—Individual Values Selection Partial Locking and Hiding

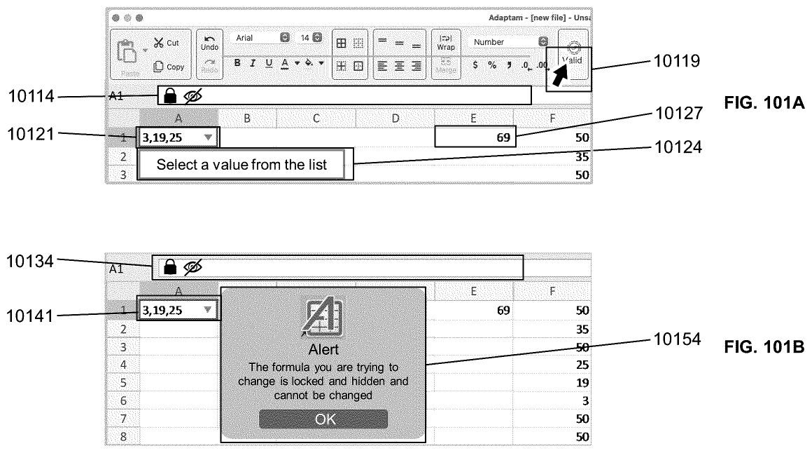

FIG. 101A and FIG. 101B examples what happens if the user employs our technology to partially lock and hide the formula of cell ‘A1’ 10121 in FIG. 101 which previously was the validated cell ‘A1’ 9921 in FIG. 99A. As we have previously exampled the cell selection values can be changed as if the cell were unlocked but the list from which the selections are made is locked and its formulaic variable or cell source is not visible to the partially locked and hidden user. The user in this embodiment gets an indication that the validation is locked and hidden from the lock and the slash eye in the formula bar 10114/10134 in FIG. 101A/101B. The hiding becomes more obvious when the user tries to change the list from which the selection values are sourced as they attempt to do for cell ‘A1’ 10121 clicking the ‘Valid’ button 10119 in the ribbon in FIG. 101A, they immediately get the error Alert’ 10154 in FIG. 101B which tells them ‘The validation you are trying to change is locked and hidden and cannot be changed’. Therefore, not allowing them to change the validation for cell ‘A1’ 10121/10141 in FIG. 101A/101B. They also were unable to see any of the validation set up which was hidden and, in this embodiment, communicated to the user via the slash eye accompanying the lock in the formula bar and the ‘hidden’ in the error Alert’ 10154 in FIG. 101B. Other modes could be employed to communicate the locking and the hiding, but we have kept our examples simple employing a common approach across all.

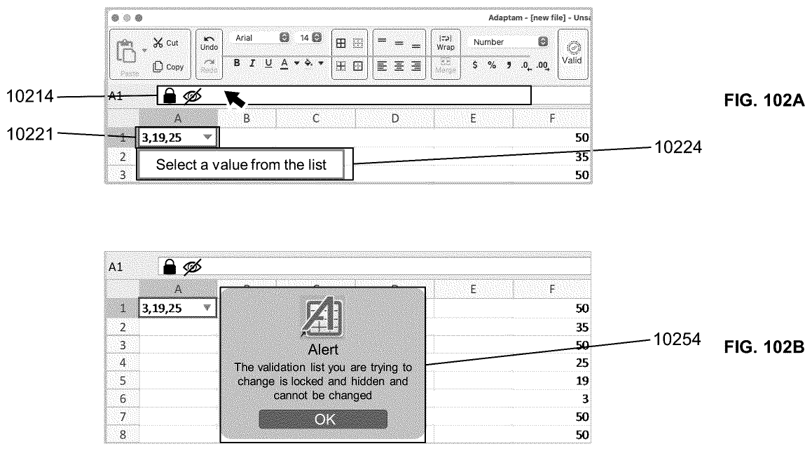

FIG. 102A and FIG. 102B examples a similar locking and hiding outcome if the user attempts to access the validation setup by clicking into the formula bar 10214 for cell ‘A1’ 10221, Instead of gaining access to the ‘List’ validation setup the user immediately gets the error Alert’ 10254 in FIG. 102B telling the user that ‘The validation you are trying to change is hidden and locked and cannot be changed’. Note, is some embodiments of our ‘Validate’ capability clicking into the formula bar does nothing and in others it gives access to the unlocked specifications.

### Cell Multi-Value Validation Capability—Individual Values Input in a Function

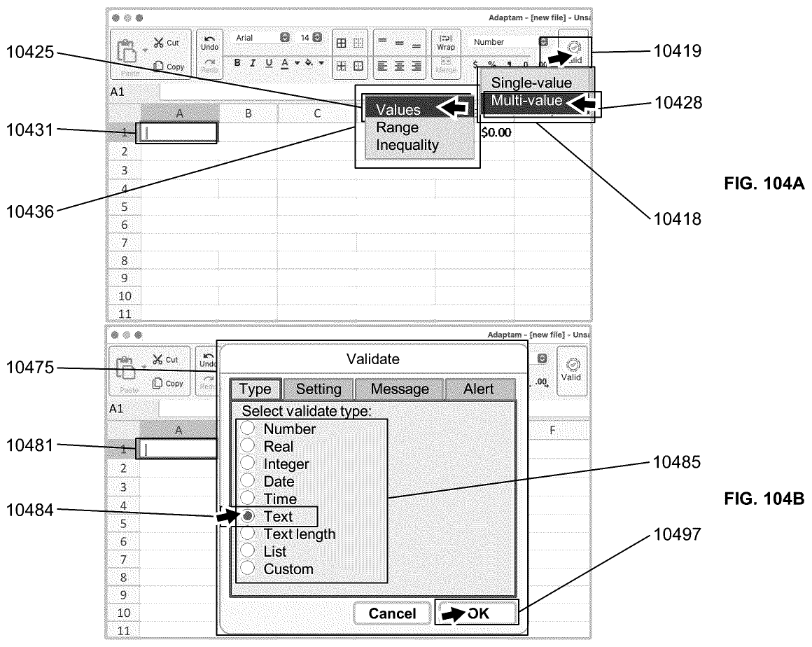

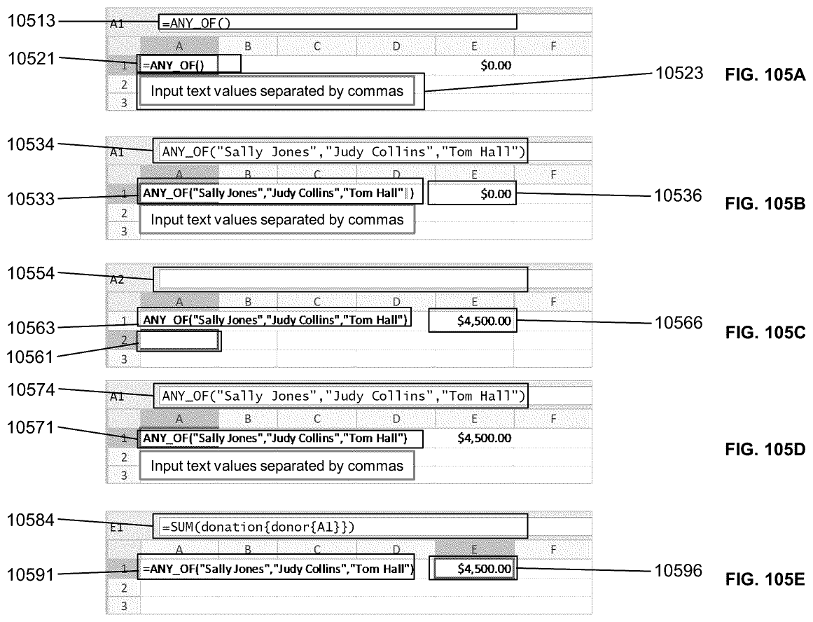

FIG. 104A examples a user beginning the set up a multi-value validation in our technology where the multiple values are populated with a function for use by other cells. In this embodiment they start by clicking the ‘Valid’ button 10419 on the spreadsheet ribbon for the cell ‘A1’ 10431. However, they could have started many other ways, such as from a menu selection. The click 10419 opens a popup selector 10418 which gives the user two options, ‘Single-value’ and ‘Multi-value’. The user clicks the ‘Multi-value’ selection 10428 to open the multi-value options popup 10436 where the user selects the ‘Values’ selection 10425 to open the ‘Validate’ popup 10475 with the ‘Type’ selection list open in FIG. 104B. That ‘Type’ selection list 10485 contains a number of numeric, text, date/time, list, and custom example options but like our previous example list could contain any other type of option employed by the other spread sheets. In this example the user selects the ‘Text’ option 10484 in the ‘Type’ selection list 10485 within the Validate’ popup 10475 for cell ‘A1’ 10481 and then clicks ‘OK’ 10497 to get the outcome in FIG. 105A. Our technology automatically generates an input message ‘Input text values separated by commas’ 10523 that tells the user the data type constraint and the input syntax for the automatically populated ‘=ANY_OF’ prebuilt spreadsheet function in cell ‘A1’ 10521 and shown in the formula bar 10513. In this embodiment the ‘ANY_OF’ function will hold the set of multiple values for referenced use by other cell formulas. Note, the ‘ANY_OF’ function can hold any type of data type values and what it will accept in this cell is controlled by the validation capability, in this example text. What the ‘ANY_OF’ function in this cell will accept would also be constrained by a validation values constraint had the user specified one. Because the user has not put any values in cell ‘A1’ 10521 the only thing there is ‘ANY_OF’ also shown in the formula bar 10513 in this embodiment. In FIG. 105B when the user inputs three comma separated text values ‘“Sally Jones”, “Judy Collins”, “Tom Hall”’ into the ‘ANY_OF’ function in cell ‘A1’ 10533 and then hits ENTER to find the input is accepted because it passes the validation text constraint as shown in its successful population in the cell ‘A1’ 10563 in FIG. 105C. Note the cell occupation moved to ‘A2’ 10561 as it would do in a normal spreadsheet after the successful entry of a value in ‘A1’. That input also results in a change in the value ‘$4,500.00’ in cell ‘E1’ 10566 compared to the value ‘$0.00’ in cell ‘E1’ 10536 in FIG. 105B. The population of the values in the ‘=ANY_OF’ 10571/10574 exampled in FIG. 105D is referenced by the formula in cell ‘E1’ 10596 in FIG. 105E with its formula bar displaying the formula ‘=SUM))’ for that cell. This formula uses our formulaic data values and does the summation of the donations for the donors Sally Jones, Judy Collins, and Tom Hall which totals ‘$4,500.00’ 10596. While the summation of the donations for the no donors in FIG. 105B 10536 totals ‘$0.00’. Exampling how our cell multi-value validated capability values are used by regular cell formulas referencing the cell.

### Cell Multi-Value Validation Capability—Individual Text Values Input Partial Locking

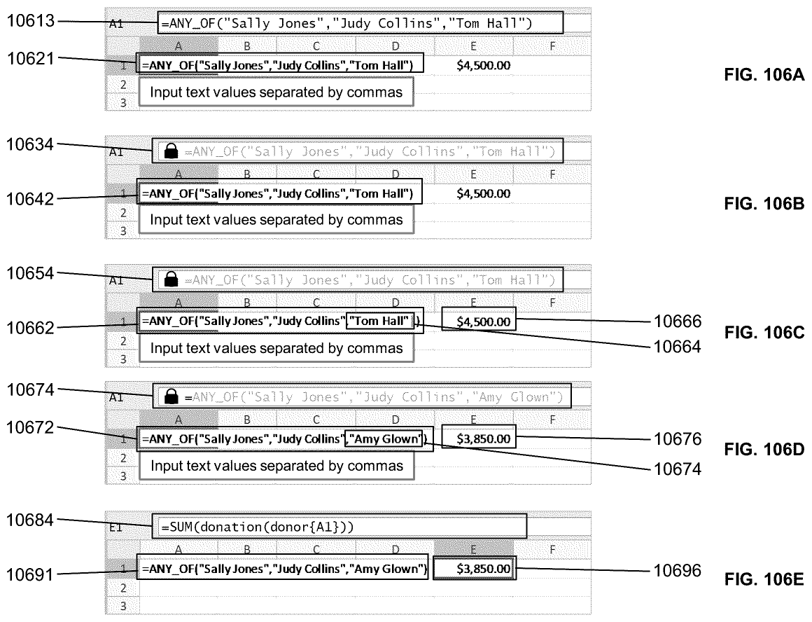

Having exampled how our cell validation capability works with text and population into a function, the user employs our partially locking technology to lock ‘A1’ 10621 in FIG. 106A which is the validated cell ‘A1’ 10571 in FIG. 105D. In this embodiment, like our previous partially locking embodiments, a lock shows up in the formula bar 10634 and the values of ‘=ANY_OF’ are greyed, while the values in the cell ‘A1’ ‘=ANY_OF’ look normal and are changeable like when they were when the cell was unlocked. This could be done differently with the formula bar value also accepting changes as what is locked is the validation constraints, ‘Message’ and ‘Alert’, and those are not a formula visible in the formula bar.

FIG. 106C and FIG. 106D example the changing of the partially locked validation in cell ‘A1’ 10662 in FIG. 106C where the user changes one of the set of multiple values ‘ “Tom Hall” ’ 10664 to ‘ “Amy Glown” ’ 10674 in FIG. 106D which was accepted because it passed the validation text constraint, and the value input is unlocked while the validation constraints and other validation settings are locked. The value change also resulted in a change in a formula referencing the multiple value set in cell ‘A1’ as exampled by the value ‘$4,500.00’ in ‘E1’ 10666 in FIG. 106C becoming ‘$3,850.00’ in ‘E1’ 10676 in FIG. 106D after the change. This is because the ‘=SUM))’ formula 10684 in the formula bar for the cell ‘E1’ 10696 exampled in FIG. 106E references the multiple values in ‘A1’ and automatically changes as the values change. Therefore, exampling how locked or unlocked cell formulas referencing one of our partially locked validation cells work for the changed values.

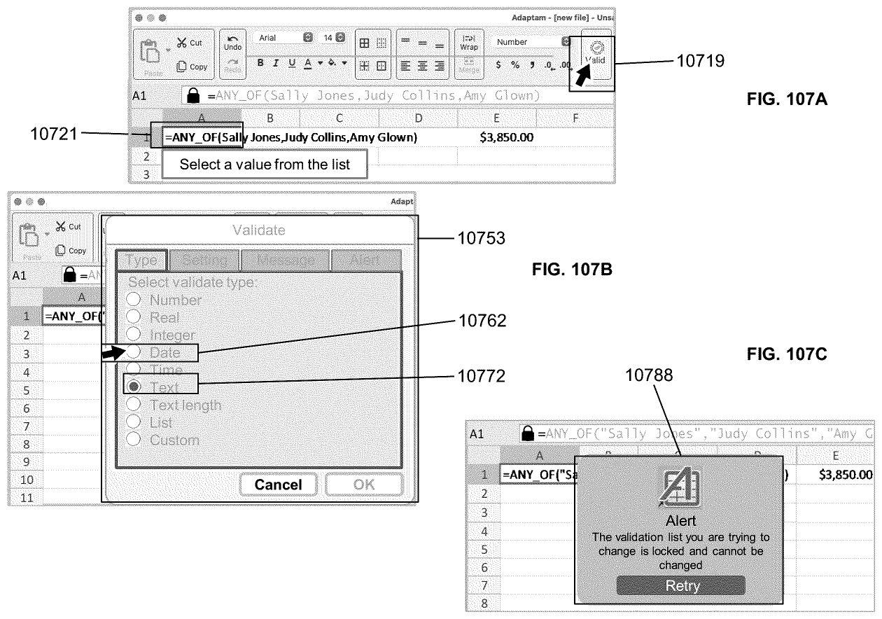

However, if the user then attempts to change the validation by clicking for cell ‘A1’ 10721 in FIG. 107A the ‘Valid’ button 10719 in the ribbon this embodiment opens the ‘Validate’ popup 10753 in FIG. 107B however with the content of all of the tabs locked as the user finds out when they attempt to change the ‘Text’ selection 10772 to the ‘Date’ selection 10762. Instead of recording and making the change our technology gives then the error ‘Alert’ 10788 in FIG. 107C which tells the user ‘The validation you are trying to change is locked and cannot be changed’. Therefore, not allowing them to change the validation for cell ‘A1’ 10721 in FIG. 107A. Thus, exampling the partial locking where the validation is locked but the input is unlocked. In this embodiment attempting to make changes on the ‘Validate’ ‘Setting’. ‘Message’, and ‘Alert’ tabs would also generate the same error outcome in FIG. 107C. Note, the partial locking and hiding for this example works as previously exampled where the user post the partial locking is unable to see any of the validation set up UIs and if they attempt to access them immediately get the error Alert. Also as previously discussed, other embodiments lock less of the validation specifications but lock at least one so that the validation is partially locked.

### Cell Multi-Value Validation Capability—Range Values Input

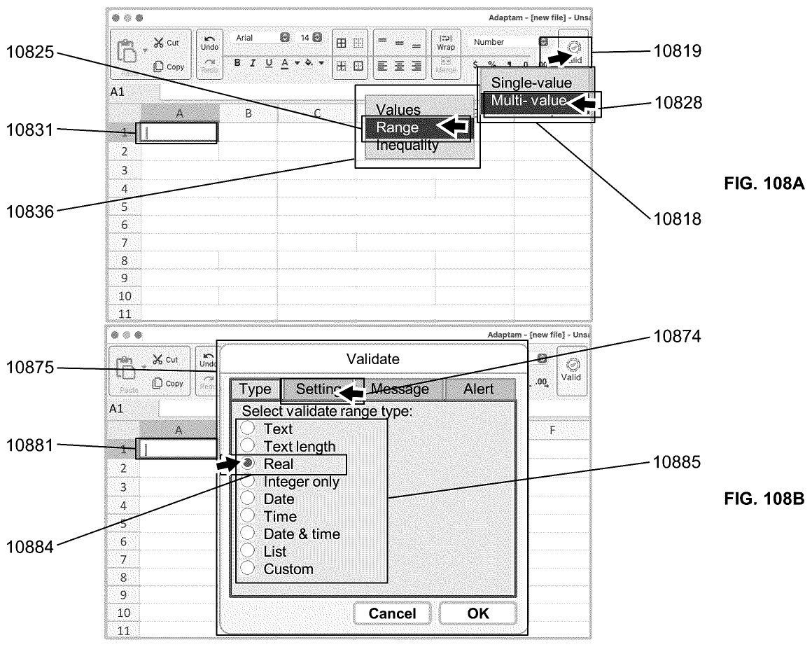

FIG. 108A through FIG. 112B examples a different way of creating the multiple value set in our technology within a validation capability setup cell. The multiple value set is expressed as a range of values contained within the single cell which can then be referenced and used in other cell formulas. The validation ensures the range fulfils the user specified data type and value constraint, if the latter is specified.

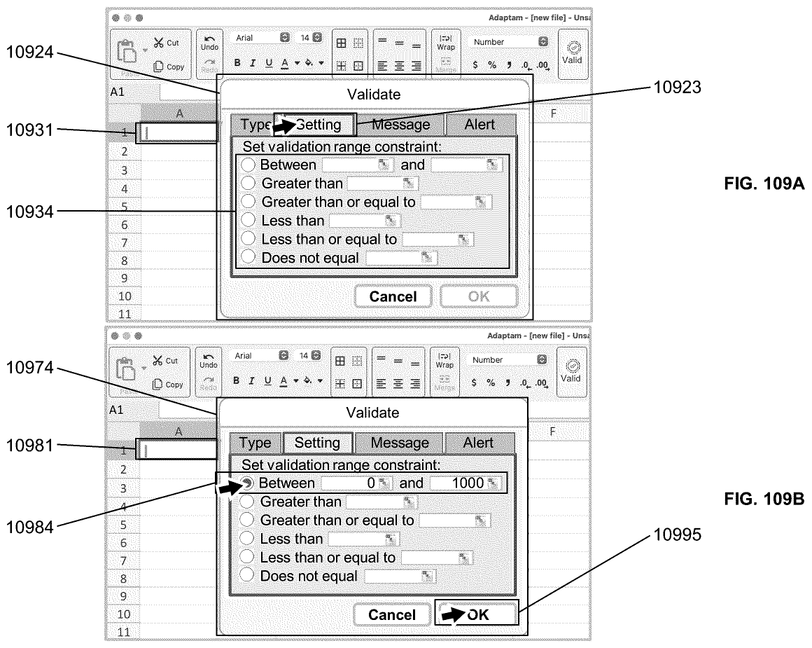

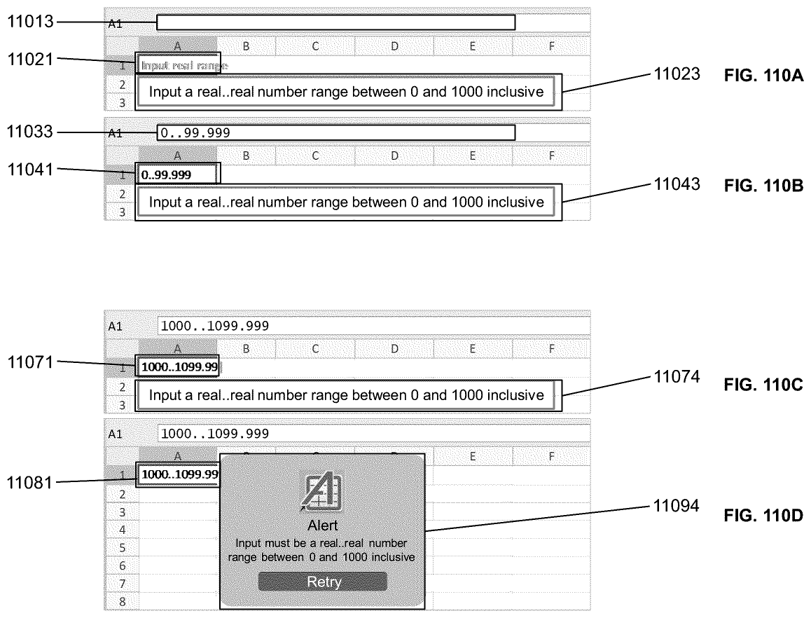

FIG. 108A examples a user beginning the set up a multi-value validation in our technology. In this embodiment they start by clicking the ‘Valid’ button 10819 on the spreadsheet ribbon for the cell ‘A1’ 10831. However, they could have started many other ways, such as from a menu selection. The click 10819 opens a popup selector 10818 which gives the user two options, ‘Single-value’ and ‘Multi-value. The user clicks the ‘Multi-value’ selection 10828 to open the multi-value options popup 10836 where the user selects the ‘Range’ selection 10825 to open the ‘Validate’ popup 10875 with the ‘Type’ selection list open as exampled in FIG. 108B. Note, for simplicity of focusing on the functionality of our technology many of our examples have followed the same UI progressions which of course could be done differently by our technology. That selection list 10885 contains a number of numeric, text, date/time, list, and custom example options but like our previous example lists could contain any other type of option employed by the other spreadsheets. The difference in this situation is the data type constraint will be applied to more than one value populated by a range in the spreadsheet cell. In this example the user selects the ‘Real’ option 10884 in the ‘Type’ selection list within the Validate’ popup 10875 for cell ‘A1’ 10881 and then clicks the ‘Setting’ tab 10874 to deliver the ‘Validate’ popup 10924 on the ‘Setting’ tab 10923 in FIG. 109A. This opens the ‘Set validation constraint’ options 10934 for cell ‘A1’ 10931, which like in other examples herein gives a set of validation constraints the user can set. We put in a representative set of validation options 10934 but our technology supports all those mentioned herein. The user then selects the ‘Between’ option 10984 for cell ‘A1’ 10981 in FIG. 109B in the selection list 10974 and fills in the ‘0’ and the ‘1000’ 10984. When the user clicks ‘OK’ 10995 they get the outcome in FIG. 110A. Our technology automatically generates an input message ‘Input a real . . . real number range between 0 and 1000 inclusive’ 11023 that tells the user both the data type constraint and the values constraint and the input syntax. Because the user has put no range into the cell ‘A1’ 11021 the only thing there is the placeholder ‘Input real range’ and because it is a capability the formula bar 11013 has no formula. Note, in another embodiment of our technology the formula bar 11013 has the placeholder message ‘Input real range’ in light gray indicating it is something to be replaced. In FIG. 110B when the user inputs the range ‘0 . . . 99.999’ into cell ‘A1’ 11041 and the input is accepted because it passes the validation constraints. However, if the user instead tries to enter ‘1000 . . . 1099.99’ in cell ‘A1’ 11071 as exampled in FIG. 110C then the validation value constraint of real number between 0 and 1000 inclusive is violated by number larger than 1000 and instead of accepting the values the user gets an error ‘Alert’ 11094 exampled in FIG. 110D with an automatic message of what the input needs to be in this embodiment ‘Input must be a real . . . real number range between 0 and 1000 inclusive’. And they are asked to ‘Retry’ until they enter a valid input into cell ‘A1’ 11081.

### Cell Multi-Value Validation Capability—Range Values Input Partial Locking

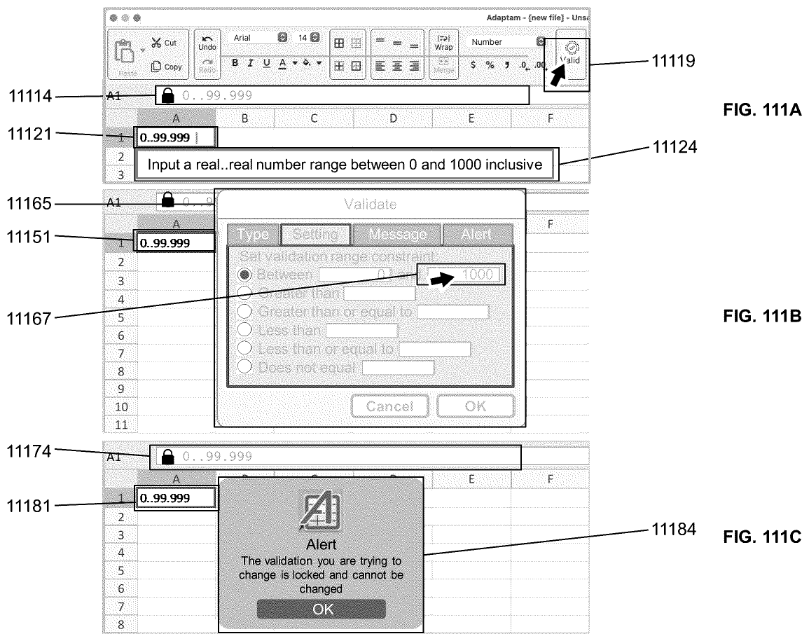

Having exampled how our cell validation capability works the user employs our partially locking technology to lock ‘A1’ 11121 in FIG. 111A which before the partial locking was the validated cell ‘A1’ 11041 in FIG. 110B. In this embodiment, like our previous partially locking embodiments, a lock shows up in the formula bar 11114 and the values there of ‘0 . . . 99.999’ are greyed, while the value in the cell ‘A1’ 11121 looks like normal and is changeable like it were unlocked. This partial locking could be done differently with the formula bar value also accepting changes as what is locked is the validation constraints, ‘Message’ and ‘Alert’ and those are not a formula visible in the formula bar.

Once the cell is partially locked in our technology the values inputted can be changed subject to passing the validation constraint as previously exampled for other validations in our technology and the value input is unlocked while the validation constraints and other validation settings are locked.

However, if the user then attempts to change the validation by clicking for cell ‘A1’ 11121 in FIG. 111A the ‘Valid’ button 11119 in the ribbon this embodiment opens the ‘Validate’ popup 11165 in FIG. 111B however with the content of all of the tabs locked as the user finds out when they attempt to change the ‘1000’ specification 11167. Instead of letting them make a change our technology gives them the error ‘Alert’ 11184 in FIG. 111C which tells the user ‘The validation you are trying to change is locked and cannot be changed’. Therefore, also not allowing them to change the validation for cell ‘A1’ 11181/11151 in FIG. 111C/111B. Thus, exampling the partial locking where the validation is locked but the input is unlocked. In this embodiment attempting to make changes on the ‘Validate’ ‘Type’, ‘Message’, and ‘Alert’ tabs would also generate the same error outcome in FIG. 111C. And as previously described our technology supports the partial locking of different combinations of the cell validation specifications.

### Cell Multi-Value Validation Capability—Range Values Input Partial Locking and Hiding

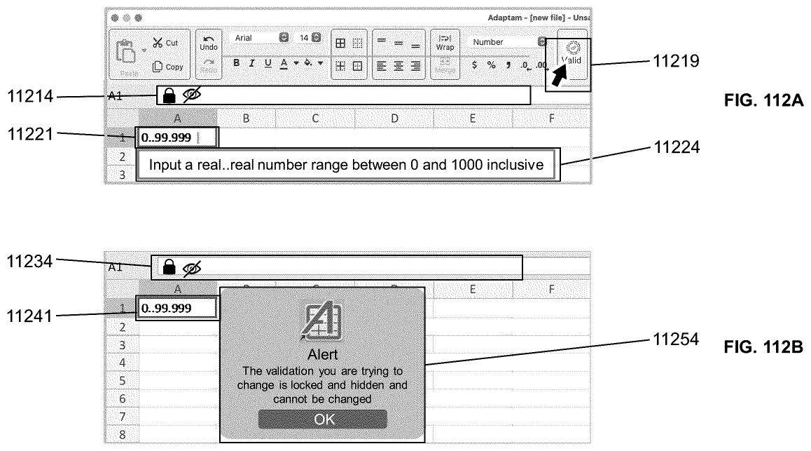

FIG. 112A and FIG. 112B examples what happens if the user employs our technology to partially lock and hide the formula of cell ‘A1’ 11221 in FIG. 112A which prior to locking and hiding was the validated cell ‘A1’ 11041 in FIG. 110B. As we have previously exampled the cell input values can still be changed by any input that fulfils the validation constraint as laid out in the input message 11224. The user in this embodiment gets an indication that the validation is locked and hidden from the lock and the slash eye in the formula bar 11214 in FIG. 112A. The hiding becomes more obvious when the user tries to change the validation as they attempt to do for cell ‘A1’ 11221 clicking the ‘Valid’ button 11219 in the ribbon in FIG. 112A. They immediately get the error Alert’ 11254 in FIG. 112B which tells them ‘The validation you are trying to change is locked and hidden and cannot be changed’. Therefore, not allowing them to change the validation for cell ‘A1’ 11241/11221 in FIG. 112B/112A. They also were unable to see any of the validation set up which was hidden and, in this embodiment, communicated to the user via the slash eye accompanying the lock in the formula bar and the ‘hidden’ in the error Alert’ 11254 in FIG. 112B. The range ‘0 . . . 99.999’ was also hidden in the formula bar by the hiding setup. Other modes could be employed to communicate the locking and the hiding, but we have kept our examples simple employing a common approach across all.

### Cell Multi-Value Validation Capability—Inequality Values Input

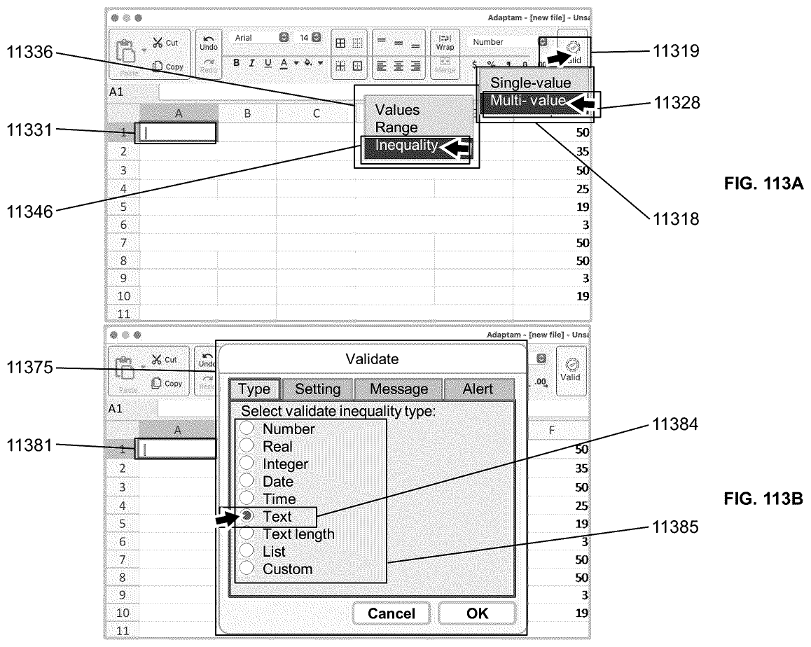

FIG. 113A through FIG. 117B examples a different way of creating the multiple value set in our technology within a validation capability setup cell. The multiple value set is expressed as an inequality which therefore effectively puts many values within the single cell which can then be referenced and used in other cell formulas. The validation ensures the inequality fulfils the user specified data type and value constraint, if the latter is specified.

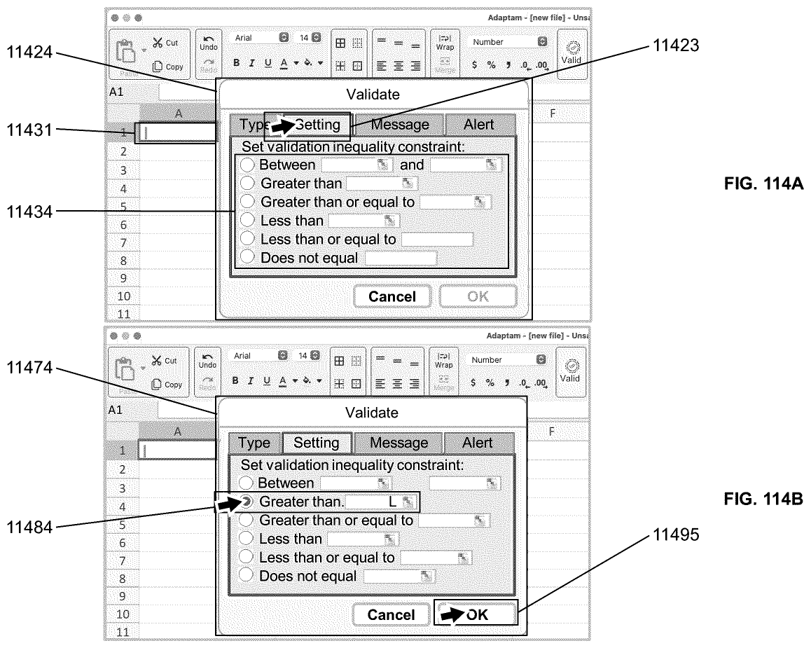

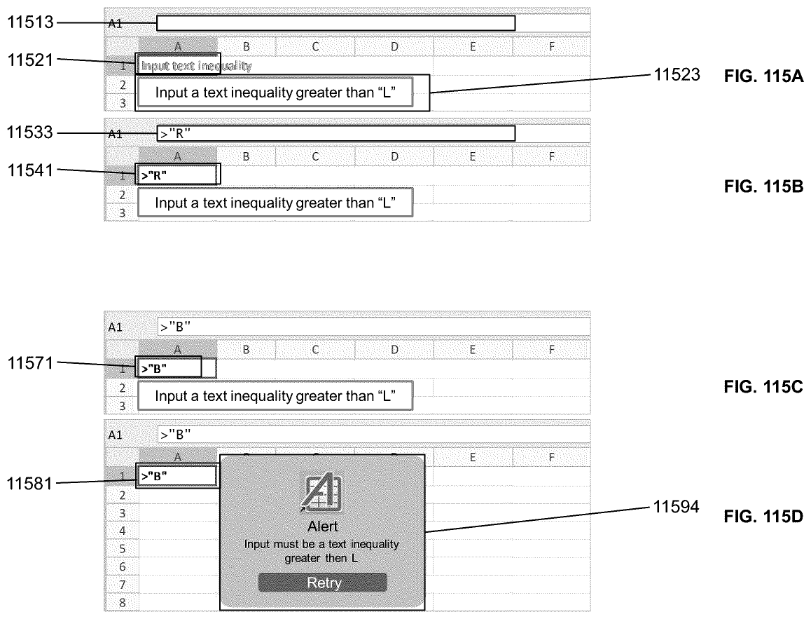

FIG. 113A examples a user beginning the set up a multi-value validation in our technology. In this embodiment they start by clicking the ‘Valid’ button 11319 on the spreadsheet ribbon for the cell ‘A1’ 11331. However, they could have started many other ways, such as from a menu selection. The click 11319 opens a popup selector 11318 which gives the user two options, ‘Single-value’ and ‘Multi-value. The user clicks the ‘Multi-value’ selection 11328 to open the multi-value options popup 11336 where the user selects the ‘Inequality’ selection 11346 to open the ‘Validate’ popup 11375 with the ‘Type’ selection list open as exampled in FIG. 113B. That ‘Type’ selection list 11385 contains a number of numeric, text, date/time, list, and custom example options but like our previous example list could contain any other type of option discussed herein. The difference in this situation is the data type constraint will be applied to more than one value populated by an inequality in the spreadsheet cell. In this example the user selects the ‘Text’ option 11384 in FIG. 113B in the ‘Type’ selection list within the Validate’ popup 11375 for cell ‘A1’ 11381 and then clicks the ‘Setting’ tab 11423 in FIG. 114A. This opens the ‘Set validation inequality constraint:’ options 11434, which as previously exampled gives a set of validation constraints the user can set. We put in a representative set of validation options 11434 but our technology supports all those previously discussed herein and available in other spreadsheets. The user then selects the ‘Greater than’ option 11484 in FIG. 114B in the selection list 11474 and fills in the ‘L’. When the user clicks ‘OK’ 11495 they get the outcome in FIG. 115A. Our technology automatically generates an input message ‘Input a text inequality greater than L’ 11523 that tells the user both the data type constraint and the values constraint. Because the user has put no inequality into the cell ‘A1’ 11521 the only thing there is the placeholder ‘Input text inequality’ and because it is a capability the formula bar 15013 has no formula. In FIG. 115B when the user inputs the inequality ‘>R’ into cell ‘A1’ 11541, which in this embodiment automatically replicates in the formula bar 11533, the input is accepted because it passes the validation constraints. However, if the user instead tries to enter ‘>B’ in cell ‘A1’ 11571 as exampled in FIG. 115C then the validation value constraint of text greater than L is violated by all the values before L and instead of accepting the inequality the user gets an error ‘Alert’ 11594 exampled in FIG. 115D with an automatic message of what the input needs to be in this embodiment ‘Input must be a text inequality greater than L’. And they are asked to ‘Retry’ until they enter a valid input into cell ‘A1’ 11581.

### Cell Multi-Value Validation Capability—Inequality Values Input Partial Locking

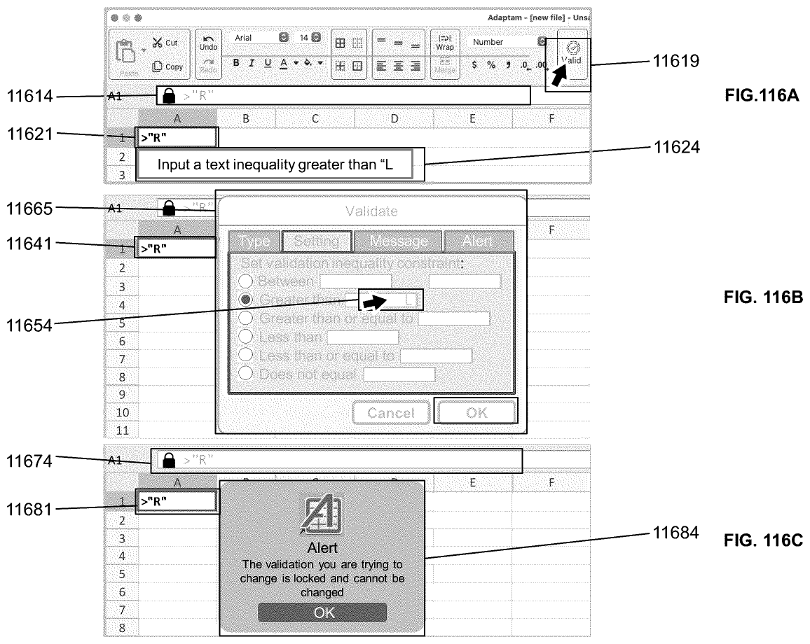

Having exampled how our cell validation capability works the user employs our partially locking technology to lock ‘A1’ 11621 in FIG. 116A which before the partial locking was the validated cell ‘A1’ 11541 in FIG. 115B. In this embodiment, like our previous partially locking embodiments, a lock shows up in the formula bar 11614 and the inequality there ‘>“R”’ is greyed, while the value in the cell ‘A1’ 11621 looks normal and is changeable like it were unlocked. This partial locking could be done differently with the formula bar value also accepting changes as what is locked is the validation constraints, ‘Message’ and ‘Alert’ and those are not a formula visible in the formula bar.

Once the cell is partially locked in our technology the values inputted can be changed subject to passing the validation constraint as previously exampled for other validations in our technology and the value input is unlocked while the validation constraints and other validation settings are locked.

However, if the user then attempts to change the validation by clicking for cell ‘A1’ 11621 in FIG. 116A the ‘Valid’ button 11619 in the ribbon this embodiment opens the ‘Validate’ popup 11165 in FIG. 116B however with the content of all of the tabs locked as the user finds out when they attempt to change the ‘L’ specification 11654. Instead of letting them make a change our technology gives them the error ‘Alert’ 11684 in FIG. 116C which tells the user ‘The validation you are trying to change is locked and cannot be changed’. Therefore, also not allowing them to change the validation for cell ‘A1’ 11681/11641 in FIG. 116C/116B. Thus, exampling the partial locking where the validation is locked but the input is unlocked. In this embodiment attempting to make changes on the ‘Validate’ ‘Type’, ‘Message’, and ‘Alert’ tabs would also generate the same error outcome in FIG. 116C.

### Cell Multi-Value Validation Capability—Inequality Values Input Partial Locking and Hiding

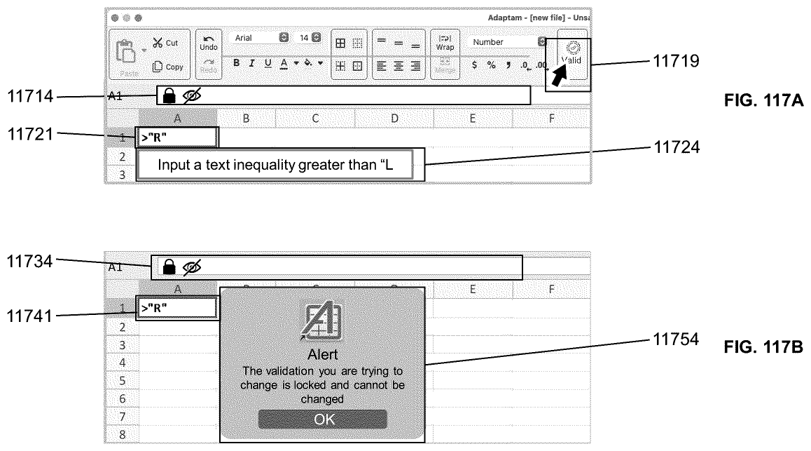

FIG. 117A and FIG. 117B examples what happens if the user employs our technology to partially lock and hide the formula of cell ‘A1’ 11721 in FIG. 117A which prior to locking and hiding was the validated cell ‘A1’ 11541 in FIG. 115B. As we have previously exampled the cell input values can still be changed by any input that fulfils the validation constraint as laid out in the input message 11724. The user in this embodiment gets an indication that the validation is locked and hidden from the lock and the slash eye in the formula bar 11714 in FIG. 117A. The hiding becomes more obvious when the user tries to change the validation as they attempt to do for cell ‘A1’ 11721 clicking the ‘Valid’ button 11719 in the ribbon in FIG. 117A, they immediately get the error Alert’ 11754 in FIG. 117B which tells them ‘The validation you are trying to change is locked and hidden and cannot be changed’. Therefore, not allowing them to change the validation for cell ‘A1’ 11741/11721 in FIG. 117B/117A. They also were unable to see any of the validation set up which was hidden and, in this embodiment, the hidden communicated to the user via the slash eye accompanying the lock in the formula bar and the ‘hidden’ in the error Alert’ 11754 in FIG. 117B. The inequality ‘>“R”’ was also hidden in the formula bar by the hiding setup in this embodiment but in other embodiments is visible because what is hidden is the validation specifications not the input. Other modes could be employed to communicate the locking and the hiding, but we have kept our examples simple employing a common approach across all.

Protection of Spreadsheet Cells without a Password

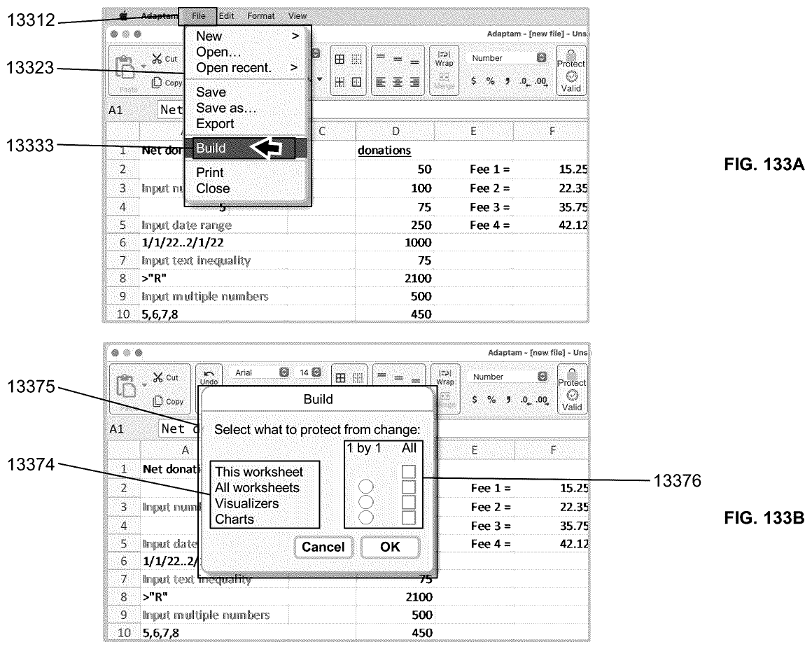

Typical cell locking within spreadsheets is disabled from user change by password protection as exampled for Microsoft Excel 142 in FIG. 1A. This allows the user to use the cells not locked within the spreadsheet and if they have the password use it to change the locking. Our technology supports a similar locking and protection approach as exampled in 6564 in FIG. 65B. However, our technology supports a more secure method of protecting the locking and/or hiding from access and change as exampled in FIG. 133A and FIG. 133B.

FIG. 133A and FIG. 133B examples a user building a locked, partially locked, and hidden version of a spreadsheet which post the build users cannot change the locked, partially locked, and hidden functional formulas and cells. Our technology supports any combination of unlocked, locked, partially locked and/or hidden functional formulas and cells specified in a spreadsheet being built into a version that once built does not allow users the ability to unlock or unhide any of the locked, partially locked and/or hidden formulas and cell content within the build. There are many ways to access and do this set-up, FIG. 133A examples the user starting with a menu selection of ‘Build’ 13333 from the ‘File’ 13312 menu dropdown/popup 13323. This opens the ‘Build’ popup 13375 in FIG. 133B which presents the user with a set of selections 13374 of ‘This worksheet’, ‘All worksheets’, Visualizers’, and ‘Charts’ where the user as appropriate can build the new protected spreadsheet with ‘All’ 13376 the selection or go through the selection ‘1 by 1’ 13376 deciding which to protect. The build protection will put the already set-up locking, partial locking and hiding within the selections into a spreadsheet build where the user has no ability to alter the build protected locking, partial locking and hiding. That spreadsheet will otherwise work as a normal spreadsheet.

### Mix and Match Embodiments

In the interest of conciseness, the combinations of features disclosed in this application have not repeated with each of the other features and in all the possible combinations. The reader will understand how features identified in this section can readily be combined with sets of other features. We will therefore move on to describing one of many example computer systems that can be used for our technology.

### Computer System

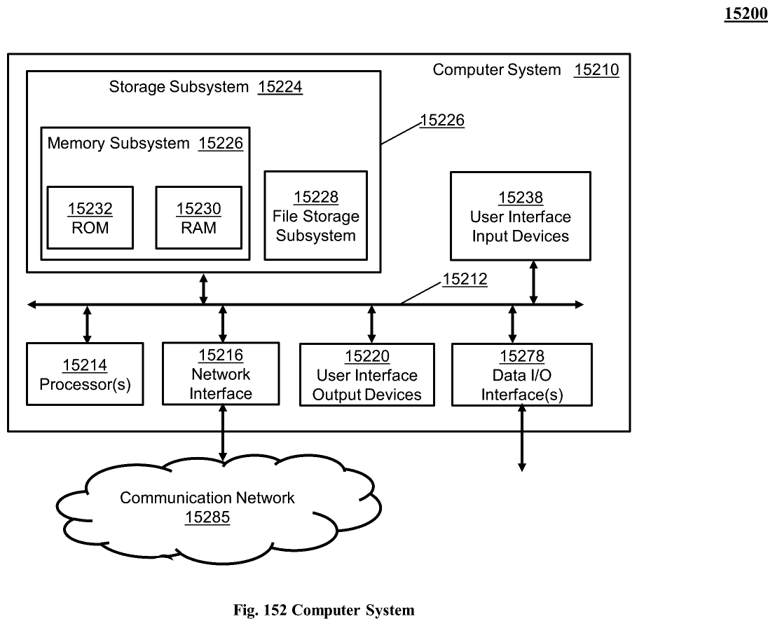

FIG. 152 is a block diagram of an example computer system, according to one implementation. Computer system 15210 typically includes at least one processor 15214 which communicates with a number of peripheral devices via bus subsystem 15212. These peripheral devices may include a storage subsystem 15224 including, for example, memory devices and a file storage subsystem, user interface input devices 15238, user interface output devices 15220, and a network interface subsystem 15216. The input and output devices allow user interaction with computer system 15210. Network interface subsystem 15216 provides an interface to outside networks, including an interface to communication network 15285, and is coupled via communication network 15285 to corresponding interface devices in other computer systems or in the cloud and usable for cloud applications.

User interface input devices 15238 may include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 15210 or onto communication network 15285.

User interface output devices 15220 may include a display subsystem, a printer, or non-visual displays such as audio output devices. The display subsystem may include a touch screen, a flat-panel device such as a liquid crystal display, a projection device, a cathode ray tube, or some other mechanism for creating a visible image. The display subsystem may also provide a non-visual display such as via audio output devices. In general, use of the term “output device” is intended to include all possible types of devices and ways to output information from computer system 15210 to the user or to another machine or computer system.

Storage subsystem 15224 stores programming and data constructs that provide the functionality of some or all of the modules and methods described herein. These software modules are generally executed by processor 15214 alone or in combination with other processors.

Memory 15226 used in the storage subsystem can include a number of memories including a main random-access memory 15230 for storage of instructions and data during program execution and a read only memory 15232 in which fixed instructions are stored. A file storage subsystem 15228 can provide persistent storage for program and data files, and may include a hard disk drive, SSD, a tape drive, an optical drive, or removable media cartridges. The modules implementing the functionality of certain implementations may be stored by file storage subsystem 15228 in the storage subsystem 15224, or in other machines accessible by the processor.

Bus subsystem 15212 provides a mechanism for letting the various components and subsystems of computer system 15210 communicate with each other as intended. Although bus subsystem 15212 is shown schematically as a single bus, alternative implementations of the bus subsystem may use multiple busses.

Computer system 15210 can be of varying types including a workstation, server, computing cluster, blade server, server farm, or any other data processing system or computing device. Due to the ever-changing nature of computers and networks, the description of computer system 15210 depicted in FIG. 152 is intended only as one example. Many other configurations of computer system 15210 are possible having more or fewer components than the computer system depicted in FIG. 152.

### Some Particular Implementations

Some particular implementations and features are described in the following discussion.

### Differential Input Functions

Implementations of our differential input prebuilt spreadsheet functions apply to any spreadsheet function where the in-cell formula input and the formula bar formula input accept different functional argument inputs. Where the in-cell input or the formula bar input accepts one or more arguments not accepted by the other input. For example, where the prebuilt function has two or more arguments, and the in-cell formula input accepts one argument of a prebuilt spreadsheet function, and the formula bar formula input accepts the other argument or arguments. The result of the differential input function, like other spreadsheet functions, is a value or values usable by other cell formulas referencing the cell. While we have exampled this extensively for the differential input validation functions, it applies to any other functions employing this different input technology.

### Differential Input Validation Functions

There are many different implementations of our differential input validation functions exampled in FIG. 40 through FIG. 78. We have labelled the functions INPUT and INPUT variants although of course they could employ any unused spreadsheet function names. All these new functions and additional variants of these functions have different embodiments that vary in how the dual inputs work. And the new functions have many different implementations varying on the dimensions of the type of output and other features. In many of those implementations the value or values argument that are then outputted by the function is available within the in-cell input while the entire formula is available in the formula bar input, although our technology supports different argument differentiation between what is in the in-cell formula and what is in the formula bar formula.

### Differential Input Validation Functions—Upon Functional Formula Reopening

One implementation initiates the differential dual inputs after the successful first completion of the functional formula as exampled in either the formula bar or in-cell inputs supporting the first completion of the ‘INPUT’ functional formula in FIG. 41A through FIG. 42B. After which reopening the cell formula in-cell allows the user to only change the argument that holds the output value as exampled in FIG. 42C through FIG. 42E and explained and exampled in FIG. 40. While, reopening the cell formula in the formula bar allows the user to change any of the argument values as exampled in FIG. 44A through FIG. 44D and explained and exampled in FIG. 40. The value populated into the cell is then referenceable and usable by other cell formulas as exampled in FIG. 59C through FIG. 59E and other examples herein. In this variant of the implementation the direct in-cell input, that is the first input, accepts only one argument or type of arguments, the output value or values of the ‘INPUT’ functional formula, while the cell formula bar input, that is the second input, accepts inputs/changes to all of the arguments of the functional formula. Although in a different embodiment of this implementation the first input accepts inputs/changes to all of the arguments of the functional formula, while the second input accepts only one argument, the output value of the ‘INPUT’ functional formula. As, we will discuss later different INPUT family functions make some changes to the number of arguments supported by both of the two different inputs however staying true to one of the two inputs accepting arguments that the other will not once the functional formula is first completed and then reopened.

### Differential Input Validation Functions—Always

Another set of implementations initiates the differential dual inputs as soon as the functional formula is ready to accept the first functional argument. At that point the function stops accepting input within an input that does not populate that argument. An example of this is in FIG. 52A/FIG. 52B and FIG. 54C/FIG. 54D where the user was inputting the functional formula in the direct in-cell input, the first input, but the first argument of the this ‘INPUT’ function can only be populated in the second input, in this embodiment the formula bar input. Therefore, the in-cell direct input stops accepting the first argument. This implementation then examples another feature where our technology automatically moves the cursor to the input that accepts that argument input, in this situation moving it from the direct in-cell input to the formula bar input as exampled in FIG. 52B and FIG. 54D. FIG. 126 then describes how this works and examples how the user can only input/change the cell output value within input one, the in-cell direct input, and has the ability to input/change any of the functional formula arguments in the second input, the formula bar input. Note in a different embodiment the argument acceptance could be reversed for the first and second inputs, where the first input accepts more, or all of the arguments and the second input accepts fewer of the arguments.

### Differential Input Validation Functions—Features Applicable to Upon Functional Formula Reopening and Always

The implementations which we will now discuss are mix and match embodiments applicable to the implementations where the inputs differ upon functional formula reopening and the implementations when the inputs differ from the first argument of the applicable functional formula.

### Differential Input Validation Functions—Different Input Setups

Our differential input validation functions implementations support a spectrum of different input setups with different combinations of arguments supported in direct in-cell input and the cell formula bar input. One set of implementations, exampled in FIG. 40 4023, FIG. 55 5536, and more figures, for the upon reopening variants once the function is in dual input mode only accepts the value or value arguments within the in-cell formula, while the cell formula bar input accepts all the arguments for the functional formula. FIG. 126 12622/12637, FIG. 56 5622/5637 and more figures examples a similar set of implementations for our functional formulas that always have differentiated dual inputs from the function ready for the first argument. Our technology also supports the reverse situation where the in-cell direct input accepts all the functional formula arguments, and the cell formula bar input accepts only the value or values arguments.

Other implementation exampled in FIG. 127A and FIG. 127B differentiates the inputs to the point of not accepting the argument input accepted by the other input. In FIG. 127A and FIG. 127B the value argument is inputted into the in-cell direct input and is an invisible argument in the functional formula which is inputted into the cell formula bar input. The two inputs together accept all the arguments required for the function to work to deliver a validated value in the cell. And of course, the inputs could be reversed where the in-cell direct input accepts the functional formula minus value and the cell formula bar accepts the value or values.

### Differential Input Validation Functions—INPUT Validation

In a set of implementations of the INTAKE family of functions arguments, other than the argument or arguments into which the value or values are inputted, validate those inputted and then outputted values as exampled in FIG. 40 through FIG. 63 for regular situations and exampled in FIG. 64 through FIG. 78 for locked and locked and hidden cell situations. Those validation constraints start with a data type constraint and then an optional values constraint within that data type as exampled in our functional formula syntax in FIG. 40 4011, FIG. 51 5153, FIG. 55 5511, FIG. 56 5615, FIG. 60 6015, FIG. 61 6115, FIG. 62 6215, and FIG. 63 6315 where ‘data type’ is the argument specifying the data type constraint and ‘constraint’ is the argument specifying the optional value constraint. With these validation constraints being set up as exampled in FIG. 41A through FIG. 44D and then validating as exampled in FIG. 47A through FIG. 47D, FIG. 50A through FIG. 50D, and FIG. 53A through FIG. 53D as well as numerous other examples herein.

### Differential Input Validation Functions—Single Value INPUT

One set of our implementation of the dual input validation functions validate one inputted value for output by the prebuilt spreadsheet function as exampled in FIG. 40 through FIG. 54E in normal situations and as exampled in FIG. 64 through FIG. 70 for locked and locked and hidden situations. These validations work for both the “upon functional formula reopening differential input validation functions” as exampled in FIG. 40 through FIG. 51C and the “always differential input validation functions” as exampled in FIG. 126 and FIG. 52A through FIG. 54E.

### Differential Input Validation Functions—Multiple Value INPUT

Another set of implementations in the family of differential INPUT validation functions validate a set of multiple values for output by the prebuilt spreadsheet function as exampled in FIG. 55 through FIG. 63 in normal situations and as exampled in FIG. 71 through FIG. 78 for locked and locked and hidden situations. The set of multiple values is supplied in our technology multiple different ways, e.g., as a range of values, as a set of separate values, and as an inequality. All of these different multiple value INPUT family of function implementations are then usable in our technology which supports populating more than one separate value within a single cell and then using those multiple values in cell formulas employing functions like those described in our U.S. application Ser. No. 17/359,418 titled “Methods and Systems for Presenting Drop-Down, Pop-Up or Other Presentation of a Multi-Value Data Set in a Spreadsheet Cell,” filed 25 Jun. 2021, now U.S. Pat. No. 11,657,217, issued 25 May 2023. Use of those multiple value differential input validated function outputs by other cells is also exampled in FIG. 59A through FIG. 59E.

### Differential Input Validation Functions—Range INPUT

The range value INPUT function implementations accept a range set of multiple values in many different ways. FIG. 55 through FIG. 59E and FIG. 71 through FIG. 74 example an embodiment where the range is set by [value] . . . [value] where both [value] specifications can be text, numeric, time, or date. Although the range can also be set in other manners such as a pair of inequalities or a fill in the blank UI feeding the functional formula in any applicable syntax.

### Differential Input Validation Functions—Multiple Separate Value INPUT

The multiple separate value INPUT function implementations accept the set of multiple values in many different ways. FIG. 60, FIG. 61, FIG. 75, and FIG. 76 example an embodiment where the multiple values are entered with comma delimiters. Although the separate values could be entered with different delimiters. in a multi-value function like the ‘ANY_OF’ function exampled in FIG. 105A through FIG. 105D, or in some other manner providing the INPUT function with more than one specified value.

### Differential Input Validation Functions—Inequality INPUT

The inequality INPUT function implementations accept the set of multiple values in many different ways. FIG. 60, FIG. 61, FIG. 75, and FIG. 76 example an embodiment where the inequality is entered as if it were in a typical spreadsheet manner. Although the inequality can also be set in other manners such as a fill in the blank UI feeding the functional formula in any applicable syntax or other modes of populating inequality in the functional formula.

Differential Input Validation Functions—INPUT Value from Referenced Cell

An implementation examples how our INPUT function accepts inputs from referenced cells. FIG. 128A through FIG. 128D examples where the argument that determines the output value is supplied by a referenced cell where that value is then validated like any other inputted value with a warning or rejection if the value does not meet the functional formula constraint. Like other spreadsheet functional formulas that accept cell references, the cell references can be used in any applicable argument, not just the value argument.

### Differential Input Validation Functions—Booleans

Booleans represent a specialized implementation of our INPUT family of functions as they present a very limited set of inputs/outputs. Implementations support the validation of the input to be ‘TRUE’ or ‘FALSE’ but the more interesting variant of the Boolean capability is exampled in FIG. 129A through FIG. 130E where our technology supports using a checkbox to determine TRUE or FALSE.

### Differential Input Validation Functions—INPUT Cell Message

Implementations of our INPUT family of functions automatically generate a cell message that accompanies the cell when it is highlighted, clicked into, or double clicked into/opened as exampled in as exampled in FIG. 42C 4274, FIG. 44D 4493, FIG. 50A 5022, FIG. 52D 5293, FIG. 54E 5493, and FIG. 59B 5944. That cell message is generated in a UI that displays the required data type as exampled in FIG. 42C 4274, FIG. 44D 4493, FIG. 50A 5022, FIG. 52D 5293, FIG. 54E 5493, and FIG. 59B 5944, and if applicable the data values constraint as exampled in FIG. 42C 4274, FIG. 44D 4493, and FIG. 59B 5944.

### Differential Input Validation Functions—INPUT Rejection or Warning

Implementations of our INPUT family of functions automatically rejects the input of a value or values that are do not comply with the validation constraint or constraints as exampled in FIG. 47B, FIG. 47D, FIG. 50D, FIG. 53B, and FIG. 53D. The rejection can be done in many different ways beyond the popups employed in those examples. In other implementations the user is automatically warned of validation constraint or constraints non-compliance, but the input is not rejected as exampled in FIG. 131A through FIG. 132B.

### Differential Input Validation Functions—INPUT Cell Distinctiveness

Implementations of our INPUT family of functions automatically identifies a cell with a populated function with no value or values specified with an input request message as exampled in by ‘Input date’ 4241 in FIG. 42B, ‘Input number’ 5021 in FIG. 50A, ‘Input text . . . text range’ 5543 in FIG. 55, and in several other figures herein.

Other implementations differentiate the completed INPUT family of function cells with a distinctive appearance as exampled in FIG. 48A through FIG. 48D. Where that distinctive appearance is a shape, such as a black box or black circle added to the cell with the value or value populated in the cell.

### Differential Input Validation Functions—INPUT Partial Locking

The implementations of our INPUT family of functions have new partial cell locking capability, where locking the cell locks some but not all of the functional formula arguments. Other variants of that partial locking locks one of the in-cell or formula bar inputs but not the other as exampled in FIG. 64 through FIG. 78 for locking the formula bar input holding the functional formula while leaving unlocked the in-cell direct input accepting changes only to the value argument or values arguments. Implementations of our partial locking of INPUT functions can make it so locking a cell holding an INPUT family function automatically partially locks the cell as exampled in FIG. 65A or where the user gets a choice and can specify it as exampled in FIG. 65B. The locking can be password protected as exampled in FIG. 65B or can be password free as exampled in FIG. 65A. As described later the password free locking protection can be such that once the spreadsheet is locked the user has no access to unlock and gain access to the unlocked version as exampled in FIG. 133A and FIG. 133B.

Implementations of our technology automatically display a visual indication of the partial locked status as exampled in FIG. 64, FIG. 66B, FIG. 71, FIG. 72B, FIG. 75, and FIG. 77 for the locking of the formula bar input/content via a lock and grayed content while not locking the in-cell direct input/content. Note, that is only one of the several ways the locked and unlocked content can be visually differentiated in our technology. Implementations of our technology also automatically display a visual indication of both the partial locked and partial hidden status in FIG. 68, FIG. 69B, FIG. 74, FIG. 76, and FIG. 78 for the locking and hiding of the formula bar input/content while not locking or hiding the in-cell direct input/content. Or alternatively not displaying the locked content in the formula while displaying the unlocked content.

### Differential Input Validation Functions—Other Implementations

Other implementations of our differential input validation function technologies may include a non-transitory computer readable storage medium storing instructions executable by a processor to perform any of the methods described above. And other implementation may include a system including memory and one or more processors operable to execute instructions, stored in the memory, to perform any of the methods described above.

### Regular Input Validation Functions

There are many different implementations of our regular input validation functions, one where all the different types are handled by a functional argument where the user specifies the input type, similar to the example in FIG. 137B, or a family of functions varying by type of input as exampled in FIG. 139 through FIG. 151B. Implementations of our technology support embodiments where the input type populated in the value argument/argument group automatically determines the type. All of these implementation's share are predefined spreadsheet functions that come prebuilt with the spreadsheet application directly or via add-ins. Those functions have multiple arguments or multiple arguments in argument groups where one type of argument accepts the value or values input into the function which is/are subject to the validation constraints and becomes the output from the function. Where there is a second type of argument or arguments which are the validation constraint. Constraints against which the first argument type value or values either pass or fail. If the first argument value or values passes the second argument type constraints, then the value or values are populated in the cell as a result. Where that result is referenceable by other cells for use in their formulas. If the first argument value or one of the values fails one or more of the second argument type constraints, then that value or those values are rejected and will be rejected until their replacements pass or they are accepted with a warning presented to the user informing them of the failure. In either of those situations the accepted first argument value or values are then populated in the cell and referenceable by other cells for use in their formulas.

Different implementations are exampled in FIG. 139 through FIG. 151B with some of the pre-locking features being exampled post cell/function locking.

### Regular Input Validation Functions—Single Value INPUT

The first set of implementations are in the family of regular INPUT validation functions and validate one inputted value for output by the prebuilt spreadsheet function as exampled in FIG. 139 through FIG. 140D in normal situations, as exampled in FIG. 141A through FIG. 142D for locked situations and exampled in FIG. 148A through FIG. 149D for locked and hidden situations.

### Regular Input Validation Functions—Multiple Value Sets INPUTs

Another set of implementations in the family of regular INPUT validation functions validate a set of multiple values for output by the prebuilt spreadsheet function as exampled in FIG. 143, FIG. 146, and FIG. 147 in normal situations, as exampled in FIG. 144A through FIG. 145D for locked situation, and as exampled in FIG. 150A through FIG. 151D for locked and hidden situations. The set of multiple values is supplied in our technology multiple different ways, e.g., as a range of values, as a set of separate values, and as an inequality.

### Regular Input Validation Functions—Range INPUT

The range value regular INPUT validation function implementations accept a range set of multiple values in many different ways. FIG. 143, FIG. 144A through FIG. 145D and FIG. 150A through FIG. 151D example an embodiment where the range is set by [value] . . . [value] argument where both [value] specifications can be text, numeric, time, or date. Although the range can also be set in other manners such as a pair of inequalities or a fill in the blank UI feeding the functional formula in any applicable syntax.

### Regular Input Validation Functions—Multiple Separate Value INPUT

The multiple separate value regular INPUT validation function implementations accept the set of multiple values in many different ways. FIG. 146 examples an embodiment where the multiple values are entered with comma delimiters. Although the separate values could be entered with different delimiters. in a multi-value function like the’ANY_OF’ function exampled in FIG. 105A through FIG. 105D, or in some other manner providing the regular INPUT validation function with more than one specified individual value.

### Regular Input Validation Functions—Inequality INPUT

The inequality regular INPUT validation function implementations accept the set of multiple values in many different ways. FIG. 147 examples an embodiment where the inequality is entered as if it were in a typical spreadsheet manner example spreadsheet formula). Although the inequality can also be set in other manners such as a fill in the blank UI feeding the functional formula in any applicable syntax or other mode of populating in the functional formula the inequality.

Regular Input Validation Functions—INPUT Value from Referenced Cell

Any one of our regular input validation functions supports implementations where the inputted value or values is populated by a referenced cell or cells. FIG. 128A through FIG. 128D examples for our differential input validation functions where the argument that determines the output value is supplied by a referenced cell where that value is then validated like any other inputted value with a warning or rejection if the value does not meet the functional formula constraint. Our regular input validation functions work in a similar manner for cell referenced values. And like other spreadsheet functional formulas that accept cell references, the cell references can be used in any applicable argument, not just the value argument.

### Regular Input Validation Functions—Booleans

Booleans represent a specialized implementation of our regular INPUT validation family of functions as they present a very limited set of inputs/outputs. Implementations support the validation of the input to be ‘TRUE’ or ‘FALSE’ but the more interesting variant of the Boolean capability is exampled in FIG. 129A through FIG. 130E where our technology supports using a checkbox to determine TRUE or FALSE. While that was exampled for our differential input validation functions it works in a similar manner for our regular input validation functions.

### Regular Input Validation Functions—INPUT Validation

Implementations of our different regular input validation functions support one or more validation constraint arguments employed by the function validating the value or values argument as exampled in FIG. 139 through FIG. 140D for regular situations, as exampled in in FIG. 141A through FIG. 142D for locked situations, and as exampled in FIG. 148A through FIG. 151D for locked and hidden cell situations. Implementations where a validation constraint is for the data type of the value or values argument as exampled in the syntax and all of the examples in FIG. 139, FIG. 143, FIG. 146, and FIG. 147. Implementations where a validation constraint is for the data values of the value or values argument as exampled in the syntax and some of the examples in FIG. 139, FIG. 143, FIG. 146, and FIG. 147.

### Regular Input Validation Functions—INPUT Cell Message

Implementations of our INPUT family of functions automatically generate a cell message that accompanies the cell when it is highlighted, clicked into, or double clicked into/opened as exampled in as exampled in FIG. 140A 14024, FIG. 140C 14074, FIG. 141E 14194, FIG. 145A 14524, FIG. 145C 14573, FIG. 148A 14824, and FIG. 148B 14844. That cell message is automatically generated in a UI that displays the required data type as exampled in and if applicable the data values constraint.

### Regular Input Validation Functions—INPUT Rejection or Warning

Implementations of our regular INPUT validation family of functions automatically rejects the input of a value or values that do not comply with the validation constraint or constraints as exampled in FIG. 140B, FIG. 140D, FIG. 142B, FIG. 142D, FIG. 145B, FIG. 145D, FIG. 149B, and FIG. 151B. The rejection can be done in many different ways beyond the popups employed in those examples. In other implementations the user is automatically warned of the value argument input or inputs non-compliance with the validation constraint, but the input is not rejected as exampled in FIG. 149D and FIG. 151D.

### Regular Input Validation Functions—INPUT Cell Distinctiveness

Implementations of our regular INPUT validation family of functions automatically identifies a cell with a populated function with no value or values specified with an input request message as exampled in by ‘Input number’ 13933 in FIG. 139, and ‘Input text’ 13963 in FIG. 139, as well as several other examples in FIG. 143, FIG. 146, and FIG. 147.

Other implementations differentiate the completed regular INPUT validation family of function populated cells with a distinctive appearance as exampled in FIG. 48A through FIG. 48D. Where that distinctive appearance is a shape, such as a black box or black circle added to the cell with the value or value populated in the cell.

### Regular Input Validation Functions—INPUT Partial Locking

The implementations of our regular INPUT validation family of functions have our new partial cell locking capability, where locking the cell locks some but not all of the functional formula arguments exampled in FIG. 141A through FIG. 142D and FIG. 144A through FIG. 145D. Particular partial locking implementations lock all the arguments except the value argument or arguments. Implementations of our partial locking of INPUT functions can make it so locking a cell holding a regular INPUT family function automatically partially locks the cell as exampled in FIG. 65A or where the user gets a choice and can specify partial versus full locking as exampled in FIG. 65B. The locking can be password protected as exampled in FIG. 65B or can be password free as exampled in FIG. 65A. As described later the password free locking protection can be such that once the spreadsheet is locked the user has no access to unlock and gain access to the unlocked version as exampled in FIG. 133A and FIG. 133B.

Implementations of our technology automatically display a visual indication of the partial locked status as exampled by the lock and gray formula text in FIG. 141A through FIG. 142D and FIG. 144A through FIG. 145D. Implementations of our technology also automatically display a visual indication of both the partial locked and partial hidden status as exampled in FIG. 148A through FIG. 151D. Noting our technology supports different modes of the visual indications of what is lock and not locked.

### Regular Input Validation Functions—Other Implementations

Other implementations of our differential input validation function technologies may include a non-transitory computer readable storage medium storing instructions executable by a processor to perform any of the methods described above. And other implementation may include a system including memory and one or more processors operable to execute instructions, stored in the memory, to perform any of the methods described above.

### Partial Locking of a Picklist Function

Another set of implementations takes our partial locking capability to the family of picklist functions in our U.S. application Ser. No. 17/359,418 titled “Methods and Systems for Presenting Drop-Down, Pop-Up or Other Presentation of a Multi-Value Data Set in a Spreadsheet Cell,” filed 25 Jun. 2021, now U.S. Pat. No. 11,657,217, issued 25 May 2023. Those functions have been exampled here as the ‘DROPDOWN’ and ‘DROPDOWN_MANY’ functions and our partial locking technology has provided a method where a user can lock the picklist from further alteration while not locking the selection of a value or values from the picklist as exampled in FIG. 79A through FIG. 82B. Those examples illustrate our partial locking technology working for a single value selection picklist and a multi-value selection picklist. Further implementations make it so that locking the cell containing the picklist function locks all the picklist functional arguments except the value selection argument or arguments exampled in FIG. 79A 7916, and FIG. 81A 8117.

Implementations of our partial locking of our picklist functions can make it so locking a cell holding on of our picklist family of functions automatically partially locks the cell as exampled in FIG. 65A or where the user gets a choice and can specify it as exampled in FIG. 65B. The locking can be password protected as exampled in FIG. 65B or can be password free as exampled in FIG. 65A. As described later the password free locking protection can be such that once the spreadsheet is locked the user has no access to unlock and gain access to the unlocked version as exampled in FIG. 133A and FIG. 133B.

Implementations of our technology automatically display a visual indication of the partial locked status as exampled in FIG. 79C, FIG. 80, FIG. 82A, and FIG. 82B for the locking of the formula bar input/content via a lock and grayed content while not locking the in-cell direct input/content. Implementations of our technology also automatically display a visual indication of both the partial locked and partial hidden status in FIG. 80 and FIG. 82B for the locking and hiding of the formula bar input/content while not locking or hiding the picklist selection content or stopping the selection changes.

### Partial Locking of a Picklist Function—Other Implementations

Other implementations of our partial locking of a picklist functions technologies may include a non-transitory computer readable storage medium storing instructions executable by a processor to perform any of the methods described above. And other implementation may include a system including memory and one or more processors operable to execute instructions, stored in the memory, to perform any of the methods described above.

### Partial Locking of a Regular Function

Our partial locking technology is applicable in regular prebuilt spreadsheets that have two or more arguments. Where at least one of the function arguments post locking cannot be changed by the user and at least one of the other arguments can be changed as exampled in FIG. 118A through FIG. 125B. That unlocked change or changes are then used in the function to alter the cell calculated value and that revised calculated value can be referenced and used by other cell formulas, as previously exampled herein for other partially locked cells. The post locking changeable function argument or arguments can be automatically specified by our application, as exampled in FIG. 65A, or can be user specified, as exampled in FIG. 134A and FIG. 134B.

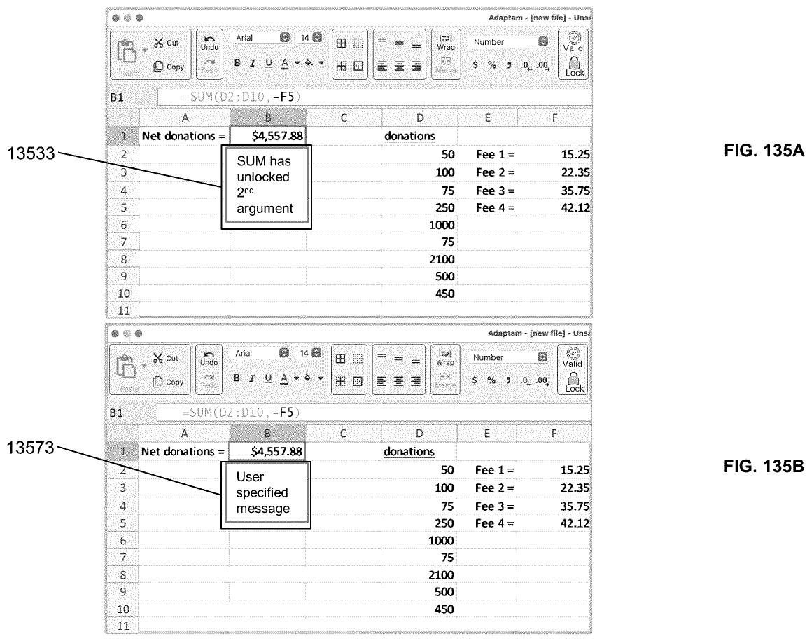

In many implementations of our regular function partial locking technology our technology automatically displays a UI accompanying the partially locked cell where the UI messages which function arguments are unlocked as exampled in FIG. 118B 11882 or in FIG. 121B 12181. In another implementation that automatically generated message accompanying the partially locked cell function is user specified as exampled in FIG. 135B 13573.

All of our partially locking regular function implementations have the option of a locking method that is password protected as exampled FIG. 65B. Alternatively, they all have the option of a locking mechanism that is password free as exampled in FIG. 65A, FIG. 133A and FIG. 133B. In further implementations the lockable argument content is hidden from the user once locked as has been exampled herein for other functions.

### Partial Locking of a Regular Function—Other Implementations

Other implementations of our partial locking of a regular function's technologies may include a non-transitory computer readable storage medium storing instructions executable by a processor to perform any of the methods described above. And other implementation may include a system including memory and one or more processors operable to execute instructions, stored in the memory, to perform any of the methods described above.

### Multi-Value Selection List Capability

Our technology supports a traditional spreadsheet picklist capability, as exampled in FIG. 37A and FIG. 37B, altered to populate more than one value in a single spreadsheet cell as exampled in FIG. 96A through FIG. 99A. Implementations support the picklist source being spreadsheet cells, as exampled in, non-spreadsheet cell data as frequently described in our other filings, and a user inputted list within the capability. Implementations of our technology present the picklist in a dropdown or popup UI as exampled in FIG. 98B, FIG. 98C, and FIG. 99C. Implementations present in the dropdown or popup UI the count of the duplicates for each deduped value presented in the list as exampled in FIG. 98B 9867. The picklists can be sourced from spreadsheet cell data as exampled in FIG. 96A through FIG. 101B or from non-spreadsheet cell external data as exampled in FIG. 136A through FIG. 136B.

### Multi-Value Selection List Capability—Partial Locking

Another set of implementations of our multi-value selection list capability technology involves the partial locking of the cell and its capability so that the picklist source list specification is locked but the ability to change selections from the picklist is not locked as exampled in FIG. 99B through FIG. 101B. Where those selection list changes not only change the multiple values stored in the cell but change the result of formulas that reference them as exampled in the summation value in FIG. 99D 9997 versus the summation value in FIG. 99C 9967.

In further implementations the lockable selections of the source content is hidden from the user once locked while not hiding the picklist as exampled in FIG. 101A and FIG. 101B. In this and other applicable implementations a lock icon is displayed and then as appropriate accompanied by a hiding icon as exampled in FIG. 101A and FIG. 101B 10134.

Implementations of our partial locking of our multi-value selection list capability can make it so locking a cell holding a multi-value selection list capability automatically partially locks the cell as exampled in FIG. 65A or where the user gets a choice and can specify it as exampled in FIG. 65B. The locking can be password protected as exampled in FIG. 65B or can be password free as exampled in FIG. 65A. As described later the password free locking protection can be such that once the spreadsheet is locked and “built” the user has no access to unlock and gain access to the unlocked version as exampled in FIG. 133A and FIG. 133B.

### Multi-Value Selection List Capability—Other Implementations

Other implementations of our multi-value selection list technologies may include a non-transitory computer readable storage medium storing instructions executable by a processor to perform any of the methods described above. And other implementation may include a system including memory and one or more processors operable to execute instructions, stored in the memory, to perform any of the methods described above.

### Multi-Value Validation Capability

Our technology supports a traditional spreadsheet cell validation capability, as exampled in FIG. 24A and FIG. 32C, altered to accept input of more than one value in a single spreadsheet cell as exampled in FIG. 89A through FIG. 95D and FIG. 104A through FIG. 107C for multiple individual value inputs, as exampled in FIG. 108A through FIG. 112B for multiple values input via a range, and as exampled in FIG. 113A through FIG. 117B for multiple values input via an inequality.

Implementations support the values inputted being direct inputs, cell reference inputs, formulaic data inputs, or combinations therein of numbers, dates, times, text, or other data input. Implementations support those multiple values being directly entered into the cell with some type of delimiter separating the values or in a predefined spreadsheet function which comes prebuilt with the spreadsheet as exampled in FIG. 105A through FIG. 105D. Implementations of the range multiple value input can employ a value and then one or more separator character and another value defining the range as exampled in FIG. 108A through FIG. 112B or a combination of inequalities. The inequality can be entered as an inequality as exampled in FIG. 113A through FIG. 117B and of course all of these could be entered using a UI's paralleling some or all of the content of FIG. 109A 10934.

Implementations support the data validation similar to the regular spreadsheet validation of a single value but in our technology rejecting and/or warning the user if any one of the multiple set of values fails the validation data type or data type and data value constraints as exampled in FIG. 93B, FIG. 104B, FIG. 108B, and FIG. 113B for different data type validations, as exampled in FIG. 109B and FIG. 111B for a range specified data values validation constraint, and as exampled in FIG. 94B, FIG. 114B, and FIG. 115D for an inequality specified data values validation constraint.

### Multi-Value Validation Capability—Cell Message

Implementations of our family of multi-value capabilities automatically generate a cell message that accompanies the cell when it is highlighted, clicked into, or double clicked into/opened as exampled in as exampled in FIG. 91A 9124, FIG. 91C 9174, FIG. 105A 10523, FIG. 110A 11023, FIG. 110C 11074, and FIG. 115A 11523. That cell message is generated in a UI that displays the required data type as exampled in FIG. 91A 9124, FIG. 91C 9174, FIG. 105A 10523, FIG. 110A 11023, FIG. 110C 11074, and FIG. 115A 11523 and when applicable the data values constraint as exampled in FIG. 91A 9124, FIG. 91C 9174, FIG. 110A 11023, FIG. 110C 11074, and FIG. 115A 11523.

### Multi-Value Validation Capability—Input Rejection or Warning

Implementations of our family of multi-value capabilities automatically rejects the input of a value or values that are do not comply with the validation constraint or constraints as exampled in FIG. 91D 9194 and FIG. 110 11094. The rejection can be done in many different ways beyond the popups employed in those examples. In other implementations the user is automatically warned of validation constraint or constraints non-compliance, but the input is not rejected as exampled in FIG. 131A through FIG. 132B.

### Multi-Value Validation Capability—Partial Locking

Implementations of our multi-value capabilities support our partial locking of the cell. Where the data type and data value, if applicable, validation constraints are locked but the ability to change the multi-values is unlocked and changeable as exampled in FIG. 92A/FIG. 92B, FIG. 95A/FIG. 95B, and FIG. 106C/FIG. 106D.

Implementations of our technology automatically display a visual indication of the partial locked status as exampled in the black lock in the formula bar in FIG. 92A, FIG. 92B, FIG. 93A, FIG. 95A, FIG. 95B, and FIG. 106A through FIG. 106D indicating the validation constraints are locked. Implementations of our technology also automatically display a visual indication of both the partial locked and partial hidden status as exampled in FIG. 112A and FIG. 112B for the locking and hiding of the validation constraints.

Implementations of our partial locking of our multi-value validation capability can make it so locking a cell holding a multi-value validation capability automatically partially locks the cell as exampled in FIG. 65A or where the user gets a choice and can specify it as exampled in FIG. 65B. The locking can be password protected as exampled in FIG. 65B or can be password free as exampled in FIG. 65A. As described later the password free locking protection can be such that once the spreadsheet is locked and “built” the user has no access to unlock and gain access to the unlocked version as exampled in FIG. 133A and FIG. 133B.

### Multi-Value Capability—Other Implementations

Other implementations of our family of multi-value capabilities may include a non-transitory computer readable storage medium storing instructions executable by a processor to perform any of the methods described above. And other implementation may include a system including memory and one or more processors operable to execute instructions, stored in the memory, to perform any of the methods described above.

### Partial Locking of a Single Value Validation Capability

Our single value validation in a cell capability works like those in existing spreadsheets except our technology automatically generates an input message displaying the validation constraint or constraints as exampled in FIG. 85A 8523 and automatically generates a validation failure warning or a rejection alert UI also displaying the validation constraint or constraints. However, our technology also differs with the existing spreadsheet technology in that our single value in a cell validation capability can be partially locked not just unlocked and not just locked. Our partially locking technology locks the validation constraint or constraints and any other validation settings while not locking the value stored in the spreadsheet cell which is subject to the validation. That value, and the changing of the value post locking is still subject to the validation rules and is successfully referenceable in formulas by other locked or unlocked cell as exampled in FIG. 83A through FIG. 88D and FIG. 138A through FIG. 138D.

Post partial locking in our technology the single value capability cell validates the cell input value just like it did when it was unlocked. Depending on the user or the spreadsheet validation setting when the user changes the input value to one not complying with one or more of the validation constraints, they automatically receive a rejection, as exampled in FIG. 138A/FIG. 138B, or a warning, as exampled in FIG. 138C/FIG. 138D.

Implementations of our partial locking of our single value validation capability can make it so locking a cell holding a single value validation capability automatically partially locks the cell as exampled in FIG. 65A or where the user gets a choice and can specify it as exampled in FIG. 65B. The locking can be password protected as exampled in FIG. 65B or can be password free as exampled in FIG. 65A. As described later the password free locking protection can be such that once the spreadsheet is locked and “built” the user has no access to unlock and gain access to the unlocked version as exampled in FIG. 133A and FIG. 133B.

### Partial Locking of a Single Value Validation Capability—Other Implementations

Other implementations of our family of single value validation capability locking may include a non-transitory computer readable storage medium storing instructions executable by a processor to perform any of the methods described above. And other implementation may include a system including memory and one or more processors operable to execute instructions, stored in the memory, to perform any of the methods described above.

Protection of Spreadsheet Cells without a Password

All of our locking implementations have implementation variants that support protection of the locking, partial locking, and/or hiding from user changes. Our technology supports the typical password protection as exampled in FIG. 65B.

Another set of implementations support password free protection where the user gets a spreadsheet with no ability to change the locking, partial locking, and/or hiding. Where the password free protection, as exampled in FIG. 133A and FIG. 133B, works for fully locked cells, partially locked cell capabilities, and partially locked prebuilt functions such that once the spreadsheet is built, that newly built spreadsheet has no provision for changes to the locking and partial locking. So, that the locked validation rules, messages, and alerts stay locked, as exampled in FIG. 86C through FIG. 87B, FIG. 93A through FIG. 94B, and FIG. 107A through FIG. 107C, while the unlocked cell input stays unlocked, as exampled in FIG. 86A, FIG. 86B, FIG. 92A, FIG. 92B, and FIG. 106A through FIG. 106E. Thus, the partial locking continuing to work in this situation password free. The same password free partial locking works for our differential input functions as exampled in the post locking examples of locking one of the inputs, e.g., the formula bar input, while leaving unlocked another input, e.g., the in-cell input. Examples of this are in FIG. 64, FIG. 66A through FIG. 67D, FIG. 71 through FIG. 73D, and FIG. 75. The same password free partial locking works for our regular input spreadsheet functions. Where the locked arguments stay locked and the unlocked arguments stay changeable as exampled in FIG. 118A through FIG. 125B, FIG. 134A through FIG. 135B, FIG. 141A through FIG. 142D, and FIG. 144A through FIG. 145D. A related set of embodiments extends that no password partial locking of changes to hiding. So, the locking and hiding works as exampled in FIG. 95A through FIG. 95D, FIG. 112A, FIG. 112B, FIG. 117A, and FIG. 117B for the partial locking and hiding of our validation capabilities. As exampled in FIG. 69A through FIG. 70D, FIG. 74, FIG. 76, and FIG. 78 for the partial locking and hiding of our differential input validation predefined functions. And as exampled in FIG. 148A through FIG. 7149D for the partial locking and hiding of our regular input spreadsheet functions.

### All Implementations

While the technology disclosed is disclosed by reference to the embodiments and examples detailed above, it is to be understood that these examples are intended in an illustrative rather than in a limiting sense. It is contemplated that modifications and combinations will readily occur to those skilled in the art, which modifications and combinations will be within the spirit of the innovation and the scope of the following clauses and claims. The reader will understand how embodiments identified in this filing can readily be combined with other embodiments in this filing.

### CLAUSES

Differentiated Dual Input Functions with Locking

### Upon Functional Formula Reopening

1. A method that implements a spreadsheet cell formula as a predefined function which supports two different inputs that differ in the content of the inputs that they accept after first instantiation of the formula, including:
receiving entry in a spreadsheet cell of a predefined spreadsheet function that comes prebuilt with a spreadsheet application;
after the predefined spreadsheet function is successfully completed in a cell, including functional arguments, receiving input reopening editing of the cell, providing in an interface to the spreadsheet application an input one and an input two that differ in the functional arguments that they accept;
   wherein the input one is direct in cell input, and
   wherein input two is formula bar input;
wherein the predefined spreadsheet function delivers an output value for the spreadsheet cell that is referenceable by other spreadsheet cells.

2. The method of clause 1, wherein, upon the reopening, the first input accepts the argument or arguments that specify the value or values populated in the cell and input two accepts functional arguments not accepted by input one.

3. The method of clause 1, wherein, upon the reopening, the first input accepts the argument or arguments that specify the value or values populated in the cell and the input two accepts functional arguments not accepted by the input one that constrain the value or values.

### From Function Ready for First Argument

4. A method that implements a spreadsheet cell formula as a predefined function which supports two different inputs that differ in content of the inputs that they accept, including:
a predefined spreadsheet function that comes prebuilt with a spreadsheet application;
wherein, after a name of the function is inputted into a cell formula and the predefined spreadsheet function is ready to accept entry of a first function argument, an input one and an input two, provided for using and completing the predefined spreadsheet function, differ in functional arguments that they accept;
   wherein the input one is direct in cell input, and
   where input two is formula bar input;
wherein one of the two inputs then accepts one or more functional arguments not accepted by the other input; and
wherein the function delivers an output value that is referenceable by other spreadsheet cells.

5. The method of clause 4, wherein once the function is inputted into the cell formula and the user is in the input that does not accept the first argument the spreadsheet automatically switches them to the other input.)

### Different Input Setups

6. The method of any of clauses 1 and 4, wherein the one input accepts all the functional formula arguments and the other input only accepts the value or values outputted by the cell argument or arguments.

7. The method of clause 6, wherein the second input accepts all the functional formula arguments and the first input only accepts the argument or arguments that accept the value or values outputted by the cell.

8. The method of any of clauses 1 and 4, wherein the second input accepts all the functional formula arguments except the argument or arguments accepted by the first input.

### INPUT Validation

9. The method of any of clauses 6, 7, and 8, wherein arguments of the functional formula validate the value or values outputted in the cell.

10. The method of clause 9, wherein the validation is for the data type of the value or values outputted by the cell functional formula.

11. The method of clause 9, wherein the validation is for a constrained set of values outputted by the cell functional formula.

12. The method of clause 11, wherein the validation constraint set of values is specified by one or more range of acceptable or unacceptable values.

13. The method of clause 11, wherein the validation constraint set of values is specified by an inequality of acceptable or not acceptable values.

### INPUT Single/Multiple Values

14. The method of any of clauses 1 and 4, wherein the output populated in the cell by the function is a single value.

15. The method of any of clauses 1 and 4, wherein the output populated in the cell by the function is a set of multiple values.

16. The method of clause 15, wherein the set of multiple values are defined by a range of values.

17. The method of clause 15, wherein the set of multiple values are defined by a set of individual values.

18. The method of clause 15, wherein the set of multiple values are defined by an inequality.

19. The method of any of clauses 1 and 4, wherein the output populated in the cell by the function is inputted by a referenced cell.

20. The method of any of clauses 1 and 4, wherein the function output referenceable in the cell is a Boolean value.

21. The method of clause 20, wherein the Boolean value is supplied by a checkbox populated within the direct cell input within the cell.

### INPUT Cell Message

22. The method of clause 9, wherein predefined spreadsheet function automatically generates a UI displaying the validation requirements.

23. The method of clause 22, wherein validation UI is automatically displayed when the cell is highlighted, clicked into or double clicked into.

24. The method of clause 22, wherein that UI displays the data type constraint in the UI message.

25. The method of clause 22, wherein that UI displays the acceptable validation constraint data values.

### INPUT Rejection or Warning

26. The method of clause 9, wherein the predefined spreadsheet function automatically rejects an output value or values non-compliant with validation input.

27. The method of clause 9, wherein the predefined spreadsheet function automatically warns a user from entering an output value or values non-compliant with validation input.

### INPUT Cell Distinctiveness

28. The method of any of clauses 1 and 4, wherein the predefined spreadsheet function automatically displays an input request message in the cell if the value argument lacks a specified value.

29. The method of any of clauses 1 and 4, wherein the cell occupied by a completed version of the predefined spreadsheet function has a differentiating appearance.

30. The method of clause 29, wherein the differentiating appearance is a shape within the cell.

### INPUT Cell Partial Locking

31. The method of any of clauses 1 and 4, wherein locking of the cell partially locks the cell locking some but not all of the function arguments.

32. The method of any of clauses 1 and 4, wherein locking of the cell partially locks the cell locking the use of the second input while not locking the use of the first input.

33. The method of any of clauses 31 and 32, wherein the partial locking Is automatically triggered by cell locking.

34. The method of any of clauses 31 and 32, wherein the partial locking is user selected as part of the locking process.

35. The method of any of clauses 31 and 32, wherein the locking mechanism is password protected.

36. The method of any of clauses 31 and 32, wherein the locking mechanism is password free yet stops the user from unlocking.

37. The method of any of clauses 31 and 32, wherein locking of the cell displays visual indication of the locked status in the input two UI.

38. The method of clause 31, wherein locking and hiding hides the locked arguments.

39. The method of clause 32, wherein locking and hiding hides the second input formula.

40. The method of clause 38, wherein locking of the cell and hiding of the cell formula displays visual indication of the locked input and hidden formula status in the input two UI.

### Other Implementations

41. A non-transitory computer readable memory, the memory impressed with computer instructions that, when executed on hardware, cause the hardware to carry out the method of any of clauses 1 through 40.

42. A system including processing hardware coupled to memory, the memory impressed with computer instructions that, when executed, cause the hardware to carry out the method of any of clauses 1 through 40.

Regular Input Validation Functions with Locking

43. A method that implements a spreadsheet cell formula as a predefined function in which one argument is the proposed output, subject to validation by rules defined in one or more other arguments, including:
receiving entry in a spreadsheet cell of a predefined spreadsheet function that comes prebuilt with the spreadsheet application;
   wherein the predefined spreadsheet function includes multiple arguments:
      argument one accepts an input for validation and for output of the cell, and
      argument two contains a validation rule to be applied to argument one,
receiving initial entry and, in instances when the initial entry is rejected, correction of an argument one value;
testing the initial entry against the argument two validation rule and
   rejecting the initial entry and receiving one or more corrections, until a corrected value or values pass the argument two validation rule, or
   accepting the initial entry despite not passing the argument two validation rule and causing display of a warning provided in a message to a user,
outputting from the cell the accepted value or values, as a spreadsheet function output result, wherein the accepted output values or values is/are referenceable by other spreadsheet cells.

### INPUT Single/Multiple Values

44. A method of clause 43, wherein argument one accepts a single value.

45. A method of clause 43, wherein argument one accepts a set of multiple values.

46. A method of clause 45, wherein the set of multiple values are defined by a range of values.

47. A method of clause 45, wherein the set of multiple values are defined by a set of individual values.

48. A method of clause 45, wherein the set of multiple values are defined by an inequality.

49. A method of clause 43, wherein the input in argument one is a referenced cell.

50. A method of clauses 43, wherein the input in argument one is a Boolean value.

51. The method of clause 50, wherein the Boolean value is supplied by a checkbox populated within the cell. {like 129A-130E))

### INPUT Validation

52. A method of clause 43, wherein there is one or more argument two.

53. A method of clause 52, wherein argument two validation is for the data type of the value or values in argument one.

54. A method of clause 52, wherein the argument two validation is for a constrained set of values in argument one.

55. A method of clause 54, wherein the validation constraint set of values is specified by one or more range of acceptable or unacceptable values.

56. The method of clause 54, wherein the validation constraint set of values is specified by an inequality of acceptable or not acceptable values.

### INPUT Cell Message

57. A method of clause 43, wherein predefined spreadsheet function automatically generates a UI displaying the validation requirements.

58. The method of clause 57, wherein validation UI is automatically displayed when the cell is highlighted, clicked into or double clicked into.
59. A method of clause 57, wherein that UI displays the argument two data type constraint in the UI message.

60. The method of clause 57, wherein that UI displays the argument two acceptable validation constraint data values.

### INPUT Rejection or Warning

61. A method of clause 43, wherein the predefined spreadsheet function automatically rejects an argument one input non-compliant with argument two validation argument.

62. The method of clause 43, wherein the predefined spreadsheet function automatically warns a user from entering an argument one input non-compliant with argument two validation argument.

### INPUT Cell Distinctiveness

63. A method of clause 43, wherein the predefined spreadsheet function automatically displays an input request message in the cell if the value argument lacks a specified argument one.

65. The method of clauses 64, wherein the differentiating appearance is a shape within the cell.

### INPUT Cell Partial Locking

66. A method of clause 43, wherein locking of the function partially locks the function locking some but not all of the function arguments.

67. A method of clause 66, wherein the partial locking locks the use of the second input while not locking the use of the first input.

68. The method of clause 66, wherein the partial locking Is automatically triggered by cell locking.

69. A method of clause 66, wherein the partial locking is user selected as part of the locking process.

70. The method of clause 66, wherein the partial locking mechanism is password protected.

71. The method of clause 66, wherein the locking mechanism is password free yet stops the user from unlocking.

72. A method of clause 66, wherein partial locking of the cell displays visual indication of the locked status.

73. A method of clause 66, wherein partial locking and hiding hides the locked arguments.

74. A method of clause 73, wherein partial locking and hiding hides the second argument.

75. A method of clause 73, wherein locking of the cell and hiding of the cell formula displays visual indication of the locked input and hidden formula status in the input two UI.

### Regular Input Validation Functions—Other Implementations

76. A non-transitory computer readable memory, the memory impressed with computer instructions that, when executed on hardware, cause the hardware to carry out the method of any of clauses 43 through 75.

77. A system including processing hardware coupled to memory, the memory impressed with computer instructions that, when executed, cause the hardware to carry out the method of any of clauses 43 through 75.

### Partial Locking of a Picklist Function

78. A method of providing a user interface including a lockable picklist for inserting a value into a cell, using a spreadsheet function running on a system including at least one processor and memory coupled to the processor, the method including:
providing a user interface including a picklist that references a list source that is not adjacent to the cell and is used for inserting a value into a cell, using a spreadsheet function,
responsive to selection of the cell containing the user interface picklist function,
   automatically retrieving, sorting and deduplicating values from the list source without modifying the list source itself;
   returning an initially displayable value to the cell that
      is from the list source,
      is blank awaiting selection from the list source, or
      is an instruction regarding use of the list source;
   making the picklist for the cell available responsive to the selection by presenting the sorted and deduplicated values;
providing a mechanism wherein a user can lock the picklist from further alteration without locking selection of a value or values from the picklist; and
upon receiving the selection from the locked picklist, replacing the initially displayable value or previously selected value or values returned by the picklist for use in the cell.

79. The method of clause 78, wherein locking the picklist locks all the picklist function arguments except the selection of the value or values argument or arguments.

80. The method of clause 78, wherein the partial locking Is automatically triggered by cell locking.

81. A method of clause 78, wherein the partial locking is user selected as part of the locking process.

82. The method of clause 78, wherein the locking mechanism is password protected.

83. The method of clause 78, wherein the locking mechanism is password free yet stops the user from unlocking.

84. A method of clause 78, wherein locking of the cell displays visual indication of the locked status in the formula bar.

85. A method of clause 78, wherein locking and hiding hides the locked arguments.

86. A method of clause 78, wherein locking and hiding hides the formula bar formula without locking and hiding the picklist selection UI and stopping selection changes.

87. A non-transitory computer readable memory, the memory impressed with computer instructions that, when executed on hardware, cause the hardware to carry out the method of any of clauses 78 through 86.

88. A system including processing hardware coupled to memory, the memory impressed with computer instructions that, when executed, cause the hardware to carry out the method of any of clauses 78 through 86.

### Partial Locking of a Regular Function

89. A method that implements locking of some but not all arguments of a spreadsheet predefined function in a spreadsheet cell, including:
receiving entry of a predefined spreadsheet function that comes prebuilt with the spreadsheet application containing first and second arguments,
receiving invocation of a spreadsheet cell partial locking process wherein
   one or more of the first arguments, post locking of the function, cannot be changed; and
   one or more of the second arguments, post locking of the function, can be changed;
responsive, post locking, to a user change to one or more unlocked second arguments, replacing a previously specified value of the second argument for use in the predefined function; and
revaluating the predefined function in the cell formula and altering the cell calculated value.

90. The method of clause 89, wherein the non-lockable second argument or arguments of the function are application specified.

91. The method of clause 89, wherein the non-lockable second argument or arguments of the function are user specified.

92. The method of clause 90, wherein the specification is done at the time of cell locking.

93. The method of clause 89, wherein the cell containing the locked function automatically displays an accompanying UI with a message informing the user of the unlocked argument.

94. The method of clause 92, wherein the message is automatically generated.

95. The method of clause 92, wherein the message is specified by the user during locking.

96. The method of clause 89, wherein the locking mechanism is password protected.

97. The method of clause 89, wherein the locking mechanism is password free yet stops the user from unlocking.

98. The method of clause 89, wherein the lockable argument content is hidden from the user once locked.

99. A non-transitory computer readable memory, the memory impressed with computer instructions that, when executed on hardware, cause the hardware to carry out the method of any of clauses 89 through 98.

100. A system including processing hardware coupled to memory, the memory impressed with computer instructions that, when executed, cause the hardware to carry out the method of any of clauses 89 through 98.

### Multi-Value Selection List CAPABILITY

101. A method of providing a user interface picklist for inserting multiple values into a cell, using a spreadsheet cell validation capability running on a system including at least one processor and memory coupled to the processor, the method including:
responsive to a user a cell that includes the interface picklist capability, wherein the picklist references a list source that is not adjacent to the cell that holds the interface picklist capability:
   automatically retrieving, sorting and deduplicating values from the list source without modifying the list source itself,
   returning an initially displayable value to the cell that is from the list source, is blank awaiting a selection from the list source, or is an instruction regarding use of the list source;
   making the picklist for the cell available for value selection by presenting the sorted and deduplicated values; and
upon receiving multiple selections from the picklist, replacing the initially displayable value returned by the picklist with the multiple values to the cell, wherein the multiple values are referenceable values and can be used by functional formulas in other cells.

102. The method of clause 101, wherein the list source is from spreadsheet cells.

103. The method of clause 101, wherein the list source is from Non-spreadsheet cell data.

104. The method of clause 101, wherein the list source is user inputted.

105. The method of clause 101, wherein the picklist is presented from the cell in a drop-down or pop-up UI.

106. The method of clause 101, wherein the picklist after deduplicating is presented with a count of duplicates for values deduplicated.

107. A method of clause 101, wherein locking of the cell locks the list source specification but not the ability to make and change selections from the picklist.

108. A method of clause 106, wherein locking of the cell hides the specification selections for the source list specification while not hiding the picklist.

109. A method of clause 107, wherein locking of the cell displays visual indication of the locked status in the formula bar or the picklist or both.

110. The method of clause 107, wherein the partial locking Is automatically triggered by cell locking.

111. A method of clause 107, wherein the partial locking is user selected as part of the locking process.

112. The method of clause 107, wherein the locking mechanism is password protected.

113. The method of clause 107, wherein the locking mechanism is password free yet stops the user from unlocking.

114. A non-transitory computer readable memory, the memory impressed with computer instructions that, when executed on hardware, cause the hardware to carry out the method of any of clauses 101 through 113.

115. A system including processing hardware coupled to memory, the memory impressed with computer instructions that, when executed, cause the hardware to carry out the method of any of clauses 101 through 113.

### Multi-Value CAPABILITY

116. A method of providing a user a spreadsheet cell input validation capability to apply validation constraints on multiple values entered into one spreadsheet cell running on a system including at least one processor and memory coupled to the processor, including:
providing a cell capability that accepts one or more validation constraint inputs;
providing a cell capability that supports input and storage in a single cell of multiple values;
providing a cell validation capability that if any value in the multiple values input in the cell does not fulfill the validation constraint or constraints rejects entry of the multiple values and/or generates a warning of the cell validation failure, and
receiving initial entry and at least one correction, wherein the initial entry is rejected, and the correction includes a set of multiple values that fulfill the validation constraints;
making the set of multiple values populated in the spreadsheet cell available for use by formulas in other cells.

117. The method of clause 116, wherein the multiple values are inputted as separate values, cell references, formulaic data or their combinations.

118. The method of clause 116, wherein the multiple values are inputted in a predefined spreadsheet function.

120. The method of clause 119, wherein the range is specified by a value then a separator character or characters and a value with the values defining the ends of the range.

121. The method of clause 116, wherein the multiple values are inputted as an inequality.

122. The method of clause 116, wherein the cell validation capability has a data type validation constraint.

123. The method of clause 116, wherein the cell validation capability has a value range validation constraint.

124. The method of clause 116, wherein the cell validation capability has an inequality validation constraint.

126. The method of clause 124, wherein the UI displaying the validation requirements is automatically displayed when the cell is opened.

127. A method of clause 124, wherein that UI displays the required data type in the UI message.

128. The method of clause 124, wherein that UI displays the acceptable input data value range or inequality.

129. A method of clause 116, wherein the cell validation capability automatically displays an input Alert message stating the validation requirements if the input does not fulfill the validation requirements.

130. The method of clause 116, wherein partial locking of the cell locks the validation constraints applicable to input but does not lock input of one or more values to be stored in the spreadsheet cell.

131. The method of clause 130, wherein the partial locking Is automatically triggered by cell locking.

132. A method of clause 130, wherein the partial locking is user selected as part of the locking process.

133. The method of clause 130, wherein the locking mechanism is password protected.

134. The method of clause 130, wherein the locking mechanism is password free yet stops the user from unlocking.

135. The method of clause 130, wherein the locking of the cell hides the validation input or inputs.

136. A non-transitory computer readable memory, the memory impressed with computer instructions that, when executed on hardware, cause the hardware to carry out the method of any of clauses 116 through 135.

137. A system including processing hardware coupled to memory, the memory impressed with computer instructions that, when executed, cause the hardware to carry out the method of any of clauses 116 through 135.

### Partial Locking of Single Value Validation Capability

138. A method of providing a user a partially lockable spreadsheet cell single value validation capability, including:
providing a cell capability that accepts one or more validation constraint inputs;
providing a cell capability that supports single value input and storage in a single cell of an initial value;
providing a cell validation capability that rejects entry of a value if the value does not fulfill the validation constraints and/or that generates a warning of the cell validation failure;
receiving and implementing a partial locking directive for the cell that locks the validation constraints applicable to input but does not lock input of the value stored in the spreadsheet cell; and
receiving and applying the cell validation capability to validate entry of an input to the cell making the value in the spreadsheet cell available for use by formulas in other cells.

139. The method of clause 138, further including providing a cell validation capability that rejects replacement of an initial value with a replacement value if that value does not fulfill the validation constraints and/or for generating a warning of the cell validation failure.

140. The method of clause 138, wherein the partial locking Is automatically triggered by cell locking.

141. A method of clause 138, wherein the partial locking is user selected as part of the locking process.

142. The method of clause 138, wherein the locking mechanism is password protected.

143. The method of clause 138, wherein the locking mechanism is password free yet stops the user from unlocking.

144. A non-transitory computer readable memory, the memory impressed with computer instructions that, when executed on hardware, cause the hardware to carry out the method of any of clauses 138 through 143.

145. A system including processing hardware coupled to memory, the memory impressed with computer instructions that, when executed, cause the hardware to carry out the method of any of clauses 138 through 143.

Protection of Spreadsheet Cells without a Password

146. A method of providing a user a spreadsheet with lockable and partially lockable cell and formula content with password free protection from locking alteration, including:
providing a locking mechanism for spreadsheet cell;
providing a partially locking mechanism for a spreadsheet cell or cell formula:
   where at least one cell capability input is locked and does not accept changes and at least one cell capability is unlocked and accepts changes, and
   where at least one spreadsheet prebuilt function argument input is locked and does not accept changes and at least argument is unlocked and accepts changes
providing a spreadsheet build method so a user of the built spreadsheet is not allowed to make changes, either with or without a password, to one or more:
   locked cells,
   locked validation rules in partially locked cells that include validation capabilities,
   locked differential input in partially locked cells that include a predefined function, and
   locked arguments in partially locked cells that include a predefined partially locked function.

147. The method of clause 146, wherein the build mechanism also locks hiding prebuilt function formulas and cell capability inputs.

148. A non-transitory computer readable memory, the memory impressed with computer instructions that, when executed on hardware, cause the hardware to carry out the method of any of clauses 146 and 147.

149. A system including processing hardware coupled to memory, the memory impressed with computer instructions that, when executed, cause the hardware to carry out the method of any of clauses 146 and 147.

We claim as follows:

1. A method that implements a spreadsheet cell formula as a predefined function which supports two different inputs that differ in content of the inputs accepted after first instantiation of the formula, including:
receiving entry in a spreadsheet cell of a predefined spreadsheet function that comes prebuilt with a spreadsheet application;
after the predefined spreadsheet function formula is successfully completed in a cell, including functional arguments, receiving input reopening editing of the cell, providing in an interface to the spreadsheet application an input one and an input two that differ in the functional arguments that they accept;
wherein the input one is direct in cell input, and
wherein input two is formula bar input;
wherein the predefined spreadsheet function delivers an output value for the spreadsheet cell that is referenceable by other spreadsheet cells.

2. The method of claim 1, wherein, upon the reopening, the input one accepts the argument or arguments that specify the value populated in the cell and input two accepts functional arguments not accepted by input one.

3. The method of claim 1, wherein, upon the reopening, the input one accepts the argument or arguments that specify the value populated in the cell and the input two accepts functional arguments not accepted by the input one that constrain the value or values.

4. The method of claim 1, wherein the input two accepts all the functional arguments and the input one only accepts the argument or arguments that accept the value outputted by the cell.

5. The method of any of claim 1, wherein the input two accepts all the functional arguments except the argument or arguments accepted by the input one.

6. The method of any of claim 1, wherein arguments of the functional formula validate the value outputted in the cell.

7. The method of claim 6, wherein the validation is for a data type of the value outputted by the cell functional formula.

8. The method of claim 6, wherein the validation is for a constrained set of values outputted by the cell functional formula.

9. The method of any of claim 1, wherein the output populated in the cell by the function is inputted by a referenced cell.

10. The method of any of claim 1, wherein the output value referenceable in the cell is a Boolean value.

11. The method of claim 10, wherein the Boolean value is supplied by a checkbox populated within the direct in cell input.

12. The method of claim 6, wherein the predefined function automatically generates a UI displaying the validation requirements.

13. The method of claim 12, wherein validation UI is automatically displayed when the cell is highlighted, clicked into or double clicked into.

14. The method of claim 12, wherein that UI displays a data type constraint in a UI message.

15. The method of claim 12, wherein that UI displays the acceptable validation constraint data values.

16. The method of claim 6, wherein the predefined spreadsheet function automatically rejects an output value or values non-compliant with validation input.

17. The method of claim 6, wherein the predefined spreadsheet function automatically warns a user from entering an output value or values non-compliant with validation input.

18. The method of any of claim 1, wherein the predefined spreadsheet function automatically displays an input request message in the cell if a value argument lacks a specified value.

19. A non-transitory computer readable memory, the memory impressed with computer instructions that, when executed on hardware, cause the hardware to carry out actions that implement a spreadsheet cell formula as a predefined function which supports two different inputs that differ in content of the inputs accepted after first instantiation of the formula, including:
receiving entry in a spreadsheet cell of a predefined spreadsheet function that comes prebuilt with a spreadsheet application;
after the predefined spreadsheet function formula is successfully completed in a cell, including functional arguments, receiving input reopening editing of the cell, providing in an interface to the spreadsheet application an input one and an input two that differ in the functional arguments that they accept;
wherein the input one is direct in cell input, and
wherein input two is formula bar input;
wherein the predefined spreadsheet function delivers an output value for the spreadsheet cell that is referenceable by other spreadsheet cells.

20. The non-transitory computer readable medium of claim 19, wherein, upon the reopening, the input one accepts the argument or arguments that specify the value populated in the cell and input two accepts functional arguments not accepted by input one.

21. The non-transitory computer readable medium of claim 19, wherein arguments of the functional formula validate the value outputted in the cell.

22. The non-transitory computer readable medium of claim 19, wherein the predefined function automatically generates a UI displaying the validation requirements.

23. A system including processing hardware coupled to memory, the memory impressed with computer instructions that, when executed, cause the hardware to carry out actions that implement a spreadsheet cell formula as a predefined function which supports two different inputs that differ in content of the inputs accepted after first instantiation of the formula, including:
receiving entry in a spreadsheet cell of a predefined spreadsheet function that comes prebuilt with a spreadsheet application;
after the predefined spreadsheet function formula is successfully completed in a cell, including functional arguments, receiving input reopening editing of the cell, providing in an interface to the spreadsheet application an input one and an input two that differ in the functional arguments that they accept;
wherein the input one is direct in cell input, and
wherein input two is formula bar input;
wherein the predefined spreadsheet function delivers an output value for the spreadsheet cell that is referenceable by other spreadsheet cells.

24. The system of claim 23, wherein, upon the reopening, the input one accepts the argument or arguments that specify the value populated in the cell and input two accepts functional arguments not accepted by input one.

25. The system of claim 23, wherein, arguments of the functional formula validate the value outputted in the cell.

26. The system of claim 23, wherein, the predefined function automatically generates a UI displaying the validation requirements.
